(19) United States
(12) Patent Application Publication
(10) Pub. No.: US 2024/0264473 A1
(43) Pub. Date: Aug. 8, 2024

(54) LIQUID CRYSTAL POLARIZATION HOLOGRAM AND FABRICATION METHOD THEREOF

(71) Applicant: Meta Platforms Technologies, LLC, Menlo Park, CA (US)

(72) Inventors: Yuge HUANG, Painted Post, NY (US); Tingling RAO, Bellevue, WA (US); Sheng YE, Redmond, WA (US); Junren WANG, Bothell, WA (US); Lu LU, Kirkland, WA (US); Hsien-Hui CHENG, Woodinville, WA (US)

(21) Appl. No.: 18/418,252

(22) Filed: Jan. 20, 2024

Related U.S. Application Data
(60) Provisional application No. 63/483,534, filed on Feb. 6, 2023.
(60) Provisional application No. 63/488,477, filed on Mar. 3, 2023.

(51) Int. Cl. G02F 1/00; G02F 1/1333; G03H 1/02; G03H 1/22; G02F 1/1337

(52) U.S. Cl. CPC G02F 1/0045; G02F 1/133365; G03H 1/0256; G03H 1/2294; G02F 1/133788; G03H 2001/0264; G03H 2250/38

(57) ABSTRACT

A device includes a substrate, an alignment structure disposed on the substrate, and a layer of a birefringent medium disposed on the alignment structure. The birefringent medium has an extraordinary refractive index, an ordinary refractive index different from the extraordinary refractive index, and an intermediate refractive index between the extraordinary refractive index and the ordinary refractive index. Molecules of the birefringent medium are configured to form helical structures having a helical axis. The layer is configured with an out-of-plane principal refractive index along the helical axis, and two equal in-plane principal refractive indices within a plane perpendicular to the helical axis. The out-of-plane principal refractive index is equal to the intermediate refractive index, and is substantially the same as the two equal in-plane principal refractive indices.

### CROSS REFERENCE TO RELATED APPLICATIONS

This application claims the benefit of priority to U.S. Provisional Application No. 63/483,534, filed on Feb. 6, 2023, and to U.S. Provisional Application No. 63/488,477, filed on Mar. 3, 2023. The contents of the above-referenced applications are incorporated by reference in their entirety.

### TECHNICAL FIELD

The present disclosure generally relates to optical devices and fabrication methods and, more specifically, to a liquid crystal polarization hologram and a fabrication method thereof.

### BACKGROUND

Liquid crystal polarization holograms (“LCPHs”) combine features of liquid crystal devices and polarization holograms. Liquid crystal displays (“LCDs”), having grown to a trillion dollar industry over the past decades, are the most successful examples of liquid crystal devices. The LCD industry has made tremendous investments to scale manufacturing, from the low end G2.5 manufacturing line to the high end G10.5+ to meet the market demands for displays. However, the LCD industry has recently faced competition from organic light-emitting diodes (“OLED”), e-paper and other emerging display technologies, which has flattened the growth rate of LCD industry and has rendered significant early generation capacity redundant. This provides an opportunity to repurpose the LCD idle capacity and existing supply chain to manufacture novel LC optical devices characterized by their polarization holograms.

LCPHs or LCPH elements have features such as small thickness (about 1 um), light weight, compactness, large aperture, high efficiency, simple fabrication, etc. Thus, LCPH elements have gained increasing interests in optical device and system applications, e.g., near-eye displays (“NEDs”), head-up displays (“HUDs”), head-mounted displays (“HMDs”), smart phones, laptops, televisions, or vehicles, etc. For example, LCPH elements may be used for addressing accommodation-vergence conflict, enabling thin and highly efficient eye-tracking and depth sensing in space constrained optical systems, developing optical combiners for image formation, correcting chromatic aberrations for image resolution enhancement of refractive optical elements in compact optical systems, and improving the efficiency and reducing the size of optical systems.

### SUMMARY OF THE DISCLOSURE

Consistent with an aspect of the present disclosure, a device is provided. The device includes a substrate, an alignment structure disposed on the substrate, and a layer of a birefringent medium disposed on the alignment structure. The birefringent medium has an extraordinary refractive index, an ordinary refractive index different from the extraordinary refractive index, and an intermediate refractive index between the extraordinary refractive index and the ordinary refractive index. Molecules of the birefringent medium are configured to form a plurality of helical structures having a helical axis. The layer is configured with an out-of-plane principal refractive index along the helical axis, and two equal in-plane principal refractive indices within a plane perpendicular to the helical axis. The out-of-plane principal refractive index is equal to the intermediate refractive index, and is substantially the same as the two equal in-plane principal refractive indices.

Consistent with another aspect of the present disclosure, a method is provided. The method includes obtaining a substrate with an alignment structure formed thereon. The method also includes forming a layer of a birefringent medium on the alignment structure. Molecules of the birefringent medium are aligned by the alignment structure to form a plurality of helical structures having a helical axis. The birefringent medium is configured with an extraordinary refractive index, an ordinary refractive index different from the extraordinary refractive index, and an intermediate refractive index between the extraordinary refractive index and the ordinary refractive index. The layer has an out-of-plane principal refractive index along the helical axis, and two equal in-plane principal refractive indices within a plane perpendicular to the helical axis. The out-of-plane principal refractive index is equal to the intermediate refractive index, and is substantially the same as the two equal in-plane principal refractive indices.

Consistent with another aspect of the present disclosure, a method is provided. The method includes forming a first layer including uniaxial molecules arranged in plurality of helical structures having a helical axis. The first layer is defined by a first dimension, a second dimension, and a third dimension that are orthogonal to one another. The first dimension and the second dimension are within a surface of the first layer, and the third dimension is along a thickness direction of the first layer. The method also includes applying an asymmetric field to the first layer along the third dimension and at least one of the first dimension or the second dimension to obtain a second layer having an induced local biaxial optical anisotropy. An out-of-plane principal refractive index of the first layer along the helical axis is greater than an in-plane principal refractive index of the first layer within a plane perpendicular to the helical axis. An out-of-plane principal refractive index of the second layer along the helical axis is substantially the same as an in-plane principal refractive index of the second layer within the plane perpendicular to the helical axis.

Other aspects of the present disclosure can be understood by those skilled in the art in light of the description, the claims, and the drawings of the present disclosure. The foregoing general description and the following detailed description are exemplary and explanatory only and are not restrictive of the claims.

### BRIEF DESCRIPTION OF THE DRAWINGS

The following drawings are provided for illustrative purposes according to various disclosed embodiments and are not intended to limit the scope of the present disclosure. In the drawings:

FIG. 1A illustrates a schematic diagram of a conventional cholesteric liquid crystal (“CLC”) element based on uniaxial liquid crystals;

FIG. 1B illustrates a schematic diagram of a refractive index ellipsoid of liquid crystal (“LC”) molecules included in the conventional CLC element shown in FIG. 1A;

FIG. 1C illustrates an effective refractive index ellipsoid of the conventional CLC element shown in FIG. 1A;

FIG. 2A illustrates a schematic diagram of a liquid crystal polarization hologram (“LCPH”) element, according to an embodiment of the present disclosure;

FIG. 2B illustrates a schematic diagram showing out-of-plane orientations of LC molecules in an LC layer of the LCPH element shown in FIG. 2A, according to an embodiment of the present disclosure;

FIG. 2C illustrates a schematic diagram of an LC molecule included in the LC layer shown in FIG. 2B, according to an embodiment of the present disclosure;

FIG. 2D illustrates an effective refractive index ellipsoid of the LC layer shown in FIG. 2B, according to an embodiment of the present disclosure;

FIG. 2E illustrates a schematic diagram showing out-of-plane orientations of LC molecules in an LC layer of the LCPH element shown in FIG. 2A, according to an embodiment of the present disclosure;

FIG. 2F illustrates an effective refractive index ellipsoid of the LC layer shown in FIG. 2E, according to an embodiment of the present disclosure;

FIGS. 3A-3E illustrate schematic diagrams showing in-plane orientations of LC molecules in the LCPH element shown in FIG. 2A, according to various embodiments of the present disclosure;

FIGS. 3F and 3G illustrate schematic diagrams showing out-of-plane orientations of LC molecules in the LCPH element shown in FIG. 2A, according to various embodiments of the present disclosure;

FIGS. 4A-4C illustrate an electrical tuning of an LCPH element, according to various embodiments of the present disclosure;

FIGS. 5A-5C illustrate biaxial LCs including single-component biaxial LC molecules, according to various embodiments of the present disclosure;

FIG. 5D illustrates biaxial LCs including a mixture of different uniaxial LC molecules, according to an embodiment of the present disclosure;

FIGS. 5E-5G illustrate processes for fabricating an LCPH element disclosed herein, according to an embodiment of the present disclosure;

FIG. 5H illustrate processes for fabricating an LCPH element disclosed herein, according to an embodiment of the present disclosure;

FIG. 6A illustrates processes for fabricating an LCPH element disclosed herein, according to an embodiment of the present disclosure;

FIGS. 6B and 6C illustrate processes for fabricating an LCPH element disclosed herein, according to an embodiment of the present disclosure;

FIGS. 6D and 6E illustrate processes for fabricating an LCPH element disclosed herein, according to an embodiment of the present disclosure;

FIG. 6F illustrates a schematic diagram of an LCPH element fabricated based on the processes shown in FIGS. 6D and 6E, according to various embodiments of the present disclosure;

FIGS. 7-9B schematically illustrate systems including one or more LCPH elements, according to various embodiments of the present disclosure;

FIG. 10A schematically illustrates a system including one or more LCPH elements, according to an embodiment of the present disclosure;

FIG. 10B schematically illustrates an optical path of an image light from a display element to an eyebox of the system shown in FIG. 10A, according to an embodiment of the present disclosure;

FIG. 11 schematically illustrates a system including one or more LCPH elements, according to an embodiment of the present disclosure;

FIG. 12A illustrates a schematic diagram of an artificial reality device, according to an embodiment of the present disclosure;

FIG. 12B schematically illustrates a cross-sectional view of half of the artificial reality device shown in FIG. 12A, according to an embodiment of the present disclosure;

FIG. 13A schematically illustrates a system including one or more LCPH elements, according to an embodiment of the present disclosure;

FIG. 13B schematically illustrates a cross-sectional view of an optical path in the system shown in FIG. 13A according to an embodiment of the present disclosure;

FIG. 14 schematically illustrates a system including one or more LCPH elements, according to an embodiment of the present disclosure;

FIGS. 15A-15C are flowcharts illustrating methods for fabricating an LCPH element disclosed herein, according to various embodiments of the present disclosure;

FIG. 16A schematically illustrates a three-dimensional (“3D”) view of an LCPH element with varying slant angles or twist angles, according to an embodiment of the present disclosure;

FIGS. 16B-16E schematically illustrate various in-plane orientations of optically anisotropic molecules in the LCPH element shown in FIG. 16A, according to various embodiments of the present disclosure;

FIGS. 16F-16I schematically illustrate various out-of-plane orientations of optically anisotropic molecules in the LCPH element shown in FIG. 16A, according to various embodiments of the present disclosure;

FIGS. 17A-17F schematically illustrate processes for fabricating an LCPH element with varying slant angles or twist angles, according to various embodiments of the present disclosure;

FIG. 17G schematically illustrates an LCPH element with a varying slant angle fabricated based on processes shown in FIGS. 17A-17F, according to an embodiment of the present disclosure;

FIG. 17H schematically illustrates out-of-plane orientations of optically anisotropic molecules in the LCPH element shown in FIG. 17G, according to an embodiment of the present disclosure;

FIG. 17I schematically illustrate out-of-plane orientations of optically anisotropic molecules in a conventional LCPH element with a constant slant angle;

FIGS. 18A-18C illustrate schematic diagrams of computer-generated images having a one-dimensional (“1D”) intensity variation or two-dimensional (“2D”) intensity variations, according to various embodiments of the present disclosure;

FIG. 18D illustrates a schematic diagram of a direct writing lithography having a 1D intensity variation, according to an embodiment of the present disclosure;

FIGS. 19A-19E schematically illustrate processes for fabricating an LCPH element with varying slant angles or twist angles, according to various embodiments of the present disclosure;

FIG. 19F schematically illustrates a sectional view of a conductive electrode layer that may be used in the fabrication process shown in FIG. 19E, according to an embodiment of the present disclosure;

FIGS. 20A-20E schematically illustrate processes for fabricating an LCPH element with varying slant angles or twist angles, according to various embodiments of the present disclosure;

FIG. 20F illustrates relationships between driving voltage waveforms for driving a flow control device coupled with a printhead and volumes of droplets dispensed by the printhead, according to an embodiment of the present disclosure;

FIG. 20G schematically illustrates a printing path of a printhead, according to an embodiment of the present disclosure;

FIG. 21A illustrates reversible photo-isomerization of molecular switches that may be included in a material of a photo-responsive chiral dopant, according to various embodiments of the present disclosure;

FIG. 21B illustrates chemical structures of materials that may be included in a photo-responsive chiral dopant, according to various embodiments of the present disclosure;

FIG. 21C illustrates chemical structures of chiral materials that may be included in a thermal-responsive chiral dopant, according to various embodiments of the present disclosure; and

FIGS. 22A-22D are flowcharts illustrating methods for fabricating an LCPH element with varying slant angle or twist angle, according to various embodiments of the present disclosure.

### DETAILED DESCRIPTION

Embodiments consistent with the present disclosure will be described with reference to the accompanying drawings, which are merely examples for illustrative purposes and are not intended to limit the scope of the present disclosure. Wherever possible, the same reference numbers are used throughout the drawings to refer to the same or similar parts, and a detailed description thereof may be omitted.

The phrase “at least one of A or B” may encompass all combinations of A and B, such as A only, B only, or A and B. Likewise, the phrase “at least one of A, B, or C” may encompass all combinations of A, B, and C, such as A only, B only, C only, A and B, A and C, B and C, or A and B and C. The phrase “A and/or B” may be interpreted in a manner similar to that of the phrase “at least one of A or B.” For example, the phrase “A and/or B” may encompass all combinations of A and B, such as A only, B only, or A and B. Likewise, the phrase “A, B, and/or C” has a meaning similar to that of the phrase “at least one of A, B, or C.” For example, the phrase “A, B, and/or C” may encompass all combinations of A, B, and C, such as A only, B only, C only, A and B, A and C, B and C, or A and B and C.

The term “processor” used herein may encompass any suitable processor, such as a central processing unit (“CPU”), a graphics processing unit (“GPU”), an application-specific integrated circuit (“ASIC”), a programmable logic device (“PLD”), or any combination thereof. Other processors not listed above may also be used. A processor may be implemented as software, hardware, firmware, or any combination thereof. The term “controller” may encompass any suitable electrical circuit, software, or processor configured to generate a control signal for controlling a device, a circuit, an optical element, etc. A “controller” may be implemented as software, hardware, firmware, or any combination thereof. For example, a controller may include a processor, or may be included as a part of a processor.

The term “film,” “layer,” “coating,” or “plate” may include rigid or flexible, self-supporting or free-standing film, layer, coating, or plate, which may be disposed on a supporting substrate or between substrates. The terms “film,” “layer,” “coating,” and “plate” may be interchangeable. The term “film plane” refers to a plane in the film, layer, coating, or plate that is perpendicular to the thickness direction or a normal of a surface of the film, layer, coating, or plate. The film plane may be a plane in the volume of the film, layer, coating, or plate, or may be a surface plane of the film, layer, coating, or plate. The term “in-plane” as in, e.g., “in-plane orientation,” “in-plane direction,” “in-plane pitch,” etc., means that the orientation, direction, or pitch is within the film plane. The term “out-of-plane” as in, e.g., “out-of-plane direction,” “out-of-plane orientation,” or “out-of-plane pitch” etc., means that the orientation, direction, or pitch is not within a film plane (i.e., non-parallel with a film plane). For example, the direction, orientation, or pitch may be along a line that is perpendicular to a film plane, or that forms an acute or obtuse angle with respect to the film plane. For example, an “in-plane” direction or orientation may refer to a direction or orientation within a surface plane, an “out-of-plane” direction or orientation may refer to a thickness direction or orientation non-parallel with (e.g., perpendicular to) the surface plane. In some embodiments, an “out-of-plane” direction or orientation may form an acute or right angle with respect to the film plane.

The term “orthogonal” as in “orthogonal polarizations” or the term “orthogonally” as in “orthogonally polarized” means that an inner product of two vectors representing the two polarizations is substantially zero. For example, two lights or beams with orthogonal polarizations (or two orthogonally polarized lights or beams) may be two linearly polarized lights (or beams) with two orthogonal polarization directions (e.g., an x-axis direction and a y-axis direction in a Cartesian coordinate system) or two circularly polarized lights with opposite handednesses (e.g., a left-handed circularly polarized light and a right-handed circularly polarized light).

The wavelength ranges, spectra, or bands mentioned in the present disclosure are for illustrative purposes. The disclosed optical device, system, element, assembly, and method may be applied to a visible wavelength band, as well as other wavelength bands, such as an ultraviolet (“UV”) wavelength band, an infrared (“IR”) wavelength band, or a combination thereof. The term “substantially” or “primarily” used to modify an optical response action, such as transmit, reflect, diffract, deflect, block or the like that describes processing of a light means that a major portion, including all, of a light is transmitted, reflected, diffracted, deflected, or blocked, etc. The major portion may be a predetermined percentage (greater than 50%) of the entire light, such as 100%, 98%, 90%, 85%, 80%, etc., which may be determined based on specific application needs. It is understood that when a light is transmitted, the propagation direction of the light is not affected. When a light is deflected (e.g., reflected, diffracted), the propagation direction is usually changed. The term “optic axis” may refer to a direction in a crystal. A light propagating in the optic axis direction may not experience birefringence (or double refraction). An optic axis may be a direction rather than a single line: lights that are parallel to that direction may experience no birefringence.

Liquid crystal (“LC”) molecules are characterized by their anisotropic molecular structure, which means that they have different physical and optical properties along different molecular axes. This anisotropic molecular structure gives LC materials their unique optical and electro-optical properties. When an LC material forms an LC layer, an overall optical property of the LC layer is determined by the collective behavior of the LC molecules forming the LC layer, in addition to the properties of individual LC molecules (or the LC material). For example, the overall optical property of the LC layer may be determined by the orientations of the LC molecules across the LC layer, and the properties of individual LC molecules (or the LC material). When LC molecules are oriented in a particular way, the collective molecular arrangement may give rise to one or more optic axes. Uniaxial LCs are characterized by having a single optic axis that is along the directors (or long molecular axes) of the LC molecules, whereas biaxial LCs are characterized by having two optic axes.

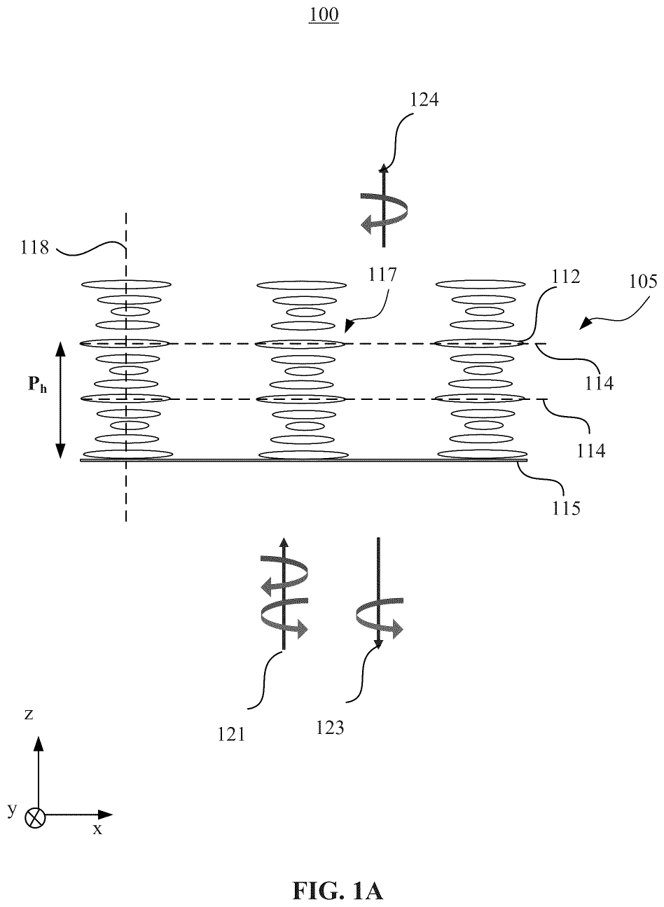

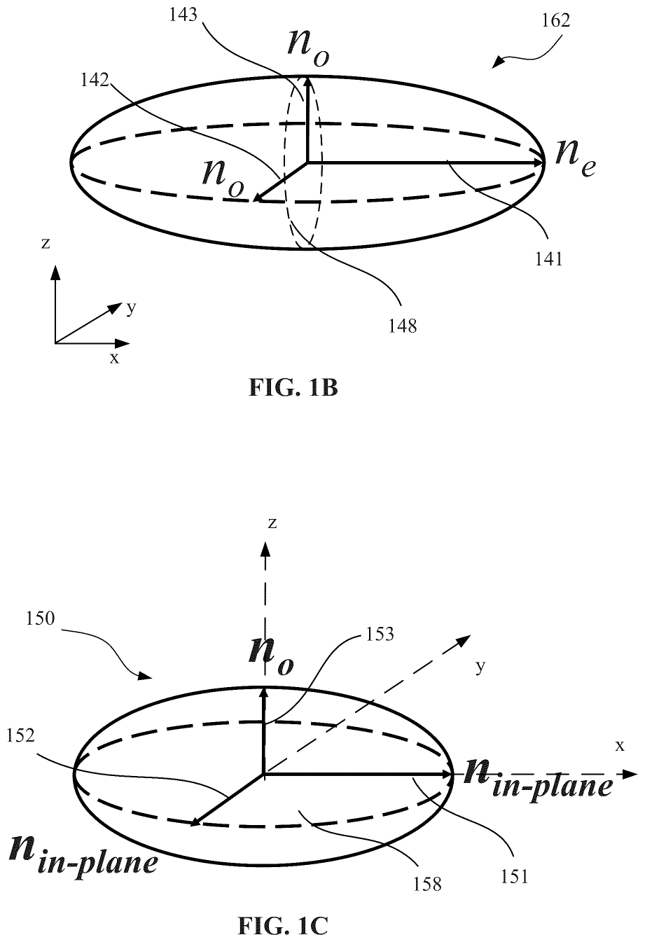

Conventional liquid crystal polarization hologram (“LCPH”) elements are often fabricated based on uniaxial LCs, such as a CLC element fabricated based on uniaxial LCs, a polarization volume hologram (“PVH”) fabricated based on uniaxial LCs, etc. A reflective PVH element may be based on self-organized CLCs, and may also be referred to as a slanted or patterned CLC element. FIG. 1A illustrates an x-z sectional view of a conventional CLC element 100 based on uniaxial LCs. As shown in FIG. 1A, the CLC element 100 may include a CLC layer 105 that is a layer of uniaxial LCs (e.g., LCs in uniaxial nematic phase). Within the volume of the CLC layer 105, uniaxial LC molecules 112 may form a plurality of helical structures 117 (also referred to as helical twist structures 117) with a plurality of helical axes 118, and a plurality of series of Bragg planes 114. The helical axis 118 may be perpendicular to a surface 115 of the CLC layer 105, extending in a thickness direction of the CLC layer 105, and the Bragg planes 114 may be parallel to the surface 115. FIG. 1A shows that the Bragg planes 114 are within an x-y plane, the helical axis 118 is extending in a z-axis direction, and the Bragg planes 114 are perpendicular to the helical axis 118.

In each helical structure 117, the directors of the LC molecules 112 may continuously rotate around the helical axis 118 in a predetermined rotation direction, e.g., clockwise direction or counter-clockwise direction. Accordingly, the helical structure 117 may exhibit a handedness, e.g., right handedness or left handedness. The azimuthal angles of the LC molecules 112 may also exhibit a continuous periodic variation along the helical axis 118. An azimuthal angle of the LC molecule 112 may be defined as an angle of the LC director with respect to a predetermined in-plane direction within the Bragg planes 114, e.g., an x-axis direction in FIG. 1A. The azimuthal angle of the LC molecule 112 may have a value within the range from 0° to 360° (including 0° and 360°). A helical pitch Pₕ of the helical structure 117 may be defined as a distance along the helical axis 118 over which the azimuthal angles of the LC molecules 112 vary by 360° or the directors of the LC molecules 112 rotate by 360°. The LC molecules 112 located in close proximity to a surface 115 of the CLC layer 105 may have a uniform in-plane orientation pattern. For example, the LC molecules 112 may be uniformly aligned in an x-axis direction shown in FIG. 1A.

The uniaxial LC molecules 112 in nematic phase may exhibit a refractive index ellipsoid after self-assembling. FIG. 1B illustrates a schematic diagram of a refractive index ellipsoid 162 of the uniaxial LC molecules 112 included in the conventional CLC element 100 shown in FIG. 1A. As shown in FIG. 1B, the refractive index ellipsoid 162 of the uniaxial LC molecules 112 in nematic phase is uniaxial anisotropic. The refractive index ellipsoid 162 may have an elongated, rod-like shape having three pairwise perpendicular axes of symmetry that intersect at a center of symmetry. The refractive index ellipsoid 162 may have three orthogonal semi-axes 141, 142, and 143. The semi-axis 141 may be the longest, and the semi-axis 142 and the semi-axis 143 may have a shorter, equal length, because the uniaxial LC molecule 112 in nematic phase thermally rotates along the semi-axis 141. An axis along the semi-axis 141 may be referred to as a long molecular axis or a director of the uniaxial LC molecule 112, and an axis along the semi-axis 142 or the semi-axis 143 may be referred to as a short molecular axis. The semi-axis 142 and the semi-axis 143 are located within a circular cross-section 148 of the rod, and the semi-axis 141 is perpendicular to the circular cross-section 148.

When a group of the uniaxial LC molecules 112 are homogeneously aligned, e.g., the semi-axes 141, the semi-axes 142, and the semi-axes 143 of all the LC molecules 112 in the group are aligned in a same first direction (e.g., an x-axis direction), a same second direction (e.g., a y-axis direction), and a same third direction (e.g., a z-axis direction), respectively, the length of the semi-axis 141, 142, or 143 corresponds to a principal refractive index of the group of the uniaxial LC molecules 112. The refractive indices along the semi-axis 141, the semi-axis 142, and the semi-axis 143 may be nₑ, nₒ, and nₒ, respectively, where nₑ represents an extraordinary refractive index of an LC material forming the CLC layer 105, and nₒ represents an ordinary refractive index of the LC material forming the CLC layer 105. For the LC material only including rod-like uniaxial LC molecules 112, the extraordinary refractive index nₑ is often greater than the ordinary refractive index nₒ, i.e., nₑ>nₒ. That is, the refractive indices along the semi-axis 142 and the semi-axis 143 may be the same, which is less than the refractive index along the semi-axis 141.

Referring to FIGS. 1A and 1B, in the CLC layer 105, the uniaxial LC molecules 112 may be aligned such that the semi-axis 143 is parallel to the helical axis 118, whereas the semi-axis 141 and the semi-axis 142 are located within the Bragg planes 114 and perpendicular to the helical axis 118. An overall optical properties of the CLC layer 105 may be determined by the arrangement (or orientations) of the uniaxial LC molecule 112 in the CLC layer 105 and the properties of the individual uniaxial LC molecules 112 (or the LC material forming the CLC layer 105). FIG. 1C illustrates an effective refractive index ellipsoid 150 of the conventional CLC element 100 or the CLC layer 105 shown in FIG. 1A. An effective refractive index ellipsoid often has three pairwise perpendicular axes of symmetry that intersect at a center of symmetry, which is called the center of the ellipsoid. The line segments that are delimited on the axes of symmetry by the ellipsoid are called the principal axes, or simply axes of the ellipsoid.

Referring to FIG. 1C, as the uniaxial LC molecules 112 in the CLC layer 105 are arranged to form the helical structures 117 across the CLC layer 105, the shape of the effective refractive index ellipsoid 150 of the CLC layer 105 may be an ellipsoid with two of the three axes of symmetry having the same length. The effective refractive index ellipsoid 150 has three orthogonal semi-axes 151, 152, and 153, which have lengths corresponding to principal refractive indices of the CLC layer 105. The semi-axis 151 and the semi-axis 152 are of equal length, which is greater than the length of the semi-axis 153. The semi-axes 151 and 152 are located within a circular cross-section 158 (e.g., within an x-y plane) of the ellipsoid 150, and the semi-axis 153 is perpendicular to the circular cross-section 158 (e.g., parallel to the z-axis). For discussion purposes, FIG. 1C shows that the semi-axis 151, the semi-axis 152, and the semi-axis 153 are parallel to the x-axis, the y-axis, and the z-axis, respectively. The principal refractive index along the semi-axis 153 may be referred to as an out-of-plane principal refractive index, and the principal refractive index along the semi-axis 151 or the semi-axis 152 may be referred to as an in-plane principal refractive index.

Referring back to FIG. 1C, the principal refractive indices of the CLC layer 105 along the semi-axis 151, the semi-axis 152, and the semi-axis 153 may be nᵢₙ₋ₚₗₐₙₑ, nᵢₙ₋ₚₗₐₙₑ, and nₒ, respectively, where

$${n}_{in - plane} = \sqrt{\frac{{n}_{o}^{2} + {n}_{e}^{2}}{2}} .$$

The principal refractive indices along the semi-axis 151 and the semi-axis 152 may be the same, i.e., nᵢₙ₋ₚₗₐₙₑ. That is, the optic axis of the CLC layer 105 may be along the semi-axis 153. As the LC material forming the CLC layer 105 often has the extraordinary refractive index nₑ greater than the ordinary refractive index nₒ, the principal refractive index of the CLC layer 105 along the semi-axis 153 may be less than the principal refractive index of the CLC layer 105 along the semi-axis 151 or the semi-axis 152, i.e., nₒ<nᵢₙ₋ₚₗₐₙₑ. As the in-plane principal refractive index is greater than the out-of-plane principal refractive index (i.e., nᵢₙ₋ₚₗₐₙₑ>nₒ), the CLC layer 105 or the CLC element 100 may have a waveplate effect that is similar to a negative C-plate.

The CLC element 100 may function as a circular reflective polarizer, with a reflection bandwidth Δλ_{R}=Δn*Pₕ, and a peak reflection wavelength λ_{R}=n*Pₕ, where Δn is the birefringence of an LC material (e.g., uniaxial LCs) used in the CLC element 100, and n is the average refractive index of the LC material. For an incident wavelength within the reflection band of the CLC element 100, a circularly polarized light with a handedness that is the same as the handedness of the helical structures 117 may be primarily or substantially reflected, and a circularly polarized light with a handedness that is different from (e.g., opposite to) the handedness of the helical structures 117 may be primarily or substantially transmitted.

Referring to FIG. 1A, a linearly polarized light 121 (having a wavelength within the reflection band of the CLC element 100) incident onto the CLC element 100 may include a right-handed circularly polarized component and a left-handed circularly polarized component. When the helical structures 117 has a right handedness, it may be desirable to design the CLC element 100 to substantially reflect the right-handed circularly polarized component as a reflected light 123 that is a right-handed circularly polarized light, and substantially transmit the left-handed circularly polarized component as a transmitted light 124 that is a left-handed circularly polarized light.

However, in practical applications, due to the waveplate effect (e.g., negative C-plate effect) of the CLC element 100, the polarization state of the reflected light 123 and/or the transmitted light 124 may be changed to an elliptical polarization. That is, the reflected light 123 and/or the transmitted light 124 may be an elliptically polarized light, rather than a circularly polarized light. This phenomenon is referred to as depolarization. The depolarization of the reflected light 123 and/or the transmitted light 124 may result in a light leakage of the CLC element 100, which may reduce a signal efficiency (e.g., the reflection efficiency or the transmission efficiency for the incident light 121, depending on different applications), and degrade the extinction ratio of the CLC element 100. Further, the light leakage of the CLC element 100 may increase as the incidence angle increases. Thus, the conventional CLC element 100 based on uniaxial LCs may have a narrow angle of incidence (“AOI”) range, which limits the applications.

In view of the limitations in the conventional technologies, the present disclosure provides a liquid crystal polarization hologram (“LCPT”) element including a layer of a birefringent medium having an intrinsic or induced biaxial optical anisotropy. The Molecules (or substructures) in the birefringent medium may be configured to form a plurality of helical structures across the layer. The birefringent medium may be configured, such that the layer where the helical structures are formed may exhibit a substantially isotropic effective refractive index ellipsoid. Accordingly, the disclosed LCPH element may reduce the light leakage, increase the efficiency, and enhance the extinction ratio over a wide AOI range.

The disclosed LCPH element may provide a circular polarization optical response. The disclosed LCPH element may be configured to reflect a circularly polarized light having a predetermined handedness, with a reduced light leakage, an increased signal efficiency, and an enhanced extinction ratio over a wide AOI range. The disclosed LCPH element may be configured to transmit a circularly polarized light having a handedness that is opposite to the predetermined handedness with a reduced light leakage, an increased signal efficiency, and an enhanced extinction ratio over a wide AOI range. The disclosed LCPH element may also be referred to as a circular polarization selective optical element.

LCPH elements may include polarization volume hologram (“PVH”) elements, Pancharatnam-Berry phase (“PBP”) elements, and cholesteric liquid crystal (“CLC”) elements, etc. A reflective PVH element may be based on self-organized CLCs, and may also be referred to as a slanted or patterned CLC element. The LCPH elements described herein may be fabricated based on various methods, such as holographic interference, laser direct writing, ink-jet printing, and various other forms of lithography. Thus, a “hologram” described herein is not limited to fabrication by holographic interference, or “holography.”

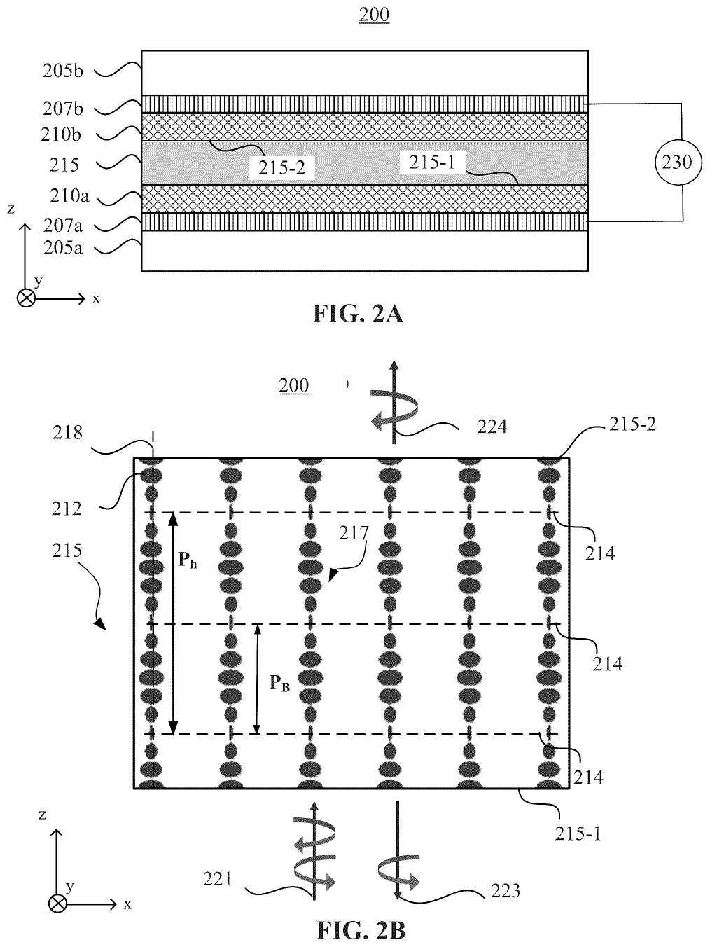

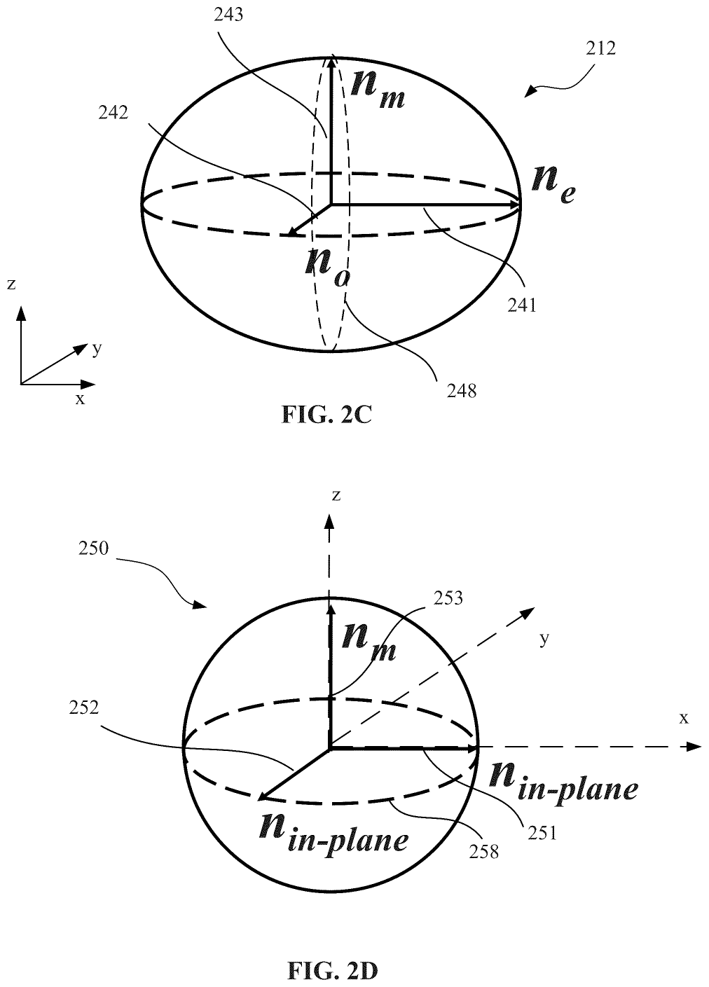

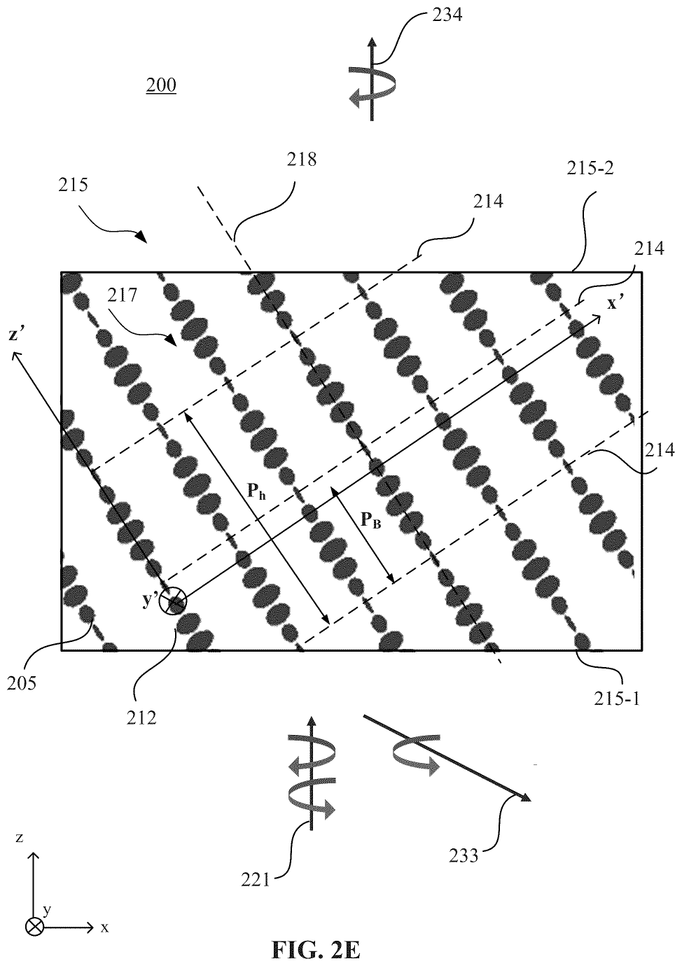

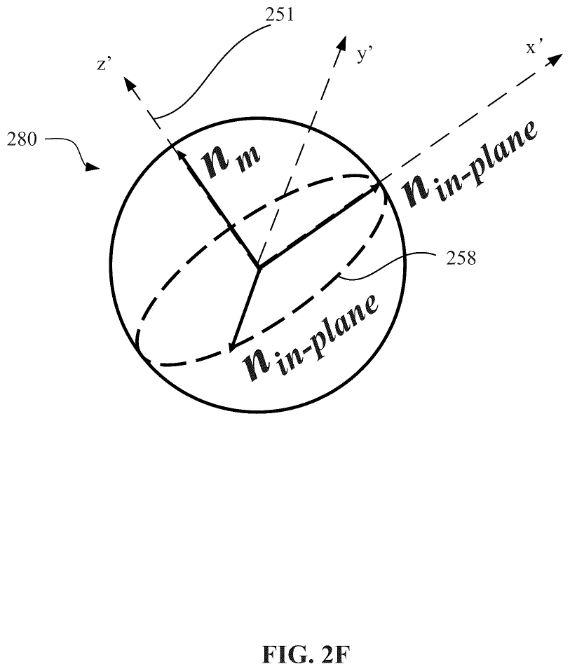

FIG. 2A illustrates an x-z sectional view of an LCPH element 200, according to an embodiment of the present disclosure. As shown in FIG. 2A, the LCPH element 200 may include a first substrate 205a and a second substrate 205b, and a birefringent medium layer 215 disposed between the first and second substrates 205a and 205b. The LCPH element 200 may include a first alignment structure 210a and a second alignment structure 210b, which may be disposed at two inner surfaces of the first and second substrates 205a and 205b that face each other, respectively. The birefringent medium layer 215 may be in contact with both of the first and second alignment structures 210a and 210b.

The substrates 205a and 205b may be configured to provide support and/or protection to various layers, films, and/or structures disposed at (e.g., on or between) the substrate 205a and 205b. In some embodiments, at least one of the first substrate 205a or the second substrate 205b may be optically transparent (e.g., having a light transmittance of about 60% or more) in at least a visible spectrum (e.g., wavelength ranging from about 380 nm to about 700 nm). In some embodiments, the substrates 205a and 205b may include a suitable material that is substantially transparent to lights of the above-listed wavelength ranges, such as, a glass, a plastic, a sapphire, a polymer, a semiconductor, or a combination thereof, etc. The substrates 205a and 205b may be rigid, semi-rigid, flexible, or semi-flexible. In some embodiments, the substrates 205a and 205b may have one or more surfaces in a flat, convex, concave, asphere, or freeform shape. In some embodiments, at least one of the first substrate 205a or the second substrate 205b may be a part of another optical element or device, or a part of another opto-electrical element or device. For example, at least one of the first substrate 205a or the second substrate 205b may be a solid optical lens or a part of a solid optical lens, or a part of a functional device (e.g., a display screen).

The LCPH element 200 may be a passive element or an active element (e.g., an electrically tunable element). When the LCPH element 200 is an active element, as shown in FIG. 2A, the LCPH element 200 may also include a first electrode layer 207a and a second electrode layer 207b. The first and second electrode layers 207a and 207b may be configured to apply a driving voltage provided by a power source 230 to the birefringent medium layer 215, thereby controlling an operation state of the LCPH element 200. In some embodiments, the LCPH element 200 may be a passive element, and the first electrode layer 207a and the second electrode layer 207b may be omitted.

In some embodiments, as shown in FIG. 2A, the first electrode layer 207a may be disposed between the first substrate 205a and the first alignment structure 210a, and the second electrode layer 207b may be disposed between the second substrate 205b and the second alignment structure 210b. The first electrode layer 207a or the second electrode layer 207b may be a continuous planar electrode layer, a patterned planar electrode layer, a protrusion electrode layer, or any other suitable type of electrode layer.

In some embodiments, both of the first electrode layer 207a and the second electrode layer 207b may be disposed at the same substrate (e.g., at the first substrate 205a or the second substrate 205b) with an electrical insulating layer disposed therebetween. For example, one of the first electrode layer 207a and the second electrode layer 207b may be a continuous planar electrode layer, and the other may be a patterned planar electrode layer, or a protrusion electrode layer. In some embodiments, the LCPH element 200 may include a single electrode layer. That is, one of the first electrode layer 207a and the second electrode layer 207b may be omitted. The single electrode layer may include interdigitated electrodes, such as two individually addressable comb-like microelectrode array strips.

The first electrode layer 207a or the second electrode layer 207b may include a suitable conductive material, such as a transparent conductive oxide material (e.g., indium tin oxide (“ITO”), aluminum zinc oxide (“AZO”), etc.), a metal material, structured metal grids, a conducting polymer, a dielectric-metal-dielectric (“DMD”) structure, carbon nanotubes, silver nanowires, or a combination thereof. In some embodiments, at least one (e.g., each) of the first electrode layer 207a or the second electrode layer 207b may include a flexible transparent conductive layer, such as ITO disposed on a plastic film. In some embodiments, the plastic film may include polyethylene terephthalate (“PET”). In some embodiments, the plastic film may include cellulose triacetate (“TAC”), which is a type of flexible plastic with a substantially low birefringence. For illustrative purposes, FIG. 2A shows that both of the first electrode layer 207a and the second electrode layer 207b are planar electrode layers disposed at different substrates 205a and 205b.

Molecules (or other substructures) in the birefringent medium layer 215 may be arranged in a plurality of helical structures within a volume of the birefringent medium layer 215. The molecules (or other substructures) located in close proximity to a surface of the birefringent medium layer 215 may be aligned in a predetermined in-plane orientation pattern, which is at least partially defined by the first alignment structure 210a and/or the second alignment structure 210b. For example, as shown in FIG. 2A, the birefringent medium layer 215 may have a first surface 215-1 and an opposing second surface 215-2. In some embodiments, the first surface 215-1 and the second surface 215-2 may be substantially parallel surfaces. In some embodiments, the first surface 215-1 may function as an interface between the birefringent medium layer 215 and the first alignment structure 210a, and the second surface 215-2 may function as an interface between the birefringent medium layer 215 and the second alignment structure 210b. Although the body of the birefringent medium layer 215 is shown as flat for illustrative purposes, the body of the birefringent medium layer 215 may have a curved shape. For example, at least one (e.g., each) of the first surface 215-1 and the second surface 215-2 may be curved.

The first alignment structure 210a or the second alignment structure 210b may be configured to provide a surface alignment to the molecules (or other substructures) of the birefringent medium layer 215 located in close proximity to a surface of the respective alignment structure. In some embodiments, the first alignment structure 210a and the second alignment structure 210b may be configured to provide parallel surface alignments, anti-parallel surface alignments, or hybrid surface alignments (e.g., one providing a homogeneous surface alignment and the other providing a homeotropic surface alignment) to the molecules (or other substructures) in contact with the alignment structures.

At least one (e.g., each) of the first alignment structure 210a or the second alignment structure 210b may be configured to provide a predetermined, suitable surface alignment pattern. The molecules (or other substructures) located in close proximity to a surface (e.g., at least one of the first surface 215-1 or the second surface 215-2) of the birefringent medium layer 215 may be aligned in a predetermined in-plane orientation pattern according to the predetermined surface alignment pattern. In some embodiments, the molecules (or other substructures) within a film plane (e.g., within a plane in close proximity to the surface of the birefringent medium layer 215 may also exhibit the predetermined in-plane orientation pattern.

The predetermined in-plane orientation pattern may be a uniform in-plane orientation pattern, or a non-uniform in-plane orientation pattern, etc. The non-uniform in-plane orientation pattern means that the orientations of the molecules (or other substructures) distributed along one or more in-plane directions may change in the one or more in-plane directions, and in some embodiments, the change of the orientations of the molecules (or other substructures) in the one or more in-plane directions may exhibit a rotation with a predetermined rotation direction, e.g., a clockwise or counter-clockwise rotation direction. The uniform in-plane orientation pattern means that the orientations of the molecules (or other substructures) may be substantially constant. Depending on the in-plane orientation pattern, the LCPH element 200 may function as a circular reflective polarizer, a waveplate or phase retarder, a grating, a lens, a freeform phase plate, etc.

The first and second alignment structures 210a and 210b shown in FIG. 2A may be any suitable alignment structures. For example, at least one (e.g., each) of the first alignment structure 210a or the second alignment structure 210b may include a polyimide layer, a photo-alignment material (“PAM”) layer, a plurality of nanostructures or microstructures, an alignment network, or any combination thereof. For example, in some embodiments, at least one (e.g., each) of the first alignment structure 210a or the second alignment structure 210b may include a PAM layer. In some embodiments, at least one (e.g., each) of the first alignment structure 210a or the second alignment structure 210b may include a polymer layer with anisotropic nano-imprint. In some embodiments, at least one (e.g., each) of the first alignment structure 210a or the second alignment structure 210b may include a polymer layer with anisotropic nano-imprint. In some embodiments, at least one (e.g., each) of the first alignment structure 210a or the second alignment structure 210b may include a plurality of microstructures, such as a surface relief grating (“SRG”) coated with or without additional alignment materials (e.g., polyimides). In some embodiments, at least one (e.g., each) of the first alignment structure 210a or the second alignment structure 210b may include a ferroelectric or ferromagnetic material configured to provide a surface alignment in a presence of a magnetic field or an electric field.

The birefringent medium layer 215 may include a birefringent medium, such as liquid crystals (e.g., active LCs, a liquid crystal polymer, etc.), an amorphous polymer, an organic solid crystal, or a combination thereof, etc. The birefringent medium may be a biaxial birefringent medium have a biaxial optical anisotropic, such as biaxial LCs, biaxial organic solid crystals, or a combination thereof, etc. In some embodiments, the biaxial optical anisotropic of the birefringent medium may be an intrinsic biaxial optical anisotropy, for example, the birefringent medium may include biaxial molecules (or other biaxial substructures) having a biaxial anisotropic molecular structure which exhibits a refractive index ellipsoid after self-assembling. In some embodiments, the biaxial optical anisotropic of the birefringent medium may be an induced biaxial optical anisotropy. For example, the birefringent medium may include a mixture of uniaxial molecules (or other uniaxial substructures) of different shapes, such as a mixture of uniaxial LC molecules having a rod shape and uniaxial LC molecules having a disc shape, a mixture of uniaxial LC molecules having a first rod shape and uniaxial LC molecules having a second, different rod shape, a mixture of uniaxial LC molecules having a first shape (e.g., a first rod shape) and nanocrystal particles having a second shape (e.g., a different rod shape or a disc shape), etc. Through mixing the uniaxial molecules (or other uniaxial substructures) of different shapes, the obtained birefringent medium may exhibit an induced biaxial optical anisotropy.

In some embodiments, the birefringent medium may include nematic LCs, twist-bend LCs, chiral nematic LCs, smectic LCs, ferroelectric LCs, etc., or any combination thereof. In some embodiments, the birefringent medium may have an induced chirality, e.g., the birefringent medium may be doped with a chiral dopant. In some embodiments, the birefringent medium may have an intrinsic molecular chirality, e.g., birefringent material may include chiral LC molecules, or molecules having one or more chiral functional groups.

For discussion purposes, in the following description, a biaxial LC molecule having a biaxial anisotropic molecular structure is used as an example of the molecule (or substructure) in the birefringent medium layer 215, and the birefringent medium forming the birefringent medium layer 215 may be biaxial LCs having an intrinsic biaxial optical anisotropy. The birefringent medium layer 215 may be a CLC layer, e.g., a non-slanted CLC layer, or a slanted CLC layer (or R-PVH layer). FIG. 2B illustrates a schematic diagram showing out-of-plane orientations of biaxial LC molecules 212 in the birefringent medium layer 215 of the LCPH element 200 shown in FIG. 2A, according to an embodiment of the present disclosure. In the embodiment shown in FIG. 2B, the birefringent medium layer 215 may be a non-slanted CLC layer, where a helical axis is perpendicular to a surface of the non-slanted CLC layer.

As shown in FIG. 2B, within the volume of the birefringent medium layer 215, the biaxial LC molecules 212 may form a plurality of helical structures 217 with a plurality of helical axes 218, and a plurality of series of Bragg planes 214. The helical axis 218 may be perpendicular to a surface (e.g., at least one of the first surface 215-1 or the second surface 215-2) of the birefringent medium layer 215, extending in a thickness direction of the birefringent medium layer 215. The Bragg planes 214 may be parallel to the surface 215-1 or 215-2 of the birefringent medium layer 215. FIG. 2B shows that the Bragg planes 214 are within an x-y plane, the helical axis 218 is extending in a z-axis direction, and the Bragg planes 214 are perpendicular to the helical axis 218.

In each helical structure 217, the directors of the biaxial LC molecules 212 may continuously rotate around the helical axis 218 in a predetermined rotation direction, e.g., clockwise direction or counter-clockwise direction. Accordingly, the helical structure 217 may exhibit a handedness, e.g., right handedness or left handedness. The azimuthal angles of the LC molecules 212 may also exhibit a continuous periodic variation along the helical axis 218. An azimuthal angle of the biaxial LC molecule 212 may be defined as an angle of the LC director with respect to a predetermined in-plane direction within the Bragg planes 214, e.g., an x-axis direction in FIG. 2A. The azimuthal angle of the biaxial LC molecule 212 may have a value within the range from 0° to 360° (including 0° and 360°). A helical pitch Pₕ of the helical structure 217 may be defined as a distance along the helical axis 218 over which the azimuthal angles of the biaxial LC molecules 212 vary by 360° or the directors of the biaxial LC molecule 212 rotate by 360°.

Further, the biaxial LC molecule 212 having a first same orientation (e.g., same first tilt angle and same first azimuthal angle) may form a first series of slanted and parallel refractive index planes (i.e., a first series of Bragg planes) 214 periodically distributed within the volume of the birefringent medium layer 215. Although not labeled, the biaxial LC molecules 212 with a second same orientation (e.g., same second tilt angle and same second azimuthal angle) different from the first same orientation may form a second series of slanted and parallel refractive index planes (i.e., a second series of Bragg planes) 214 periodically distributed within the volume of the birefringent medium layer 215. Different series of Bragg planes may be formed by the biaxial LC molecules 212 having different orientations. In the same series of Bragg planes, the biaxial LC molecules 212 may have the same orientation, and the refractive index may be the same. Different series of Bragg planes may correspond to different refractive indices. When the number of the Bragg planes (or the thickness of the birefringent medium layer 215) increases to a sufficient value, Bragg reflection may be established. The distance between adjacent Bragg planes 214 of the same series may be referred to as a Bragg period P_{B}. In the embodiment shown in FIG. 2B, the Bragg period P_{B} is half of the helical pitch Pₕ. The biaxial LC molecules 212 located in close proximity to the surface 215-1 or 215-2 of the birefringent medium layer 215 may have a uniform in-plane orientation pattern. For example, the LC molecules 212 may be uniformly aligned in an x-axis direction shown in FIG. 2B.

FIG. 2C illustrates a biaxial anisotropic molecular structure of the biaxial LC molecule 212, according to an embodiment of the present disclosure. As shown in FIG. 2C, the biaxial LC molecule 212 may have may three orthogonal semi-axes 241, 242, and 243 of three different lengths. The semi-axis 242 and the semi-axis 243 are located within an elliptical cross-section 248, which is perpendicular to the semi-axis 241. The length of the semi-axis 241 may be configured to be greater than the length of the semi-axis 242 and the length of the semi-axis 243, and the length of the semi-axis 243 may be configured to be greater than the length of the semi-axis 242. An axis along the semi-axis 241 may be referred to as a long molecular axis or a director of the biaxial LC molecule 212, and an axis along the semi-axis 242 and an axis along the semi-axis 243 may be referred to as short molecular axes. That is, the biaxial LC molecule 212 may have three molecular axes of three different lengths.

When a group of the biaxial LC molecules 212 are homogeneously aligned, e.g., the semi-axes 241, the semi-axes 242, and the semi-axes 243 of all the biaxial LC molecules 212 in the group are aligned in a same first direction (e.g., an x-axis direction), a same second direction (e.g., a y-axis direction), and a same third direction (e.g., a z-axis direction), respectively, the length of the semi-axis 241, 242, or 243 corresponds to a principal refractive index of the group of the biaxial LC molecules 212. The refractive indices along the semi-axis 241, the semi-axis 242, and the semi-axis 243 may be nₑ, nₒ, and nₘ, respectively, where nₑ, nₒ, and nm represent an extraordinary refractive index, an ordinary refractive index, and an intermediate refractive index of the biaxial LCs forming birefringent medium layer 215, respectively. In the present disclosure, the intermediate refractive index nm may be configured to be between the extraordinary refractive index nₑ and the ordinary refractive index nₒ.

In some embodiments, as shown in FIG. 2C, the extraordinary refractive index nₑ may be greater than the ordinary refractive index nₒ and the intermediate refractive index nₘ, and the intermediate refractive index nₘ may be greater than the ordinary refractive index nₒ, i.e., nₑ>nₘ>nₒ. In some embodiments, although not shown, the extraordinary refractive index nₑ may be less than the ordinary refractive index nₒ and the intermediate refractive index nₘ, and the intermediate refractive index nₘ may be greater than the ordinary refractive index nₒ, i.e., nₒ>nₘ>nₑ.

An overall optical property of the birefringent medium layer 215 including the helical structures 217 may be determined by the orientations of the biaxial LC molecules 212 in the birefringent medium layer 215 and the properties of individual biaxial LC molecules 212 (or the biaxial LCs forming the birefringent medium layer 215). Referring to FIGS. 2B and 2C, in the birefringent medium layer 215, the biaxial LC molecules 212 may be aligned to form the helical structures 217 across the birefringent medium layer 215, where the short molecular axes (or the semi-axis 243) of the biaxial LC molecules 212 may be aligned along the helical axis 218 of the helical structures 217, and the short molecular axes (or the semi-axis 242) and the long molecular axes (or the semi-axis 241) of the biaxial LC molecules 212 may be aligned to be located within the Bragg plane 214 and perpendicular to the helical axis 218. In the present disclosure, as the birefringent medium layer 215 is formed by the biaxial LCs having the refractive index nₘ between the extraordinary refractive index nₑ and the ordinary refractive index nₒ, and the biaxial LC molecules 212 are arranged to form the helical structures 217 across the birefringent medium layer 215, the birefringent medium layer 215 may exhibit an effective refractive index ellipsoid that is a substantially sphere (i.e., an ellipsoid with three axes of symmetry having substantially the same length). That is, the effective refractive index ellipsoid of the birefringent medium layer 215 may be a substantially isotropic effective refractive index ellipsoid.

FIG. 2D illustrates an effective refractive index ellipsoid 250 of the birefringent medium layer 215 shown in FIG. 2B, according to an embodiment of the present disclosure. As shown in FIG. 2D, the effective refractive index ellipsoid 250 of the birefringent medium layer 215 may be a triaxial ellipsoid. The effective refractive index ellipsoid 250 has three orthogonal semi-axes 251, 252, and 253, which have lengths corresponding to principal refractive indices of the birefringent medium layer 215. The semi-axes 251 and 252 are located within a circular cross-section 258 (e.g., within an x-y plane) of the ellipsoid 250, and the semi-axis 253 is perpendicular to the circular cross-section 258 (e.g., parallel to the z-axis). For discussion purposes, FIG. 2D shows that the semi-axis 251, the semi-axis 252, and the semi-axis 253 are parallel with the x-axis, the y-axis, and the z-axis shown in FIGS. 2B and 2D, respectively.

The principal refractive indices of the birefringent medium layer 215 along the semi-axis 251, the semi-axis 252, and the semi-axis 253 may be nᵢₙ₋ₚₗₐₙₑ, nᵢₙ₋ₚₗₐₙₑ, and nₘ, respectively, where

$${n}_{in - plane} = \sqrt{\frac{{n}_{o}^{2} + {n}_{e}^{2}}{2}} .$$

The principal refractive indices along the semi-axis 251 and the semi-axis 252 may be the same, i.e., nᵢₙ₋ₚₗₐₙₑ, and the principal refractive index along the semi-axis 253 may be equal to the intermediate refractive index nₘ. That is, the optic axis of the birefringent medium layer 215 may be along the semi-axis 253. The principal refractive index along the semi-axis 253 may be referred to as an out-of-plane principal refractive index, and the principal refractive index along the semi-axis 251 or the semi-axis 252 may be referred to as an in-plane principal refractive index. That is, the in-plane principal refractive index of the birefringent medium layer 215 may be

$${n}_{in - plane} = \sqrt{\frac{{n}_{o}^{2} + {n}_{e}^{2}}{2}} ,$$

and the out-of-plane principal refractive index of the birefringent medium layer 215 may be equal to nₘ.

In the present disclosure, as the biaxial LCs forming the birefringent medium layer 215 has the intermediate refractive index nₘ between the extraordinary refractive index nₑ and the ordinary refractive index nₒ, the out-of-plane principal refractive index nₘ of the birefringent medium layer 215 may be closer to the in-plane principal refractive index nᵢₙ₋ₚₗₐₙₑ of the birefringent medium layer 215 than the ordinary refractive index nₒ of the biaxial LCs forming the birefringent medium layer 215. That is, the difference between the in-plane principal refractive index nᵢₙ₋ₚₗₐₙₑ and the out-of-plane principal refractive index nₘ may be less than the difference between the in-plane principal refractive index nᵢₙ₋ₚₗₐₙₑ and the ordinary refractive index nₒ, i.e., |nᵢₙ₋ₚₗₐₙₑ−nₘ|>|nᵢₙ₋ₚₗₐₙₑ−nₒ|.

In some embodiments, the in-plane principal refractive index nᵢₙ₋ₚₗₐₙₑ may be slightly different from the out-of-plane principal refractive index nₘ. In some embodiments, the out-of-plane principal refractive index nₘ may be configured according to the following equation, such that the out-of-plane principal refractive index nₘ may be equal to the in-plane principal refractive index nᵢₙ₋ₚₗₐₙₑ (i.e., nₘ=nᵢₙ₋ₚₗₐₙₑ),

$${n}_{m} = \frac{1}{2 π} {\int }_{0}^{2 π} \sqrt{{( {n}_{o} sin φ )}^{2} + {( {n}_{e} cos φ )}^{2}} d φ ,$$

where φ is an angle defined by the orientation of the biaxial LC molecule 212 at the surface 215-1 or 215-2 of the birefringent medium layer 215. For example, φ may be an angle of the LC director with respect to a predetermined in-plane direction (e.g., the x-axis direction in FIG. 2B). In some embodiments, as the orientations of the biaxial LC molecules 212 change in the predetermined in-plane direction at the surface 215-1 or 215-2 of the birefringent medium layer 215, the intermediate refractive index nₘ of the biaxial LCs forming the birefringent medium layer 215 may be an average of local refractive indices of the biaxial LC molecules 212 along the predetermined in-plane direction. In the present disclosure, the difference between the in-plane principal refractive index nᵢₙ₋ₚₗₐₙₑ and the out-of-plane principal refractive index nₘ may be less than or equal to a predetermined value, e.g., 0.01, 0.02, 0.03, 0.04, 0.05, 0.06, 0.07, 0.08, 0.09, or between any two of the aforementioned values.

Thus, compared to the effective refractive index ellipsoid 150 of the CLC layer 105 shown in FIG. 1C, the effective refractive index ellipsoid 250 of the birefringent medium layer 215 shown in FIG. 2D may be closer to a sphere and, accordingly, the birefringent medium layer 215 may be closer to an optically isotropic layer than the CLC layer 105. For example, the semi-axes 151-153 of the effective refractive index ellipsoid 250 may have substantially the same length (including the equal length). The effective refractive index ellipsoid 250 may be a substantially isotropic effective refractive index ellipsoid (including the isotropic effective refractive index ellipsoid when nₘ=nᵢₙ₋ₚₗₐₙₑ). Accordingly, the birefringent medium layer 215 may be a substantially optically isotropic layer (including an optically isotropic layer when nₘ nᵢₙ₋ₚₗₐₙₑ). Thus, for a same incident light, the waveplate effect (that is proportional to d*(nᵢₙ₋ₚₗₐₙₑ−nₘ)) provided by the birefringent medium layer 215 may be reduced, as compared to the waveplate effect (that is proportional to d*(nᵢₙ₋ₚₗₐₙₑ−nₒ)) provided by the CLC layer 105. Thus, the birefringent medium layer 215 may reduce the light leakage, increase the efficiency, and enhance the extinction ratio over a wide AOI range, as compared to the CLC layer 105.

The helical structures 217 (or the biaxial LC structures) in the birefringent medium layer 215 may have a dimension (e.g., the helical pitch and/or the in-plane pitch) that is comparable with (or at the same order as) the reflection wavelength of the LCPH element 200. Thus, the LCPH element 200 may modulate an input light having a wavelength within a reflection band of the LCPH element via Bragg reflection, and transmit an input light having a wavelength outside of the reflection band. The birefringent medium layer 215 shown in FIG. 2B or the LCPH element 200 including the birefringent medium layer 215 shown in FIG. 2B may function as a circular reflective polarizer that may reduce the light leakage, increase the efficiency, and enhance the extinction ratio over a wide AOI range.

For example, as shown in FIG. 2B, a linearly polarized incident light 221 of the LCPH element 200 may have a wavelength within the reflection band of the LCPH element 200. The linearly polarized light 221 may include a right-handed circularly polarized component and a left-handed circularly polarized component. For discussion purposes, the helical structures 217 may have a right handedness. The LCPH element 200 may substantially reflect the right-handed circularly polarized component of the linearly polarized light 221 as a reflected light 223 that is substantially close to a right-handed circularly polarized light, and substantially transmit the left-handed circularly polarized component of the linearly polarized light 221 as a transmitted light 224 that is substantially close to a left-handed circularly polarized light. FIG. 2B shows that when the linearly polarized light 221 is normally incident onto the LCPH element 200, the propagation directions of the reflected light 223 and the transmitted light 224 are substantially parallel to the propagation directions of the incident light 221.

Referring to FIG. 1A and FIG. 2B, the linearly polarized incident light 121 and the linearly polarized incident light 221 are presumed to be the same. As the waveplate effect provided by the birefringent medium layer 215 is reduced compared to the waveplate effect provided by the CLC layer 105, the reflected light 223 of the LCPH element 200 may be closer to a right-handed circularly polarized light than the reflected light 123 of the conventional CLC element 100, and the transmitted light 224 of the LCPH element 200 may be closer to a left-handed circularly polarized light than the reflected light 123 of the conventional CLC element 100. Thus, the light leakage of the LCPH element 200 may be reduced, while the signal efficiency may be increased, and the extinction ratio may be enhanced, e.g., for an incident light having an AOI ranging from 0 to 60 degrees and a visible wavelength range (e.g., from 400 nm to 750 nm).

In some embodiments, for an incident light having a wavelength within the reflection bandwidth and a first circular polarization (that has the same handedness as the helical structures), the LCPH element 200 including the birefringent medium layer 215 shown in FIG. 2B may be configured to provide a reflectance greater than 95%, greater than 96%, greater than 97%, greater than 98%, or greater than 99% over an AOI range of 60 degrees. In some embodiments, for an incident light having a wavelength within the reflection bandwidth and a second circular polarization (that has the opposite handedness of the helical structures), the LCPH element 200 may be configured to provide a transmittance greater than 95%, greater than 96%, greater than 97%, greater than 98%, or greater than 99% over an AOI range of 60 degrees.

An extinction ratio of the LCPH element 200 may be defined as a ratio between the reflectance of a light having the second circular polarization and the reflectance of a light having the first circular polarization, or a ratio between the transmittance of a light having the second circular polarization and the transmittance of a light having the first circular polarization. In some embodiments, the extinction ratio of the LCPH element 200 including the birefringent medium layer 215 shown in FIG. 2B may be greater than 100:1, 200:1, 300:1, 400:1, 500:1, 600:1, 700:1, 800:1, 900:1, 1000:1, 1100:1, 1200:1, 1300:1, 1400:1, 1500:1, 1600:1, 1700:1, 1800:1, 1900:1, 2000:1, 3000:1, 4000:1, 5000:1, 6000:1, 7000:1, 8000:1, 9000:1, 10000:1, 15000:1, 20000:1, or between any two of the aforementioned ratios.

FIG. 2E illustrates a schematic diagram showing out-of-plane orientations of the biaxial LC molecules 212 in the birefringent medium layer 215 of the LCPH element 200 shown in FIG. 2A, according to an embodiment of the present disclosure. In the embodiment shown in FIG. 2E, the helical axis 218 may be slanted with respect to a surface (e.g., the first surface 215-1 or the second surface 215-2) of the birefringent medium layer 215, and the Bragg planes 214 may form an angle (e.g., an acute angle) with the surface of the birefringent medium layer 215. The x-y-z coordinate system shown in FIG. 2E refers to a global coordinate system for the birefringent medium layer 215, whereas an x′-y′-z′ coordinate system shown in FIG. 2E refers to a local coordinate system for the helical structure 217. FIG. 2E shows that the Bragg planes 214 are within an x′-y′ plane, the helical axis 218 is extending in a z′-axis direction, and the Bragg planes 214 are perpendicular to the helical axis 218. In the birefringent medium layer 215 (or the non-slanted CLC layer) shown in FIG. 2B, the x′-y′-z′ coordinate system may coincide with the x-y-z coordinate system.

FIG. 2F illustrates an effective refractive index ellipsoid 250 of the birefringent medium layer 215 shown in FIG. 2E, according to an embodiment of the present disclosure. The effective refractive index ellipsoid 280 shown in FIG. 2F may be similar to the effective refractive index ellipsoid 250 shown in FIG. 2D. That is, the effective refractive index ellipsoid 280 may be a substantially sphere. Referring to FIGS. 2E and 2F, as the helical axis 218 is slanted with respect to the surface 215-1 or 215-2 of the birefringent medium layer 215, the semi-axis 251 that is parallel to the helical axis 218 may also be slanted with respect to the surface 215-1 or 215-2 of the birefringent medium layer 215. The semi-axis 251 and the semi-axis 252 may be located within the Bragg plane 214 that is perpendicular to the helical axis 218. The semi-axis 251, the semi-axis 252, and the semi-axis 253 may be parallel to the x′-axis, the y′-axis, and the z′-axis shown in FIG. 2F, respectively.

The LCPH element 200 having the birefringent medium layer 215 shown in FIG. 2E may be referred to as a slanted CLC element or a reflective PVH element, which may function as a reflective polarizer that can reduce the light leakage, increase the efficiency, and enhance the extinction ratio over a wide AOI range, e.g., for an incident light having an AOI ranging from 0 to 60 degrees and a visible wavelength range (e.g., from 400 nm to 750 nm). Referring to FIG. 2E, the birefringent medium layer 215 (or the LCPH element 200) may substantially diffract, via backward reflection, the right-handed circularly polarized component of the linearly polarized light 221 as a reflected (or diffracted) light 233 that is substantially close to a right-handed circularly polarized light, and substantially transmit the left-handed circularly polarized component of the linearly polarized light 221 as a transmitted light 224 that is substantially close to a left-handed circularly polarized light. When the linearly polarized light 221 is normally incident onto the LCPH element 200, the propagation direction of the transmitted light 224 may be parallel with the propagation direction of the incident light 221, and the propagation direction of the diffracted light 233 may not be parallel with the propagation direction of the linearly polarized light 221.

In some embodiments, for an incident light having a wavelength within the reflection bandwidth and a first circular polarization (that has the same handedness as the helical structures), the LCPH element 200 including the birefringent medium layer 215 shown in FIG. 2E may be configured to provide a reflectance (or backward diffraction) greater than 95%, greater than 96%, greater than 97%, greater than 98%, or greater than 99% over an AOI range of 60 degrees. In some embodiments, for an incident light having a wavelength within the reflection bandwidth and a second circular polarization (that has the opposite handedness of the helical structures), the LCPH element 200 may be configured to provide a transmittance greater than 95%, greater than 96%, greater than 97%, greater than 98%, or greater than 99% over an AOI range of 60 degrees.

An extinction ratio of the LCPH element 200 may be defined as a ratio between the reflectance of a light having the second circular polarization and the reflectance of a light having the first circular polarization, or a ratio between the transmittance of a light having the second circular polarization and the transmittance of a light having the first circular polarization. In some embodiments, the extinction ratio of the LCPH element 200 including the birefringent medium layer 215 shown in FIG. 2E may be greater than 100:1, 200:1, 300:1, 400:1, 500:1, 600:1, 700:1, 800:1, 900:1, 1000:1, 1100:1, 1200:1, 1300:1, 1400:1, 1500:1, 1600:1, 1700:1, 1800:1, 1900:1, 2000:1, 3000:1, 4000:1, 5000:1, 6000:1, 7000:1, 8000:1, 9000:1, 10000:1, 15000:1, 20000:1, or between any two of the aforementioned ratios.

For the LCPH element 200 shown in FIG. 2B, a local refractive index n_{z} of the birefringent medium layer 215 in the thickness direction of the birefringent medium layer 215 may be equal to nₘ across the entire birefringent medium layer 215. In some embodiments, the local refractive index n_{z} of the birefringent medium layer 215 may be equal to nₘ only in one or more portions, less than all, of the birefringent medium layer 215. For the embodiment shown in FIG. 2E, the local refractive index n_{z} of the birefringent medium layer 215 may be between nₒ and nₑ. In some embodiments, the local refractive index n_{z} of the birefringent medium layer 215 may gradually change from nₒ to nₑ along a direction perpendicular to the film plane of the birefringent medium layer 215. In some embodiments, the local refractive index n_{z} of the birefringent medium layer 215 may gradually change from nₒ to nₑ in one or more directions within the film plane of the birefringent medium layer 215. In some embodiments, the local refractive index n_{z} of the birefringent medium layer 215 may gradually change from nₒ to nₑ in a direction that is slanted with respect to the surface of the birefringent medium layer 215 (that is non-parallel and non-perpendicular to the film plane of the birefringent medium layer 215).

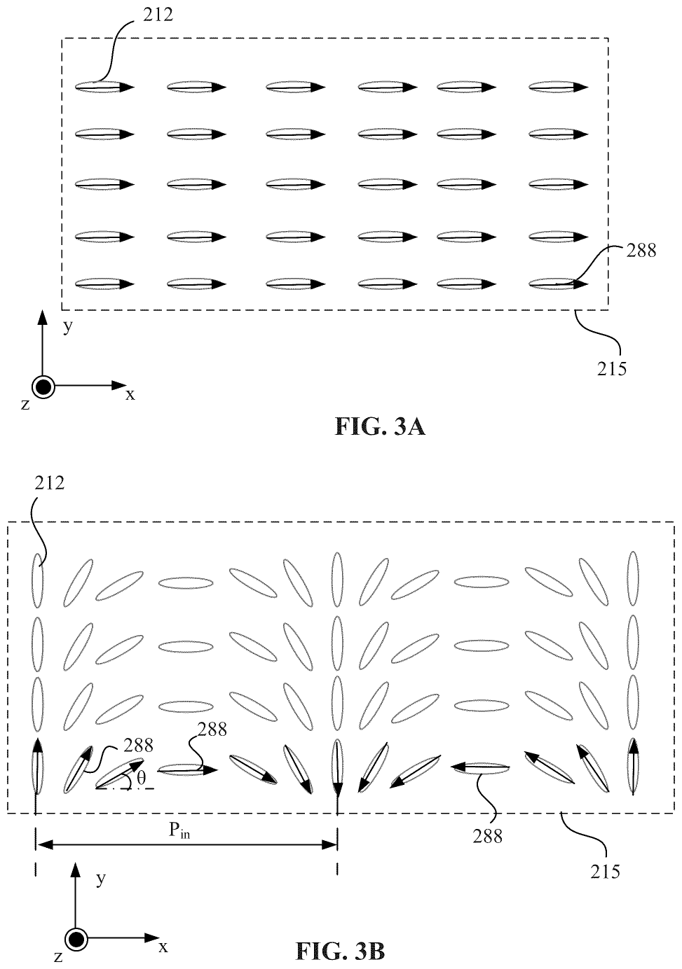

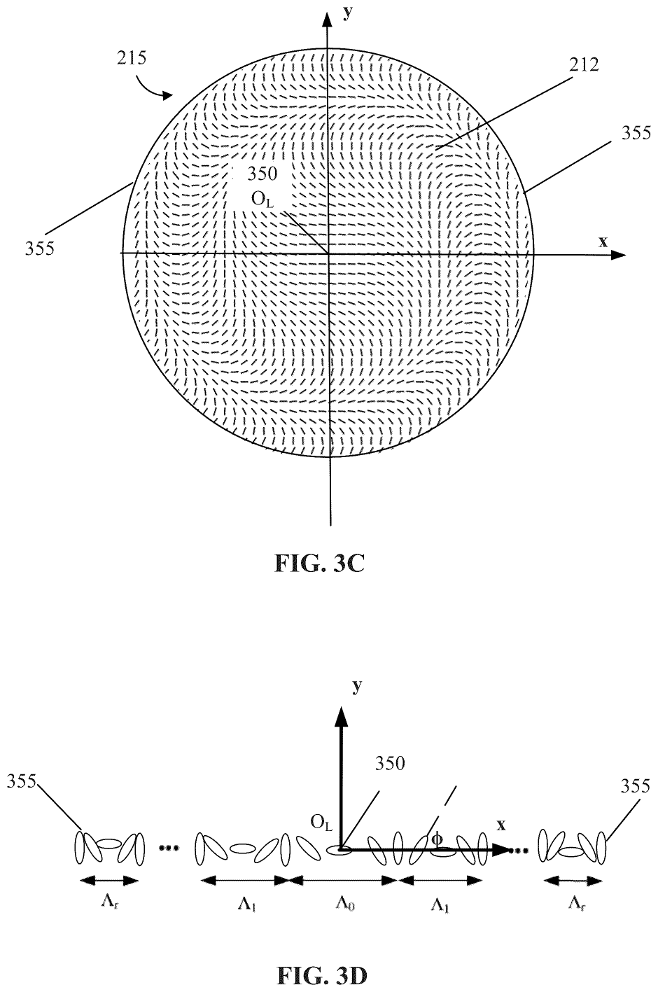

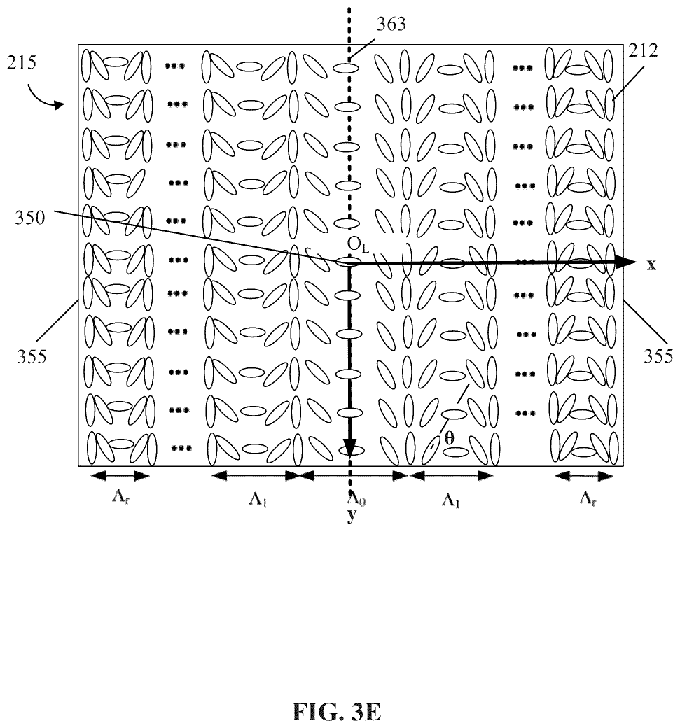

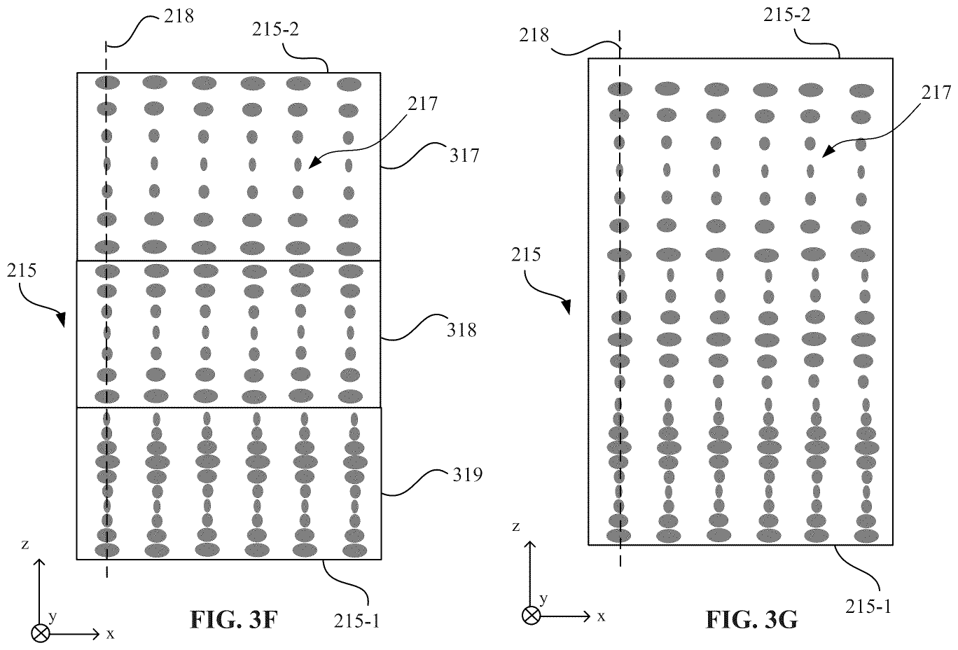

FIGS. 3A-3E illustrate x-y sectional views of a portion of the birefringent medium layer 215 shown in FIG. 2A, showing exemplary in-plane orientation patterns of the LC directors of the LC molecules 212 located in close proximity to a surface (e.g., 215-1 or 215-2) of the birefringent medium layer 215, according to various embodiments of the present disclosure. In some embodiments, the LC molecules 212 located in close proximity to the surface of the birefringent medium layer 215 may have other suitable surface alignment patterns different from those shown in FIGS. 3A-3E.

In the embodiment shown in FIG. 3A, at least one (e.g., each) of the first alignment structure 210a or the second alignment structure 210b may be configured to provide spatially uniform alignments to the LC molecules 212 that are located in close proximity to the surface of the birefringent medium layer 215. That is, the LC directors of the LC molecules 212 that are located in close proximity to the surface of the birefringent medium layer 215 may be substantially uniformly aligned (e.g., along an x-axis direction shown in FIG. 3A). Accordingly, the orientations of the LC directors of the LC molecules 212 located in close proximity to the surface of the birefringent medium layer 215 may exhibit a uniform in-plane orientation pattern. In some embodiments, the LCPH element 200 including the birefringent medium layer 215 having the in-plane orientation pattern shown in FIG. 3A and the out-of-plane orientation pattern shown in FIG. 2B may function as a circular reflective polarizer.

In some embodiments, at least one (e.g., each) of the first alignment structure 210a or the second alignment structure 210b may be configured to provide spatially non-uniform surface alignments. Thus, the orientations of the LC directors of the LC molecules 212 located in close proximity to the surface of the birefringent medium layer 215 may exhibit a non-uniform in-plane orientation pattern. For example, orientations of the LC directors of the LC molecules located in close proximity to the surface of the birefringent medium layer 215 may periodically or non-periodically vary in at least one in-plane direction within the surface, such as a linear direction, in a radial direction, in a circumferential (e.g., azimuthal) direction, or a combination thereof. Accordingly, the birefringent medium layer 215 may provide different optical functions. For example, the LCPH element 200 may function as a grating, a prism, a lens, a segmented waveplate or a segmented phase retarder, a lens array, a prism array, etc. Exemplary non-uniform alignment patterns of the LC molecules that are located in close proximity to the surface of the birefringent medium layer 215 are shown in FIGS. 3B-3E.

In the embodiment shown in FIG. 3B, the directors of the LC molecules 212 located in close proximity to the surface of the birefringent medium layer 215 may exhibit a periodic, continuous rotation in a predetermined in-plane direction within the surface, e.g., the x-axis direction. The continuous rotation of the LC directors may form a periodic rotation pattern with a uniform (e.g., same) in-plane pitch Pᵢₙ. It is noted that the predetermined in-plane direction may be any other suitable direction within the surface, such as the y-axis direction, the radial direction, or the circumferential direction within the x-y plane. The in-plane pitch (or horizontal pitch) Pᵢₙ may be defined as a distance along the predetermined in-plane direction (e.g., the x-axis) over which the orientations of the LC directors exhibit a rotation by a predetermined angle (e.g., 180°). The periodically varying in-plane orientations of the LC directors shown in FIG. 3B may be referred to as a grating pattern, and the LCPH element 200 including the birefringent medium layer 215 configured with the in-plane orientation pattern shown in FIG. 3B and the out-of-plane orientation pattern shown in FIG. 2E may function as a reflective PVH grating.

In addition, within the surface of the birefringent medium layer 215, the orientations of the directors of the LC molecules 212 may rotate along the predetermined in-plane direction (e.g., the x-axis) in a predetermined rotation direction, e.g., a clockwise direction or a counter-clockwise direction. Accordingly, the rotation of the orientations of the directors of the LC molecules 212 along the predetermined in-plane direction (e.g., the x-axis) may exhibit a handedness, e.g., right handedness or left handedness. For discussion purposes, FIG. 2C shows that the orientations of the directors of the LC molecules 212 may rotate along the predetermined in-plane direction (e.g., the x-axis) in a clockwise direction, exhibiting a left handedness.

Although not shown in FIG. 3B, in some embodiments, the orientations of the directors of the LC molecules 212 located in close proximity to the surface of the birefringent medium layer 215 may exhibit a rotation in a counter-clockwise direction. Accordingly, the rotation of the orientations of the directors of the LC molecules 212 may exhibit a right handedness. Although not shown, in some embodiments, within the surface of the birefringent medium layer 215, domains in which the orientations of the directors of the LC molecules 212 exhibit a rotation in a clockwise direction (referred to as domains DL) and domains in which the orientations of the directors of the LC molecules 212 exhibit a rotation in a counter-clockwise direction (referred to as domains D_{R}) may be alternatingly arranged in two in-plane directions, e.g., in x-axis and y-axis directions.

The in-plane orientation pattern of the LC directors shown in FIG. 3C may be referred to as a lens pattern (e.g., a spherical lens pattern). The LCPH element 200 including the birefringent medium layer 215 configured with the in-plane orientation pattern shown in FIG. 3C and the out-of-plane orientation pattern shown in FIG. 2E may function as a reflective PVH lens (e.g., spherical lens). In the embodiment shown in FIG. 3C, the orientations of the LC directors of LC molecules 212 located in close proximity to the surface of the birefringent medium layer 215 may exhibit a continuous rotation in at least two opposite in-plane directions from a lens pattern center 350 to opposite lens pattern peripheries 355 with a varying pitch. The orientations of the LC directors may exhibit a rotation in the same rotation direction (e.g., clockwise, or counter-clockwise) from the lens pattern center 350 to the opposite lens pattern peripheries 355.

The pitch Λ of the in-plane orientation pattern may be defined as a distance in the in-plane direction (e.g., a radial direction) over which the orientations of the LC directors (or azimuthal angles ϕ of the LC molecules 212) change by a predetermined angle (e.g., 180°) from a predetermined initial state. FIG. 3D illustrates a section of the in-plane orientation pattern taken along an x-axis in the birefringent medium layer 215 shown in FIG. 3C, according to an embodiment of the present disclosure. As shown in FIG. 3D, according to the LC director field along the x-axis direction, the pitch Λ may be a function of the distance from the lens pattern center 350. The pitch Λ may monotonically decrease from the lens pattern center 350 to the lens pattern peripheries 355 in the at least two opposite in-plane directions (e.g., two opposite radial directions) in the x-y plane, e.g., Λ₀>Λ₁> . . . >Λᵣ. Λ₀ is the pitch at a central region of the lens pattern, which may be the largest. The pitch Λᵣ is the pitch at a periphery region (e.g., lens pattern periphery 355) of the lens pattern, which may be the smallest. In some embodiments, the azimuthal angle ϕ of the LC molecule 212 may change in proportional to the distance from the lens pattern center 350 to a local point of the birefringent medium layer 215 at which the LC molecule 212 is located.

In the embodiment shown in FIG. 3E, the LCPH element 200 is shown as having a rectangular shape (or a rectangular lens aperture). A width direction of LCPH element 200 may be referred to as a lateral direction (e.g., an x-axis direction in FIG. 3E), and a length direction of the LCPH element 200 may be referred to as a longitudinal direction (e.g., a y-axis direction in FIG. 3E).

In the embodiment shown in FIG. 3E, the orientations of the LC molecules 212 located in close proximity to the surface of the birefringent medium layer 215 may be configured with an in-plane orientation pattern having a varying pitch in at least two opposite lateral directions, from the lens pattern center (“O_{L}”) 350 to the opposite lens pattern peripheries 355. The orientations of the LC directors of the LC molecules 212 located on the same side of an in-plane lens pattern center axis 363 and at a same distance from the in-plane lens pattern center axis 363 may be substantially the same. The rotations of the orientations of the LC directors from the lens pattern center 350 to the opposite lens pattern peripheries 355 in the two opposite lateral directions may exhibit a same handedness (e.g., right, or left handedness).

In the embodiment shown in FIG. 3E, the directors of the LC molecules 212 may be configured with a continuous in-plane rotation pattern with a varying pitch (Λ₀, λ₁, . . . , Λᵣ) from the lens pattern center 350 to opposite lens pattern peripheries 355 in the two opposite lateral directions. As shown in FIG. 3E, the pitch of the lens pattern may vary with the distance to the in-plane lens pattern center axis 363 in the lateral direction. In some embodiments, the pitch of the lens pattern may monotonically decrease as the distance to the in-plane lens pattern center axis 363 in the lateral direction increases, i.e., Λ₀>Λ₁> . . . >Λᵣ, where Λ₀ is the pitch at a central portion of the lens pattern, which may be the largest. The pitch Λᵣ is the pitch at an edge or periphery region of the lens pattern, which may be the smallest.

The LCPH element 200 including the birefringent medium layer 215 configured with the in-plane orientation pattern shown in FIG. 3E and the out-of-plane orientation pattern shown in FIG. 2E may function as a reflective PVH lens, e.g., an on-axis focusing cylindrical lens that may focus a beam into a line (e.g., a line of focal points or a line focus). The cylindrical lens with the in-plane orientation pattern shown in FIG. 3E may be considered as a 1D example of the spherical lens with the in-plane orientation pattern shown in FIGS. 3C and 3D, and the at least two opposite in-plane directions in the LCPH element 200 may include at least two opposite lateral directions (e.g., the +x-axis and −x-axis directions).

In some embodiments, to broaden the reflection band of the LCPH element 200, the helical structures 217 in the birefringent medium layer 215 may be configured with a varying helical pitch. FIGS. 3F and 3G schematically illustrate x-z sectional views of the birefringent medium layer 215 shown in FIG. 2A, according to various embodiments of the present disclosure. For discussion purposes, FIGS. 3F and 3G show that the helical axis 218 of helical structures 217 formed in the birefringent medium layer 215 is perpendicular to the surface of the birefringent medium layer 215 and parallel with the thickness direction of the birefringent medium layer 215. In some embodiments, although not shown, the helical axis 218 of helical structures 217 formed in the birefringent medium layer 215 may be tilted with respect to the thickness direction of the birefringent medium layer 215.

In the embodiment shown in FIG. 3F, the birefringent medium layer 215 may include a plurality of sub-layers (e.g., 317, 318, and 319) arranged in a stacked configuration. The sub-layers 317, 318, and 319 may be individually fabricated and stacked together, or one sub-layer may be fabricated on another sub-layer. Each of the sub-layers 317, 318, and 319 may include the helical twist strictures 217 having a helical pitch. For each sub-layer, the helical pitch may be the same throughout the sub-layer. At least two of the sub-layers 317, 318, and 319 may have different helical pitches. In some embodiments, helical pitches for all of the sub-layers 317, 318, and 319 may be different. For discussion purposes, FIG. 3F shows that the helical pitches of the sub-layers 317, 318, and 319 gradually increase from the first surface 215-1 to the second surface 215-2 in a predetermined direction (e.g., in a thickness direction of the birefringent medium layer 215 shown in FIG. 3E). The sub-layers 317, 318, and 319 with different helical pitches may be fabricated by varying concentration and/or helical twist power of the chiral dopants doped in the biaxial host LCs in the sub-layers 317, 318, and 319.

In the embodiment shown in FIG. 3G, the birefringent medium layer 215 may not include sub-layers, and the birefringent medium layer 215 itself may be configured with a varying (e.g., non-constant) helical pitch in a predetermined direction (e.g., in a thickness direction of the birefringent medium layer 215 shown in FIG. 3G). For illustrative purposes, FIG. 3G shows that the helical pitch of the helical twist strictures 217 gradually increases from the first surface 215-1 to the second surface 215-2 in the thickness direction. The varying helical pitch of the helical twist strictures 217 shown in FIG. 3G may be obtained by varying the concentration and/or helical twist power of the chiral dopants doped in the biaxial host LCs along the thickness direction of the birefringent medium layer 215.

The LCPH element disclosed herein may be a passive or an active element. In some embodiments, when a voltage is applied to the birefringent medium layer 215, the local orientations of the LC molecules 212 in the helical structures 217 may be re-orientated, and/or the in-plane orientation pattern of the LC molecules located in close proximity to the surface of the birefringent medium layer 215 may be changed. Accordingly, the optical response of the LCPH element 200 shown in FIG. 2A may be changed. For example, the deflection angle, the optical power, the phase shift, the reflection band, and/or the reflection wavelength, etc., of the LCPH element 200 may be adjustable through adjusting the voltage applied to the birefringent medium layer 215.

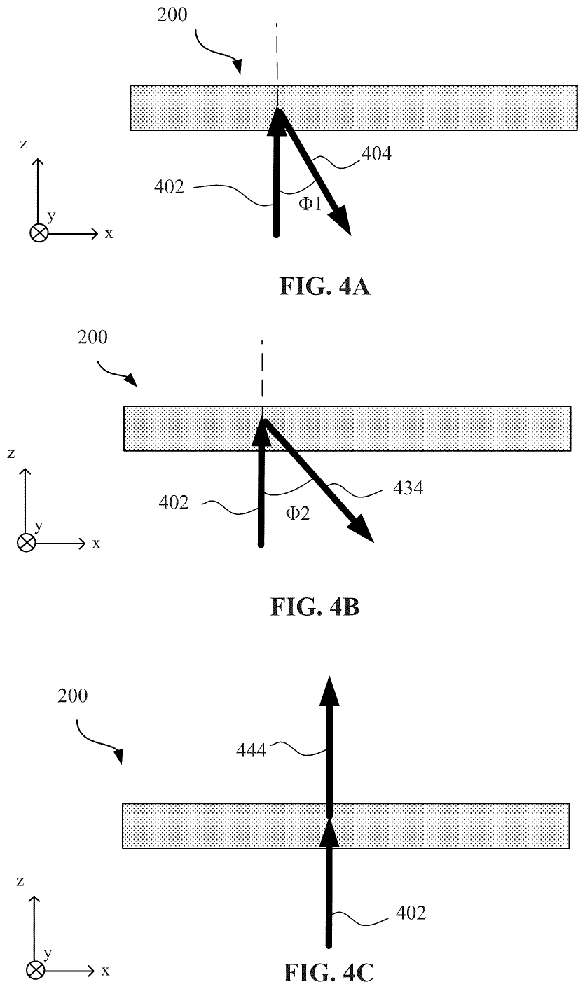

FIGS. 4A and 4B illustrates an electrical tuning of the LCPH element 200 shown in FIG. 2A, according to an embodiment of the present disclosure. For discussion purposes, FIGS. 4A and 4B show that the LCPH element 200 functions as a reflective PVH element. As shown in FIG. 4A, at a voltage-off state (power source is not shown), the LCPH element 200 may substantially reflect (e.g., via backward diffraction) a circularly polarized input light 402 in a first deflection direction as a substantially circularly polarized output light 404 forming a first deflection angle ϕ1 with respect to a surface normal of the LCPH element 200. The substantially circularly polarized output light 404 may have a predetermined handedness. As shown in FIG. 4B, at a voltage-on state (power source is not shown), the LCPH element 200 may substantially reflect (e.g., via backward diffraction) the circularly polarized input light 402 having the predetermined handedness as a substantially circularly polarized output light 434, in a second deflection direction forming a second deflection angle ϕ2 with respect to a surface normal of the LCPH element 200. For discussion purposes, FIGS. 4A and 4B show that as the applied voltage increases (here from voltage-off state to voltage-on state), the deflection angle of the LCPH element 200 may increase accordingly. Thus, the LCPH element 200 may function as or may be implemented in a beam steering device. After the voltage is removed, the LCPH element 200 may return to the initial state shown in FIG. 4A.

In some embodiments, when the voltage applied to the birefringent medium layer 215 is sufficiently high, the biaxial LC molecules 212 may be substantially aligned in the electric field direction, and the helical structures 217 may be unwound. In this case, as shown in FIG. 4C, the LCPH element 200 may not reflect the circularly polarized input light 402. Instead, the LCPH element 200 may transmit the circularly polarized input light 402 as a circularly polarized output light 444. After the voltage is removed, the LCPH element 200 may return to the initial state shown in FIG. 4A.

The present disclosure also provides various fabrication methods for fabricating the LCPH elements disclosed herein. In some embodiments, the LCPH element disclosed herein may be fabricated based on self-assembly of biaxial LC molecules (or other substructures), or self-assembly of uniaxial LC molecules (or other substructures) of different shapes. In some embodiments, the LCPH element disclosed herein may be fabricated by processing a layer of uniaxial LCs. In some embodiments, the LCPH element disclosed herein may be fabricated based on layered deposition of biaxial films formed by LC polymers or organic solid crystals.

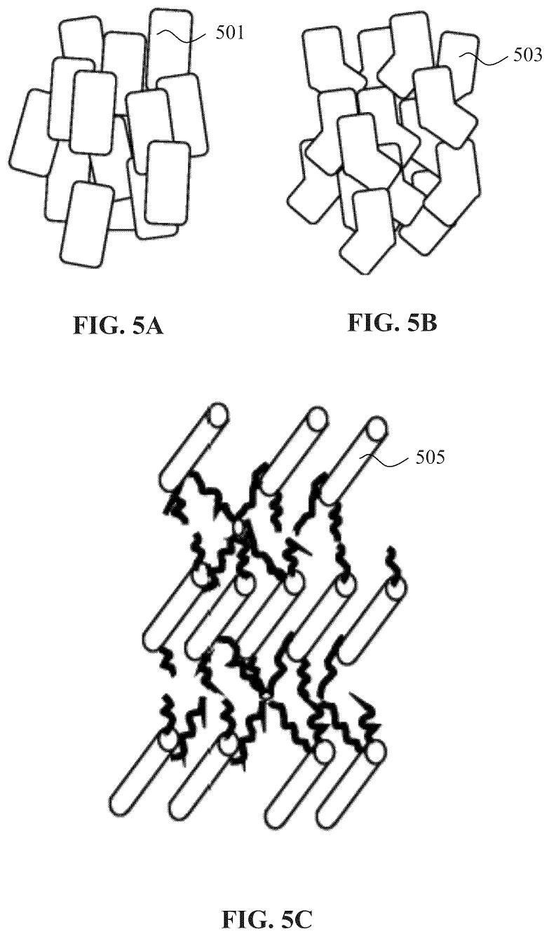

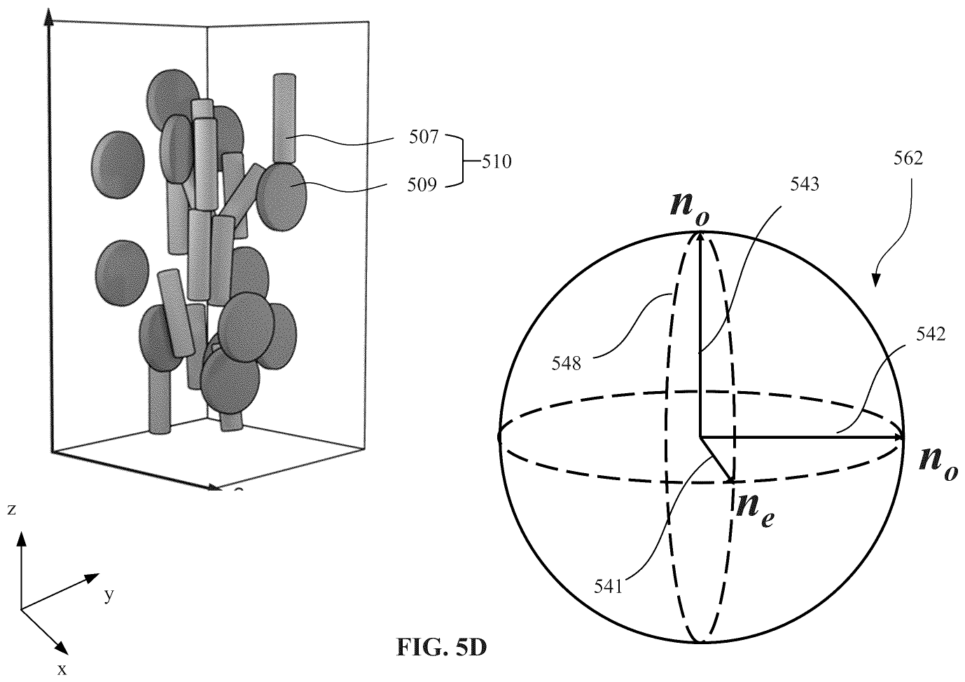

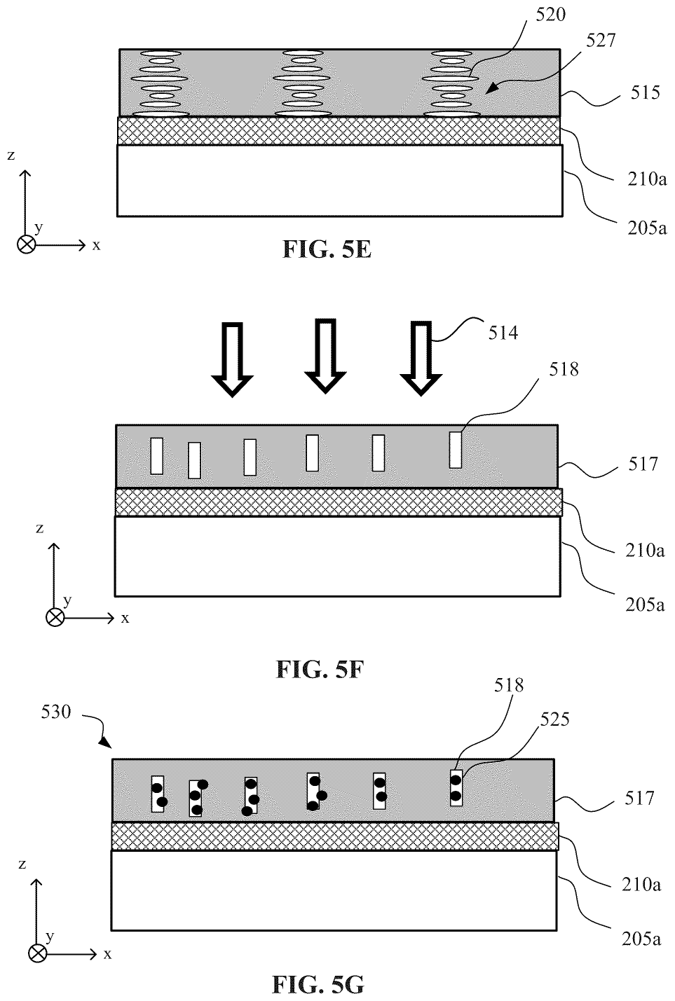

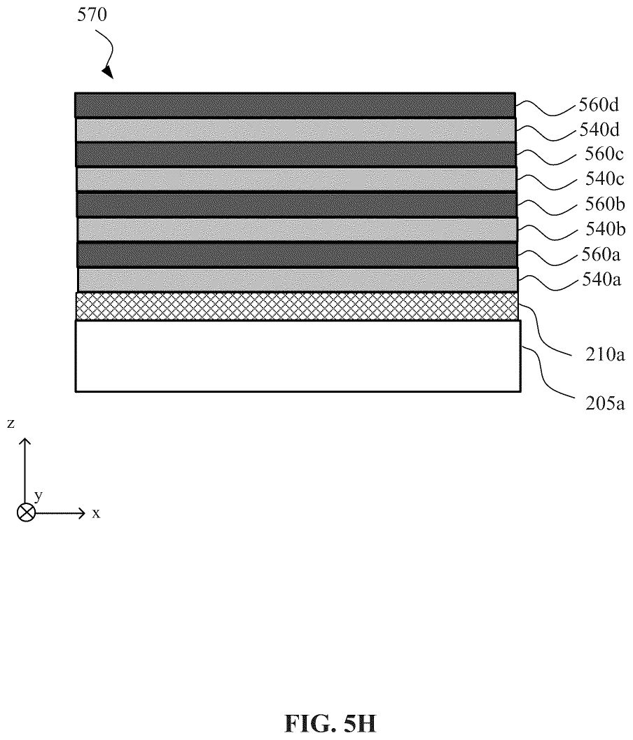

In some embodiments, the LCPH element disclosed herein may be fabricated based on self-assembly of biaxial LC molecules (or other substructures). For example, FIGS. 5A-5C illustrate biaxial LCs having an intrinsic biaxial optical anisotropy, according to various embodiments of the present disclosure. The birefringent medium (or biaxial LCs) having an intrinsic biaxial optical anisotropy may include biaxial LC molecules having biaxial anisotropic molecular structures. In some embodiments, the biaxial LCs having an intrinsic biaxial optical anisotropy may include single-component biaxial molecules. FIG. 5A shows that biaxial LCs having an intrinsic biaxial optical anisotropy may include board-shaped molecules 501, e.g., anisometric parallelepiped platelets. FIG. 5B shows that biaxial LCs having an intrinsic biaxial optical anisotropy may include bent-shaped molecules 503, e.g., V-shaped molecules, or J-shaped molecules, etc. FIG. 5C shows that biaxial LCs having an intrinsic biaxial optical anisotropy may include multipodes 505, e.g., symmetric tetrapodes or asymmetric tetrapodes, etc. In some embodiments, the biaxial LCs having an intrinsic biaxial optical anisotropy may include a side-chain LC polymer having biaxial phase.

In some embodiments, the LCPH element disclosed herein may be fabricated by disposing the biaxial LCs having an intrinsic biaxial optical anisotropy (e.g., doped with chiral dopants) at an alignment structure (e.g., a photo-alignment layer) that provides a predetermined surface alignment pattern, or filling the biaxial LCs into a cell formed by two substrates provided with the alignment structures. The biaxial LC molecules may be self-assembled to form a plurality of helical structures, such as the helical structures 217 shown in FIG. 2B or FIG. 2E.

In some embodiments, the LCPH element disclosed herein may be fabricated based on self-assembly of a mixture of uniaxial LC molecules (or other uniaxial substructures) of different shapes. In some embodiment, the mixture of uniaxial LC molecules (or other uniaxial substructures) of different shapes may include first LC molecules (or other substructures) having a first shape, and second LC molecules (or other substructures) having a second shape different from the first shape. The first shape and the second shape may define uniaxial optical anisotropies in different directions, and the mixture of the first LC molecules (or other substructures) and the second LC molecules (or other substructures) may exhibit an induced biaxial optical anisotropy. That is, the mixture of the first LC molecules and the second LC molecules may form biaxial LCs having an induced biaxial optical anisotropy. In some embodiments, the first shape may correspond to a rod shape, and the second shape may correspond to a disc shape. In some embodiments, the first shape may correspond to a first rod shape, and the second shape may correspond to a second, different rod shape. In some embodiments, the mixture of uniaxial LC molecule (or other uniaxial substructure) may include LC molecules having the first shape (e.g., the rod shape) and nanocrystal particles having the second shape (e.g., the different rod shape or the disc shape).

FIG. 5D illustrates a birefringent medium (e.g., biaxial LCs) 510 having an induced biaxial optical anisotropy, according to an embodiment of the present disclosure. For discussion purposes, FIG. 5D shows that the birefringent medium 510 includes a mixture of calamitic LCs and discotic LCs. The calamitic LCs may include uniaxial calamitic (or rod-like, or rod-shaped) LC molecules 507, and the discotic LCs may include uniaxial discotic (or disc-like, or disc-shaped) LC molecules 509. The uniaxial calamitic (or rod-like, or rod-shaped) LC molecules 507 may be similar to the LC molecules 112 shown in FIGS. 1A and 1B. The discotic LC molecules 509 may include a flat or substantially flat central aromatic disc-shaped core, substituted by more than three flexible aliphatic carbon chains. In the schematic diagram shown in FIG. 5D, the discotic LC molecules 509 are represented by disks. FIG. 5D also illustrates a refractive index ellipsoid 562 of the uniaxial discotic LC molecules 509. As shown in FIG. 5D, the refractive index ellipsoid 562 of the uniaxial discotic LC molecule 509 in nematic phase is uniaxial anisotropic. The refractive index ellipsoid 562 may have a flat, disc-like shape having three pairwise perpendicular axes of symmetry that intersect at a center of symmetry. The refractive index ellipsoid 562 may have three orthogonal semi-axes 541, 542, and 543. The semi-axis 541 may be the shortest, and the semi-axis 542 and the semi-axis 543 may have a longer equal length, because the uniaxial discotic LC molecule 509 in nematic phase thermally rotates along the semi-axis 141. An axis along the semi-axis 541 may be referred to as a short molecular axis or a director of the uniaxial LC molecule 512, and an axis along the semi-axis 542 or the semi-axis 543 may be referred to as a long molecular axis. The semi-axis 542 and the semi-axis 543 are located within a circular cross-section 548 of the disc, and the semi-axis 541 is perpendicular to the circular cross-section 548.

When a group of the uniaxial LC molecules 509 are homogeneously aligned, e.g., the semi-axes 541, the semi-axes 542, and the semi-axes 543 of all the LC molecules 509 in the group are aligned in a same first direction (e.g., an x-axis direction), a same second direction (e.g., a y-axis direction), and a same third direction (e.g., a z-axis direction), respectively, the length of the semi-axis 541, 542, or 543 corresponds to a principal refractive index of the group of the uniaxial LC molecules 509. The refractive indices along the semi-axis 541, the semi-axis 542, and the semi-axis 543 may be nₑ, nₒ, and nₒ, respectively, where nₑ and nₒ represent an extraordinary refractive index and an ordinary refractive index of the discotic LCs, respectively. For the discotic LCs only including the disc-like uniaxial LC molecule 509, the ordinary refractive index nₒ is often greater than the extraordinary refractive index nₑ, i.e., nₑ<nₒ. That is, the refractive indices along the semi-axis 542 and the semi-axis 543 may be the same, which is greater than the refractive index along the semi-axis 541.

For discussion purposes, the discotic LCs including the discotic LC molecules 509 where nₑ<nₒ may be referred to as an LC material having a negative uniaxial optical anisotropy (or −LC material). The calamitic LCs including the uniaxial calamitic LC molecules 507 where nₑ>nₒ may be referred to as an LC material having a positive uniaxial optical anisotropy (or +LC material). For discussion purposes, the extraordinary refractive index nₑ and the ordinary refractive index nₒ of the +LC material may be represented as nₑ+ and nₒ+, respectively. The extraordinary refractive index nₑ and the ordinary refractive index nₒ of the −LC material may be represented as nₑ₋ and nₒ₋, respectively.

In some embodiments, the LCPH element disclosed herein may be fabricated by disposing the birefringent medium 510 (e.g., doped with chiral dopants) on an alignment structure (e.g., a photo-alignment layer) that provides a predetermined in-plane orientation pattern, or filing the birefringent medium 510 (e.g., doped with chiral dopants) into a cell formed by two substrates provided with the alignment structures. The uniaxial calamitic LC molecules 507 and the uniaxial discotic LC molecules 509 may be self-assembled to form a plurality of helical structures, such as the helical structures 217 shown in FIG. 2B or FIG. 2E. A single biaxal LC molecule 212 shown in FIG. 2B or FIG. 2E may be considered as equivalent to a group of one or more uniaxial calamitic LC molecules 507 and one or more uniaxial discotic LC molecules 509.

FIGS. 5E-5G illustrate fabrication processes of an LCPH element disclosed herein, according to an embodiment of the present disclosure. As shown in FIG. 5E, a layer 515 of a first LC material may be disposed at the substrate 205a, which may be provided with the alignment structure 210a. The first LC material may include first LC molecules (or other substructures) 520 having a first shape. The first LC molecules 520 may be self-assembled to form a plurality of helical structures 527 within the volume of the layer 515. For discussion purposes, FIG. 5E shows the helical structures 527 are non-slanted, i.e., having a helical axis perpendicular to the surface of the layer 515. In some embodiments, although not shown, the helical structures 527 may be slanted, i.e., having a helical axis slated with respect to the surface of the layer 515.

The first LC material may be polymerizable, e.g., photo-polymerizable or thermo-polymerizable. For example, the first LC material may include reactive mesogens mixed with chiral dopants and photo-initiators. As shown in FIG. 5F, the layer 515 may be exposed to a polymerization irradiation 514, and the layer 515 may be polymerized to form a porous frame of helical structures, e.g., three-dimensional network or scaffold formed by helical structures with pores or cavities 518. The layer 515 after the polymerization may be a porous layer or a porous liquid crystal polymer layer 517. The shape of the effective refractive index ellipsoid of the layer 515 or the liquid crystal polymer layer 517 may be an ellipsoid with two of the three axes of symmetry having the same length.

As shown in FIG. 5G, after the layer 515 is polymerized, a second LC material that includes second LC molecules (or other substructures) 525 having a second shape may be disposed at the porous layer 517, and may at least partially fill into the pores or cavities 518 in the porous layer 517. The porous layer 517 filled with the second LC material (or the second LC molecules 525) may form an LCPH element 530 having a substantially isotropic effective refractive index ellipsoid, e.g., similar to the effective refractive index ellipsoid 250 shown in FIG. 2D or the effective refractive index ellipsoid 280 shown in FIG. 2F. In some embodiments, the porous layer 517 filled with the second LC material (or the second LC molecules 525) may be exposed to the polymerization irradiation 514, thereby stabilizing the orientations of the second LC molecules 525. In some embodiments, the porous layer 517 filled with second LC material (or the second LC molecules 525) may not be exposed to the polymerization irradiation 514, such that the second LC molecules 525 may be switchable between different orientations, and the fabricated LCPH element 530 may be switchable between different operation states.

In some embodiments, as shown in FIG. 5E and FIG. 5G, the first LC molecules 520 having the first shape may be the uniaxial calamitic LC molecules 507, whereas the second LC molecules 525 having the second shape may be the uniaxial discotic LC molecules 509. In some embodiments, the first LC molecules 520 having the first shape may be the uniaxial discotic LC molecules 509, whereas the second LC molecules 525 having the second shape may be the uniaxial calamitic LC molecules 507. In some embodiments, the uniaxial calamitic LC molecules 507 may be aligned to have the short molecular axes along the helical axis of the helical structures 527, and the uniaxial discotic LC molecules 509 may be aligned to have the long molecular axes along the helical axis of the helical structures 527. In some embodiments, the first LC material and the second LC material may be configured to have matching refractive indexes, e.g., nₑ of the first LC material may be equal to nₒ of the second LC material, and nₒ of the first LC material may be equal to nₑ of the second LC material.

FIG. 5H illustrates fabrication processes of an LCPH element disclosed herein, according to an embodiment of the present disclosure. As shown in FIG. 5H, a layer 540a of the first LC material that the includes the first LC molecules (or other substructures) 520 having the first shape may be disposed on a surface of the substrate 205a, which may be provided with the alignment structure 210a. The first LC molecules 520 may be self-assembled to form a plurality of helical structures within the volume of the layer 540a.

Then the layer 540a may be exposed to a polymerization irradiation to form a liquid crystal polymer layer (also referred to as 540a for discussion purposes). Then a layer 560a of the second LC material that includes the second LC molecules 525 having the second shape may be disposed at the liquid crystal polymer layer 540a. The second LC molecules 525 may be self-assembled to form a plurality of helical structures within the volume of the layer 560a. Then the layer 560a may be exposed to the polymerization irradiation to form a liquid crystal polymer layer (also referred to as 560a for discussion purposes).

In some embodiments, the first LC molecules 520 having the first shape may be the uniaxial calamitic LC molecules 507, whereas the second LC molecules 525 having the second shape may be the uniaxial discotic LC molecules 509. In some embodiments, the uniaxial calamitic LC molecules 507 in the layer 540a may be aligned to have the short molecular axes along the helical axis of the helical structures, and the uniaxial discotic LC molecules 509 in the layer 560a may be aligned to have the long molecular axes along the helical axis of the helical structures. In some embodiments, the first LC molecules 520 having the first shape may be the uniaxial discotic LC molecules 509, whereas the second LC molecules 525 having the second shape may be the uniaxial calamitic LC molecules 507. In some embodiments, the first LC material and the second LC material may be configured to have matching refractive indexes, e.g., nₑ of the first LC material may be equal to nₒ of the second LC material, and nₒ of the first LC material may be equal to nₑ of the second LC material.

The fabrication processes of the liquid crystal polymer layer 540a and the liquid crystal polymer layer 560a may be repeated, such that a plurality of liquid crystal polymer layers 540a-540d of the first LC material (or the first molecules 520) and a plurality of liquid crystal polymer layers 560a-560d of the second LC material (or the second LC molecules 525) may be alternately arranged on the substrate 205a. The stack of the alternately arranged liquid crystal polymer layers 540a-540d and liquid crystal polymer layers 560a-560d may form an LCPH element 570 having a substantially isotropic effective refractive index ellipsoid, e.g., similar to the effective refractive index ellipsoid 250 shown in FIG. 2D or the effective refractive index ellipsoid 280 shown in FIG. 2F.

In some embodiments, the LCPH element disclosed herein may be fabricated using three-dimensional (“3D”) patterning techniques. In some embodiments, the 3D patterning includes sequentially disposing (e.g., coating, depositing, printing, or spraying, etc.) the first LC material at a first location of a substrate and the second LC material at a second location of the substrate. The second location may be different from the first location. In some embodiments, the first LC material and the second LC material may be disposed at different locations to form a 3D matrix. For example, the 3D matrix may include multiple layers, such as a first layer and a second layer different from the first layer, where the first layer and the second layer may have different distributions of the first LC material and the second LC material. In some embodiments, each layer may include helical structures formed by the first LC molecules of the first material and the second LC molecules of the second material. In some embodiments, the helical axis of the helical structures may be slanted or non-slanted.

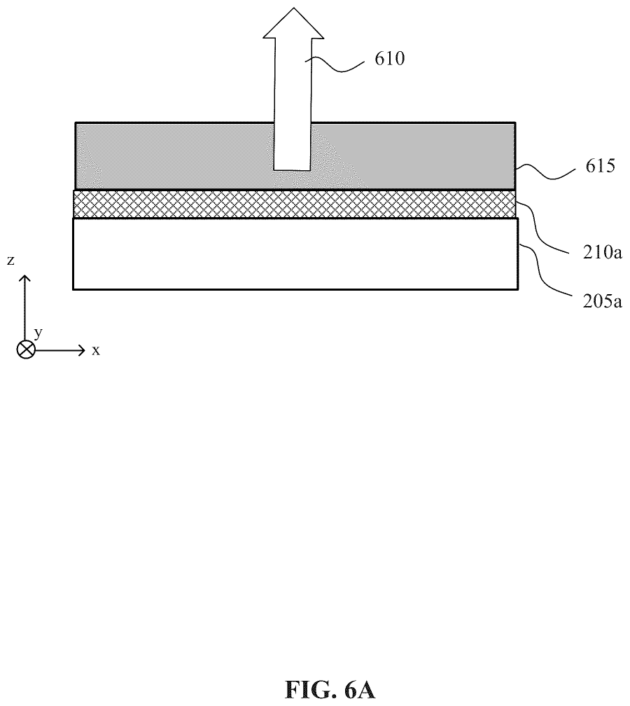

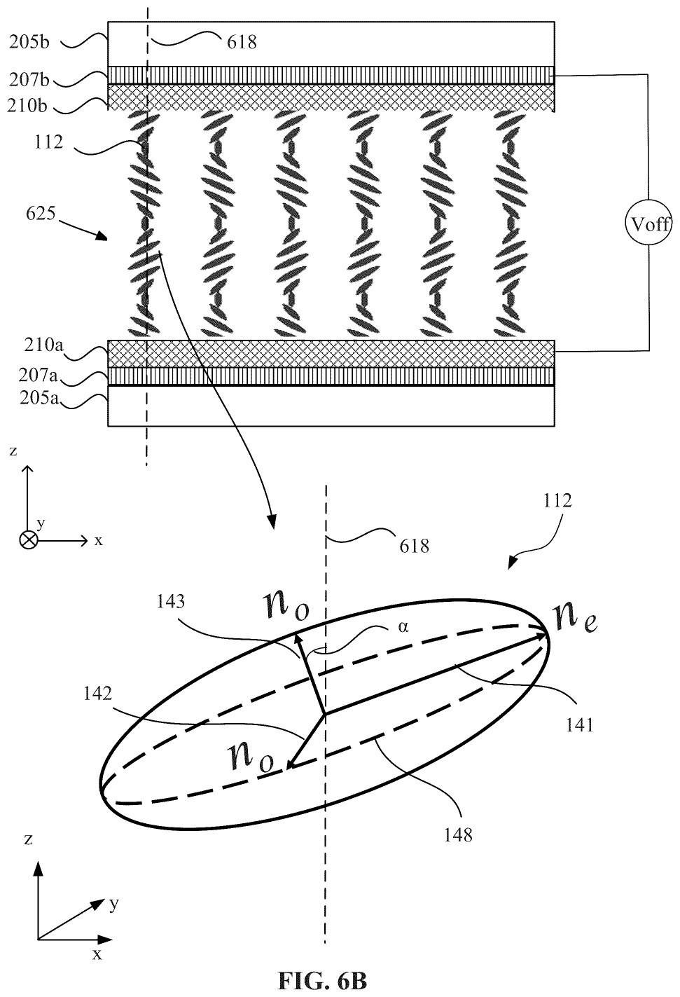

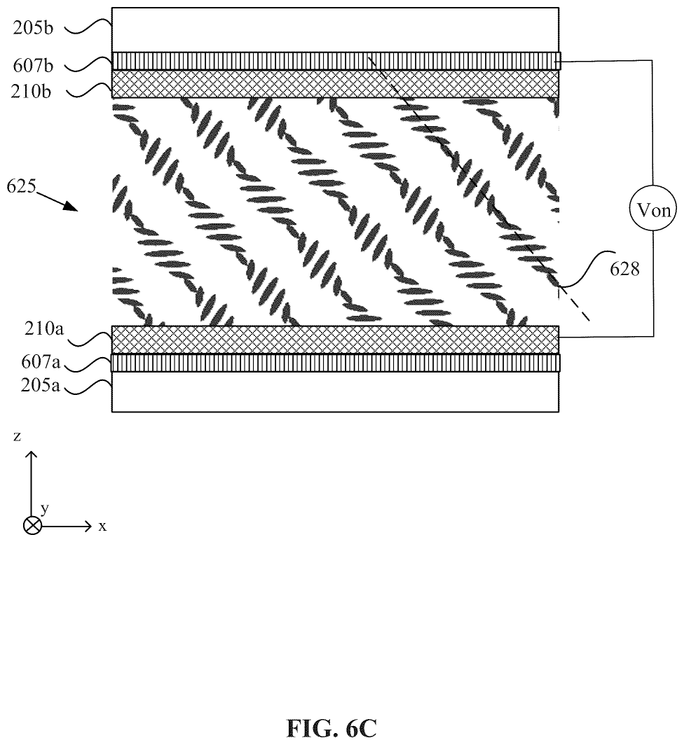

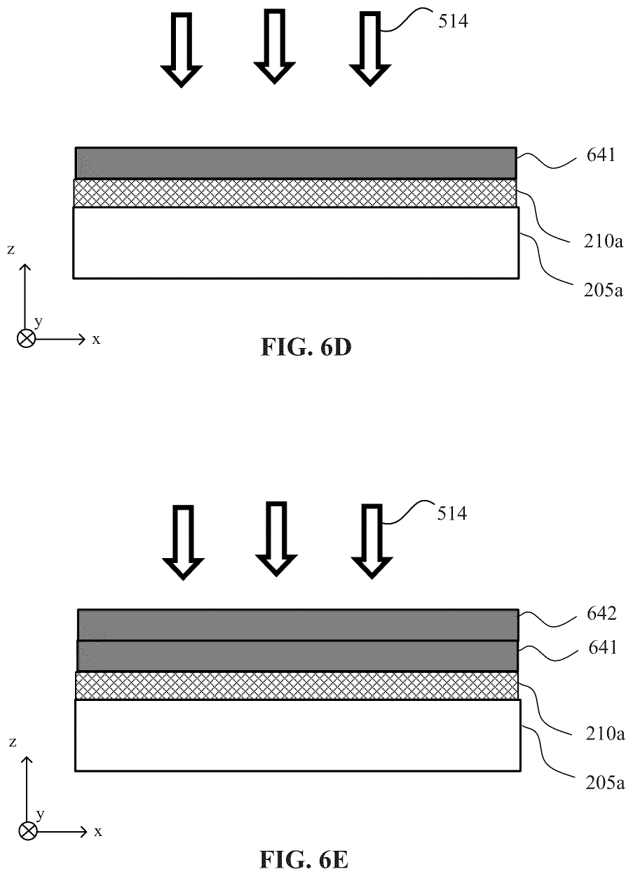

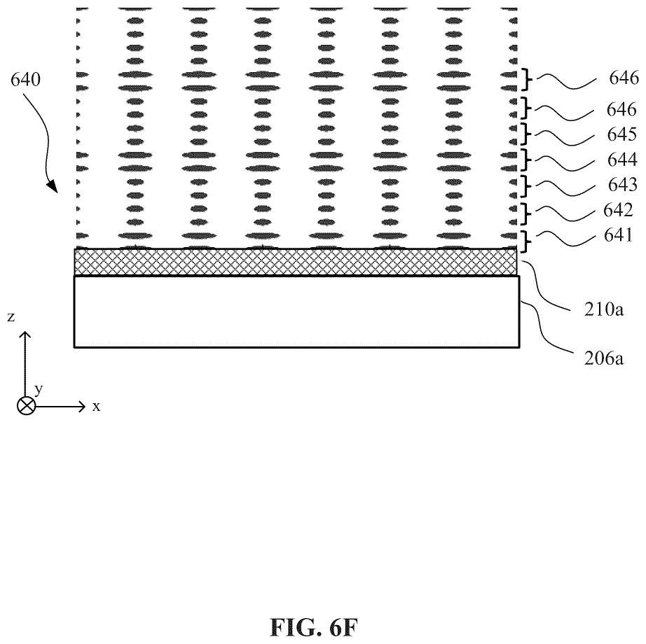

FIG. 6A illustrates processes for fabricating an LCPH element disclosed herein, according to an embodiment of the present disclosures. The processes shown in FIG. 6A may include processing a layer of uniaxial LCs (referred to as a uniaxial LC layer) to change the effective refractive index ellipsoid of the uniaxial LC layer to be a substantially isotropic effective refractive index ellipsoid. The uniaxial LCs may include any suitable uniaxial LC molecules, such as the uniaxial discotic LC molecules 509, or the uniaxial calamitic LC molecules 507. The uniaxial LC molecules may be self-assembled to form a plurality of helical structures in the uniaxial LC layer. The shape of the effective refractive index ellipsoid of the uniaxial LC layer may be an ellipsoid with two of the three axes of symmetry having the same length. The uniaxial LC layer may be a non-slanted CLC layer or a slanted CLC layer (e.g., reflective PVH layer). When the uniaxial LC layer is a non-slanted CLC layer, the effective refractive index ellipsoid of the uniaxial LC layer may be similar to the effective refractive index ellipsoid 150 shown in FIG. 1C. When the uniaxial LC layer is a slanted CLC layer (e.g., reflective PVH layer), the effective refractive index ellipsoid of the uniaxial LC layer may be tilted, as the helical axis of the slanted CLC layer (e.g., reflective PVH layer) is tilted with respect to the surface of the slanted CLC layer (e.g., reflective PVH layer).

FIG. 6A shows that a layer 615 of uniaxial LCs is disposed on the substrate 205a provided with the alignment structures 210a. The layer 615 of uniaxial LCs may also be referred to as CLC layer 615, which may be a non-slanted CLC layer or slanted CLC layer. The uniaxial LC layer 615 may have a shape defined by three dimensions, a first dimension, a second dimension, and a third dimension that are orthogonal to one another. For example, the first dimension, the second dimension, and the third dimension of the CLC layer 615 may be the dimensions along the x-axis direction, the y-axis direction, and the z-axis direction shown in FIG. 6A, respectively. An asymmetric field may be applied to the CLC layer 615 along the third dimension (that is parallel to the helical axis, e.g., the z-axis direction) and the two orthogonal dimensions (that are the first and second dimension perpendicular to the helical axis, e.g., within the x-y plane) to induce a local biaxial optical anisotropy of the CLC layer 615, or change the anisotropic molecular structure of the LC molecules or fragments of polymeric molecules in the CLC layer 615, thereby changing the effective refractive index ellipsoid of the CLC layer 615.

The asymmetric field may include an asymmetric electric field, an asymmetric magnetic field, an asymmetric mechanical force, or a combination thereof, etc. The asymmetric field may be configured, such that the CLC layer 615 that has been applied with the asymmetric field may exhibit a substantially isotropic effective refractive index ellipsoid, e.g., similar to the effective refractive index ellipsoid 250 shown in FIG. 2D or the effective refractive index ellipsoid 280 shown in FIG. 2F. In some embodiments, the in-plane principal refractive index of the CLC layer 615 that has been applied with the asymmetric field may be different from the in-plane principal refractive index of the original CLC layer 615, and/or the out-of-plane principal refractive index of the CLC layer 615 that has been applied with the asymmetric field may be different from the out-of-plane principal refractive index of the original CLC layer 615.

In some embodiments, the CLC layer 615 may include active uniaxial LCs, and the CLC layer 615 may be coupled with two electrodes. An asymmetric electric field or an asymmetric magnetic field may be applied to the CLC layer 615 via the two electrodes. The applied asymmetric electric field or magnetic field may change the orientations of the uniaxial LC molecules in the CLC layer 615, which may induce a local biaxial optical anisotropy in the CLC layer 615. Accordingly, the effective refractive index ellipsoid of the CLC layer 615 may be changed. In some embodiments, the uniaxial LC layer 615 shown in FIG. 6A may include uniaxial reactive mesogens doped with photo-initiators, and the CLC layer 615 that is applied with the asymmetric field may be exposed to a polymerization irradiation, such that the orientations of the uniaxial LC molecules 112 may be stabilized.

In some embodiments, the CLC layer 615 may be a liquid crystal polymer layer, and the asymmetric mechanical force applied to the CLC layer 615 may change the shape of the CLC layer 615 which, in turn, changes the anisotropic molecular structure of the LC molecules or fragments of polymeric molecules in the CLC layer 615. Accordingly, the effective refractive index ellipsoid of the CLC layer 615 may be changed. For example, as shown in FIG. 6A, the CLC layer 615 may be a liquid crystal polymer layer, and an asymmetric mechanical force 610 may be applied to the uniaxial LC layer 615 along the third dimension (that is parallel to the helical axis, e.g., the z-axis direction) and the two orthogonal dimensions (that are the first and second dimension perpendicular to the helical axis, e.g., within the x-y plane), thereby changing the shape of the uniaxial LC layer 615 may be changed. A ratio among the first dimension, the second dimension, and the third dimension of the CLC layer 615 applied with the symmetric mechanical force 610 may be different from a ratio among the first dimension, the second dimension, and the third dimension of the original CLC layer 615. In other words, an aspect ratio of the CLC layer 615 applied with the symmetric mechanical force 610 may be different from an aspect ratio of the original CLC layer 615.

For example, as shown in FIG. 6A, the uniaxial LC layer 615 may be stretched in the third dimension (that is parallel to the helical axis, e.g., the z-axis direction), thereby increasing a length of the CLC layer 615 along the third dimension. In some embodiments, the lengths of the CLC layer 615 along the first dimension and the second dimension may remain substantially unchanged. In some embodiments, the lengths of the CLC layer 615 along the first dimension and the second dimension may decrease, depending on the Poisson's ratio of the material of the CLC layer 615. In some embodiments, the CLC layer 615 may be compressed instead of being stretched or pulled. For example, the CLC layer 615 may be compressed in the third dimension (that is parallel to the helical axis, e.g., the z-axis direction), thereby decreasing a length of the uniaxial LC layer 615 along the third dimension. In some embodiments, applying the external mechanical force to the CLC layer 615 may permanently change the shape of the uniaxial LC layer 615. In some embodiments, applying the external mechanical force to the uniaxial LC layer 615 may temporarily change the shape of the CLC layer 615, e.g., the uniaxial LC layer 615 may return to its original shape after the external mechanical force is removed.

FIGS. 6B and 6C illustrate processes for fabricating an LCPH element disclosed herein, according to an embodiment of the present disclosures. As shown in FIG. 6B, active uniaxial LCs may be filled into a cell formed by the substrate 205a and the substrate 205b to form a layer 625 of uniaxial LCs. The layer 625 of uniaxial LCs may also be referred to as CLC layer 615. Each substrate 205 or 205b may be provided with the alignment structure 210a or 210b, and the electrode layer 207a or 207b. The electrode layer 207a and 207b may apply a voltage provided by a power source (not shown) to the CLC layer 625. FIG. 6B shows the orientations of the uniaxial LC molecules 112 when the voltage is not applied to the CLC layer 625. The uniaxial LC molecules 112 may be self-assembled to form a plurality of helical structures in the CLC layer 625. For discussion purposes, FIG. 6B shows that the CLC layer 625 is a non-slanted CLC layer, in which a helical axis 618 of the helical structures may be perpendicular to the surface of the CLC layer 625, and may be along the thickness direction of the CLC layer 625, e.g., the z-axis direction. The active uniaxial LCs in the CLC layer 625 may be a positive LC material, where nₑ>nₒ. FIG. 6B also illustrates a schematic diagram of the uniaxial LC molecule 112 in the CLC layer 625. The uniaxial LC molecule 112 may be aligned to have the semi-axis 143 (or the short molecular axis) forming an acute angle α with respect to the helical axis 618. The effective refractive index ellipsoid of the CLC layer 625 may be an ellipsoid in which two of the three axes of symmetry have the same length, e.g., similar to the effective refractive index ellipsoid 150 shown in FIG. 1C.

As shown in FIG. 6C, when a voltage is applied to the CLC layer 625 via the electrode layer 207a and 207b, a vertical electric field along the thickness direction may be generated with the CLC layer 625. The vertical electric field may reorient the uniaxial LC molecule 112 towards the direction of the vertical electric field, e.g., the z-axis direction, forming “tilted” or “slanted” CLC structures (e.g., R-PVH structures) shown in FIG. 6C. An helical axis 628 of the “tilted” or “slanted” CLC structures may be tilted with respect to the surface of the CLC layer 625, forming a tilt angle with respect to the surface of the CLC layer 625. The vertical electric field may be configured, such that at a certain tilt angle of the helical axis 628, the CLC layer 625 with the “tilted” or “slanted” CLC structures may have a substantially isotropic effective refractive index ellipsoid. In some embodiments, the CLC layer 625 with the “tilted” or “slanted” CLC structures may be exposed to a polymerization irradiation, such that the “tilted” or “slanted” CLC structures may be stabilized.

FIGS. 6D and 6E illustrates fabrication processes of an LCPH element disclosed herein, according to an embodiment of the present disclosure. The fabrication processes shown in FIGS. 6D and 6E may include forming a stack of biaxial films layer by layer. In some embodiments, the biaxial film may include a liquid crystal polymer or organic solid crystal. In some embodiments, the LC molecules (or other substructures) in the biaxial film may be biaxial LC molecules (or other biaxial substructures). FIG. 6F illustrates an x-z sectional view of an LCPH element 640 fabricated based on the fabrication processes shown in FIGS. 6D and 6E, according to an embodiment of the present disclosure. The LCPH element 640 may include a plurality of helical structures. However, the helical structures in the LCPH element 640 may not be in the chiral-induced continuous form. Instead, the helical structure over a single helical pitch may be formed by N layers (N=5-20) of liquid crystal polymers or organic solid crystals. For discussion purposes, liquid crystal polymers are used as an example for explaining the fabrication processes.

As shown in FIGS. 6D and 6E, a first biaxial film 641 may be formed on the substrate 205a provided with the alignment structure 210a, e.g., via coating, depositing, printing, or spraying, etc. The first biaxial film 641 may be exposed to the polymerization irradiation 514 to form a first liquid crystal polymer layer (also referred to as 641 for discussion purposes). Then a second biaxial film 642 may be formed on the first liquid crystal polymer layer 641, e.g., via coating, depositing, printing, or spraying, etc. The second biaxial film 642 may be exposed to the polymerization irradiation 514 to form a second liquid crystal polymer layer (also referred to as 642 for discussion purposes). The processes may be repeated, until a desired number of liquid crystal polymer layers are formed on the substrate 205a.

As shown in FIG. 6F, the LCPH element 640 may include a stack of liquid crystal polymer layers, each of which may include LC molecules uniformly oriented in a predetermined direction. The helical structure over a single helical pitch may be formed by N layers (N=5-20) of liquid crystal polymers 641-646. In the helical structure over a single helical pitch, the LC molecules in the same liquid crystal polymer layer may have the same orientation, whereas the LC molecules in different liquid crystal polymer layers may have different orientations. For example, the LC molecules in each liquid crystal polymer layer may be aligned to have the short molecular axes (corresponding to intermediate refractive index nₘ) along a helical axis of the helical structures, and the short molecular axes (corresponding to the ordinary refractive index nₒ) and the molecular axes (corresponding to the extraordinary refractive index nₑ) located with the Bragg plane formed by the helical structures. For discussion purposes, the direction of the orientation (or the long molecular axes or directors) of the LC molecules in the same liquid crystal polymer layer may be referred to as an in-plane optic axis of the liquid crystal polymer layer, and an angle of the in-plane optic axis with respect to a predetermined in-plane direction (e.g., the x-axis direction in FIG. 6F) may be referred to as an in-plane optic axis angle. That is, different liquid crystal polymer layers 641-646 may have different in-plane optic axis angles, or the liquid crystal polymers 641-646 may have discrete in-plane optic axes.

A difference between the in-plane optic axis angles of two adjacent liquid crystal polymer layers may be equal to 360°/N. For example, when N=6, a difference between the in-plane optic axis angles of two adjacent liquid crystal polymer layers may be equal to 60°, and the in-plane optic axis of the respective liquid crystal polymers 641-646 may be rotated by 60° with respect to the in-plane optic axis of an adjacent liquid crystal polymer layer. In some embodiments, the stack of liquid crystal polymer layers in the LCPH element 640 may have a thickness of about 2 micrometers to 15 micrometers, and the total number of the liquid crystal polymer layers in the LCPH element 640 may be within a range from 20 to 500.

The LCPH element disclosed herein may reduce the light leakage, increase the efficiency, and enhance the extinction ratio over a wide AOI range, e.g., for an incident light having an AOI ranging from 0 to 60 degrees and a visible wavelength range (e.g., from 400 nm to 750 nm). The LCPH elements described herein may be implemented in systems or devices for imaging, sensing, communication, biomedical applications, etc. For example, the LCPH elements described herein may be implemented in various systems for augmented reality (“AR”), virtual reality (“VR”), and/or mixed reality (“MR”) applications, e.g., near-eye displays (“NEDs”), head-up displays (“HUDs”), head-mounted displays (“HMDs”), smart phones, laptops, televisions, vehicles, etc. For example, the disclosed LCPH element may be implemented as a passive or active reflective polarizer in a path-folding lens assembly (e.g., a pancake lens assembly), implemented as a light guide image combiner in a light guide display assembly, implemented as an input or output coupler (or in-coupling element or out-coupling element) in a light guide illumination assembly, or implemented as a retinal projection combiner in a retinal projection display assembly, etc. The disclosed LCPH element may also be used to provide multiple image planes, pupil steered AR, VR, and/or MR display systems (e.g., holographic near eye displays, retinal projection eyewear, and wedged waveguide displays), smart glasses for AR, VR, and/or MR applications, compact illumination optics for projectors, light-field displays, etc. In some embodiments, the disclosed LCPH element may be implemented as a passive or active reflective polarizer in an object tracking system. The object tracking system including one or more disclosed LCPH elements may provide an object tracking with enhanced accuracy.

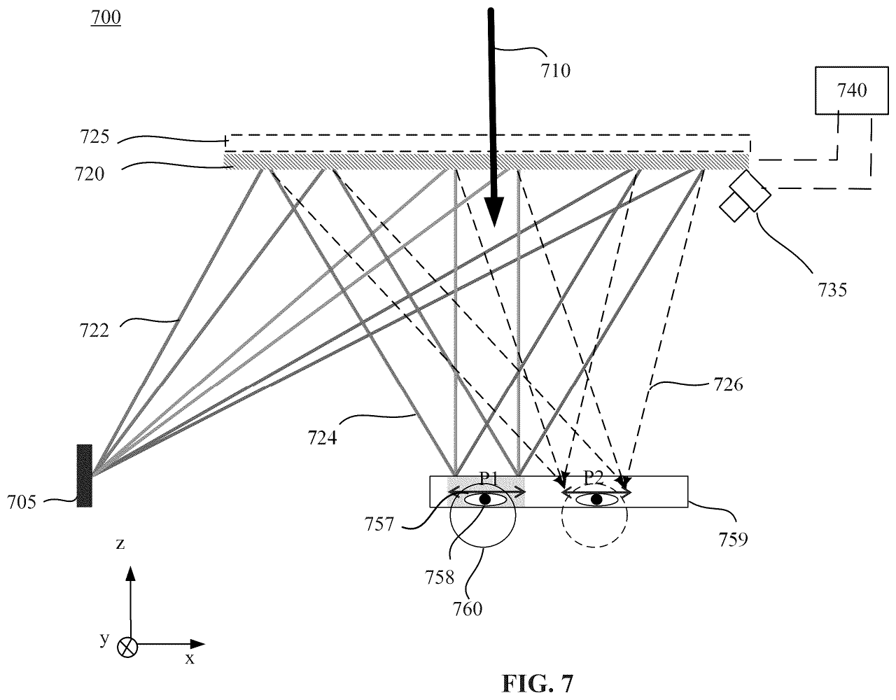

Exemplary applications of the disclosed biaxial LC polarization holograms in AR, VR, and/or MR systems will be explained. The various systems including one or more disclosed biaxial LC polarization holograms may be a part of a system for VR, AR, and/or MR applications (e.g., an NED, an HUD, an HMD, a smart phone, a laptop, or a television, etc.). FIG. 7 schematically illustrates an x-y sectional view of a system 700, according to an embodiment of the present disclosure. As shown in FIG. 7, the system 700 may include a display element 705 configured to generate an image light (or beam) 722 representing a virtual image, and an off-axis combiner 720 configured to direct the image light 722 toward an eyebox 759 of the system 700. The system 700 may further include an eye tracking device 735 and a controller 740. The controller 740 may be communicatively coupled with one or more devices in the system 700, such as the display element 705, the eye tracking device 735, and the off-axis combiner 720. The controller 740 may receive signals from the one or more devices, and may control the operations of the one or more devices.

In some embodiments, the display element 705 may include a projector (e.g., retinal projection display) configured to output the image light 722. In some embodiments, the display element 705 may be an off-axis display element configured to provide an off-axis projection with respective to the off-axis combiner 720. For example, the image light 722 may be an off-axis light with respective to the off-axis combiner 720.

In some embodiments, the off-axis combiner 720 may include one or more LCPH elements disclosed herein, such as the LCPH element 200 shown in FIG. 2A. In some embodiments, the off-axis combiner 720 may function as an off-axis reflective lens configured to focus the off-axis image light 722 to one or more spots at one or more exit pupils 757 within the eyebox 759 of the system 700. An exit pupil 757 may be a portion of the eyebox 759, where an eye pupil 758 of a user may be positioned to receive the image light. The size of a single exit pupil 757 may be larger than and comparable with the size of the eye pupil 758. The exit pupils 757 may be sufficiently spaced apart, such that when one of the exit pupils 757 substantially coincides with the position of the eye pupil 758, the remaining one or more exit pupils 757 may be located beyond the position of the eye pupil 758 (e.g., outside of the eye pupil 758). For example, as shown in FIG. 7, the off-axis combiner 720 may focus the off-axis image light 722 as an image light 724 propagate through one or more exit pupils 757 at the eyebox 759.

When configured for AR or MR applications, the off-axis combiner 720 may also combine the image light 722 received from the display element 705 and a light (or beam) 710 from a real-world environment (referred to as a real-world light 710), and direct both of the lights 710 and 722 toward the eyebox 759. Thus, the off-axis combiner 720 may also be referred to as an off-axis image combiner. In some embodiments, the system 700 may include a compensator 725 coupled with (e.g., stacked with) the off-axis combiner 720. The off-axis combiner 720 may be disposed between the compensator 725 and the eyebox 759. The real-world light 710 may be incident onto the compensator 725 before being incident onto the off-axis combiner 720. In some embodiments, the controller 740 may be configured to control the compensator 725 and the off-axis combiner 720 to provide opposite steering effects and lensing effects to the real-world light 710. For example, when the optical powers provided by the compensator 725 and the off-axis combiner 720 have opposite signs and a substantially same absolute value, the steering provided by the compensator 725 and the off-axis combiner 720 may have opposite directions. Thus, the compensator 725 may compensate for the distortion of the real-world light 710 caused by the off-axis combiner 720, such that images of real-world objects viewed through the system 700 may be substantially unaltered. In some embodiments, when the system 700 is configured for VR applications, the compensator 725 may be omitted.

In some embodiments, the off-axis combiner 720 may be a passive element that is not tunable by an external field. In some embodiments, the off-axis combiner 720 may be an active element that is tunable by an external field. For example, the optical power of the off-axis combiner 720 may be tunable by an applied voltage. In some embodiments, the LC layer included in the off-axis combiner 720 may include a plurality of sub-layers stacked together. The plurality of sub-layers may be configured to have high diffraction efficiencies at a plurality of wavelengths, (e.g., red, green, and blue wavelength ranges), thereby enabling a full color display. For example, the off-axis image light 722 may be a visible polychromatic light, and the respective sub-layers may be configured to focus the respective portions of the off-axis image light 722 associated with different wavelength ranges to the same exit pupil 757.

In some embodiments, the LC layer included in the off-axis combiner 720 may include a plurality of sub-layers stacked together, and different sub-layers may be configured to reflect and focus the off-axis image light 722 to propagate through different exit pupils 757. That is, different sub-layers may be configured to steer the off-axis image light 722 by different steering angles to propagate through different exit pupils 757. In some embodiments, the plurality of sub-layers may function as passive elements, each of which may be configured to simultaneously reflect and focus the off-axis image light 722 to propagate through one of the exit pupils 757 with a relatively low efficiency. The plurality of sub-layers may be configured to simultaneously reflect and focus the off-axis image light 722 to propagate through a plurality of exit pupils 757 forming the eyebox 759. For discussion purposes, each exit pupil 757 may also referred to as a sub-eye box, and the eyebox 759 formed by the plurality of exit pupils 757 may also be referred to as an uncompressed eyebox, which is relatively large.

In some embodiments, the plurality of sub-layers may function as active elements, each of which may be configured to operate in an active state to reflect the off-axis image light 722 to an exit-pupil 757 with a relatively high efficiency, and operate in a non-active state to transmit the off-axis image light 722. In some embodiments, one or more (not all) of the sub-layers may be configured to operate in the active state to focus the off-axis image light 722 to propagate through one or more exit pupils 757 (or one or more sub-eye boxes), forming a compressed eyebox having a size smaller than a size of the uncompressed eyebox. The remaining sub-layers may operate in the non-active state to transmit the off-axis image light 722. In some embodiments, the controller 740 may be communicatively coupled with one or more power sources (not shown) to adjust the voltages applied to the respective sub-layers included in the off-axis combiner 720.

In some embodiments, the eye tracking device 735 may include one or more light sources (e.g., infrared light sources) and one or more optical sensors. The one or more light sources may be configured to emit IR lights to illuminate one or both eyes of the user, and the optical sensors may be configured to receive the IR light reflected from the eyes. In some embodiments, the optical sensors may be configured to generate image data of one or both eyes of the user based on the received IR lights. For example, the optical sensors may be imaging devices, such as cameras. In some embodiments, a processor included in the eye tracking device 735 may be configured to obtain, in real time, the eye-tracking information relating to the eye pupil 758 by analyzing the captured images of the eye pupil 758.

The eye-tracking information may include at least one of a position (or location), a moving direction, a size, or a viewing direction of the eye pupil 758. The position, moving direction, size, or viewing direction of the eye pupil 758 may be dynamically changing. Thus, the eye tracking device 735 may dynamically capture the images of the eye pupil 758 and dynamically obtain and/or provide the eye-tracking information in real time. In some embodiments, the eye tracking device 735 may measure or determine (e.g., through the processor) the position and/or movement of the eye pupil 758 up to six degrees of freedom (i.e., 3D position, roll, pitch, and yaw).

In some embodiments, the eye tracking device 735 may transmit, through a transmitter included in the eye tracking device 735, the eye-tracking information to the controller 740. In some embodiments, the eye tracking device 735 may transmit the images (i.e., image data) of the eye pupil 758 to the controller 740, and the controller 740 may analyze the images to obtain the eye-tracking information in real time. In some embodiments, the controller 740 may determine, based on one or more types of the eye-tracking information (e.g., based on the position of the eye pupil 758), the operation state of the off-axis combiner 720, such as, the operation states of the active sub-layers included in the off-axis combiner 720.

According to the eye-tracking information, the off-axis combiner 720 may provide different steering angles to the off-axis image light 722 to focus the off-axis image light 722 to propagate through different exit pupils 757. In other words, the off-axis combiner 720 may function as a pupil steering element that provide a pupil steering function. For example, during an operation, based on the eye-tracking information, the controller 740 may control one or more of the sub-layers included in the off-axis combiner 720 to operate in the active state, and the remaining sub-layers to operate in the non-active state. For illustrative purposes, FIG. 7 shows two operation states of the off-axis combiner 720. For example, at a first time instance, the eye tracking device 735 may detect that the eye pupil 758 of the user is located at a position P1 at the eyebox 759. Based on the eye-tracking information, the controller 740 may control a first sub-layer in the off-axis combiner 720 to operate in the active state while the remaining sub-layers to operate in the non-active state. The first sub-layer may reflect and focus the off-axis image light 722 as an image light 724, which propagates through to an exit pupil 757 (e.g., a first sub-eye box) that substantially coincides with the position P1 of the eye pupil 758.

At a second time instance, the eye tracking device 735 may detect that the eye pupil 758 of the user has moved to a new position P2 at the eyebox 759 in the x-axis direction from the previous position P1. Based on new eye-tracking information relating to the new position P2, the controller 740 may control a second, different sub-layer in the off-axis combiner 720 to operate in the active state while the remaining sub-layers to operate in the non-active state. The second sub-layer may reflect and focus the off-axis image light 722 as an image light 726 (represented by dashed lines), which propagates through an exit pupil 757 (e.g., a second sub-eye box) that substantially coincides with the position P2 of the eye pupil 758.

For discussion purposes, FIG. 7 shows that the off-axis combiner 720 provides a 1D pupil steering, e.g., steering the exit pupil 757 in the x-axis direction shown in FIG. 7. In some embodiments, although not shown, the off-axis combiner 720 may provide a 2D pupil steering, e.g., steering the exit pupil 757 in two different directions (e.g., the x-axis direction and the y-axis direction shown in FIG. 7). In some embodiments, although not shown, the off-axis combiner 720 may provide a 3D pupil steering, e.g., steering the exit pupil 757 in three different directions (e.g., the x-axis direction, the y-axis direction, and the z-axis direction shown in FIG. 7). For example, the off-axis combiner 720 may include three LC layers configured to steer the exit pupil 757 in the x-axis direction, the y-axis direction, and the z-axis direction, respectively.

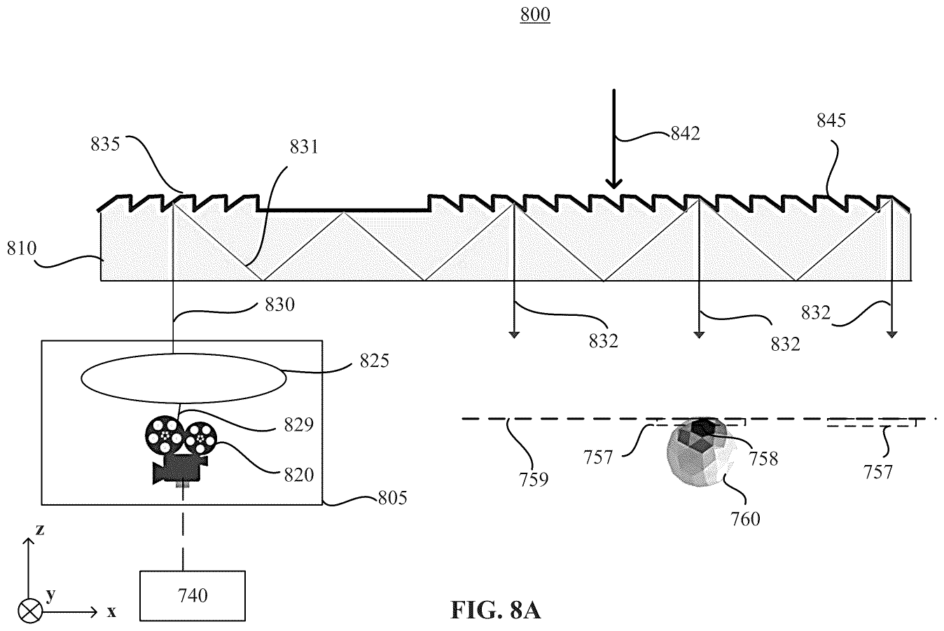

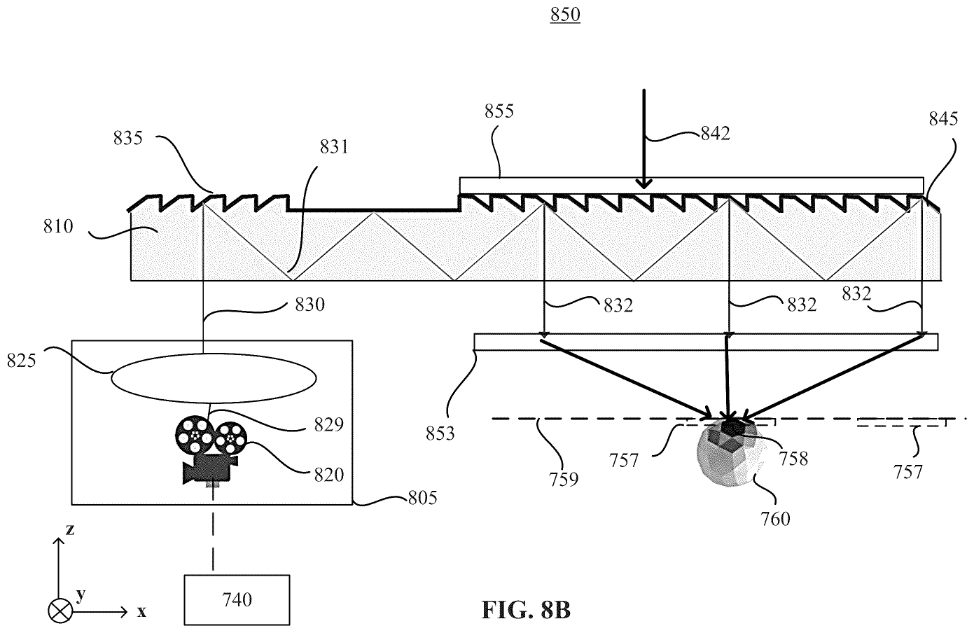

FIG. 8A schematically illustrates a diagram of a system 800, according to an embodiment of the present disclosure. The system 800 may also be referred to as a light guide display system or assembly. As shown in FIG. 8A, the system 800 may include a light source assembly 805 that includes a display element (e.g., a display panel) 820 and a collimating lens 825, a light guide 810 coupled with an in-coupling element (or input coupler) 835 and an out-coupling element (or output coupler) 845, and the controller 740. The light guide 810 coupled with the in-coupling element 835 and the out-coupling element 845 may also be referred to as a light guide image combiner.

The display panel 820 may output an image light 829 representing a virtual image (having a predetermined image size associated with a linear size of the display panel 820) toward the collimating lens 825. The image light 829 may be a divergent image light including a bundle of rays. For illustrative purposes, FIG. 8A shows a single ray of the image light 829. The collimating lens 825 may transmit the image light 829 as an image light 830 having a predetermined input FOV (e.g., a) toward an input side of the light guide 810. The collimating lens 825 may transform or convert a linear distribution of the pixels in the virtual image formed by the image light 829 into an angular distribution of the pixels in the image light 830 having the predetermined input FOV. Each ray in the in the image light 830 may represent an FOV direction of the input FOV. For illustrative purposes, FIG. 8A shows a single ray (e.g., central ray) of the image light 830 that is normally incident onto the in-coupling element 835, and the single ray of the image light 830 may represent a single FOV direction (e.g., 0° FOV direction) of the input FOV.

The in-coupling element 835 may couple the image light 830 into the light guide 810 as an in-coupled image light 831, which may propagate inside the light guide 810 toward the out-coupling element 845 via total internal reflection (“TIR”). The out-coupling element 845 may couple the in-coupled image light 831 out of the light guide 810 as a plurality of output image lights 832 at different locations along the longitudinal direction (e.g., x-axis direction) of the light guide 810, each of which may have an output FOV that may be substantially the same as the input FOV (e.g., as represented by an angle α). For discussion purposes, FIG. 8A shows three output image lights 832, and shows a single ray (e.g., central ray) of each output image light 832. At least one of the in-coupling element 835 or the out-coupling element 845 may include an LCPH element disclosed herein, such as the LCPH element 200 shown in FIG. 2A. In some embodiments, the LCPH element may be configured to function as a grating that couples the image light into the light guide 810 or out of the light guide 810 via diffraction.

Each output image light 832 may include the same image content as the virtual image displayed on the display panel 820. Thus, the light guide 810 coupled with the in-coupling element 835 and the out-coupling element 845 may replicate the image light 830 at the output side of the light guide 810, to expand an effective pupil of the system 800. For discussion purposes, FIG. 8A shows a one-dimensional pupil expansion along the x-axis direction in FIG. 8A. In some embodiments, the system 800 may also provide a two-dimensional pupil expansion, e.g., along both the x-axis direction and the y-axis direction in FIG. 8A. For example, in some embodiments, although not shown, the system 800 may also include a redirecting element (or folding element) coupled to the light guide 810, and configured to redirect the in-coupled image light 831 to the out-coupling element 845. The redirecting element may be configured to expand the input image light 830 in a first direction, e.g., the y-axis direction, and the out-coupling element 845 may be configured to expand the input image light 830) in a second, different direction, e.g., the x-axis direction. In some embodiments, the redirecting element may include an LCPH element functioning as a grating that redirects the in-coupled image light 831 to the out-coupling element 845.

The plurality of image lights 832 may propagate through the exit pupils 757 located in the eyebox 759 of the system 800. The size of a single exit pupil 757 may be larger than and comparable with the size of the eye pupil 758. The exit pupils 757 may be sufficiently spaced apart, such that when one of the exit pupils 757 substantially coincides with the position of the eye pupil 758, the remaining one or more exit pupils 757 may be located beyond the position of the eye pupil 758 (e.g., falling outside of the eye pupil 758). The light guide 810 and the out-coupling element 845 may also transmit a light 842 from a real-world environment (referred to as a real-world light 842), combining the real-world light 842 with the output image light 832 and delivering the combined light to the eye 760. Thus, the eye 760 may observe the virtual scene optically combined with the real world scene.

In the embodiment shown in FIG. 8A, the light guide image combiner may generate an image of the display element 820 at an image plane that has an infinite depth (or image plane distance) with respect to the eye pupil 758 positioned at the eyebox 759. In some embodiments, the light guide image combiner may generate an image of the display element 820 at an image plane that has a finite depth (or image distance) with respect to the eye pupil 758 positioned at the eyebox 759. FIG. 8B schematically illustrates a diagram of a system 850, according to an embodiment of the present disclosure. The system 850 may also be referred to as a light guide display system or assembly. The system 850 may include elements that are similar to or the same as those included in the system 800 shown in FIG. 8A. Descriptions of the same or similar elements or features can refer to the above corresponding descriptions, including those rendered in connection with FIG. 8A.

As shown in FIG. 8B, the system 850 may include the light source assembly 805, and the light guide 810 coupled with the in-coupling element 835 and the output-coupling element 845 (also referred to as the light guide image combiner). The system 800 may also include a lens or lens assembly 853 disposed between the light guide image combiner and the eyebox 759. In some embodiments, the lens assembly 853 may be configured to provide at least one of an adjustable optical power or an adjustable steering angle to the output image lights 832.

In some embodiments, based on the eye tracking information from the eye tracking system (not shown), the controller 740 may be configured to control the lens assembly 853 to steer and focus the plurality of output image lights 832 to an image plane within the eyebox 759, where one or more exit pupils 757 are located. In some embodiments, the lens assembly 853 may be configured to provide a 3D beam steering to the output image lights 832. For example, the lens assembly 853 may be configured to laterally steer (or shift) the focus of the output image lights 832 in one or two dimensions (e.g., an x-axis direction and/or a y-axis direction). In some embodiments, the lens assembly 853 may also be configured to vertically shift the image plane, at which the output image lights 832 are focused, in a third dimension (e.g., in a z-axis direction). Thus, a continuous or discrete shift of the exit pupil 757 of the system 850 may be provided in a 3D space to cover an expanded eyebox based on the eye tracking information.

In some embodiments, the vertical distance of the image plane of the display element 820 with respect to the eyebox 759 may be adjusted for addressing the vergence accommodation conflict. Accordingly, the user experience of the system 850 may be improved. For example, the display element 820 may display a virtual image. Based on the eye tracking information provided by the eye tracking system (not shown), the controller 740 may determine a virtual object within the virtual image at which the eyes 760 are currently looking. The controller 740 may determine a vergence depth (dᵥ) of the gaze of the user based on the gaze point or an estimated intersection of gaze lines determined by the eye tracking system. The gaze lines may converge or intersect at the distance dᵥ, where the virtual object is located. The controller 740 may control the lens assembly 853 to adjust the optical power to provide an accommodation that matches the vergence depth (dᵥ) associated with the virtual object at which the eyes 760 are currently looking, thereby reducing the accommodation-vergence conflict in the system 850. For example, the controller 740 may control the lens assembly 853 to operate in a desirable operation state to provide an optical power corresponding to a focal plane (or an image plane) that matches the vergence depth (dᵥ).

In some embodiments, when used for AR and/or MR applications, in addition to the lens assembly 853 (referred to as a first lens assembly 853), the system 850 may further include a second lens assembly 855. The first lens assembly 853 and the second lens assembly 855 may be disposed at two sides of the light guide 810. The controller 740 may be communicatively coupled with the second lens assembly 855. In some embodiments, when used for AR and/or MR applications, the controller 740 may be configured to control the first lens assembly 853 and the second lens assembly 855 to provide opposite steering effects and lensing effects to the real-world light 842. For example, the optical powers provided by the first lens assembly 853 and the second lens assembly 855 may have opposite signs and a substantially same absolute value, the steering provided by the first lens assembly 853 and the second lens assembly 855 may have opposite directions. Thus, the second lens assembly 855 may be configured to compensate for the distortion of the real-world light 842 caused by the first lens assembly 853, such that images of the real-world objects viewed through the system 850 may be substantially unaltered.

In some embodiments, each of the first lens assembly 853 and the second lens assembly 855 may be an active element. For example, the steering effect and lensing effect of the first lens assembly 853 or the second lens assembly 855 may be adjustable by an external field. When the LC layer included in the first lens assembly 853 or the second lens assembly 855 includes a plurality of sub-layers, the steering effect and lensing effect of each sub-layer may be adjustable by an external field.

In some embodiments, each of the first lens assembly 853 and the second lens assembly 855 may be a passive element. Each of the first lens assembly 853 and the second lens assembly 855 may be coupled with a switchable halfwave plate. The switchable halfwave plate may control the polarization of a light that is to be incident onto the first lens assembly 853 or the second lens assembly 855. The steering effect and lensing effect of the first lens assembly 853 or the second lens assembly 855 may be adjustable by controlling the switchable halfwave plate. When the LC layer included in the first lens assembly 853 or the second lens assembly 855 includes a plurality of sub-layers, each sub-layer may be coupled with a switchable halfwave plate, and the steering effect and lensing effect of each sub-layer may be adjustable controlling the switchable halfwave plate.

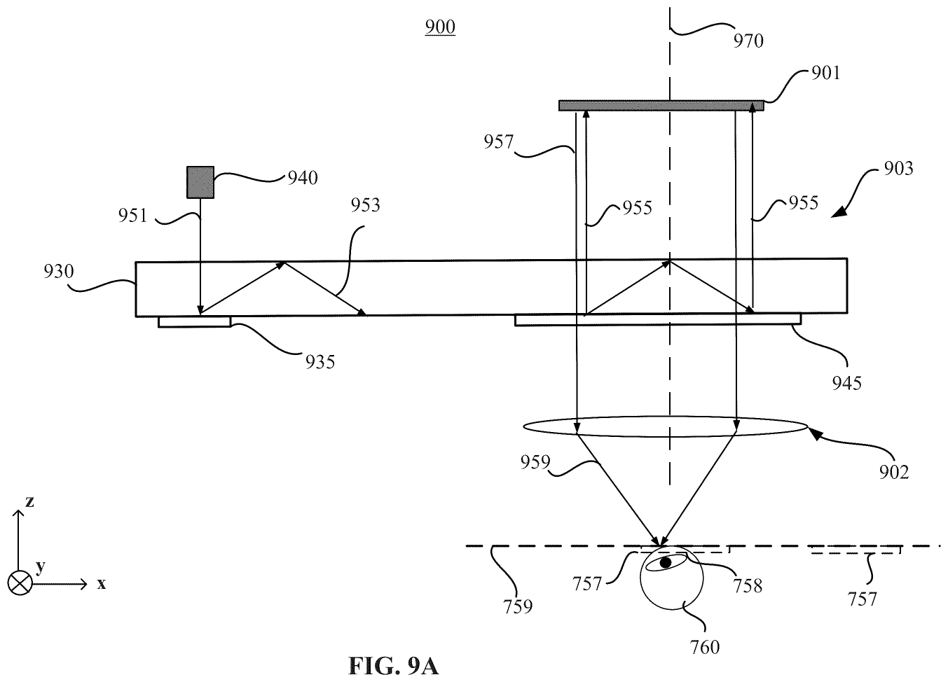

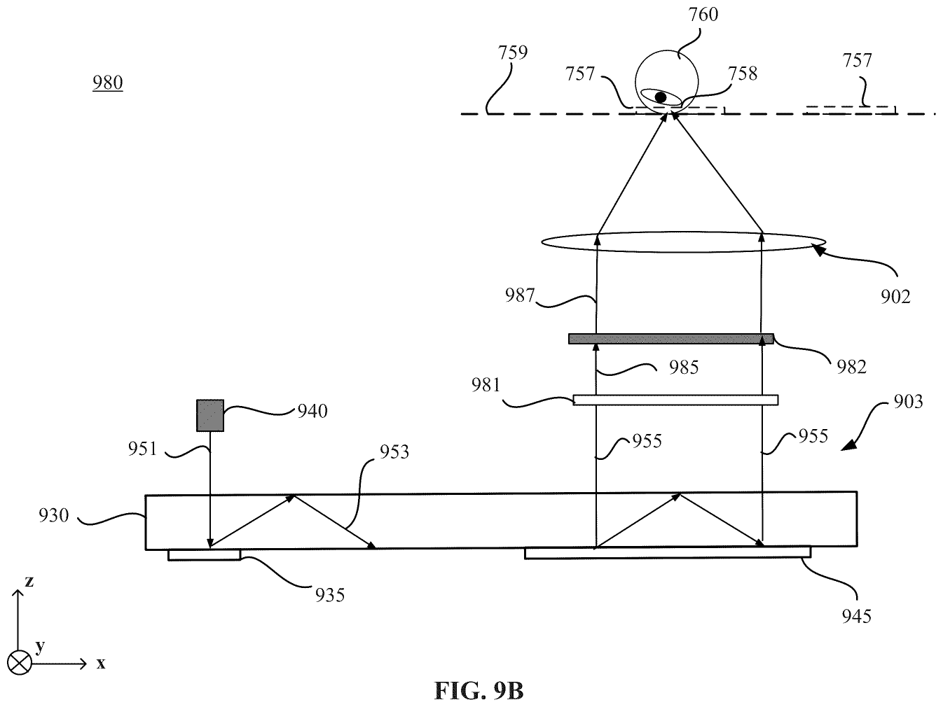

FIG. 9A schematically illustrates a diagram of a system 900, according to an embodiment of the present disclosure. As shown in FIG. 9A, the system 900 may include a light guide illumination assembly 903, a display panel 901, and a lens assembly 902. The light guide illumination assembly 903 may include a light source assembly 940, and a light guide 930 coupled with an in-coupling element 935 and an out-coupling element 945. The display panel 901 and the lens assembly 902 may be disposed at opposite sides of the light guide 930. The display panel 901 and the lens assembly 902 may be arranged in parallel, and may be aligned on a same axis 970. The axis 970 may be an optical axis of the lens assembly 902, or an axis of symmetry of the display panel 901. The light guide 930 may be arranged in parallel with the display panel 901 and the lens assembly 902, with the surface normal of the light guide 930 being parallel with the axis 70. The light source assembly 940 may output a light 951 toward the light guide 930. The light source assembly 940 may include a light emitting diode (“LED”), a superluminescent diode (“SLED” or “SLD”), a laser diode, or a combination thereof, etc.

The light 951 may be guided by the light guide 930 to the display panel 901 for illuminating the display panel 901. The in-coupling element 935 may couple the light 951 into the light guide 930 as an in-coupled light 953 that prorogates along the light guide 930 toward the out-coupling element 945 via total internal reflection (“TIR”). The out-coupling element 945 may couple the in-coupled light 953 out of the light guide 930 as a light 955 propagating toward the display panel 901 to illuminate the display panel 901. Thus, the light 955 may also be referred to as an illuminating light 955. In some embodiments, the in-coupling element 935 may include a direct edge illumination, an input grating, a prism, a mirror, and/or photonic integrated circuits. In some embodiments, at least one of the in-coupling element 935 or the out-coupling element 945 may include an LCPH element disclosed herein, such as the LCPH element 200 shown in FIG. 2A. In some embodiments, the LCPH element may be configured to function as a grating that couples the illumination light into the light guide 910 or out of the light guide 910 via diffraction.

The light 955 may be normally incident onto the display panel 901. The display panel 901 may modulate and convert the light 955 into an image light 957 that represents a virtual image generated by the display panel 901. The lens assembly 902 may focus the image light 957 to an exit pupil 757 in the eyebox 759. Thus, the eye 760 located at the exit pupil 757 may perceive the image light 959 that represents the virtual image displayed on the display panel 901. In some embodiments, the lens assembly 902 may be configured to provide at least one of an adjustable optical power or an adjustable steering angle to the image light 959.

The display panel 901 may be a reflective display panel or a transmissive display panel. For illustrative purposes, FIG. 9A shows the display panel 901 as a reflective display panel (e.g., a reflective LCD panel) that modulates and reflects the light 955 into the image light 957. In a system 980 shown in FIG. 9B, a display panel 982 may be a transmissive display panel (e.g., a transmissive LCD panel) that modulates and transmits the light 955 as an image light 987 that represents a virtual image generated by the display panel 982. The display panel 982 may be disposed between the lens assembly 902 and the light guide 930, and the lens assembly 902 may focus the image light 987 to the exit pupil 757 in the eyebox 759.

In some embodiments, as shown in FIG. 9B, the system 980 may also include a polarizer or quarter-wave plate 981 disposed between the display panel 982 and the light guide 930. The polarizer or quarter-wave plate 981 may be configured to convert the illuminating light 955 into an illuminating light 985 having a predetermined polarization state, e.g., a linear polarization.

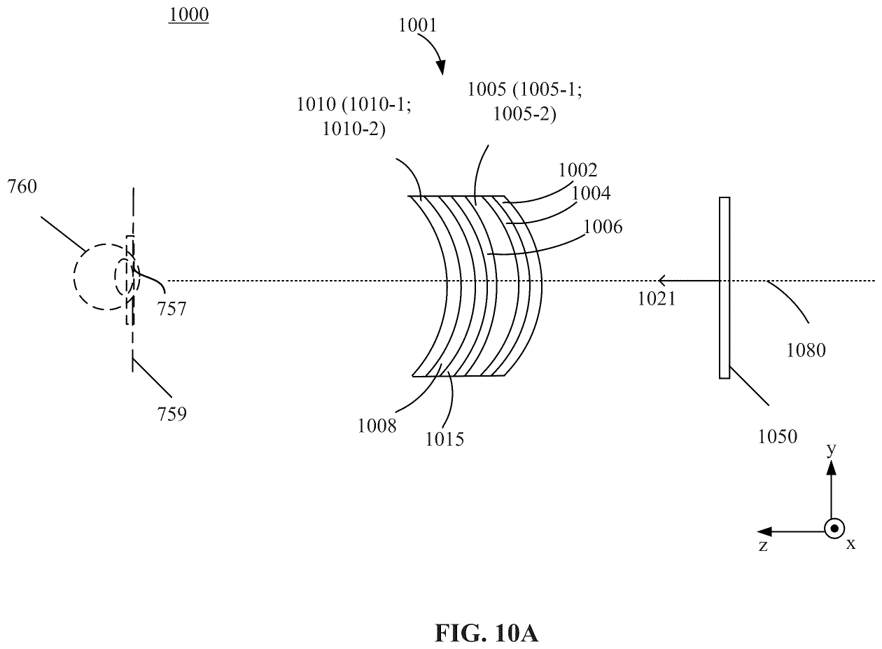

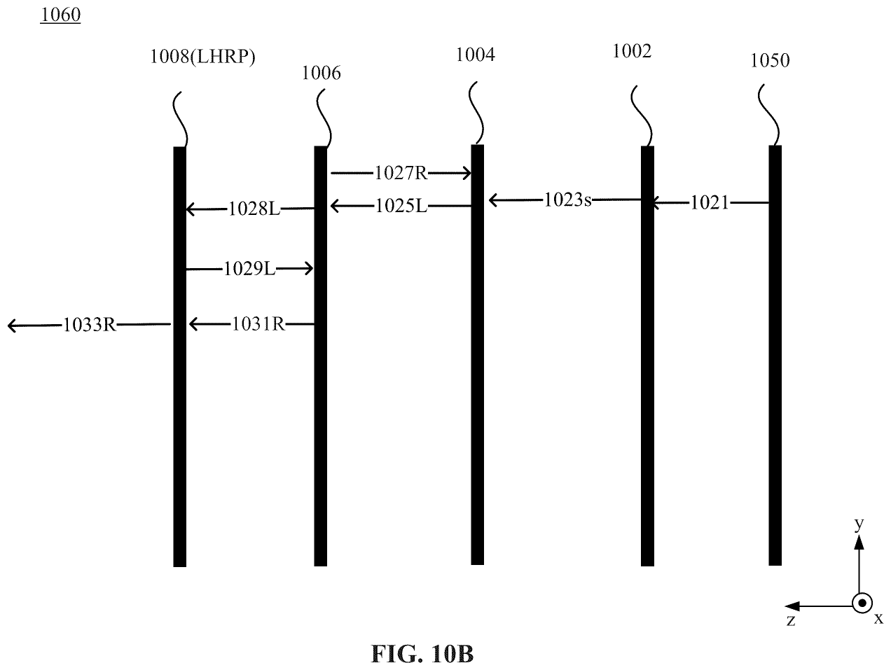

FIG. 10A schematically illustrates a system 1000, according to an embodiment of the present disclosure. The system 1000 may include a light source assembly (e.g., a display element) 1050 configured to output an image light 1021 (e.g., a divergent image light) representing a virtual image. The system 1000 may also include a path-folding lens assembly (e.g., pancake lens assembly) 1001 configured to fold the optical path of the image light 1021, and transform the rays (forming the divergent image light 1021) emitted from each light outputting unit of the display element 1050 into a bundle of parallel rays that substantially cover one or more exit pupils 757 in the eyebox 759 of the system 1000. Due to the path folding, the lens assembly 1001 may increase a field of view (“FOV”) of the system 1000 without increasing the physical distance between the display element 1050 and the eyebox region 759, and without compromising the image quality. The path-folding lens assembly 1001 may include one or more LCPH elements disclosed herein, such as the LCPH element 200 shown in FIG. 2A.

In some embodiments, the display element 1050 may be a monochromatic display that includes a narrowband monochromatic light source (e.g., a 30-nm-bandwidth light source). In some embodiments, the display element 1050 may be a polychromatic display (e.g., a red-green-blue (“RGB”) display) that includes a broadband polychromatic light source (e.g., 300-nm-bandwidth light source covering the visible wavelength range). In some embodiments, the display element 1050 may be a polychromatic display (e.g., an RGB display) including a stack of a plurality of monochromatic displays, which may include corresponding narrowband monochromatic light sources respectively.

In some embodiments, the path-folding lens assembly 1001 may include a first optical element (e.g., a first optical lens) 1005 and a second optical element (e.g., a second optical lens) 1010. In some embodiments, the path-folding lens assembly 1001 may be configured as a monolithic pancake lens assembly without any air gaps between optical elements included in the path-folding lens assembly. In some embodiments, one or more surfaces of the first optical element 1005 and the second optical element 1010 may be shaped (e.g., curved) to compensate for field curvature. In some embodiments, one or more surfaces of the first optical element 1005 and/or the second optical element 1010 may be shaped to be spherically concave (e.g., a portion of a sphere), spherically convex, a rotationally symmetric asphere, a freeform shape, or some other shape that can mitigate field curvature. In some embodiments, the shape of one or more surfaces of the first optical element 1005 and/or the second optical element 1010 may be designed to additionally compensate for other forms of optical aberration. The disclosed LCPH element may be formed on one or more curved surfaces of at least one of the first optical element 1005 or the second optical element 1010. In some embodiments, one or more of the optical elements within the path-folding lens assembly 1001 may have one or more coatings, such as an anti-reflective coating, to reduce ghost images and enhance contrast. In some embodiments, the first optical element 1005 and the second optical element 1010 may be coupled together by an adhesive 1015. Each of the first optical element 1005 and the second optical element 1010 may include one or more optical lenses. In some embodiments, at least one of the first optical element 1005 or the second optical element 1010 may have at least one flat surface.

The first optical element 1005 may include a first surface 1005-1 facing the display element 1050 and an opposing second surface 1005-2 facing the eye 760. The first optical element 1005 may be configured to receive an image light at the first surface 1005-1 from the display element 1050 and output an image light with an altered property at the second surface 1005-2. The path-folding lens assembly 1001 may also include a linear polarizer 1002, a waveplate 1004, and a mirror 1006 arranged in an optical series, each of which may be an individual layer, film, or coating disposed at (e.g., bonded to or formed at) the first optical element 1005. The linear polarizer 1002, the waveplate 1004, and the mirror 1006 may be disposed at (e.g., bonded to or formed at) the first surface 1005-1 or the second surface 1005-2 of the first optical element 1005. For illustrative purposes, FIG. 10A shows that the linear polarizer 1002 and the waveplate 1004 are disposed at (e.g., bonded to or formed at) the first surface 1005-1 facing the display element 1050, and the mirror 1006 is disposed at (e.g., bonded to or formed at) the second surface 1005-2 facing the second optical element 1010. Other arrangements are also contemplated.

In some embodiments, the waveplate 1004 may be a quarter-wave plate (“QWP”). A polarization axis of the waveplate 1004 may be oriented relative to the polarization direction of a linearly polarized light to convert the linearly polarized light into a circularly polarized light or vice versa for a visible spectrum and/or an IR spectrum. In some embodiments, for an achromatic design, the waveplate 1004 may include a multilayer birefringent material (e.g., a polymer, liquid crystals, or a combination thereof) to produce quarter-wave birefringence across a wide spectral range. For example, an angle between the polarization axis (e.g., the fast axis) of the waveplate 1004 and the transmission axis of the linear polarizer 1002 may be configured to be in a range of about 35-50 degrees. In some embodiments, for a monochrome design, an angle between the polarization axis (e.g., the fast axis) of the waveplate 1004 and the transmission axis of the linear polarizer 1002 may be configured to be about 45 degrees. In some embodiments, the mirror 1006 may be a polarization non-selective partial reflector that is partially reflective to reflect a portion of a received light. In some embodiments, the mirror 1006 may be configured to transmit about 50% and reflect about 50% of a received light, and may be referred to as a “50/50 mirror.” In some embodiments, the handedness of the reflected light may be reversed, and the handedness of the transmitted light may remain unchanged.

The second optical element 1010 may have a first surface 1010-1 facing the first optical element 1005 and an opposing second surface 1010-2 facing the eye 760. The path-folding lens assembly 1001 may also include a reflective polarizer 1008, which may be an individual layer, film, or coating disposed at (e.g., bonded to or formed at) the second optical element 1010. The reflective polarizer 1008 may be configured to primarily reflect a circularly polarized light having a first handedness and primarily transmit a circularly polarized light having a second handedness that is orthogonal to the first handedness.

In the embodiment shown in FIG. 10A, the reflective polarizer 1008 may include an LCPH element disclosed herein. Thus, the light leakage of the reflective polarizer 1008 for an input light having a large incident angle (e.g., greater than or equal to 60°) may be reduced. Accordingly, the ghost image caused by the light leakage may be suppressed. In some embodiments, the reflective polarizer 1008 including an LCPH element disclosed herein may function as a passive reflective polarizer with zero optical power. In some embodiments, the reflective polarizer 1008 including an LCPH element disclosed herein may function as an active reflective polarizer with an adjustable optical power, for addressing the vergence accommodation conflict in the system 1001.

The reflective polarizer 1008 may be disposed at (e.g., bonded to or formed at) the first surface 1010-1 or the second surface 1010-2 of the second optical element 1010 and may receive a light output from the mirror 1006. For illustrative purposes, FIG. 10A shows that the reflective polarizer 1008 is disposed at (e.g., bonded to or formed at) the first surface 1010-1 of the second optical element 1010. That is, the reflective polarizer 1008 may be disposed between the first optical element 1005 and the second optical element 1010. For example, the reflective polarizer 1008 may be disposed between the second surface 1010-2 of the second optical element 1010 and the adhesive layer 1015. In some embodiments, the reflective polarizer 1008 may be disposed at the second surface 1010-2 of the second optical element 1010.

Referring to FIG. 10A, in some embodiments, the image light 1021 emitted from the display element 1050 may be an unpolarized light. The linear polarizer 1002 and the waveplate 1004 may be replaced by a circular polarizer, which may be configured to the convert the unpolarized light into a circularly polarized light, and direct the circularly polarized light toward the mirror 1006. In some embodiments, the image light 1021 emitted from the display element 1050 may be a linearly polarized light, and the linear polarizer 1002 may be omitted. A polarization axis of the waveplate 1004 may be oriented relative to the polarization direction of the linearly polarized light to convert the linearly polarized light into a circularly polarized light or vice versa for a visible spectrum and/or an IR spectrum. In some embodiments, the image light 1021 emitted from the display element 1050 may be a circularly polarized light, and the linear polarizer 1002 and the waveplate 1004 may be omitted.

In some embodiments, one or more of the first surface 1005-1 and the second surface 1005-2 of the first optical element 1005 and the first surface 1010-1 and the second surface 1010-2 of the second optical element 1010 may be curved surface(s) or flat surface(s). In some embodiments, the path-folding lens assembly 1001 may have one of the optical elements 1005 and 1010, or may include more than two optical elements that may be similar to the optical elements 1005 or 1010. In some embodiments, the path-folding lens assembly 1001 may further include other optical elements in addition to the first and second optical elements 1005 and 1010, such as one or more linear polarizers, one or more waveplate, one or more circular polarizers, etc.

FIG. 10B illustrates a schematic cross-sectional view of an optical path 1060 of a light propagating in the path-folding lens assembly 1001 shown in FIG. 10A, according to an embodiment of the present disclosure. In the light propagation path 1060, the change of polarization of the light is shown. Thus, the first optical element 1005 and the second optical element 1010, which are presumed to be lenses that do not affect the polarization of the light, are omitted for the simplicity of illustration. In FIG. 10B, the letter “R” appended to a reference number (e.g., “1027R”) denotes a right-handed circularly polarized light, and the letter “L” appended to a reference number (e.g., “1025L”) denotes a left-handed circularly polarized light, the letter “s” appended to a reference number (e.g., “1023s”) denotes an s-polarized light.

For discussion purposes, as shown in FIG. 10B, the linear polarizer 1002 may be configured to transmit an s-polarized light and block a p-polarized light, and the reflective polarizer 1008 may be a left-handed reflective polarizer configured to reflect a left-handed circularly polarized light and transmit a right-handed circularly polarized light. For illustrative purposes, the display element 1050, the linear polarizer 1002, the waveplate 1004, the mirror 1006, and the reflective polarizer 1008 are illustrated as flat surfaces in FIG. 10B. In some embodiments, one or more of the display element 1050, the linear polarizer 1002, the waveplate 1004, the mirror 1006, and the reflective polarizer 1008 may include a curved surface.

As shown in FIG. 10B, the display element 1050 may generate the unpolarized image light 1021 covering a predetermined spectrum, such as a portion of the visible spectral range or substantially the entire visible spectral range. The unpolarized image light 1021 may be transmitted by the linear polarizer 1002 as an s-polarized image light 1023s, which may be transmitted by the waveplate 1004 as a left-handed circularly polarized image light 1025. A first portion of the left-handed circularly polarized image light 1025 may be reflected by the mirror 1006 as a right-handed circularly polarized image light 1027 toward the waveplate 1004, and a second portion of the left-handed circularly polarized image light 1025 may be transmitted as a left-handed circularly polarized image light 1028 toward the reflective polarizer 1008. The left-handed circularly polarized image light 1028 may be reflected by the reflective polarizer 1008 as a left-handed circularly polarized image light 1029 toward the mirror 1006. The left-handed circularly polarized image light 1029 may be reflected by the mirror 1006 as a right-handed circularly polarized image light 1031, which may be transmitted through the reflective polarizer 1008 as a right-handed circularly polarized image light 1033 toward the eyebox 759.

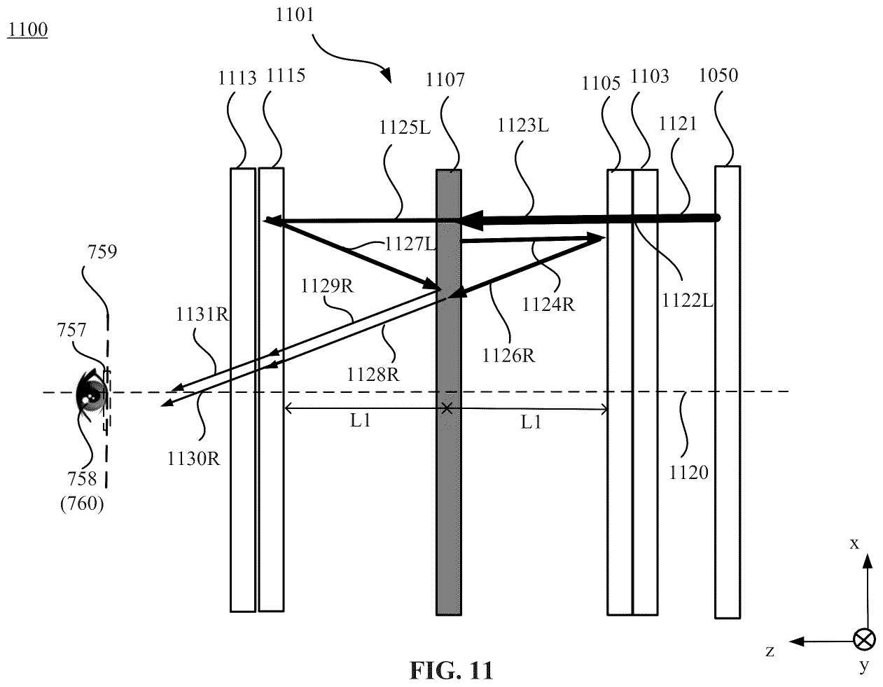

FIG. 11 schematically illustrates an x-z sectional view of a system 1100, according to an embodiment of the present disclosure. The system 1100 may include the display element 1050 (which is an example of a light source) configured to output an image light 1121 representing a virtual image, and a path-folding lens assembly 1101 (also referred to as a lens assembly 1101) configured to fold the path of the image light 1121 from the display element 1050 to the eyebox 759. The lens assembly 1101 may be disposed between the display element 1050 and the eyebox 759. The lens assembly 1101 may transform the rays (forming a divergent image light) emitted from each light outputting unit of the display element 1050 into a bundle of parallel rays that substantially cover one or more exit pupils 757 in the eyebox 759 of the system 1100. For illustrative purposes, FIG. 11 shows a single ray of the image light 1121 emitted from a light outputting unit (e.g., a pixel) at the upper half of the display element 1050. The exit pupil 757 may correspond to a spatial zone where the eye pupil 758 of the eye 760 may be positioned in the eyebox 759 of the system 1100 to perceive the virtual image.

The lens assembly 1101 may include a first circular polarizer 1103, a first polarization selective reflector 1105 (e.g., a first reflective PVH element configured with a first optical power (i.e., functioning as a first PVH lens)), a polarization non-selective partial reflector 1107 (also referred to as a partial reflector 1107), a second polarization selective reflector 1115 (e.g., a second reflective PVH element configured with a second optical power (i.e., functioning as a second PVH lens)), and a second circular polarizer 1113 arranged in an optical series. For discussion purposes, the first polarization selective reflector 1105 and the second polarization selective reflector 1115 are referred to as a first PVH element 1105 and a second PVH element 1115, respectively.

In the embodiment shown in FIG. 11, at least one of the first PVH element 1105 or the second PVH element 1115 may include a disclosed LCPH element, e.g., a passive or an active LCPH element. In some embodiments, the LC layer included in at least one of the first PVH element 1105 or the second PVH element 1115 may include a plurality of sub-layers.

The partial reflector 1107 may be configured to partially transmit an input light while maintaining the polarization and propagation direction, and partially reflect the input light while changing the polarization, independent of the polarization of the input light. That is, regardless of the polarization of the input light, the partial reflector 1107 may partially transmit the input light and partially reflect the input light. For discussion purposes, the partial reflector 1107 is also referred to as a mirror. In some embodiments, the mirror 1107 may be configured to transmit about 50% of an input light and reflect about 50% of the input light (referred to as a 50/50 mirror).

FIG. 11 illustrates an optical path or a propagation path of the image light 1121 propagating from the display element 1050 to the eyebox 759 through the lens assembly 1101. In below figures, the letter “R” appended to a reference number (e.g., “1124R”) denotes a right-handed circularly polarized light, and the letter “L” appended to a reference number (e.g., “1123L”) denotes a left-handed circularly polarized light, the letter “s” appended to a reference number denotes an s-polarized light, and the letter “p” appended to a reference number denotes a p-polarized light.

In the embodiment shown in FIG. 11, the first PVH element 1105 and the second PVH element 1115 may have the same optical power and different polarization selectivities (e.g., may reflect lights of orthogonal polarizations). For example, the first PVH element 1105 may function as a right-handed PVH lens that reflects and converges, via diffraction, a right-handed circularly polarized light, and transmits a left-handed circularly polarized light with negligible or zero diffraction. The second PVH element 1115 may function as a left-handed PVH lens that reflects and converges, via diffraction, a left-handed circularly polarized light, and transmits a right-handed circularly polarized light with negligible or zero diffraction. A distance (e.g., L1) between the first PVH element 1105 and the mirror 1107 may be equal to a distance (e.g., L1) between the second PVH element 1115 and the mirror 1107. In some embodiments, the first PVH element 1105 and the second PVH element 1115 may have different optical powers, and the distance between the first PVH element 1105 and the mirror 1107 may be different from the distance the second PVH element 1115 and the mirror 1107.

As shown in FIG. 11, the first circular polarizer 1103 may convert the image light 1121 into an image light 1122L. The first PVH element 1105 may substantially transmit the image light 1122L as an image light 1123L toward the mirror 1107. The mirror 1107 may transmit a first portion of the image light 1123L as an image light 1125L toward the second PVH element 1115, and reflect a second portion of the image light 1123L back to the first PVH element 1105 as an image light 1124R. The second PVH element 1115 may substantially reflect and converge, via diffraction, the image light 1125L as an image light 1127L toward the mirror 1107. The mirror 1107 may transmit a first portion of the image light 1127L toward the first PVH element 1105 as a left-handed circularly polarized image light (not shown), and reflect a second portion of the image light 1127L back to the second PVH element 1115 as an image light 1129R. The second PVH element 1115 may substantially transmit the image light 1129R while maintaining the polarization and propagation direction. The second circular polarizer 1113 may transmit the image light 1129R as an image light 1131R toward the eyebox 759.

When the image light 1123L is normally incident onto the mirror 1107, the image light 1124R may propagate in a direction opposite to the propagation direction of the image light 1123L. That is, the image light 1124R and the image light 1123L may substantially coincide with one another and have opposite propagation directions. To better illustrate the optical paths of the image light 1124R and the image light 1123L, FIG. 11 shows a small gap between the image light 1124R and the image light 1123L. The first PVH element 1105 may reflect and converge, via diffraction, the image light 1124R as an image light 1126R toward the mirror 1107. The mirror 1107 may transmit a first portion of the image light 1126R toward the second PVH element 1105 as an image light 1128R, and reflect a second portion of the image light 1126R back to the first PVH element 1105 as a left-handed circularly polarized image light (not shown). The second PVH element 1115 may substantially transmit the image light 1128R, while maintaining the propagation direction and the polarization. The second circular polarizer 1113 may transmit the image light 1128R as an image light 1130R toward the eyebox 759.

In the embodiment shown in FIG. 11, both of the first PVH element 1105 and the second PVH element 1115 may be passive elements, or both of the first PVH element 1105 and the second PVH element 1115 may be active elements configured to operate in the active state. As the first PVH element 1105 and the second PVH element 1115 have the same optical power, and the same axial distance (e.g., L1) to the mirror 1107 along an optical axis 1120 of the system 1100, the image light 1130R and the image light 1131R may substantially coincide or overlap with one another, forming a single image with a high image quality within the eyebox 759. When the distance between the between the first PVH element 1105 and the mirror 1107 is different from the distance between the second PVH element 1115 and the mirror 1107, the optical powers of the first PVH element 1105 and the second PVH element 1115 may be configured to be different, and additional optical elements may be included such that the image light 1130R and the image light 1131R may still substantially coincide or overlap with one another.

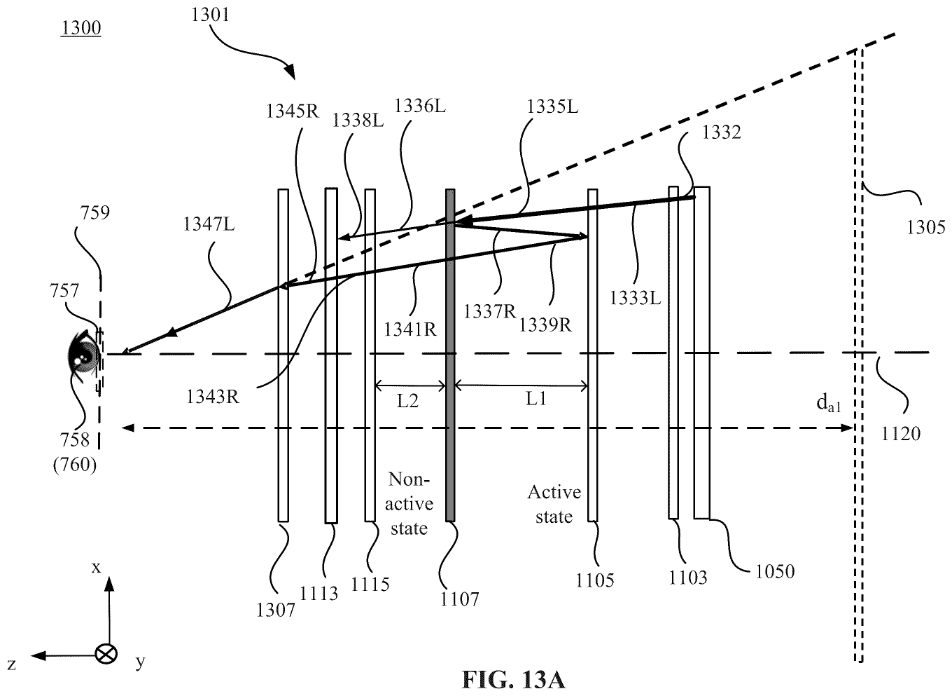

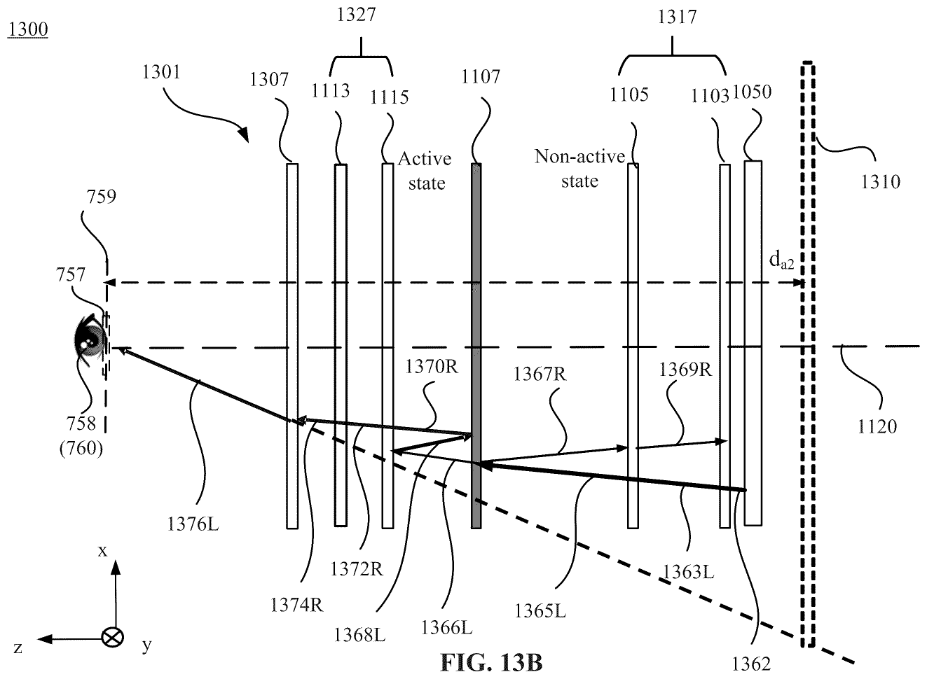

FIG. 13A illustrates an x-z sectional view of a system 1300, according to an embodiment of the present disclosure. The system 1300 may include elements that are similar to or the same as those included in the system 1100 shown in FIG. 11. Descriptions of the same or similar elements or features can refer to the above corresponding descriptions, including those rendered in connection with FIG. 11. As shown in FIG. 13A, the system 1300 may include the display element 1050, and a path-folding lens assembly 1301 (also referred to as lens assembly 1301) configured to fold the path of an image light emitted from the display element 1050 to the eyebox 759. The lens assembly 1301 may include the first circular polarizer 1103, the first PVH lens 1105 (also referred to as a first lens 1105), the mirror 1107, the second PVH lens 1115 (also referred to as a second lens 1115), and the second circular polarizer 1113 arranged in an optical series.

The system 1300 may also include a transmissive lens 1307 (also referred to as a third lens 1307) disposed between the eyebox 759 and the second circular polarizer 1113. The transmissive lens 1307 may include a conventional solid lens including at least one curved surface (e.g., a glass lens, a polymer lens, or a resin lens, etc.), a liquid lens, a Fresnel lens, a meta lens, a transmissive PVH lens, etc. The transmissive lens 1307 may be configured with a fixed optical power or a tunable optical power. For discussion purposes, FIG. 13A shows that the transmissive lens 1307 includes flat surfaces. In some embodiments, the transmissive lens 1307 may include at least one curved surface.

In the embodiment shown in FIG. 13A, each of the first PVH lens 1105 and the second PVH lens 1115 may be an active element that is switchable between operating in an active state and operating in a non-active state. When operating in the active state, the first PVH lens 1105 or the second PVH lens 1115 may selectively reflect or transmit an input light depending on a polarization of the input light. When operating in the non-active state, the first PVH lens 1105 or the second PVH lens 1115 may transmit an input light independent of the polarization of the input light. Thus, the first PVH lens 1105 or the second PVH lens 1115 operating in the active state may have a polarization selective optical power (e.g., zero or non-zero optical power depending on the polarization of the input light), and the first PVH lens 1105 or the second PVH lens 1115 operating in the non-active state may have a zero optical power independent of the polarization of the input light. For example, the first PVH lens 1105 or the second PVH lens 1115 may operate in the active state when an applied voltage is less than or equal to a first threshold value (e.g., a voltage that is insufficiently high to reorientate the LC molecules), and may operate in the non-active state when the applied voltage is equal to or greater than a second threshold value (e.g., a voltage that is sufficiently high to reorientate the LC molecules to be substantially parallel with an electric field direction).

In some embodiments, the controller 740 (not shown) may be communicatively coupled with the first PVH lens 1105 and the second PVH lens 1115 to control the operation state thereof. For example, the first PVH lens 1105 or the second PVH lens 1115 may be electrically coupled with a power source (not shown). The controller 740 may control the output of the power source to control the electric field in the first PVH lens 1105 or the second PVH lens 1115, thereby controlling the operation state of the first PVH lens 1105 or the second PVH lens 1115.

The optical power of the first PVH lens 1105 or the second PVH lens 1115 may be fixed or adjustable. The first PVH lens 1105 and the second PVH lens 1115 may be configured to have at least one of different optical powers or different axial distances (e.g., L1 and L2) to the mirror 1107 along the optical axis 1120. For example, in some embodiments, the first PVH lens 1105 and the second PVH lens 1115 may be configured to have the same optical power, and different axial distances to the mirror 1107. In some embodiments, the first PVH lens 1105 and the second PVH lens 1115 may be configured to have different optical powers, and the same axial distance to the mirror 1107. In some embodiments, the first PVH lens 1105 and the second PVH lens 1115 may be configured to have different optical powers, and different axial distances to the mirror 1107. For discussion purposes, FIG. 13A shows that the axial distance L1 is greater than the axial distance L2. In some embodiments, the axial distance L1 may be equal to or smaller than the axial distance L2.

FIG. 13A also illustrates an optical path of an image light 1332 from the display element 1050 to the eyebox 759, according to an embodiment of the present disclosure. In FIG. 13A, the controller 740 (not shown) may control the first PVH lens 1105 to operate in the active state, and control the second PVH lens 1115 to operate in the non-active state.

FIG. 13B illustrates an optical path of an image light 1362 from the display element 1050 to the eyebox 759, according to an embodiment of the present disclosure. In FIG. 13B, the controller 740 (not shown) may control the first PVH lens 1105 to operate in the non-active state, and control the second PVH lens 1115 to operate in the active state.

For discussion purposes, in FIGS. 13A and 13B, the first PVH lens 1105 operating in the active state may reflect and converge a right-handed circularly polarized light, and may transmit a left-handed circularly polarized light while maintaining the propagation direction of the left-handed circularly polarized light. The second PVH lens 1115 operating in the active state may reflect and converge a left-handed circularly polarized light, and may transmit a right-handed circularly polarized light while maintaining the propagation direction of the right-handed circularly polarized light. For discussion purposes, the transmissive lens 1307 may be a right-handed PBP lens configured to converge a right-handed circularly polarized light and diverge a left-handed circularly polarized light, the first circular polarizer 1103 may transmit a left-handed circularly polarized light and block a right-handed circularly polarized light, and the second circular polarizer 1113 may transmit a right-handed circularly polarized light and block a left-handed circularly polarized light.

Referring back to FIG. 13A, the display element 1050 may output a first image light 1332 (e.g., representing a first virtual object). The first circular polarizer 1103 may convert the image light 1332 into an image light 1333L toward the first PVH lens 1105. The first PVH lens 1105 operating in the active state may substantially transmit the image light 1333L as an image light 1335L toward the mirror 1107. The mirror 1107 may transmit a first portion of the image light 1335L as an image light 1336L toward the second PVH lens 1115, and reflect a second portion of the image light 1335L back to the first PVH lens 1105 as an image light 1337R. The second PVH lens 1115 may transmit the image light 1336L as an image light 1338L toward the second circular polarizer 1113. The second circular polarizer 1113 may block the image light 1338L from being incident onto the transmissive lens 1307, such that a ghost image may be suppressed.

The first PVH lens 1105 may reflect and converge, via diffraction, the image light 1337R as an image light 1339R toward the mirror 1107. The mirror 1107 may transmit a first portion of the image light 1339R toward the second PVH lens 1115 as an image light 1341R, and reflect a second portion of the image light 1339R back to the first PVH lens 1105 as a left-handed circularly polarized image light (not shown). The second PVH lens 1115 may substantially transmit the image light 1341R as an image light 1343R toward the second circular polarizer 1113. The second circular polarizer 1113 may transmit the image light 1343R as an image light 1345R toward the transmissive lens 1307. The transmissive lens 1307 may focus the image light 1345R into an image light 1347L. The light intensity of the image light 1347L may be about 25% of the light intensity of the image light 1332L output from the display element 1050. The optical path of an image light from being the image light 1332L to being the image light 1347L may be referred to as a first optical path.

The lens assembly 1301 may image the display element 1050 to a first image plane 1305 having a first axial distance of dₐ₁ to the eyebox 759, along the optical axis 1120 of the lens assembly 1301. Thus, the first virtual object displayed by the display element 1050 (e.g., displayed on the display panel) may be imaged, by the lens assembly 1301, to the first image plane 1305 that is apart from the eyebox 759 by the first axial distance of dₐ₁. In other words, the lens assembly 1301 may form an image of the first virtual object at the first image plane 1305. Accordingly, for the eye 760 placed at the exit pupil 757 within the eyebox 759, the accommodation distance of the first virtual object may be substantially equal to the first axial distance dₐ₁.

As shown in FIG. 13B, the display element 1050 may output a second image light 1362 (e.g., representing a second virtual object). The first circular polarizer 1103 may convert the image light 1362 into an image light 1363L propagating toward the first PVH lens 1105. The first PVH lens 1105 may substantially transmit the image light 1363L as an image light 1365L toward the mirror 1107. The mirror 1107 may transmit a first portion of the image light 1365L as an image light 1366L toward the second PVH lens 1115, and reflect a second portion of the image light 1365L back to the first PVH lens 1105 as an image light 1367R. The first PVH lens 1105 may transmit the image light 1367R as an image light 1369R toward the first circular polarizer 1103. The first circular polarizer 1103 may block the image light 1369R from being incident onto the display element 1050.

The second PVH lens 1115 may reflect and converge, via diffraction, the image light 1366L as an image light 1368L toward the mirror 1107. The mirror 1107 may transmit a first portion of the image light 1368L toward the first PVH lens 1105 as a left-handed circularly polarized image light (not shown), and reflect a second portion of the image light 1368L back to the second PVH lens 1115 as an image light 1370R. The second PVH lens 1115 may substantially transmit the image light 1370R as an image light 1372R toward the second circular polarizer 1113. The second circular polarizer 1113 may transmit the image light 1372R as an image light 1374R toward the transmissive lens 1307. The transmissive lens 1307 may focus the image light 1374R into an image light 1376L. The light intensity of the image light 1376L may be about 25% of the light intensity of the image light 1362L output from the display element 1050. The optical path of an image light from being the image light 1363L to being the image light 1376L may be referred to as a second optical path.

The lens assembly 1301 may image the display element 1050 to a second image plane 1310 having a second axial distance of dₐ₂ to the eyebox 759, along the optical axis 1120 of the lens assembly 1301. Thus, the second virtual object displayed by the display element 1050 (e.g., displayed on the display panel) may be imaged by the lens assembly 1301 to be at the second image plane 1310 that is spaced apart from the eyebox 759 by the second axial distance of dₐ₂. In other words, the lens assembly 1301 may form an image of the second virtual object at the second image plane 1310. Accordingly, for the eye 760 placed at the exit pupil 757 within the eyebox 759, the accommodation distance of the second virtual object may be substantially equal to the second axial distance dₐ₂.

Referring to FIGS. 13A and 13B, in some embodiments, when the axial distances L1 and L2 are fixed, the first axial distance dₐ₁ of the first image plane 1305 may be determined by the respective optical powers of the first PVH lens 1105 and the transmissive lens 1307, and the second axial distance dₐ₂ of the second image plane 1310 may be determined by the respective optical powers of the second PVH lens 1115 and the transmissive lens 1307. Thus, through configuring the respective optical powers of the transmissive lens 1307, the first PVH lens 1105, and the second PVH lens 1115, the second axial distance dₐ₂ may be configured to be different from the first axial distance dₐ₁. For discussion purposes, FIGS. 13A and 13B show that the first axial distance dₐ₁ is greater than the second axial distance dₐ₂, and the first virtual object and the second virtual object displayed by the display element 1050 may be a distant virtual object and a close virtual object, respectively.

Thus, when each of the transmissive lens 1307, the first PVH lens 1105, and the second PVH lens 1115 is presumed to have a fixed optical power, the lens assembly 1301 may image the display element 1050 to two different image planes having different axial distances to the eyebox 759. In other words, the lens assembly 1301 may form respective images of the first virtual object and the second virtual object displayed by the display element 1050 (e.g., displayed on the display panel) at two different image planes that are spaced apart from the eyebox 759 by different axial distances. Accordingly, for the eye 760 placed at the exit pupil 757 within the eyebox 759, the accommodation distance of the first virtual object and the second virtual object may be different from one another.

When the display element 1050 displays the first virtual object and the second virtual object associated with different vergence distances (from the eye 760 placed at the exit pupil 757 within the eyebox 759), the respective optical powers of the transmissive lens 1307, the first PVH lens 1105, and the second PVH lens 1115 may be configured, and the axial distances L1, and L2 for the lens assembly 1301 may be configured, such that the first axial distance dₐ₁ may be substantially equal to the vergence distance of the first virtual object, and the second axial distance dₐ₂ may be substantially equal to the vergence distance of the second virtual object.

Thus, the vergence-accommodation conflict in the system 1300 may be reduced, and the user experience may be enhanced. In some embodiments, when at least one of the transmissive lens 1307, the first PVH lens 1105, or the second PVH lens 1115 has an adjustable optical power, the lens assembly 1301 may image the virtual content displayed by the display element 1050 to more than two different image planes having different axial distances to the eyebox 759. The accommodation capability of the lens assembly 1301 may be further improved.

In some embodiments, during a display frame of the display element 1050, a distant virtual object and a close virtual object may be displayed by the display element 1050, during different sub-frames of the display frame. The display element 1050 may render the close virtual object to appear closer to the eyes 760 than the distant virtual object. Referring to FIGS. 13A and 13B, the distant virtual object may be the first virtual object represented by the image light 1332 shown in FIG. 13A, and the close virtual object may be the second virtual object represented by the image light 1362 shown in FIG. 13B.

The display element 1050 may be configured to display virtual objects associated with different vergence distances in a time sequential manner during the operation of the system 200. For example, the display element 1050 may be configured to switch between displaying the distant virtual object and displaying the close virtual object at a predetermined frequency or predetermined frame rate. In some embodiments, the display frame of the display element 1050 may include a first sub-frame and a second sub-frame. The controller 740 may be configured to control the display element 1050 to display the distant virtual object and the close virtual object during the respective sub-frames of the display frame of the display element 1050. In some embodiments, the frame rate of the display element 1050 may be at least 60 Hz according to the frame rate of the human vision.

In addition, during the operation of the system 1300, the controller 740 may be configured to control each of the first PVH lens 1105 and the second PVH lens 1115 to switch between the active state and the non-active state. In some embodiments, when the display frame of the display element 1050 includes a first sub-frame and a second sub-frame, the controller 740 may be configured to control the first PVH lens 1105 and the second PVH lens 1115 to sequentially operate in the active state during the two sub-frames. The switching of the first PVH lens 1105 and the second PVH lens 1115 may be synchronized with the switching of the display element 1050 between displaying the distant virtual object and the close virtual object.

For example, during the first sub-frame, the controller 740 may be configured to control the display element 1050 to display only the distant virtual object, and output the image light 1332 representing the distant virtual object (as shown in FIG. 13A). In some embodiments, based on the eye tracking information provided by the eye tracking device (not shown), the controller 740 may determine a vergence distance dᵥ₁ of the distant virtual object. Based on the determined eye tracking information, the controller 740 may control the first PVH lens 1105 to operate in the active state and the second PVH lens 1115 to operate in the non-active state. Referring to FIG. 13A, the lens assembly 1301 may image the distant virtual object to the first image plane 1305 having the first axial distance of dₐ₁ to the eyebox 759. In some embodiments, the first axial distance of dₐ₁ may be configured to be substantially equal to the vergence distance dᵥ₁ of the distant virtual object. Thus, the eyes 760 placed at the exit pupil 757 within the eyebox 759 may accommodate for the distant virtual object.

During the second sub-frame, the controller 740 may be configured to control the display element 1050 to display only the close virtual object, and output the image light 1362 representing the close virtual object (as shown in FIG. 13B). Based on the eye tracking information provided by the eye tracking device (not shown), the controller 740 may determine a vergence distance dᵥ₂ of the close virtual object. Based on the determined eye tracking information, the controller 740 may control the first PVH lens 1105 to operate in the non-active state and the second PVH lens 1115 to operate in the active state. Referring to FIG. 13B, the lens assembly 1301 may image the close virtual object to the second image plane 1310 having the second axial distance of dₐ₂ to the eyebox 759. In some embodiments, the second axial distance of dₐ₂ may be configured to be substantially equal to the vergence distance dᵥ₂ of the close virtual object. Thus, the eyes 760 placed at the exit pupil 757 within the eyebox 759 may accommodate for the close virtual object.

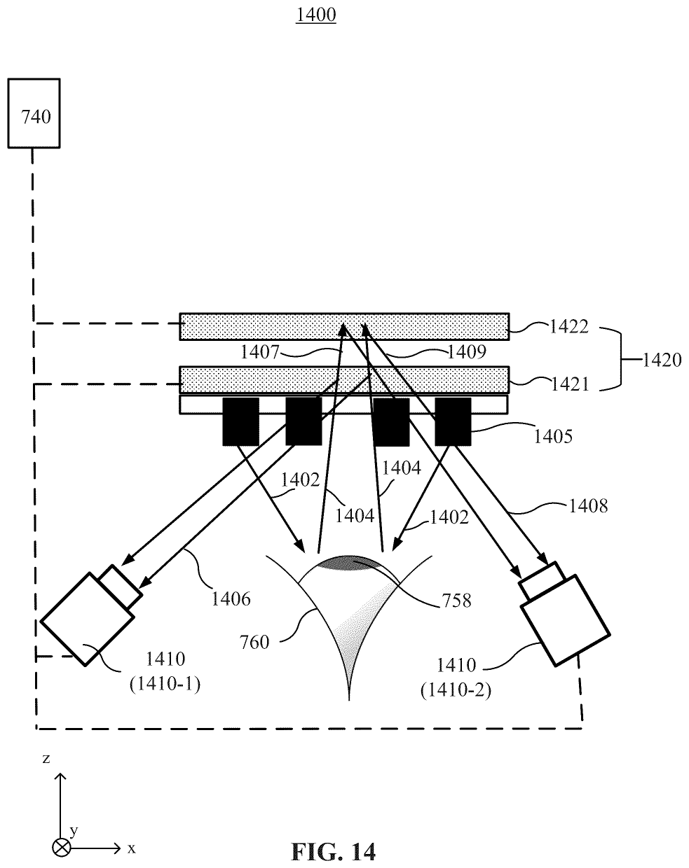

FIG. 14 illustrates an x-z sectional view of an object tracking system (e.g., eye tracking system) 1400 that may include one or more disclosed LCPH elements, according to an embodiment of the present disclosure. As shown in FIG. 14, the eye tracking system 1400 may include one or more light sources 1405, a polarization selective optical element 1420, and one or more optical sensors 1410. The one or more light sources 1405 may be configured to emit an IR light 1402 to illuminate one or two eyes 760 of the user. The eye 760 may reflect the IR light 1402 as an IR light 1404 propagating toward the polarization selective optical element 1420. The polarization selective optical element 1420 may be configured to split (e.g., deflect) the IR light 1404 reflected by the eye 760 as a plurality of signal lights, e.g., a first signal light 1406 and a second signal light 1408, propagating towards the one or more optical sensors 1410. In some embodiments, the polarization selective optical element 1420 may be configured to diffract the light 1404 as the plurality of diffracted lights propagating towards the one or more optical sensors 1410.

In the embodiment shown in FIG. 14, the eye tracking system 1400 is shown as including two optical sensors 1410 disposed apart from one another at both sides of the eye 760 (or user). The two optical sensors 1410 are labelled as the first optical sensor 1410-1 and the second optical sensor 1410-2. The optical sensors 1410-1 and 1410-2 may be disposed obliquely relative to a normal of a light exiting surface of the polarization selective optical element 1420. That is, the optical sensors 1410-1 and 1410-2 may be disposed off-axis with respect to the line of sight of the eye 760. The optical sensors 1410-1 and 1410-2 and the eye 760 may be located at the same side of the polarization selective optical element 1420.

The polarization selective optical element 1420 may be a reflective polarization selective optical element, which may be configured to backwardly diffract the light 1404 reflected by the eye 760 as a first signal light 1406 propagating in a first direction toward the first optical sensor 1410-1, and a second signal light 1408 propagating in a second direction toward the second optical sensor 1410-2. The first direction may be substantially different from the second direction, and may not be parallel with the second direction. In some embodiments, the first signal light 1406 and the second signal light 1408 may be orthogonally polarized lights.

In some embodiments, the first optical sensor 1410-1 and the second optical sensor 1410-2 may be positioned with suitable orientations or directions to receive the first signal light 1406 and the second signal light 1408, respectively. The first optical sensor 1410-1 and the second optical sensor 1410-2 may be configured to generate signals, data, or information based on the first signal light 1406 and the second signal light 1408, respectively. In some embodiments, individual images of the eye 760 may be generated by the optical sensors 1410-1 and 1410-2 based on first signal light 1406 and the second signal light 1408, respectively, thereby providing multiple perspective views of the eye 760. For example, a first perceptive view of the eye 760 may be obtained from a first image generated by the first optical sensor 1410-1 based on the first signal light 1406, and a second perceptive view of the eye 760 may be obtained from a second image generated by the second optical sensor 1410-2 based on the second signal light 1408.

In some embodiments, the polarization selective optical element 1420 may include one or more disclosed LCPH elements, such as the LCPH element 200 including the birefringent medium layer 215 (functioning as a reflective PVH element) shown in FIG. 2E. For example, the polarization selective optical element 1420 may include a first LCPH element 1421 and a second LCPH element 1422 arranged in an optical series. The light 1402 output from the light source 1405 or the light 1404 reflected by the eye 760 may include two orthogonally polarized components, e.g., a right-handed circularly polarized component and a left-handed circularly polarized component.

The first LCPH element 1421 and the second LCPH element 1422 may be configured with different polarization selectivities. For example, one of the first LCPH element 1421 and the second LCPH element 1422 may be configured to substantially backwardly diffract the right-handed circularly polarized (or left-handed circularly polarized) component of the light 1404, and substantially transmit, with negligible diffraction, the left-handed circularly polarized (or right-handed circularly polarized) component of the light 1404. The other of the first LCPH element 1421 and the second LCPH element 1422 may be configured to substantially backwardly diffract the left-handed circularly polarized (or right-handed circularly polarized) component of the light 1404, and substantially transmit, with negligible diffraction, the right-handed circularly polarized (or left-handed circularly polarized) component of the light 1404.

For example, in some embodiments, the first LCPH element 1421 may function as a right-handed PVH lens, and the second LCPH element 1422 may function as a left-handed PVH lens. A PVH lens may provide a large field of view. Although not shown, in some embodiments, the first LCPH element 1421 and the second LCPH element 1422 may function as PVH gratings. The first LCPH element (e.g., right-handed PVH lens) 1421 may be configured to substantially backwardly diffract and converge or diverge the right-handed circularly polarized component of the light 1404 as the first signal light (e.g., that is substantially close to a right-handed circularly polarized light) 1406 having a positive diffraction angle and propagating toward the first optical sensor 1410-1. The first LCPH element 1421 may substantially transmit, with negligible diffraction, the left-handed circularly polarized component of the light 1404 as a light (e.g., that is substantially close to a left-handed circularly polarized light) 1407 propagating toward the second LCPH element (e.g., left-handed PVH lens) 1422.

The second LCPH element 1422 may be configured to substantially backwardly diffract and converge or diverge the light 1407 as a light (e.g., that is substantially close to a left-handed circularly polarized light) 1409 having a negative diffraction angle and propagating toward the first LCPH element 1421. The first LCPH element 1421 may substantially transmit the light 1409 as the second signal light (e.g., that is substantially close to a left-handed circularly polarized light) 1408 propagating toward the second optical sensor 1410-2. That is, the first LCPH element 1421 and the second LCPH element 1422 may split, via diffraction, the IR light 1404 reflected by the eye 760 spatially as the first signal light 1406 and the second signal light 1408.

As the first LCPH element 1421 and the second LCPH element 1422 reduce the light leakage, increase the efficiency, and enhance the extinction ratio over a wide AOI range, the system 1400 may provide more accurate eye tracking information and a larger tracking ranges of the eye 760 in the horizontal and/or vertical directions, as compared to conventional eye tracking systems.

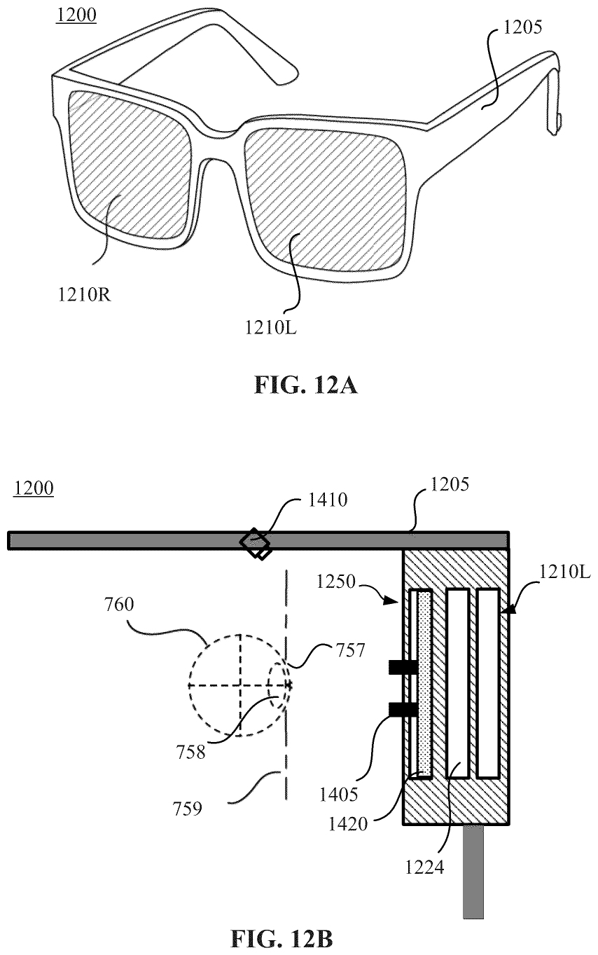

FIG. 12A illustrates a schematic diagram of an artificial reality device 1200 according to an embodiment of the present disclosure. In some embodiments, the artificial reality device 1200 may produce VR, AR, and/or MR content for a user, such as images, video, audio, or a combination thereof. The artificial reality device 1200 may include one or more disclosed LCPH elements, and may provide an enhanced performance and user experience. In some embodiments, the artificial reality device 1200 may be smart glasses. In one embodiment, the artificial reality device 1200 may be a near-eye display (“NED”). In some embodiments, the artificial reality device 1200 may be in the form of eyeglasses, goggles, a helmet, a visor, or some other type of eyewear. In some embodiments, the artificial reality device 1200 may be configured to be worn on a head of a user (e.g., by having the form of spectacles or eyeglasses, as shown in FIG. 12A), or to be included as part of a helmet that is worn by the user. In some embodiments, the artificial reality device 1200 may be configured for placement in proximity to an eye or eyes of the user at a fixed location in front of the eye(s), without being mounted to the head of the user. In some embodiments, the artificial reality device 1200 may be in a form of eyeglasses which provide vision correction to a user's eyesight. In some embodiments, the artificial reality device 1200 may be in a form of sunglasses which protect the eyes of the user from the bright sunlight. In some embodiments, the artificial reality device 1200 may be in a form of safety glasses which protect the eyes of the user. In some embodiments, the artificial reality device 1200 may be in a form of a night vision device or infrared goggles to enhance a user's vision at night.

For discussion purposes, FIG. 12A shows that the artificial reality device 1200 includes a frame 1205 configured to mount to a head of a user, and left-eye and right-eye display systems 1210L and 1210R mounted to the frame 1205. FIG. 12B is a cross-sectional view of half of the artificial reality device 1200 shown in FIG. 12A according to an embodiment of the present disclosure. For illustrative purposes, FIG. 12B shows the cross-sectional view associated with the left-eye display system 1210L. The frame 1205 is merely an example structure to which various components of the artificial reality device 1200 may be mounted. Other suitable type of fixtures may be used in place of or in combination with the frame 1205.

In some embodiments, the left-eye and right-eye display systems 1210L and 1210R each may include suitable image display components configured to generate virtual images, such as the display element 705 shown in FIG. 7, the display panel 901 and the light guide illumination assembly 903 shown in FIG. 9A, the display panel 982 and the light guide illumination assembly 903 shown in FIG. 9B, or the display element 1050 shown in FIG. 10A, FIG. 11, and FIGS. 13A and 13B, etc. In some embodiments, the left-eye and right-eye display systems 1210L and 1210R may each include a light guide display system, e.g., the system 800 shown in FIG. 8A or the system 850 in FIG. 8B. In some embodiments, the left-eye and right-eye display systems 1210L and 1210R may include one or more disclosed LCPH elements.

In some embodiments, the artificial reality device 1200 may also include a viewing optics system 1224 disposed between the left-eye display system 1210L or right-eye display system 1210R and the eyebox 759. The viewing optics system 1224 may be configured to guide an image light (representing a computer-generated virtual image) output from the left-eye display system 1210L or right-eye display system 1210R to propagate through one or more exit pupils 757 within the eyebox 759. For example, the viewing optics system 1224 may include the off-axis combiner 720 shown in FIG. 7, the off-axis combiner 780 shown in FIG. 7B, the lens assembly 853 shown in FIG. 8B, the lens assembly 902 shown in FIG. 9A or FIG. 9B, the path-folding lens assembly 1001 shown in FIG. 10A, the path-folding lens assembly 1101 shown in FIG. 11, or the path-folding lens assembly 1301 shown in FIGS. 13A and 13B, etc. In some embodiments, the viewing optics system 1224 may also be configured to perform a suitable optical adjustment of an image light output from the left-eye display system 1210L or right-eye display system 1210R, e.g., correct aberrations in the image light, adjust a position of the focal point of the image light in the eyebox 759, etc. In some embodiments, the viewing optics system 1224 may include one or more disclosed LCPH elements. In some embodiments, the viewing optics system 1224 may be omitted.

In some embodiments, as shown in FIG. 12B, the artificial reality device 1200 may also include an object tracking system 1250 (e.g., eye tracking system and/or face tracking system). The object tracking system 1250 may include one or more disclosed LCPH elements. In some embodiments, the object tracking system 1250 may be similar to the object tracking system 1400 shown in FIG. 14. For example, the object tracking system 1250 may include one or more IR light sources 1405 configured to illuminate the eye 760 and/or the face, the light deflecting element 1420 configured to deflect the IR light reflected by the eye 760 toward the optical sensor 1410. The optical sensor 1410 may receive the IR light deflected by the deflecting element 1420 and generate a tracking signal (e.g., an eye tracking signal).

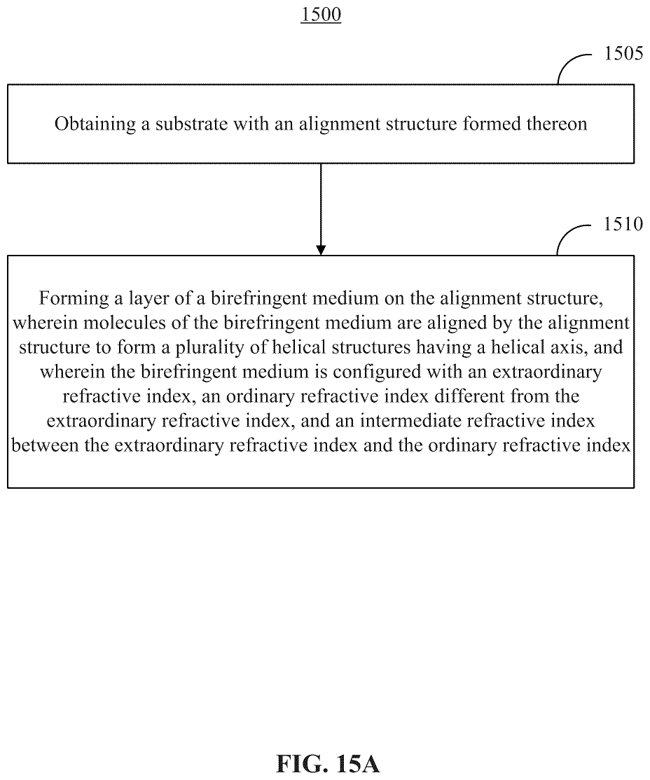

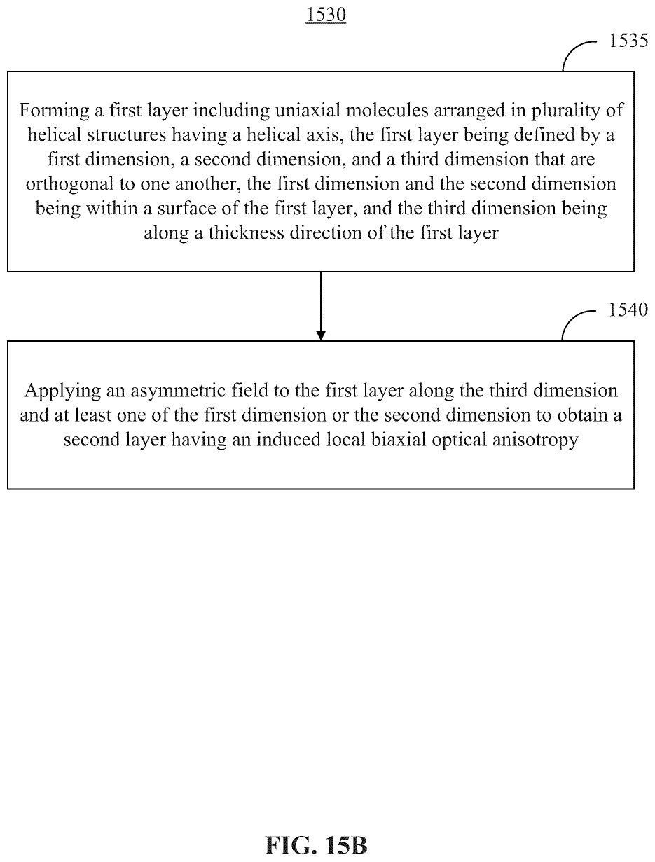

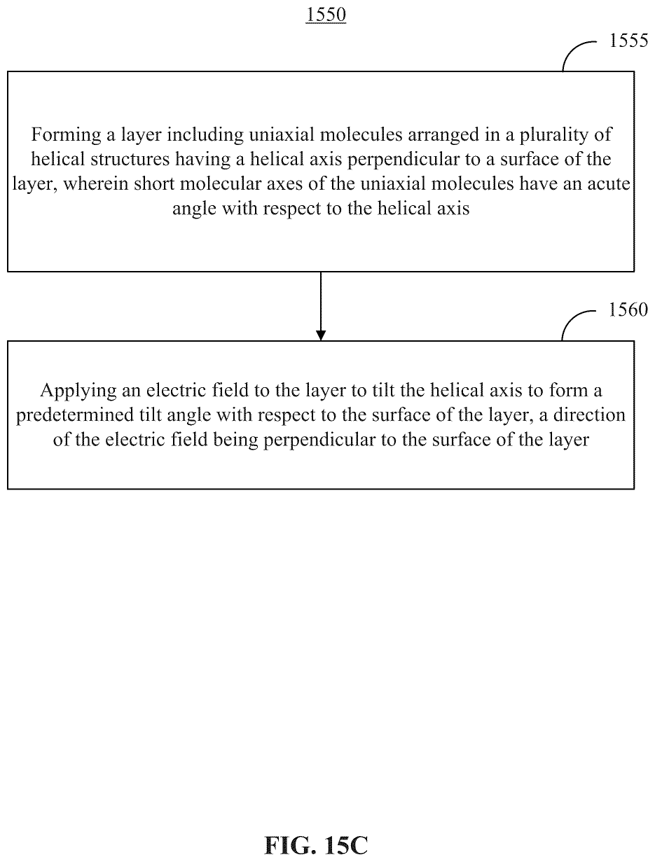

FIGS. 15A-15C are flowcharts illustrating various methods for fabricating an LCPH element disclosed herein, such as a circular polarization selective optical element, according to various embodiments of the present disclosure. In some embodiments, the circular polarization selective optical element may be a circular reflective polarizer.

FIG. 15A is a flowchart illustrating a method 1500 for fabricating an LCPH element, such as a circular polarization selective optical element, according to an embodiment of the present disclosure. As shown in FIG. 15A, the method 1500 may include obtaining a substrate with an alignment structure formed thereon (step 1505). In some embodiments, obtaining the substrate with the alignment structure formed thereon may include forming the alignment structure on a surface of the substrate. The method 1500 may also include forming a layer of a birefringent medium on the alignment structure, wherein molecules of the birefringent medium are aligned by the alignment structure to form a plurality of helical structures having a helical axis, and wherein the birefringent medium is configured with an extraordinary refractive index, an ordinary refractive index different from the extraordinary refractive index, and an intermediate refractive index between the extraordinary refractive index and the ordinary refractive index (step 1510).

In some embodiments, the layer may have an out-of-plane principal refractive index along the helical axis, and two equal in-plane principal refractive indices within a plane perpendicular to the helical axis. In some embodiments, the out-of-plane principal refractive index may be equal to the intermediate refractive index, and may be substantially the same as the two equal in-plane principal refractive indices. In some embodiments, the molecules of the birefringent medium include biaxial molecules having a biaxial molecular structure. In some embodiments, the molecules of the birefringent medium include a mixture of liquid crystal molecules having a rod shape and nanocrystal particles. In some embodiments, the molecules of the birefringent medium include a mixture of first uniaxial molecules having a first shape and second uniaxial molecules having a second shape different from the first shape.

In some embodiments, forming the layer of the birefringent medium on the alignment structure includes: forming a first sub-layer including the first uniaxial molecules on the alignment structure, the first uniaxial molecules being configured to form the helical structures within the first sub-layer; polymerizing the first sub-layer to form a polymerized first sub-layer that is a porous film including a plurality of pores; and forming a second sub-layer including the second uniaxial molecules on the polymerized first sub-layer, wherein the second uniaxial molecules at least partially fill the pores of the polymerized first sub-layer. In some embodiments, forming the layer of the birefringent medium on the alignment structure includes: forming a plurality of sub-layers stacked along the helical axis on the substrate, wherein molecules in each sub-layer are configured with a same orientation, and molecules in two adjacent sub-layers are configured with different orientations. In some embodiments, the plurality of sub-layers include a plurality of biaxial liquid crystal polymer layers or a plurality of biaxial organic solid crystals.

FIG. 15B is a flowchart illustrating a method 1530 for fabricating an LCPH element, such as a circular polarization selective optical element, according to an embodiment of the present disclosure. As shown in FIG. 15B, the method 1530 may include forming a first layer including uniaxial molecules arranged in plurality of helical structures having a helical axis, the first layer being defined by a first dimension, a second dimension, and a third dimension that are orthogonal to one another, the first dimension and the second dimension being within a surface of the first layer, and the third dimension being along a thickness direction of the first layer (step 1535). The method 1530 may also include applying an asymmetric field to the first layer along the third dimension and at least one of the first dimension or the second dimension to obtain a second layer having an induced local biaxial optical anisotropy (step 1540).

In some embodiments, an out-of-plane principal refractive index of the first layer along the helical axis may be different from (e.g., greater than or less than) an in-plane principal refractive index of the first layer within a plane perpendicular to the helical axis. In some embodiments, an out-of-plane principal refractive index of the second layer along the helical axis may be substantially the same as an in-plane principal refractive index of the second layer within the plane perpendicular to the helical axis. In some embodiments, the asymmetric field includes at least one of an asymmetric electric field, an asymmetric magnetic field, or an asymmetric mechanical force.

In some embodiments, applying the asymmetric field to the first layer along the third dimension and at least one of the first dimension or the second dimension to obtain the second layer includes: applying an asymmetric mechanical field to the first layer along the third dimension and at least one of the first dimension or the second dimension to change a shape of the first layer. A ratio among a first dimension, a second dimension, and a third dimension of the second layer may be different from a ratio among the first dimension, the second dimension, and the third dimension of the first layer. In some embodiments, applying an asymmetric field to the first layer along the third dimension and at least one of the first dimension or the second dimension to change the shape of the first layer includes: pulling the first layer to increase at least one of the first dimension, the second dimensions, or the third dimension of the first layer, or compressing the first layer to decrease at least one of the first dimension, the second dimension, or the third dimension of the first layer.

In some embodiments, the out-of-plane principal refractive index of the first layer is smaller than the out-of-plane principal refractive index of the second layer, and the in-plane principal refractive index of the first layer is greater than the in-plane principal refractive index of the second layer. In some embodiments, the out-of-plane principal refractive index of the first layer is greater than the out-of-plane principal refractive index of the second layer, and the in-plane principal refractive index of the first layer is smaller than the in-plane principal refractive index of the second layer.

FIG. 15C is a flowchart illustrating a method 1550 for fabricating an LCPH element, such as a circular polarization selective optical element, according to an embodiment of the present disclosure. As shown in FIG. 15C, the method 1550 may include forming a layer including uniaxial molecules arranged in a plurality of helical structures having a helical axis perpendicular to a surface of the layer, wherein short molecular axes of the uniaxial molecules have an acute angle with respect to the helical axis (step 1555). The method 1550 may also include applying an electric field to the layer to tilt the helical axis to form a predetermined tilt angle with respect to the surface of the layer, a direction of the electric field being perpendicular to the surface of the layer (step 1560). In some embodiments, the layer applied with the electric field may have an out-of-plane principal refractive index along the titled helical axis, and two equal in-plane principal refractive indices within a plane perpendicular to the titled helical axis. In some embodiments, the out-of-plane principal refractive index may be substantially the same as the two equal in-plane principal refractive indices.

According to some embodiments, the present disclosure provides wide-view circular reflective polarizers and fabrication methods thereof. The biaxial circular reflective polarizers may be configured to reflect a light having a predetermined circular polarization while transmitting a light having a circular polarization orthogonal to the predetermined circular polarization. While reflecting the light having the predetermined circular polarization, the biaxial circular reflective polarizer may maintain the polarization of the light. In some embodiments, the biaxial circular reflective polarizers of the present disclosure may be configured to reflect an incident light with a broad incident angle range. In accordance with some embodiments, a method for fabricating a circular reflective polarizer includes obtaining a layer of liquid crystals extending along a first plane. The liquid crystals have a uniaxial anisotropy. The liquid crystals are arranged in a plurality of helical patterns. The layer is defined by a first dimension, a second dimension, and a third dimension that are orthogonal to one another. The method includes changing a shape of the layer of liquid crystals so that a ratio among a first dimension, a second dimension, and a third dimension of the changed layer of liquid crystals is different from a ratio among the first dimension, the second dimension, and the third dimension of the layer of liquid crystals prior to the change. The liquid crystals in the changed layer of liquid crystals have a biaxial refractive index anisotropy.

In accordance with some embodiments, a method for fabricating a circular reflective polarizer includes obtaining molecules having biaxial anisotropy. The method includes arranging the molecules having biaxial anisotropy in a layer by self-assembly such that the molecules are arranged in helical patterns. The layer may reflect a light having a first circular polarization and transmit a light having a second circular polarization orthogonal to the first circular polarization.

In accordance with some embodiments, a method for fabricating a circular reflective polarizer includes forming a first layer of liquid crystals on a substrate. The first layer of liquid crystals includes a first plurality of liquid crystal molecules having a first shape defining a uniaxial refractive index anisotropy in a first direction. The method includes polymerizing the first layer of liquid crystals. The method also includes forming a second layer of liquid crystal on the polymerized first layer of liquid crystals. The second layer of liquid crystals includes a second plurality of liquid crystal molecules having a second shape. The second shape is different from the first shape. The second plurality of liquid crystal molecules define a uniaxial refractive index anisotropy in a second direction different from the first direction. The method forms a film of biaxial anisotropic material having a biaxial refractive index anisotropy as a combination of the first direction and the second direction.

In accordance with some embodiments, a method for fabricating a circular reflective polarizer includes sequentially depositing materials to form a circular reflective polarizer. Sequentially depositing the materials includes depositing a first material at a first location and depositing a second material at a second location different from the first location.

In some embodiments, the present disclosure provides a device that includes a substrate, an alignment structure disposed on the substrate, and a layer of a birefringent medium disposed on the alignment structure. The birefringent medium has an extraordinary refractive index, an ordinary refractive index different from the extraordinary refractive index, and an intermediate refractive index between the extraordinary refractive index and the ordinary refractive index. Molecules of the birefringent medium are configured to form a plurality of helical structures having a helical axis. The layer is configured with an out-of-plane principal refractive index along the helical axis, and two equal in-plane principal refractive indices within a plane perpendicular to the helical axis. The out-of-plane principal refractive index is equal to the intermediate refractive index, and is substantially the same as the two equal in-plane principal refractive indices. In some embodiments, the molecules of the birefringent medium include biaxial molecules having a biaxial molecular structure. In some embodiments, the birefringent medium includes at least one of liquid crystal molecules having parallelepiped platelets shapes, liquid crystal molecules having bent shapes, multipodes, or a liquid-crystalline side-chain polymer. In some embodiments, the birefringent medium includes a mixture of liquid crystal molecules having a rod shape and nanocrystal particles. In some embodiments, the molecules of the birefringent medium include a mixture of first uniaxial molecules having a first shape and second uniaxial molecules having a second shape different from the first shape. In some embodiments, the first uniaxial molecules having the first shape include first uniaxial liquid crystal molecules having a rod shape, and the second uniaxial molecules having the second shape include second uniaxial liquid crystal molecules having a disc shape. In some embodiments, the first uniaxial molecules having the first shape include first uniaxial liquid crystal molecules having a first rod shape, and the second uniaxial molecules having the second shape include second uniaxial liquid crystal molecules having a second rod shape different from the first rod shape. In some embodiments, the layer of the birefringent medium is a porous liquid crystal polymer layer including a plurality of pores, the first uniaxial molecules are configured to form the helical structures, and the second uniaxial molecules are located within the pores. In some embodiments, the layer of the birefringent medium includes a plurality of sub-layers stacked along the helical axis, the molecules in each sub-layer being configured with a same orientation, and the molecules in two adjacent sub-layers being configured with different orientations. In some embodiments, the plurality of sub-layers include a plurality of biaxial liquid crystal polymer layers or a plurality of biaxial organic solid crystals. In some embodiments, the helical axis is perpendicular to a surface of the layer of the birefringent medium, or tilted with respect to the surface of the layer of the birefringent medium.

In some embodiments, the present disclosure provides a method. The method includes obtaining a substrate with an alignment structure formed thereon. The method also includes forming a layer of a birefringent medium on the alignment structure. Molecules of the birefringent medium are aligned by the alignment structure to form a plurality of helical structures having a helical axis, and the birefringent medium is configured with an extraordinary refractive index, an ordinary refractive index different from the extraordinary refractive index, and an intermediate refractive index between the extraordinary refractive index and the ordinary refractive index. The layer has an out-of-plane principal refractive index along the helical axis, and two equal in-plane principal refractive indices within a plane perpendicular to the helical axis. The out-of-plane principal refractive index is equal to the intermediate refractive index, and is substantially the same as the two equal in-plane principal refractive indices.

In some embodiments, the molecules of the birefringent medium include biaxial molecules having a biaxial molecular structure. In some embodiments, the molecules of the birefringent medium include a mixture of liquid crystal molecules having a rod shape and nanocrystal particles. In some embodiments, the molecules of the birefringent medium include a mixture of first uniaxial molecules having a first shape and second uniaxial molecules having a second shape different from the first shape. In some embodiments, forming the layer of the birefringent medium on the alignment structure includes: forming a first sub-layer including the first uniaxial molecules on the alignment structure, the first uniaxial molecules being configured to form the helical structures within the first sub-layer; polymerizing the first sub-layer to form a polymerized first sub-layer that is a porous film including a plurality of pores; and forming a second sub-layer including the second uniaxial molecules on the polymerized first sub-layer, wherein the second uniaxial molecules at least partially fill the pores of the polymerized first sub-layer. In some embodiments, forming the layer of the birefringent medium on the alignment structure includes: forming a plurality of sub-layers stacked along the helical axis on the substrate, wherein molecules in each sub-layer are configured with a same orientation, and molecules in two adjacent sub-layers are configured with different orientations. In some embodiments, the plurality of sub-layers include a plurality of biaxial liquid crystal polymer layers or a plurality of biaxial organic solid crystals.

In some embodiments, the present disclosure provides a method. The method includes forming a first layer including uniaxial molecules arranged in plurality of helical structures having a helical axis, the first layer being defined by a first dimension, a second dimension, and a third dimension that are orthogonal to one another, the first dimension and the second dimension being within a surface of the first layer, and the third dimension being along a thickness direction of the first layer. The method also includes applying an asymmetric field to the first layer along the third dimension and at least one of the first dimension or the second dimension to obtain a second layer having an induced local biaxial optical anisotropy. An out-of-plane principal refractive index of the first layer along the helical axis is greater than an in-plane principal refractive index of the first layer within a plane perpendicular to the helical axis. An out-of-plane principal refractive index of the second layer along the helical axis is substantially the same as an in-plane principal refractive index of the second layer within the plane perpendicular to the helical axis. In some embodiments, the asymmetric field includes at least one of an asymmetric electric field, an asymmetric magnetic field, or an asymmetric mechanical force. In some embodiments, applying the asymmetric field to the first layer along the third dimension and at least one of the first dimension or the second dimension to obtain the second layer includes: applying an asymmetric mechanical field to the first layer along the third dimension and at least one of the first dimension or the second dimension to change a shape of the first layer, wherein a ratio among a first dimension, a second dimension, and a third dimension of the second layer is different from a ratio among the first dimension, the second dimension, and the third dimension of the first layer. In some embodiments, applying an asymmetric field to the first layer along the third dimension and at least one of the first dimension or the second dimension to change the shape of the first layer includes: pulling the first layer to increase at least one of the first dimension, the second dimensions, or the third dimension of the first layer, or compressing the first layer to decrease at least one of the first dimension, the second dimension, or the third dimension of the first layer. In some embodiments, the out-of-plane principal refractive index of the first layer is smaller than the out-of-plane principal refractive index of the second layer, and the in-plane principal refractive index of the first layer is greater than the in-plane principal refractive index of the second layer. In some embodiments, the out-of-plane principal refractive index of the first layer is greater than the out-of-plane principal refractive index of the second layer, and the in-plane principal refractive index of the first layer is smaller than the in-plane principal refractive index of the second layer.

In some embodiments, the present disclosure provides a method. The method includes forming a layer including uniaxial molecules arranged in a plurality of helical structures having a helical axis perpendicular to a surface of the layer, wherein short molecular axes of the uniaxial molecules have an acute angle with respect to the helical axis. The method also includes applying an electric field to the layer to tilt the helical axis to form a predetermined tilt angle with respect to the surface of the layer, a direction of the electric field being perpendicular to the surface of the layer. The layer applied with the electric field has an out-of-plane principal refractive index along the titled helical axis, and two equal in-plane principal refractive indices within a plane perpendicular to the titled helical axis. The out-of-plane principal refractive index is substantially the same as the two equal in-plane principal refractive indices.

According to some embodiments, the present disclosure provides circular reflective polarizers with wide viewing angles. The disclosed circular reflective polarizers may have a large extinction ratio (e.g., 1000:1 or greater for a light at a normal incidence angle, and 100:1 or greater at an angle of incidence of 60 degrees or greater). The disclosed circular reflective polarizers may provide a large extinction ratio without requiring an external compensator. The disclosed circular reflective polarizers may be formed on a flat surface or a curved surface. The disclosed circular reflective polarizers may be used in various applications, such as wide-angle folded optical systems (e.g., pancake lenses), which can increase the viewing angle of near-eye displays of head-mounted display devices, or light emitting diodes or semiconductor laser devices. In some configurations, the circular reflective polarizer includes a layer of biaxial anisotropic material arranged in helical patterns. The layer selectively interacts with the incident light based on polarization, wavelength and/or incident angle of the light. For example, a layer of biaxial anisotropic materials arranged in helical patterns may redirect an incident light having a first polarization and a first wavelength range while transmitting an incident light having a polarization different from the first polarization and/or an incident light having a wavelength outside the first wavelength range. Due to the biaxial anisotropic nature of the material forming the helical patterns, the layer may efficiently redirect light with a wide range of incident angles while maintaining a high extinction ratio.

The biaxial circular reflective polarizers (e.g., circular reflective polarizers that include molecules or structures having biaxial refractive index anisotropy) described herein have a high reflectance and a high polarization extinction ratio at incident angles ranging from 0 to 60 degrees for a visible wavelength range (e.g., from 400 nm to 750 nm). In some embodiments, a biaxial circular reflective polarizer has a reflectance more than 95%, more than 96%, more than 97%, more than 98%, or more than 99% when reflecting a light having a first circular polarization (e.g., either left circular polarization or right circular polarization) with an incident angle ranging from 0 to 60 degrees. In some embodiments, the biaxial circular reflective polarizer transmits more than 95%, more than 96%, more than 97%, more than 98%, more than 99% of a light having a second circular polarization at an incident angle ranging from 0 to 60 degrees. The second circular polarization is orthogonal to the first circular polarization (e.g., the first circular polarization corresponds to left-handed circularly polarized light and the second circular polarization corresponds to right-handed circularly polarized light, or vice versa). In some embodiments, a polarization extinction ratio defined as a ratio between the transmittance of the light having the second circular polarization and the transmittance of the light having the first circular polarization is greater than 100:1 (e.g., greater than 100:1, 200:1, 300:1, 400:1, 500:1, 600:1, 700:1, 800:1, 900:1, 1000:1, 1100:1, 1200:1, 1300:1, 1400:1, 1500:1, 1600:1, 1700:1, 1800:1, 1900:1, 2000:1, 3000:1, 4000:1, 5000:1, 6000:1, 7000:1, 8000:1, 9000:1, 10000:1, 15000:1, 20000:1, or between any two of the aforementioned ratios).

In some embodiments, two or more circular reflective polarizers are stacked together. In some embodiments, a stack includes a first circular reflective polarizer configured to reflect a light in a first wavelength range, a second circular reflective polarizer configured to reflect a light in a second wavelength range, and a third circular reflective polarizer configured to reflect a light in a third wavelength range. The first wavelength range, the second wavelength range, and the third wavelength are different from each other. For example, the first wavelength range corresponds to a red color, the second wavelength range corresponds to a green color, and the third wavelength range corresponds to a blue color. In some embodiments, at least two of the first wavelength range, the second wavelength range, and the third wavelength range partially overlap with each other. In some embodiments, at least two of the first wavelength range, the second wavelength range, and the third wavelength range partially overlap with each other. In some embodiments, none of the first wavelength range, the second wavelength range, and the third wavelength range overlap with one another. In some embodiments, the polarization extinction ratio for a stack of circular reflective polarizers ranges from 100:1 to 2000:1 (e.g., from 100:1 to 1900:1, from 100:1 to 1800:1, from 100:1 to 1700:1, from 100:1 to 1600:1, from 100:1 to 1500:1, from 200:1 to 1900:1, from 200:1 to 1800:1, from 200:1 to 1700:1, from 200:1 to 1600:1, from 200:1 to 1500:1, from 300:1 to 1900:1, from 300:1 to 1800:1, from 300:1 to 1700:1, from 300:1 to 1600:1, or from 300:1 to 1500:1, etc.) for an incident angle between 0 and 60 degrees.

In some embodiments, a circular reflective polarizer is fabricated by obtaining molecules having biaxial anisotropy and arranging the molecules in a layer by self-assembly such that the molecules form helical patterns. In some embodiments, the method includes adding one or more chiral dopants to the molecules to assist in arranging the molecules in the helical patterns. In some embodiments, the molecules include molecules having biaxial shapes. In some embodiments, the molecules having biaxial shapes include board-shaped (e.g., parallelepiped platelets, such as a rectangular prism with a length, a width, and a thickness that are different from one another) or bent-shaped (e.g., V-shaped or J-shaped) biaxial molecules. In some embodiments, the molecules include multipod substructures (e.g., multipods having a rod shape forming a symmetric or asymmetric polymer network).

In some embodiments, the molecules include a mixture of molecules (or other substructures) having a first shape and molecules (or other substructures) having a second shape different from the first shape. The first shape and the second shape define uniaxial anisotropies in different directions such that a mixture of the molecules having the first shape and the molecules having the second shape has a biaxial anisotropy. In some embodiments, the molecules are liquid crystal molecules. In some embodiments, the first shape corresponds to a rod shape and the second shape corresponds to a disc shape (or a spherical shape). In some embodiments, the molecules include a mixture of liquid crystal molecules having a first shape (e.g., the rod shape) and nanocrystal particles having a second shape (e.g., a different rod shape).

In some embodiments, a circular reflective polarizer is fabricated by a polymer post-stretching method. The stretching method includes obtaining a layer of molecules (e.g., cholesteric liquid crystals) arranged in helical patterns on a substrate. The layer extends along a first plane (e.g., x-y plane). The layer has a shape defined by three dimensions (e.g., a first dimension, a second dimension, and a third dimension that are orthogonal to one another, such as x-axis, y-axis, and z-axis directions). The CLCs have a uniaxial anisotropy and are arranged in helical patterns. In some embodiments, the method includes stretching or pulling the layer of helically arranged molecules for changing the shape of the layer (and accordingly, the arrangement of the molecules within the layer). The shape is changed such that a ratio among the first dimension, the second dimension, and the third dimension of the stretched layer of molecules is different from a ratio among the first dimension, the second dimension, and the third dimension of the original (non-stretched) layer of molecules. For example, the layer of molecules is stretched in the first dimension thereby increasing a length of the layer along the first dimension while a length along the second dimension and a length along the third dimension remain substantially constant (or the length along the second dimension and the length along the third dimension may decrease, depending the Poisson's ratio of the base material of the layer). By changing the ratio, the anisotropy of the molecules (or the local anisotropy of the helical arrangement of the molecules) is changed from the uniaxial anisotropy to a biaxial anisotropy. The molecules in the stretched layer of molecules thereby have a biaxial refractive index anisotropy. In some embodiments, the layer of molecules is compressed instead of being stretched or pulled. Compressing the layer of molecules changes the shape of the layer of molecules such that a ratio among the first dimension, the second dimension, and the third dimension of the pressed layer of molecules is different from the ratio among the first dimension, the second dimension, and the third dimension of the original layer of molecules. In some embodiments, compressing the layer of molecules permanently (or semi-permanently) changes the shape of the layer of molecules. In some embodiments, compressing the layer of molecules permanently (or semi-permanently) changes the shape of the layer of molecules temporarily (e.g., the layer of molecules returns to its original shape once the force for changing the layer of molecules is removed).

In some embodiments, a circular reflective polarizer is fabricated by periodic layering. In some embodiments, the circular reflective polarizer fabricated by periodic layering includes a plurality of layers of liquid crystals arranged in helical patterns with alternating positive uniaxial anisotropy in a first direction and negative uniaxial anisotropy in a second direction (e.g., +LC/−LC/+LC/−LC/ . . . ). A positive uniaxial anisotropy corresponds to a molecule having the extraordinary refractive index (nₑ) greater than the ordinary refractive index (nₒ). A negative uniaxial anisotropy corresponds to a molecule having the ordinary refractive index greater than the extraordinary refractive index. The alternating layers of liquid crystals having positive and negative uniaxial anisotropies form a circular reflective polarizer having a biaxial refractive index anisotropy as a combination of the first direction and the second direction. In some embodiments, the alternating layers of liquid crystals include liquid crystal molecules of different shapes. For example, a first layer may include liquid crystal molecules having a rod shape and a second layer may include liquid crystal molecules having a disc shape. In some embodiments, the first layer and the second layer have matching indices of refraction such that nₑ₊ of the first layer equals to nₒ₋ of the second layer, and nₒ₊ of the first layer equals to nₑ₋ of the second layer. In some embodiments, the method for fabricating the layered circular reflective polarizer includes forming a first layer of liquid crystal molecules on a substrate and polymerizing the first layer of liquid crystal molecules (e.g., the first layer having liquid crystal molecules with a positive uniaxial anisotropy). The method also includes forming a second layer of liquid crystal molecules on the polymerized first layer of liquid crystal molecules (e.g. the second layer having liquid crystal molecules with a negative uniaxial anisotropy). In some embodiments, the first layer and the second layer are different from each other. In some embodiments, the first layer forms a porous polymer and the second layer is at least partially immersed within the pores of the first layer. In some embodiments, a multilayered circular reflective polarizer includes a number of discrete layers ranging from 20 to 500. In some embodiments, the second layer is also polymerized. In some embodiments, the second layer remains unpolymerized (e.g., for switchable operations).

In some embodiments, each layer of a multilayer circular reflective polarizer includes liquid crystals in helical patterns that rotate continuously along a depth of the layer. In some embodiments, each layer includes liquid crystals oriented at a predetermined angle (e.g., at 0 degree, 30 degrees, 60 degrees, 90 degrees, 120 degrees, 150 degrees, 180 degrees, 210 degrees, 240 degrees, 270 degrees, 300 degrees, 330 degrees, etc.) on a plane parallel to the substrate (e.g., a surface of the liquid crystal layer). Such liquid crystal layers define discrete optical axes in a direction parallel with the substrate. In some embodiments, the liquid crystal layers defining the discrete optical axes provide a high polarization extinction ratio. In some embodiments, the polarization extinction ratio of a multilayer circular reflective polarizer ranges between 90:1 and 2500:1 and depends on a thickness, a refractive index, and a total number of layers (e.g., the refractive index ranges from 0.3 to 1, the thickness ranges from 2 micrometers to 15 micrometers, and the total number of layers ranges from 20 to 500).

In some embodiments, circular reflective polarizers are fabricated using three-dimensional (3D) patterning techniques. In some embodiments, the 3D patterning includes sequentially depositing a first material at a first location of a substrate and a second material at a second location of a substrate. The second location is different from the first location. In some embodiments, the first material and the second material are deposited at different locations to form a 3D matrix (e.g., the 3D matrix includes multiple layers, including a first layer and a second layer different from the first layer, where the first layer and the second layer have different distributions of the first material and the second material). In some embodiments, the first material has an extraordinary refractive index greater than an ordinary refractive index, and the second material has an ordinary refractive index less than an extraordinary refractive index. In some embodiments, the first material and the second material include liquid crystals forming helical patterns. In some embodiments, the helical patterns have helical axes that are non-parallel and non-perpendicular to a plane defined by the circular reflective polarizer (e.g., the helical patterns are tilted with respect to the substrate and/or surface of the circular reflective polarizer).

In some embodiments, n_{z} of the molecules equals to n_{c} across the entire circular reflective polarizer. In some embodiments, n_{z} of the molecules equals to n_{c} only in one or more portions, less than all, of the circular reflective polarizer. In some embodiments, n_{z} of the molecules is between nₒ and nₑ. In some embodiments, n_{z} of the molecules gradually changes from nₒ or nₑ along a direction perpendicular to a plane defined by the circular reflective polarizer. In some embodiments, n_{z} of the molecules gradually changes from nₒ or nₑ along the plane defined by the circular reflective polarizer. In some embodiments, n_{z} of the molecules gradually changes from nₒ or nₑ in a direction that is non-parallel with and non-perpendicular to the plane defined by the circular reflective polarizer.

In some embodiments, the present disclosure provides a method for fabricating a circular reflective polarizer. The method includes obtaining a layer of molecules extending along a first plane. The molecules have a uniaxial anisotropy, the molecules are arranged in a plurality of helical patterns. The layer is defined by a first dimension, a second dimension, and a third dimension that are orthogonal to one another. The method also includes changing a shape of the layer of molecules such that a ratio among a first dimension, a second dimension, and a third dimension of the changed layer of molecules, orthogonal to one another, is different from a ratio among the first dimension, the second dimension, and the third dimension of the layer of molecules. The molecules in the changed layer of molecules have a local biaxial refractive index anisotropy. In some embodiments, changing the shape of the layer of molecules includes pulling the layer of molecules to increase one or more of the first dimension, the second dimensions, or the third dimension. In some embodiments, changing the shape of the layer of molecules includes compressing the layer of molecules to decrease one or more of the first dimension, the second dimension, or the third dimension. In some embodiments, the molecules in the layer of molecules have a first ordinary refractive index and a first extraordinary refractive index that is different from the first ordinary refractive index; the molecules in the changed layer of molecules have a second ordinary refractive index and a second extraordinary refractive index that is different from the second ordinary refractive index; the molecules in the layer of molecules have a refractive index along an axis perpendicular to the first plane corresponding to the first ordinary refractive index; and the molecules in the changed layer of molecules have a refractive index along the axis perpendicular to the first plane, the refractive index along the axis being determined based on the second ordinary refractive index and the second extraordinary refractive index. In some embodiments, the first extraordinary refractive index is different from the second extraordinary refractive index. In some embodiments, wherein the first ordinary refractive index is different from the second ordinary refractive index.

In some embodiments, the present disclosure provides a method for fabricating a circular reflective polarizer. The method includes obtaining molecules having biaxial anisotropy; and arranging the molecules having biaxial anisotropy in a layer by self-assembly such that the molecules are arranged in helical patterns. The layer reflects a light having a first circular polarization and transmits a light having a second circular polarization orthogonal to the first circular polarization. In some embodiments, arranging the molecules having biaxial anisotropy includes adding one or more chiral dopants to the molecules having biaxial anisotropy for arranging the molecules having biaxial anisotropy in helical patterns. In some embodiments, the molecules having biaxial anisotropy includes liquid crystal molecules having parallelepiped platelets shapes. In some embodiments, the molecules having biaxial anisotropy includes liquid crystal molecules having bent shapes. In some embodiments, the molecules having biaxial anisotropy include multipod substructures. In some embodiments, the molecules having biaxial anisotropy include a mixture of first molecules having a first shape and second molecules having a second shape different from the first shape. In some embodiments, the molecules having biaxial anisotropy include a mixture of liquid crystal molecules having a rod shape and nanocrystal particles.

In some embodiments, the present disclosure provides a method for fabricating a circular reflective polarizer. The method includes forming a first layer of liquid crystals on a substrate, the first layer of liquid crystals including a first plurality of liquid crystal molecules having a first shape defining a uniaxial refractive index anisotropy in a first direction; polymerizing the first layer of liquid crystals; and forming a second layer of liquid crystal on the polymerized first layer of liquid crystals, the second layer of liquid crystals including a second plurality of liquid crystal molecules having a second shape, different from the first shape, defining a uniaxial refractive index anisotropy in a second direction different from the first direction, thereby forming a film of biaxial anisotropic material having a biaxial refractive index anisotropy as a combination of the first direction and the second direction. In some embodiments, the first plurality of liquid crystal molecules have a rod shape and the second plurality of liquid crystals molecules have a disc shape. In some embodiments, the first plurality of liquid crystal molecules of the first layer of liquid crystals have a first extraordinary refractive index and a first ordinary refractive index, the first extraordinary refractive index being greater than the first ordinary refractive index; the second plurality of liquid crystals of the second layer of liquid crystals have a second extraordinary refractive index and a second ordinary refractive index, the second ordinary refractive index being greater than the second extraordinary refractive index. The first extraordinary refractive index corresponds to the second ordinary refractive index, and the first ordinary refractive index corresponds to the second extraordinary refractive index. In some embodiments, the first layer of liquid crystals is different from the second layer of liquid crystals. The method further includes: polymerizing the second layer of liquid crystals; forming a third layer of liquid crystals on the polymerized second layer of liquid crystals, the third layer of liquid crystals including a third plurality of liquid crystal molecules having the first shape defining the uniaxial refractive index anisotropy in the first direction; polymerizing the third layer of liquid crystals; forming a fourth layer of liquid crystals on the polymerized third layer of liquid crystals, the fourth layer of liquid crystals including a fourth plurality of liquid crystal molecules having the second shape defining the uniaxial refractive index anisotropy in the second direction; polymerizing the fourth layer of liquid crystals. In some embodiments, a total number of layers in the film of biaxial anisotropic material ranges from 20 to 500. In some embodiments, the polymerized first layer of liquid crystals is porous; the second layer of liquid crystals is at least partially immersed within the pores of the first layer of liquid crystals.

In some embodiments, the present disclosure provides a method for fabricating a circular reflective polarizer. The method includes sequentially depositing materials to form a circular reflective polarizer. In some embodiments, the method includes depositing a first material at a first location; and depositing a second material at a second location different from the first location. In some embodiments, the first material has a first rotation angle with respect to a plane defined by the circular reflective polarizer at the first location and the second material has a second rotation angle with respect to the plane defined by the circular reflective polarizer at the second location. In some embodiments, the first material has an extraordinary refractive index greater than an ordinary refractive index, and the second material has an ordinary refractive index less than an extraordinary refractive index. In some embodiments, the first material and the second material include liquid crystals forming helical patterns, the helical patterns having helical axes non-parallel and non-perpendicular to a plane defined by the circular reflective polarizer.

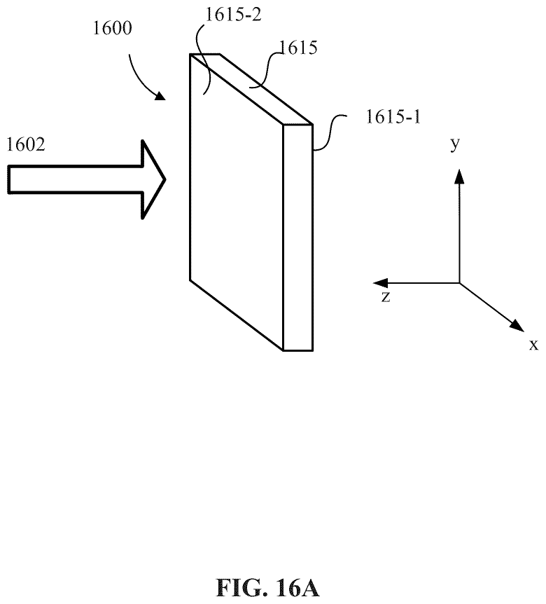

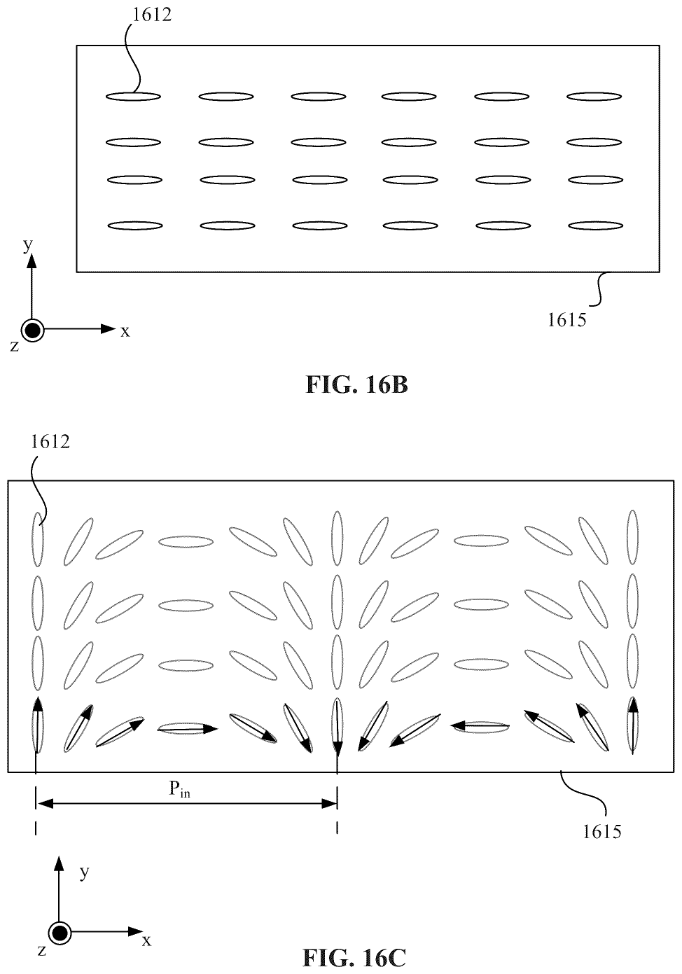

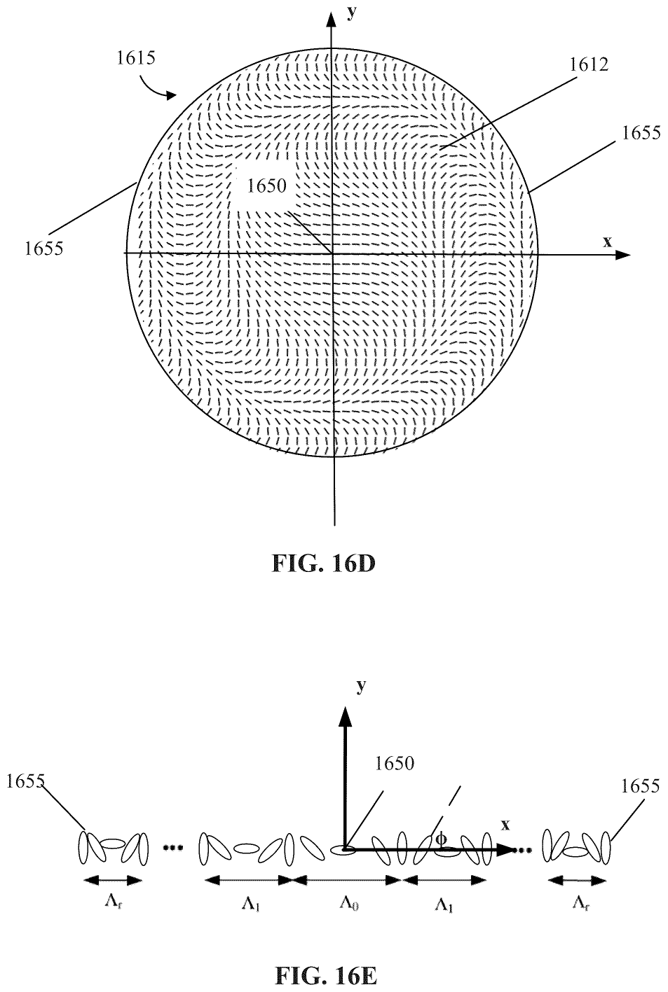

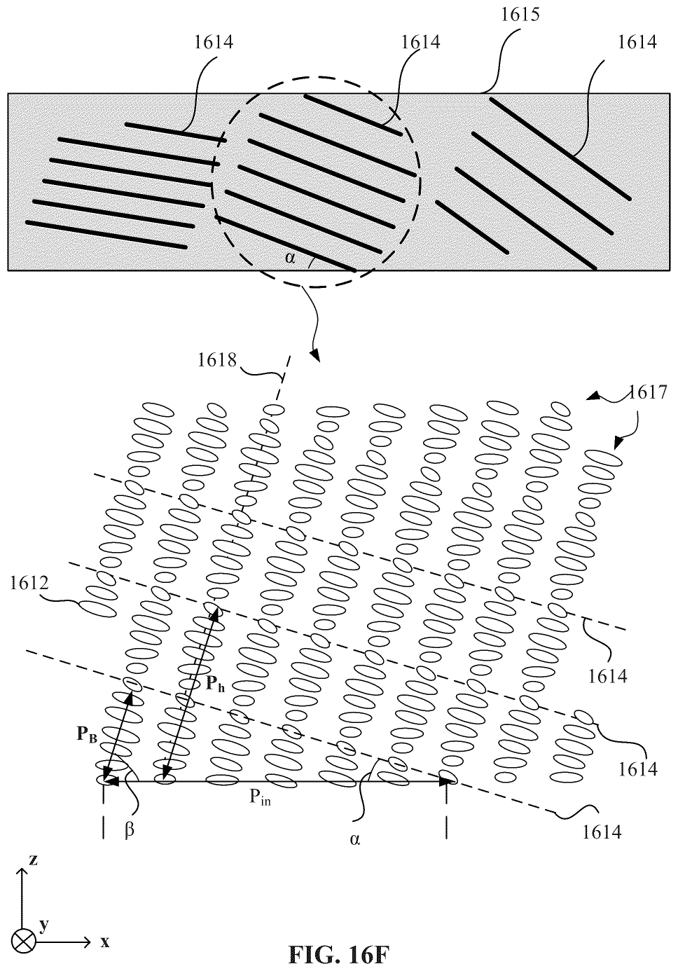

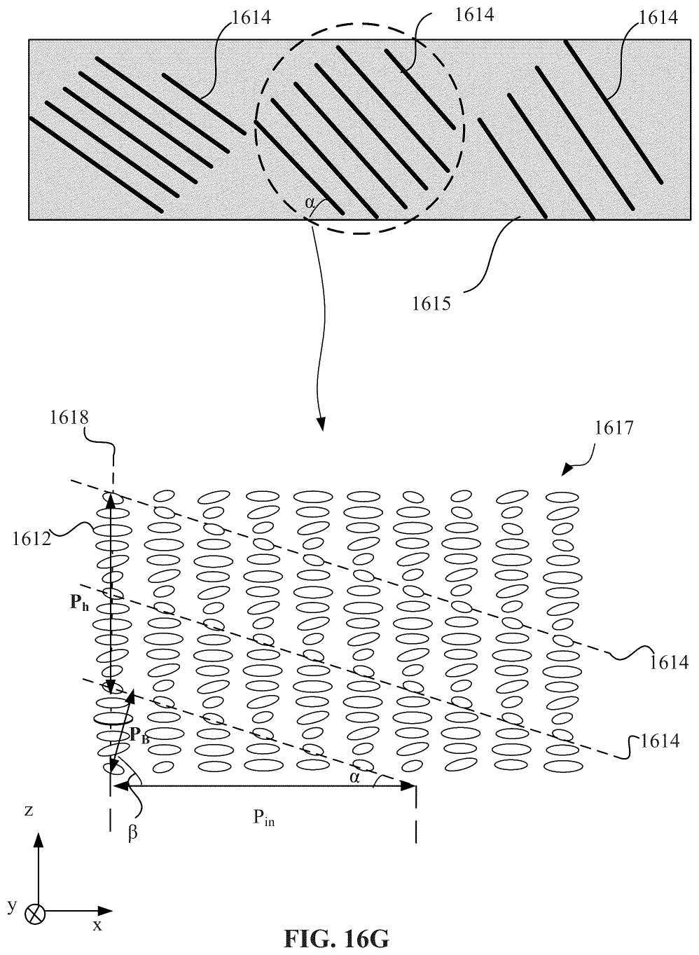

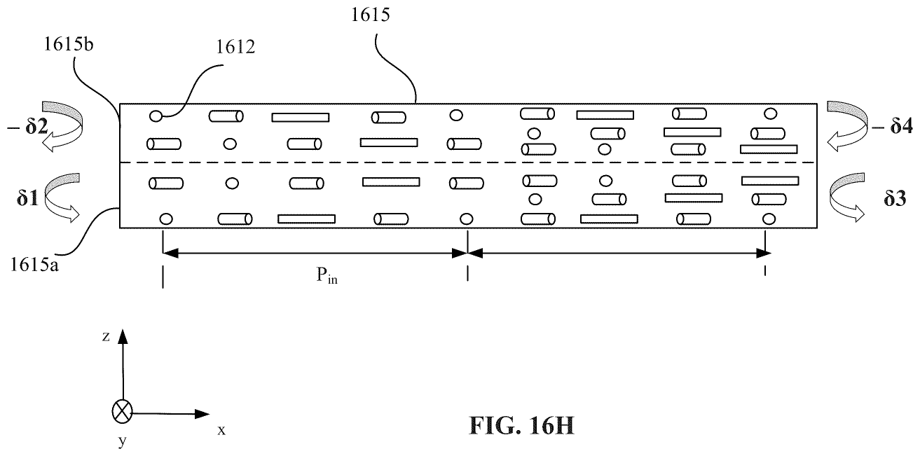

The present disclosure also provides methods for fabricating LCPH elements with varying slant angles or twist angles. LCPH elements with spatially varying slant angles or twist angles may provide an enhanced angular and achromatic performance compared to LCPH elements with a constant slant angle or twist angle. FIG. 16A illustrates a schematic three-dimensional (“3D”) view of an LCPH element 1600 with a light 1602 incident onto the LCPH element 1600 along a −z-axis, according to an embodiment of the present disclosure. The LCPH element 1600 may be configured with varying slant angles or twist angles. The LCPH element 1600 may include a birefringent medium layer (e.g., an LC layer) 1615 having a first surface 1615-1 on one side and a second surface 1615-2 on an opposite side. The first surface 1615-1 and the second surface 1615-2 may be surfaces along the light propagating path of the incident light 1602. Optically anisotropic molecules (e.g., LC molecules) in the birefringent medium layer 1615 may be configured with a 3D orientational pattern to provide a polarization selective optical response. In some embodiments, the orientation of an optic axis of the birefringent medium layer 1615 may be configured to spatially vary in at least one in-plane direction. In some embodiments, the orientation of the optic axis of the birefringent medium layer 1615 may also be configured to spatially vary in an out-of-plane direction. The term “optic axis” may refer to a direction in a crystal. A light propagating in the optic axis direction may not experience birefringence (or double refraction). An optic axis may be a direction rather than a single line: lights that are parallel to that direction may experience no birefringence. The local optic axis may refer to an optic axis within a predetermined region of a crystal.

FIGS. 16B-16E schematically illustrate x-y sectional views of a portion of the LCPH element 1600 shown in FIG. 16A, showing in-plane orientations of the optically anisotropic molecules 1612 in the LCPH element 1600, according to various embodiments of the present disclosure. For discussion purposes, rod-like LC molecules 1612 are used as examples of the optically anisotropic molecules 1612 of the birefringent medium layer 1615. The rod-like LC molecule 1612 may have a longitudinal direction (or a length direction) and a lateral direction (or a width direction). The longitudinal direction of the LC molecule 1612 may be referred to as a director of the LC molecule 1612 or an LC director. An orientation of the LC director may determine a local optic axis orientation or an orientation of the optic axis at a local point of the birefringent medium layer 1615.

For illustrative purposes, the LC molecules 1612 shown in FIGS. 16B-16E are presumed to be within a film plane of the birefringent medium layer 1615. The film plane may be parallel with at least one of the first surface 1615-1 or the second surface 1615-2 of the birefringent medium layer 1615. The film plane may be perpendicular to the thickness direction of the birefringent medium layer 1615. The in-plane orientation patterns of the LC directors shown in FIGS. 16B-16E are for illustrative purposes. The birefringent medium layer 1615 may have any suitable in-plane orientation patterns of the LC directors.

FIG. 16B schematically illustrates a uniform in-plane orientation pattern of the LC directors of the LC molecules 1612 within the film plane of the birefringent medium layer 1615. As shown in FIG. 16B, the directors of the LC molecule 1612 may have uniform or constant orientations within the film plane of the birefringent medium layer 1615, e.g., the LC molecule 1612 may be aligned in the x-axis direction.

In some embodiments, the LC molecules 1612 may be configured with a varying in-plane orientation pattern, in which the directors of the LC molecules may periodically or non-periodically vary in at least one in-plane direction along which the LC molecules 1612 are distributed. The in-plane direction may be an in-plane linear direction (e.g., an x-axis direction, a y-axis direction), an in-plane radial direction, an in-plane circumferential (e.g., azimuthal) direction, or a combination thereof. Accordingly, the optic axis of the birefringent medium layer 1615 may be configured with a spatially varying orientation in the at least one in-plane direction along which the molecules 1612 are distributed.

FIG. 16C schematically illustrates a periodically varying in-plane orientation pattern of the LC directors of the LC molecules 1612 within the film plane of the birefringent medium layer 1615. As shown in FIG. 16C, the directors of the LC molecules 1612 within the film plane of the birefringent medium layer 1615 may continuously rotate in a predetermined in-plane direction within the film plane, e.g., the x-axis direction, along which the LC molecules 1612 are distributed. The continuous rotation of the LC directors may form a periodic rotation pattern with a uniform (e.g., same) in-plane pitch Pᵢₙ. It is noted that the predetermined in-plane direction may be any other suitable direction within the film plane, such as the y-axis direction, the radial direction, or the circumferential direction within the x-y plane. The in-plane pitch (or horizontal pitch) Pᵢₙ may be defined as a distance along the predetermined in-plane direction (e.g., the x-axis) over which the orientations of the LC directors exhibit a rotation by a predetermined value (e.g., 180°). The periodically varying in-plane orientations of the LC directors shown in FIG. 16C may be referred to as a grating pattern.

FIG. 16D schematically illustrates a radially varying in-plane orientation pattern of the LC directors of the LC molecules 1612 within the film plane of the birefringent medium layer 1615. FIG. 16E illustrates a section of the in-plane orientation pattern taken along an x-axis in the birefringent medium layer 1615 shown in FIG. 16D. The radially varying in-plane orientation pattern of the LC directors shown in FIG. 16D may be referred to as a lens pattern. As shown in FIG. 16D, the LC directors of the LC molecules 1612 within the film plane may be configured with an in-plane orientation pattern having a varying pitch in at least two opposite in-plane directions from a lens pattern center 1650 to opposite lens pattern peripheries 1655. The orientations of the LC directors from the lens pattern center 1650 to the opposite lens pattern peripheries 1655 may exhibit a rotation in the same rotation direction (e.g., clockwise, or counter-clockwise). A pitch Λ of the radial in-plane orientation pattern may be defined as a distance in the radial in-plane direction over which the orientations of the LC directors, or azimuthal angles ϕ of the LC molecules 1612, change by a predetermined angle (e.g., 180°) from a predetermined initial state.

As shown in FIG. 16E, according to the LC director field along the x-axis direction, the pitch Λ may be a function of the distance from the lens pattern center 1650. The pitch Λ may monotonically decrease from the lens pattern center 1650 to the lens pattern peripheries 1655 in the at least two opposite in-plane directions (e.g., two opposite radial directions) in the x-y plane, e.g., Λ₀>Λ₁> . . . >Λᵣ. Λ₀ is the pitch at a central region of the lens pattern, which may be the largest. The pitch Λᵣ is the pitch at a periphery region (e.g., periphery 1655) of the lens pattern, which may be the smallest. In some embodiments, the azimuthal angle ϕ of the LC molecule 1612 may change in proportional to the distance from the lens pattern center 1650 to a local point of the birefringent medium layer 1615.

FIGS. 16F-16I schematically illustrate x-z sectional views of a portion of the LCPH element 1600, showing out-of-plane orientations of the LC directors of the LC molecules 1612 in a portion of the LCPH element 1600, according to various embodiments of the present disclosure. For discussion purposes, FIGS. 16F-16H schematically illustrate out-of-plane orientations of the LC directors of the LC molecules 1612 configured with the periodic in-plane orientation pattern shown in FIG. 16C. FIG. 16I schematically illustrates out-of-plane orientations of the LC directors of the LC molecules 1612 configured with the uniform in-plane orientation pattern shown in FIG. 16B.

FIG. 16F shows Bragg planes having different tilt angles at different portions of the birefringent medium layer 1615, and an enlarged view of a central portion showing the out-of-plane orientations of the LC directors of the LC molecules 1612. As shown in FIG. 16F, within a volume of the birefringent medium layer 1615, the LC molecules 1612 may form a series of Bragg planes 1614 represented by solid black lines. In different portions of the birefringent medium layer 1615, the Bragg planes 1614 may have different orientations (or tilt angles) with respect to the first surface 1615-1 and/or the second surface 1615-2 of the birefringent medium layer 1615. For discussion purposes, FIG. 16F shows that the orientation (or tilt angle) variation of the Bragg planes 1614 is in the x-axis direction. In some embodiments, the orientation (or tilt angle) variation of the Bragg planes 1614 may be in two or more in-plane directions within the film plane and/or the thickness direction.

For example, as shown in FIG. 16F, the Bragg planes 1614 within a left portion of the LCPH element 1600 may have a relatively small tilt angle (e.g., a first tilt angle), the Bragg planes 1614 within a central portion of the LCPH element 1600 may have a medium tilt angle (e.g., a second tilt angle), and the Bragg planes 1614 within a right portion of the LCPH element 1600 may have a relatively large tilt angle (e.g., a third tilt angle). The Bragg planes 1614 are schematically indicated by inclined lines within the respective portions in this cross sectional view. The Bragg planes 1614 within each portion may have continuous planar shapes, titled with respect to the first surface 1615-1 and/or the second surface 1615-2. In some embodiments, due to the different tilt angles, the Bragg planes 1614 at neighboring portions of the birefringent medium layer 1615 may not be parallel. For example, the Bragg plane 1614 at the left portion may not be parallel with the Bragg plane 1614 at the center portion of the of the birefringent medium layer 1615, and the Bragg plane 1614 at the right portion may not be parallel with the Bragg plane 1614 at the center portion of the of the birefringent medium layer 1615. That is, due to the different tilt angles, the Bragg planes 1614 at different portions of the entire volume of the birefringent medium layer 1615 may not be parallel.

The enlarged view of the central portion in FIG. 16F shows out-of-plane orientations of the LC directors of the LC molecules 1612 in the central portion of the LCPH element 1600. The Bragg planes 1614 within the central portion of the LCPH element 1600 may have a constant tilt angle α. As shown in FIG. 16F, within a volume of the birefringent medium layer 1615, the LC molecules 1612 may be arranged in a plurality of helical structures 1617 with a plurality of helical axes 1618 and a helical pitch Pₕ along the helical axes. In the embodiment shown in FIG. 16F, the helical axes 1618 may be tilted with respect to the first surface 1615-1 and/or the second surface 1615-2 of the birefringent medium layer 1615 (or with respect to the thickness direction of the birefringent medium layer 1615).

The orientations of the LC directors of the LC molecules 1612 arranged along a single helical structure 1617 may continuously rotate around the helical axis 1618 in a predetermined rotation direction, e.g., clockwise direction or counter-clockwise direction. Accordingly, the helical structure 1617 may exhibit a handedness, e.g., a right handedness or a left handedness. The azimuthal angles of the LC molecules 1612 may exhibit a continuous periodic variation along the helical axis 1618. The helical pitch Pₕ may be defined as a distance along the helical axis 1618 over which the orientations of the LC directors exhibit a rotation around the helical axis 1618 by 360°, or the azimuthal angles of the LC molecules vary by 360°.

Further, the LC molecules 1612 having a same first orientation (e.g., same first tilt angle and same first azimuthal angle) may form a first series of slanted and parallel refractive index planes (i.e., a first series of Bragg planes) 1614 periodically distributed within the volume of the birefringent medium layer 1615. Although not labeled, the LC molecules 1612 with a same second orientation (e.g., same second tilt angle and same second azimuthal angle) different from the first orientation may form a second series of slanted and parallel refractive index planes (i.e., a second series of Bragg planes) periodically distributed within the volume of the birefringent medium layer 1615. Different series of slanted and parallel refractive index planes may be formed by the LC molecules 1612 having different orientations. In the same series of parallel and periodically distributed, slanted refractive index planes 1614, the LC molecules 1612 may have the same orientation and the refractive index may be the same. Different series of slanted refractive index planes may correspond to different refractive indices. When the number of the slanted refractive index planes (or the thickness of the birefringent medium layer) increases to a sufficient value, Bragg diffraction may be established according to the principles of volume gratings. A distance (or a period) between adjacent Bragg planes 1614 of the same series may be referred to as a Bragg period P_{B}. The Bragg period P_{B} shown in FIG. 16F may be half of the helical pitch Pₕ.

A slant angle β of the LCPH element 1600 (or the helical twist structures in the LCPH element 1600) may be defined as β=90°−α, where α=arcsin (P_{B}/Pᵢₙ). That is, the slant angle β of the LCPH element 1600 may be a complementary angle of the tilt angle α of the Bragg plane 1614. The slant angle β may be a function of a ratio between the Bragg period P_{B} and the horizontal in-plane pitch Pᵢₙ. For example, when the horizontal in-plane pitch Pᵢₙ is presumed to be constant across the LCPH element 1600, as the helical pitch Pₕ increases, the Bragg period P_{B} may increase. Thus, the tilt angle α of the Bragg plane 1614 may increase and, accordingly, the slant angle β of the LCPH element 1600 may decrease. As the helical pitch Pₕ decreases, the Bragg period P_{B} may decrease. Thus, the tilt angle α of the Bragg plane 1614 may decrease and, accordingly, the slant angle β of the LCPH element 1600 may increase. In some embodiments, the LCPH element 1600 having the out-of-plane orientations shown in the enlarged view in FIG. 16F may function as a reflective PVH element. reflective PVH element.

FIG. 16G shows Bragg planes having different tilt angles at different portions of the birefringent medium layer 1615, and an enlarged view of a central portion showing the out-of-plane orientations of the LC directors of the LC molecules 1612. In the embodiment shown in FIG. 16G, the helical axes 1618 may be substantially perpendicular to the first surface 1615-1 and/or the second surface 1615-2 of the birefringent medium layer 1615. In other words, the helical axes 1618 of the helical structures 1617 may be in a thickness direction (e.g., a z-axis direction) of the birefringent medium layer 1615. In the embodiment shown in FIG. 16G, the Bragg period P_{B} may be smaller than half of the helical pitch Pₕ. In some embodiments, the LCPH element 1600 having the out-of-plane orientations shown in FIG. 16G may function as a reflective PVH element.

In the embodiment shown in FIG. 16H, along the thickness direction of the birefringent medium layer 1615, the directors of the LC molecules 1612 may twist by a certain degree from the bottom to a predetermined height (e.g., half way) of the birefringent medium layer 1615, then twist from the predetermined height to the top. That is, along the thickness direction of the birefringent medium layer 1615, the directors of the LC molecules 1612 may twist in a first rotation direction (e.g., a clockwise direction or a counter-clockwise direction) from the bottom to the predetermined height (e.g., half way) of the birefringent medium layer 1615, then twist in a second, opposite rotation direction (e.g., a counter-clockwise direction or a clockwise direction) to the top. Accordingly, from the bottom to the predetermined height of the birefringent medium layer 1615, the rotation of the orientations of the LC directors along the thickness direction of the birefringent medium layer 1615 may exhibit a first handedness, e.g., a right handedness or a left handedness. In some embodiments, as shown in FIG. 16H, from the predetermined height to the top of the birefringent medium layer 1615, the rotation of the orientations of the LC directors along the thickness direction of the birefringent medium layer 1615 may exhibit a second, opposite handedness, e.g., a left handedness or a right handedness. In some embodiments, although not shown, from the predetermined height to the top of the birefringent medium layer 1615, the rotation of the orientations of the LC directors along the thickness direction of the birefringent medium layer 1615 may also exhibit the first handedness. In some embodiments, although not shown, from the predetermined height to the top of the birefringent medium layer 1615, the orientations of the LC directors along the thickness direction of the birefringent medium layer 1615 may be substantially the same, and may not exhibit a twist.

In the embodiment shown in FIG. 16H, Bragg planes may not present within the volume of the birefringent medium layer 1615. The LCPH element 1600 having the out-of-plane orientations shown in FIG. 16H may function as a PBP element. For discussion purposes, FIG. 16H shows that the variation of the twist angle is in the x-axis direction. For example, in the left portion of the birefringent medium layer 1615, the directors of the LC molecules 1612 may twist by a first twist angle +δ₁ from the bottom to a predetermined height of the birefringent medium layer 1615, then twist by a second twist angle −δ₂ from the predetermined height to the top of the birefringent medium layer 1615. The absolute values of the first twist angle and the second twist angle may be the same or may be different. In the right portion of the birefringent medium layer 1615, the directors of the LC molecules 1612 may twist by a third twist angle 83 from the bottom to the predetermined height of the birefringent medium layer 1615, then twist by a fourth twist angle −δ₄ from the predetermined height to the top of the birefringent medium layer 1615. The absolute values of the third twist angle and the fourth twist angle may be the same or may be different. The third twist angle may be different from the first twist angle, and the fourth twist angle may be different from the second twist angle. In some embodiments, the LCPH element 1600 shown in FIG. 16H may be fabricated by forming a first sub-layer 1615a, and forming a second sub-layer 1615b on the first sub-layer 1615a.

In some embodiments, the variation of the twist angle may be in one or more in-plane directions within the film plane and/or the thickness direction. For discussion purposes, FIG. 16H shows that twist angles in different portions of the of the birefringent medium layer 1615 (in which each portion corresponds to a single in-plane pitch Pᵢₙ in the x-axis direction) are different, while the twist angle in the same portion is constant. In some embodiments, the twist angle in a single portion corresponding to the single in-plane pitch in the x-axis direction may also vary.

FIG. 16I schematically illustrates Bragg planes having different Bragg periods at different portions of the birefringent medium layer 1615, and enlarged views of a central portion and a right portion, each showing the out-of-plane orientations of the LC directors of the LC molecules 1612 configured with the uniform in-plane orientation pattern shown in FIG. 16B. Within the volume of the birefringent medium layer 1615, the LC molecules 1612 may form a series of Bragg planes 1614 represented by solid black lines. The Bragg planes 1614 may be parallel with the first surface 1615-1 and/or the second surface 1615-2 of the birefringent medium layer 1615. In different portions of the birefringent medium layer 1615, the Bragg planes 1614 may have different Bragg periods. For discussion purposes, FIG. 16I shows that the variation of the Bragg period is in the x-axis direction. In some embodiments, the variation of the Bragg period may be in two or more in-plane directions within the film plane and/or the thickness direction.

For example, as shown in FIG. 16I, the Bragg planes 1614 within a left portion of the LCPH element 1600 may have a relatively small Bragg period, the Bragg planes 1614 within a central portion of the LCPH element 1600 may have a medium Bragg period, and the Bragg planes 1614 within a right portion of the LCPH element 1600 may have a relatively large Bragg period. The Bragg planes 1614 are schematically indicated by horizontal lines within the respective portions The Bragg planes 1614 within each portion may have continuous planar shapes, parallel with the first surface 1615-1 and/or the second surface 1615-2. In some embodiments, the Bragg planes 1614 at neighboring portions of the birefringent medium layer 1615 may not be parallel. For example, the Bragg planes 1614 at the left portion and the central portion of the birefringent medium layer 1615 may not be parallel, and the Bragg planes 1614 at the right portion and the central portion of the birefringent medium layer 1615 may not be parallel. That is, the Bragg planes 1614 in different portions of the entire volume of the birefringent medium layer 1615 may not be parallel.

The enlarged views in FIG. 16I also show out-of-plane orientations of the LC directors of the LC molecules 1612 in the central portion and the right portion of the LCPH element 1600. As shown in FIG. 16I, within the volume of the birefringent medium layer 1615, the LC molecules 1612 may be arranged in the helical structures 1617 with the helical axes 1618 and the helical pitch Pₕ along the helical axes. The helical axes 1618 may be substantially perpendicular to the first surface 1615-1 and/or the second surface 1615-2 of the birefringent medium layer 1615. The LCPH element 1600 having the out-of-plane orientations shown in FIG. 16I may function as a CLC element with varying helical pitch (or varying twist angle). The twist angle of the CLC element may be defined as an azimuthal angle variation of the LC molecules located along the helical axis per unit thickness over a single helical pitch Pₕ. In other words, the twist angle of the CLC element may be represented by an azimuthal angle varying rate of the LC molecules located along the helical axis over a single helical pitch Pₕ. As the helical pitch increases, the azimuthal angle variation of the LC molecules located along the helical axis per unit thickness may decrease, and the twist angle of the CLC element may decrease.

The present disclosure provides methods for fabricating LCPH elements with varying slant angles or twist angles, such as a PVH element with varying slant angle, a PBP elements with varying twist angle, or a CLC element with varying twist angle, etc. An LCPH element fabricated based on the disclosed methods may be in the form of an optical film having a predetermined slant angle or twist angle pattern (or profile). In some embodiments, the predetermined slant angle or twist angle pattern may include one or more predetermined slant angle or twist angle variations in one or more directions within a film plane and/or a predetermined slant angle or twist angle variation in a thickness direction of the optical film. A slant angle or twist angle variation refers to a variation in the slant angle or twist angle within a volume or body (including the surfaces) of the optical film. A slant angle or twist angle variation means that local slant angles or twist angles at different portions or points of the optical film are different. That is, the local slant angle or twist angle may vary from one portion to another within the volume or body (including the surfaces) of the optical film. For example, a local slant angle or twist angle may be 35° at one portion of the optical film, and 40° at another portion of the optical film.

When the optical film has a slant angle or twist angle variation in one direction within the film plane or in the thickness direction, the optical film is referred to as having a one-dimensional (“1D”) slant angle or twist angle variation. When the optical film has two slant angle or twist angle variations in two directions within the film plane, or in one direction within the film plane and in the thickness direction, the optical film is referred to as having a two-dimensional (“2D”) slant angle or twist angle variation. The slant angle or twist angle variations in the two directions may be different. When the optical film has two slant angle or twist angle variations in two directions (e.g., two perpendicular directions) within the film plane and a slant angle or twist angle variation in the thickness direction, the optical film is referred to as having a three-dimensional (“3D”) slant angle or twist angle variation. The two slant angle or twist angle variations in the two directions within the film plane may be the same, similar, or different. The slant angle or twist angle in the thickness direction may be different from the two slant angle or twist angle variations within the film plane.

The disclosed fabrication methods may be used to fabricate LCPH elements having a 1D, 2D, or 3D slant angle variation or twist angle variation(s). The disclosed methods may include non-contact methods configured to introduce a 1D, 2D, or 3D helical twisting power variation in the LCPH element. The 1D, 2D, or 3D helical twisting power variation in LCPHs may result in a 1D, 2D, or 3D helical pitch variation in LCPHs which, in turn, may result in the 1D, 2D, or 3D slant angle variation or twist angle variation in LCPHs. The LCPHs fabricated by the disclosed methods may provide a specific optical response, such as a spatially varying optical response that is specifically designed or controlled. Conventional LCPHs with thickness variations may also provide a spatially varying optical response. However, as compared with conventional LCPHs with thickness variations, LCPHs fabricated by the disclosed methods may provide complex optical functions while maintaining a small form factor, compactness and light weight. The disclosed fabrication methods may provide robust processes for mass production of LCPHs having spatially varying slant angles or twist angles with compactness and enhanced optical performance. In some embodiments, the disclosed methods for introducing the varying slant angles or twist angles may fabricate an LCPH with a uniform thickness. In some embodiments, the disclosed methods for introducing the varying slant angles or twist angles may be compatible with a thickness variation of an LCPH, thereby further enhancing an optical performance of the LCPH.

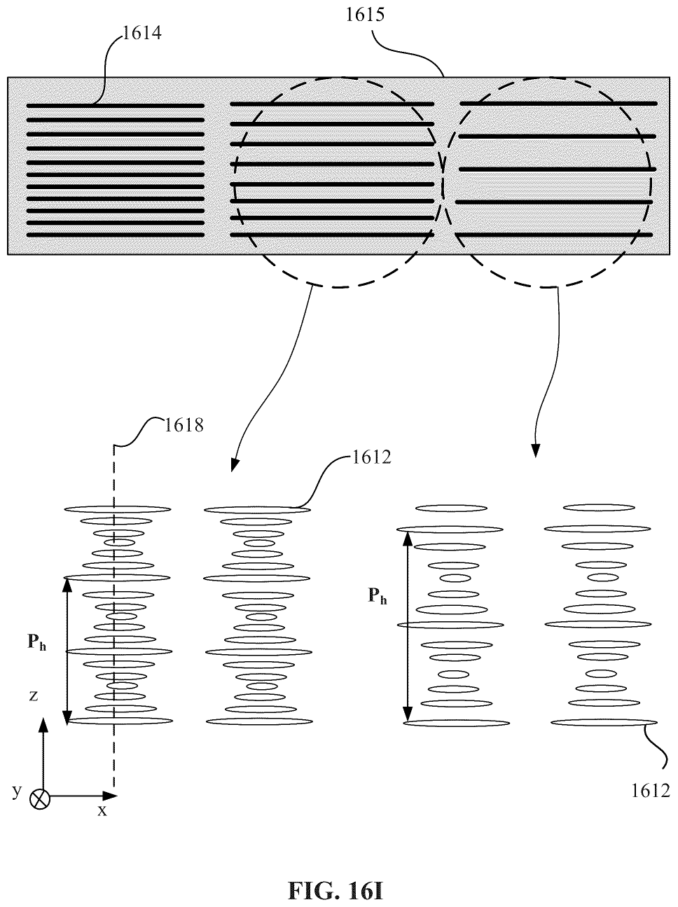

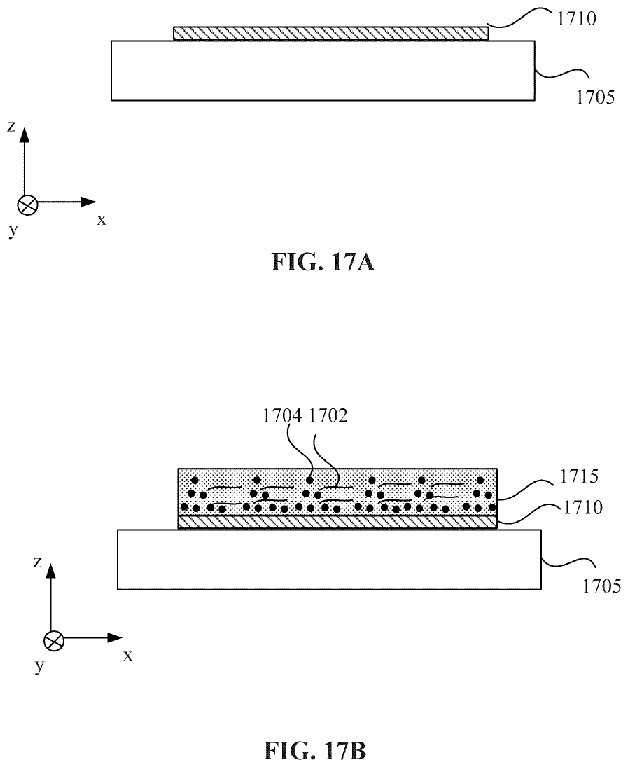

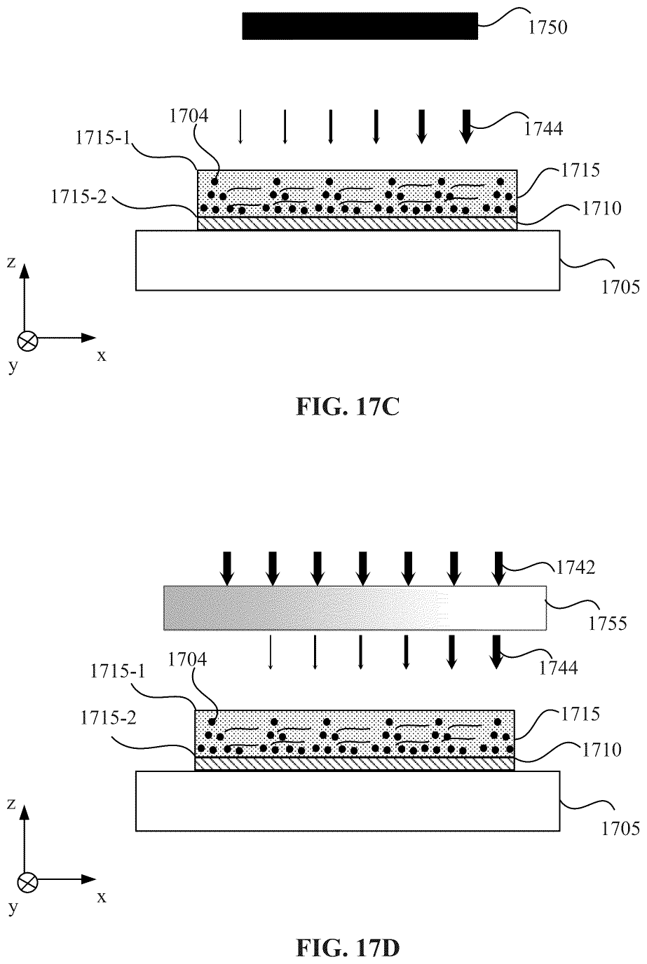

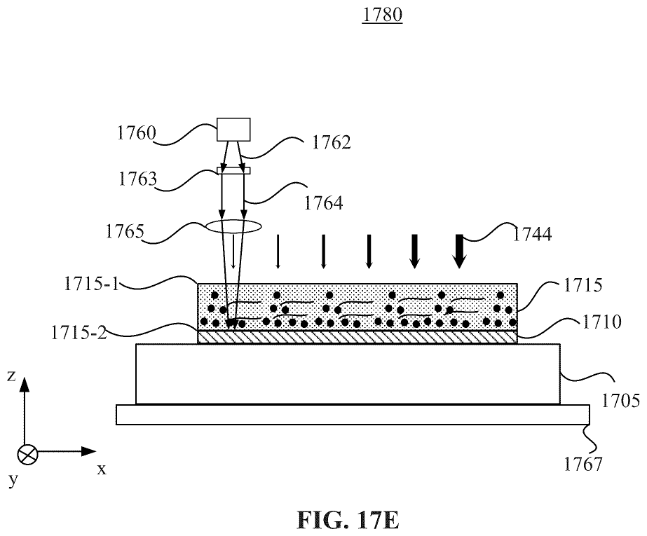

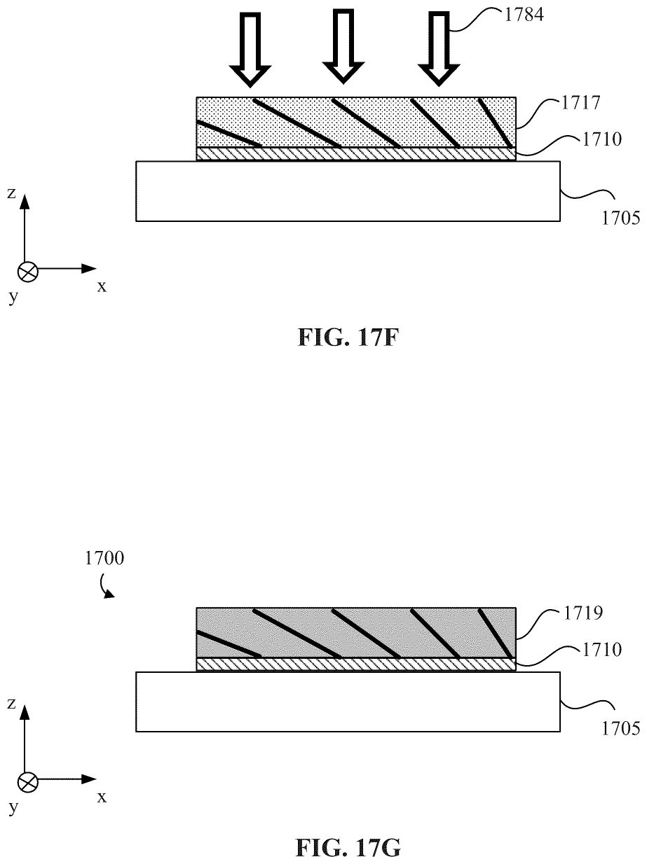

FIGS. 17A-17F schematically illustrate processes for fabricating an LCPH element with varying slant angle or twist angle (or for slant angle or twist angle patterning), according to various embodiments of the present disclosure. FIG. 17G schematically illustrates an LCPH element 1700 fabricated based on one or more processes shown in FIGS. 17A-17F. FIG. 17A shows a process of the fabrication method. As shown in FIG. 17A, an alignment structure 1710 may be formed on a surface (e.g., a top surface) of a substrate 1705. The substrate 1705 may provide support and protection to various layers, films, and/or structures formed thereon. The substrate 1705 may include a suitable material, such as silicon, glass, plastic, sapphire, or polymer, etc. The substrate 1705 may be rigid, semi-rigid, flexible, or semi-flexible. In some embodiments, the substrate 1705 may include an optical coating (e.g., an anti-reflection coating) disposed at one side of the substrate 1705, or two optical coatings (e.g., anti-reflection coatings) disposed at two sides of the substrate 1705. The substrate 1705 may include a flat surface or a curved surface, on which the different layers or films may be formed. In some embodiments, the substrate 1705 may be a part of another optical element or device (e.g., another opto-electrical element or device). For example, the substrate 1705 may be a solid optical lens, a part of a solid optical lens, or a light guide (or waveguide), etc.

The alignment structure 1710 may provide any suitable alignment pattern corresponding to a predetermined in-plane orientation pattern, such as an in-plane orientation pattern with uniform orientations, periodic or non-periodic linear orientations, periodic or non-periodic radial orientations, periodic or non-periodic azimuthal orientations, or a combination thereof, etc. The alignment structure 1710 may include any suitable alignment structure, such as a photo-alignment material (“PAM”) layer, a mechanically rubbed alignment layer, an alignment layer with anisotropic nanoimprint, an anisotropic relief, or a ferroelectric or ferromagnetic material layer, etc.

In some embodiments, the alignment structure 1710 may be a PAM layer, and the alignment pattern provided by the PAM layer may be formed via any suitable approach, such as holographic interference, laser direct writing, ink-jet printing, or various other forms of lithography. The PAM layer may include a polarization sensitive material (e.g., a photo-alignment material) that can have a photo-induced optical anisotropy when exposed to a polarized irradiation. The polarized irradiation may have a spatially uniform polarization (e.g., a linear polarization with a fixed polarization direction) or a spatially varying polarization (e.g., a linear polarization with a spatially varying polarization direction) in a predetermined space in which the polarization sensitive material (e.g., photo-alignment material) is disposed. As the PAM layer is substantially thin, the intensity of the polarized irradiation within the PAM layer is presumed to be uniform. Under the polarized irradiation, molecules (or fragments) and/or photo-products of the polarization sensitive material may be configured to generate an orientational ordering under the polarized irradiation. After being subjected to a sufficient exposure of the polarized irradiation, local alignment directions of the anisotropic photo-sensitive units may be induced in the polarization sensitive material, resulting in an alignment pattern (or in-plane modulation) of an optic axis of the polarization sensitive material.

FIG. 17B shows another process of the fabrication method subsequent to the process shown in FIG. 17A. As shown in FIG. 17B, after the alignment structure 1710 is formed on the substrate 1705, a birefringent medium layer 1715 may be formed on the alignment structure 1710. In some embodiments, the birefringent medium layer 1715 may include a mixture of a host birefringent material, a stimuli-responsive chiral dopant 1702, and a photo-initiator for polymerization. The helical twisting power (“HTP”) of the stimuli-responsive chiral dopant 1702 may be tunable in response to an external stimulus, such as a light, a heat, an electric field, or a magnetic field, etc. In some embodiments, the birefringent medium layer 1715 may also include other ingredients, such as an absorbing additive (or absorber) 1704, a non-stimuli-responsive chiral dopant, dyes, and/or a surfactant, etc. The non-stimuli-responsive chiral dopant may have a constant HTP that is not tunable by an external stimulus.

HTP (unit of μm⁻¹) of a chiral dopant (stimuli-responsive chiral dopant 1702 or non-stimuli-responsive chiral dopant) is the ability of the chiral dopant to twist a host birefringent material. The HTP of the chiral dopant may exhibit a handedness, e.g., right-handedness or left-handedness. The helical pitch Pₕ of helical twist structures formed in the host birefringent material may be determined by, in part, the HTP of the chiral dopant and the weight concentration (or molar fraction) of the chiral dopant in the host birefringent material. In some embodiments, the helical pitch Pₕ of the helical twist structures formed in the host birefringent material may be inversely proportional to the HTP of the chiral dopant, and inversely proportional to the weight concentration (or molar fraction) of the chiral dopant in the host material. That is, when the concentration of the chiral dopant is fixed, a greater HTP of the chiral dopant may lead to a shorter helical pitch Pₕ of the helical twist structures. When the HTP of the chiral dopant is fixed, a greater weight concentration (or molar fraction) of the chiral dopant in the host birefringent material may lead to a shorter helical pitch Pₕ of the helical twist structures. In some embodiments, the HTP of the stimuli-responsive chiral dopant 1702 may increase or decrease as the external stimulus changes. In some embodiments, the handedness of the HTP of the stimuli-responsive chiral dopant 1702 may be reversed as the external stimulus changes.

The host birefringent material may have an intrinsic birefringence, and may include optically anisotropic molecules. In some embodiments, the host birefringent material may include nematic LCs, twist-bend LCs, ferroelectric LCs, smectic LCs, etc., or any combination thereof. In some embodiments, the host birefringent material may not have an intrinsic or induced chirality. In some embodiments, the host birefringent material may have an intrinsic molecular chirality. For example, the host birefringent material may include chiral LC molecules, or molecules having one or more chiral functional groups.

In some embodiments, the host birefringent material may be photo-polymerizable, such as reactive mesogens (“RMs”), a polymer dispersed liquid crystal precursor mixture, a polymer stabilized liquid crystal precursor mixture, or a dye-doped liquid crystal mixture (e.g., a dye-doped polymer dispersed liquid crystal precursor mixture, or a dye-doped stabilized liquid crystal precursor mixture), etc. The polymer dispersed liquid crystal precursor mixture or polymer stabilized liquid crystal precursor mixture may be a mixture of RMs and LCs. The dye-doped liquid crystal mixture may be a mixture of RMs, LCs, and dyes.

RMs may also be referred to as a polymerizable mesogenic or liquid-crystalline compound, or polymerizable LCs. For discussion purposes, the term “liquid crystal molecules” or “LC molecules” may encompass both polymerizable LC molecules (e.g., RM molecules) and non-polymerizable LC molecules. For discussion purposes, in the following descriptions, RMs are used as an example of polymerizable birefringent materials, and RM molecules are used as an example of optically anisotropic molecules included in a polymerizable birefringent material. In some embodiments, polymerizable birefringent materials other than RMs may also be used.

The photo-initiator may be a compound that generates polymerization initiating species under a light (or light irradiation) of a suitable wavelength range, upon absorbing a light energy of the suitable wavelength range. The polymerization initiating species may react with the monomer double bonds in the polymerizable birefringent material, resulting in a polymerization of the birefringent material. The light irradiation used for polymerizing the birefringent material (or to which the photo-initiator is sensitive) may be referred to as polymerization irradiation. For example, in some embodiments, the photo-initiator may be sensitive to a UV irradiation. In some embodiments, an absorptive band of the photo-initiator may include the UV spectrum. The photo-initiator may absorb the UV light and generate the polymerization initiating species.

In some embodiments, the stimuli-responsive chiral dopant 1702 may include a photo-responsive chiral dopant (also referred to as 1702) with a photo-responsive HTP. The HTP of the photo-responsive chiral dopant 1702 may vary when the photo-responsive chiral dopant 1702 is exposed to a light irradiation of a suitable wavelength range, due to the photo-isomerization of the photo-responsive chiral dopant. The HTP of the photo-responsive chiral dopant 1702 may vary (e.g., increase, decrease, or reverse the handedness) as the degree of the photo-isomerization of the photo-responsive chiral dopant 1702 varies. In some embodiments, the photo-isomerization of the photo-responsive chiral dopant 1702 may be reversible.

The light irradiation used for varying the HTP of the photo-responsive chiral dopant 1702 (or to which the photo-responsive chiral dopant 1702 is sensitive) may be referred to as a stimulus irradiation. A suitable device may be used to generated the stimulus irradiation. The stimulus irradiation may be different from the polymerization irradiation. The stimulus irradiation may only activate the stimuli-responsive chiral dopant 1702 to change the HTP, and may not activate the photo-initiator to generate the polymerization initiating species. That is, the photo-initiator may not respond to the stimulus irradiation, and the stimulus irradiation may not cause the polymerization of the birefringent material. The polymerization irradiation may only activate the photo-initiator to generate the polymerization initiating species, and may not activate the stimuli-responsive chiral dopant 1702 to vary the HTP. That is, the stimuli-responsive chiral dopant 1702 may not respond to the polymerization irradiation, and the polymerization irradiation may not change the HTP of the stimuli-responsive chiral dopant 1702.

In some embodiments, the photo-responsive chiral dopant 1702 may undergo different degrees of photo-isomerization in response to different external light stimuli (or different stimulus irradiations), such as stimulus irradiations having different parameters. A variable parameter of the stimulus irradiation may include one of the light intensity, the wavelength, the time duration, and the dose (or amount). One or more parameters may be changed to generate different stimulus irradiations. The wavelength (or wavelength range) of the stimulus irradiation may be within (or correspond to) the UV wavelength range, the visible wavelength range, the infrared wavelength range, or a combination thereof, depending on different types of photo-responsive chiral dopants.

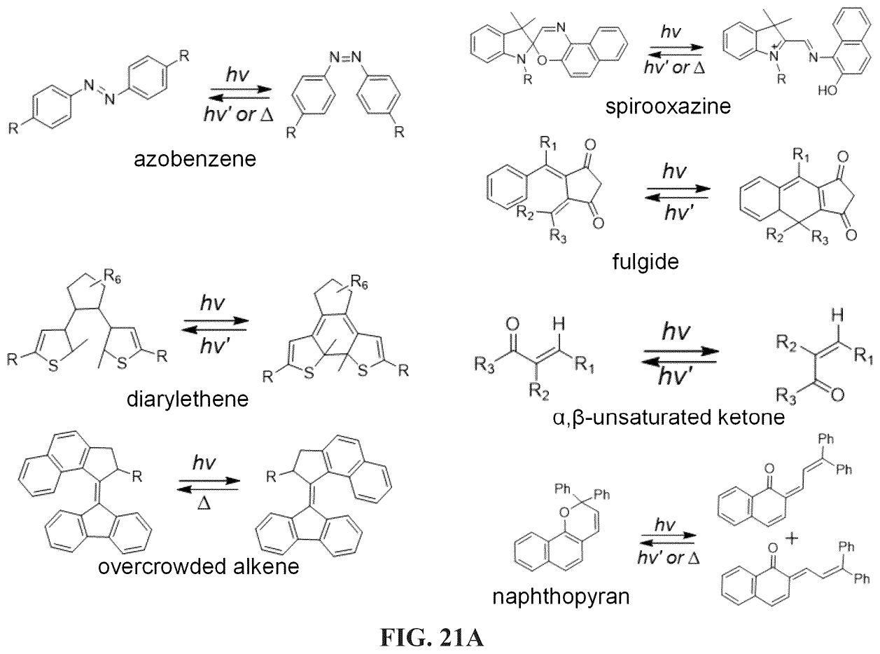

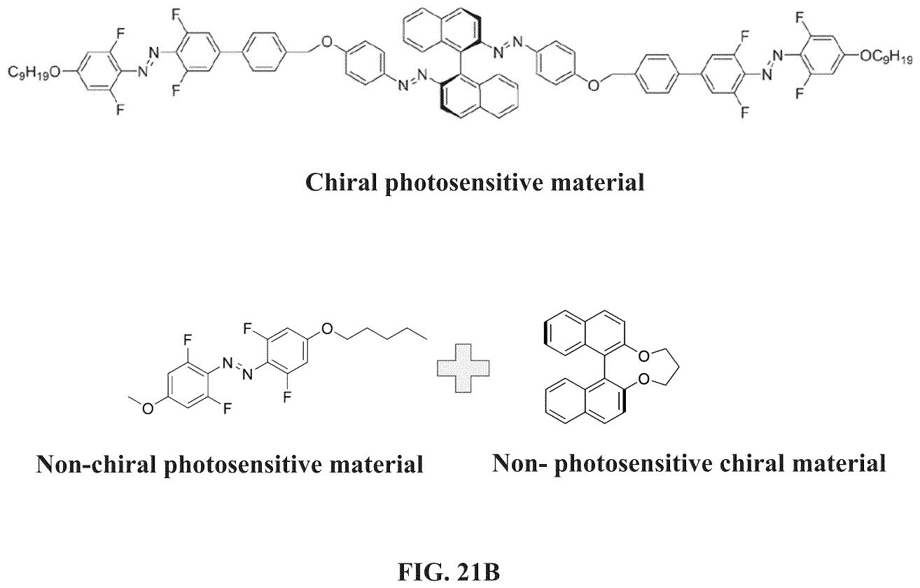

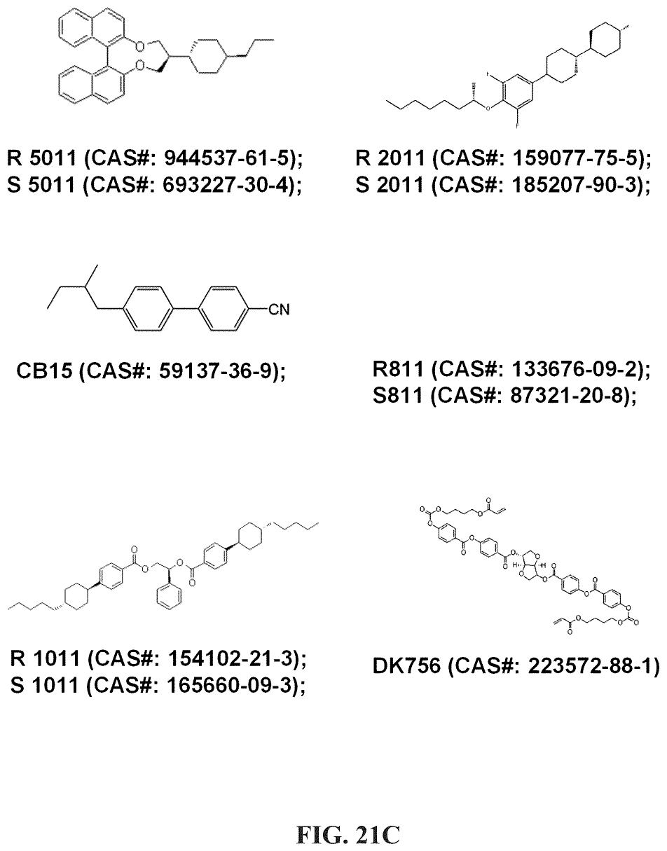

In some embodiments, the photo-responsive chiral dopant 1702 may include azobenzene, diarylethene overcrowded alkene, spirooxazine, fulgide, α,β-unsaturated ketone, naphthopyran, or a combination thereof. FIG. 21A illustrates the reversible photo-isomerization of molecular switches which may be included in the photo-responsive chiral dopant 1702. In FIG. 21A, hv denotes a stimulus irradiation “on” condition, and hv′ indicates a stimulus irradiation “off” condition, and Δ denotes a temperature change.

FIG. 21B illustrates chemical structures of materials of the photo-responsive chiral dopant 1702, according to various embodiments of the present disclosure. As shown in FIG. 21B, in some embodiments, the photo-responsive chiral dopant 1702 may include a chiral photosensitive material. The chiral photosensitive material may undergo different degrees of photo-isomerization in response to different stimulus irradiations. In some embodiments, the photo-responsive chiral dopant 1702 may include a mixture of a non-chiral photosensitive material and a non-photosensitive chiral material. The non-photosensitive chiral material may twist the optically anisotropic molecules in the host birefringent material to form helical twist structures. The non-chiral photosensitive material may undergo different degrees of photo-isomerization in response to different stimulus irradiations.

Referring back to FIG. 17B, in some embodiments, the absorbing additive 1704 may be configured to absorb the stimulus irradiation that activates the photo-responsive chiral dopant 1702. The absorbing additive 1704 may be different from the photo-initiator and the photo-responsive chiral dopant 1702. The absorbing additive 1704 may not chemically react with the birefringent material and the photo-responsive chiral dopant 1702. The absorbing additive 1704 added to the host birefringent material may be configured to provide a significant absorption capability for absorbing the stimulus irradiation in a controlled manner. In some embodiments, the absorbing additive 1704 may not absorb the polymerization irradiation. In some embodiments, the absorbing additive 1704 may include absorbing dyes.

In some embodiments, the absorbing additive 1704 may be configured to uniformly distribute within the birefringent medium layer 1715, at a predetermined concentration. In some embodiments, the absorbing additive 1704 may be non-uniformly distributed within the birefringent medium layer 1715. For example, the absorbing additive 1704 may be non-uniformly distributed along a thickness direction (e.g., the z-axis direction in FIG. 17B) of the birefringent medium layer 1715, and/or in one or more directions within a film plane (e.g., the x-y plane in FIG. 17B). The non-uniform distribution of the absorbing additive 1704 is also referred to as a concentration variation of the absorbing additive 1704. That is, different amounts of absorbing additive 1704 may be concentrated (or distributed) at different portions of the birefringent medium layer 1715.

In some embodiments, the respective ingredients of the birefringent medium layer 1715 may be dissolved in a solvent to form a solution. A suitable amount of the solution may be dispensed (e.g., coated, or sprayed, etc.) on the alignment structure 1710 to form the birefringent medium layer 1715. In some embodiments, the solution may be coated on the alignment structure 1710 using a suitable process, e.g., spin coating, slot coating, blade coating, spray coating, or jet (ink-jet) coating or printing. In some embodiments, the formed birefringent medium layer 1715 may be heated to remove the residual solvent. The alignment structure 1710 may provide a surface alignment to the optically anisotropic molecules that are in close proximity to (including in contact with) the alignment structure 1710, thereby aligning the optically anisotropic molecules that are in close proximity to (including in contact with) in the predetermined in-plane orientation pattern.

FIG. 17C shows another process of the fabrication method subsequent to the process shown in FIG. 17B. Referring to FIG. 17C, after the birefringent medium layer 1715 is formed on the alignment structure 1710, the birefringent medium layer 1715 may be exposed to a stimulus irradiation 1744. The stimulus irradiation 1744 may introduce a photo-isomerization degree variation of the photo-responsive chiral dopant 1702 within the birefringent medium layer 1715. In some embodiments, the photo-isomerization degree of the photo-responsive chiral dopant 1702 may depend on one or more parameters of the stimulus irradiation 1744, such as the intensity, the wavelength, the time duration, or the dose (amount), etc. The stimulus irradiation 1744 may have a UV wavelength range, a visible wavelength range, an IR wavelength range, or a combination thereof. Thus, through controlling a variation of at least one parameter of the stimulus irradiation 1744, different portions of the birefringent medium layer 1715 may be subject to different stimulus irradiations, and the photo-isomerization degree of the photo-responsive chiral dopant 1702 in the birefringent medium layer 1715 may be configured with a predetermined variation. Accordingly, a predetermined HTP variation of the photo-responsive chiral dopant 1702 may be achieved in the birefringent medium layer 1715 which, in turn, results in a predetermined helical pitch variation in the birefringent medium layer 1715. The predetermined helical pitch variation in the birefringent medium layer 1715 may result in a predetermined slant angle or twist angle variation of the helical twist structures in the birefringent medium layer 1715. That is, when the birefringent medium layer 1715 is exposed to the stimulus irradiation 1744 with the varying intensity, wavelength, dose, and/or time duration, the slant angle or twist angle may vary in the one or more directions within the film plane and/or in the thickness direction of the birefringent medium layer 1715.

In some embodiments, controlling the stimulus irradiation 1744 in the birefringent medium layer 1715 may include configuring the intensity, wavelength, dose, and/or time duration variation of the stimulus irradiation 1744 in one or more directions within the film plane (e.g., the x-y plane) of the birefringent medium layer 1715. The intensity, wavelength, dose, and/or time duration variation of the stimulus irradiation 1744 in one or more directions within the film plane (e.g., the x-y plane) of the birefringent medium layer 1715 may be configured via any suitable devices, e.g., a projector, a photomask, or a direct writing lithography device. In some embodiments, controlling the stimulus irradiation 1744 in the birefringent medium layer 1715 may also include configuring the intensity variation of the stimulus irradiation 1744 in the thickness direction (e.g., the z-axis direction) of the birefringent medium layer 1715. The intensity variation of the stimulus irradiation 1744 in the thickness direction (e.g., the z-axis direction) of the birefringent medium layer 1715 may be configured via controlling the distributed variation (or concentration variation) along the thickness direction (e.g., the z-axis direction in FIG. 17B) of the birefringent medium layer 1715.

For discussion purposes, FIGS. 17C and 17D illustrate the intensity variation of the stimulus irradiation 1744 (also referred to an exposure intensity variation or variation of exposure intensity) as an example. In some embodiments, when the intensity of the stimulus irradiation 1744 varies only in one direction within the film plane, or only in the thickness direction, a 1D slant angle or twist angle variation may be generated in the birefringent medium layer 1715. When the intensity of the stimulus irradiation 1744 varies in two directions within the film plane, or in one direction within the film plane and in the thickness direction, 2D slant angle or twist angle variations may be generated in the birefringent medium layer 1715. When the intensity of the stimulus irradiation 1744 varies in two directions within the film plane, and in the thickness direction, 3D slant angle or twist angle variations may be generated in the birefringent medium layer 1715. Thus, by controlling the intensity variation of the stimulus irradiation 1744 in the film plane (e.g., the x-y plane) and/or the thickness direction (e.g., the z-axis direction) of the birefringent medium layer 1715, a 1D, 2D, or 3D slant angle or twist angle variation(s) of the birefringent medium layer 1715 may be configured.

Referring to FIG. 17C, the stimulus irradiation 1744 may be configured with a predetermined 1D intensity variation or 2D intensity variations in one or two dimensions within the wavefront, which means that local intensities at different portions of the wavefront may be different. The stimulus irradiation 1744 shown in FIG. 17C is represented by arrows, in which the thinner arrow indicates a lower intensity, and the thicker arrow indicates a higher intensity. For discussion purposes, FIG. 17C shows that the stimulus irradiation 1744 has a planar wavefront configured with a predetermined 1D intensity variation along the x-axis direction, and the intensity of the stimulus irradiation 1744 increases in the +x-axis direction in a gradient manner. The gradient manner may be a linearly gradient manner, a non-linearly gradient manner, a stepped gradient manner, or a suitable combination thereof, etc. Thus, the exposure intensity within the film plane of the birefringent medium layer 1715 may increase in the +x-axis direction.

The stimulus irradiation 1744 with the predetermined 1D intensity variation or 2D intensity variations within the wavefront may be generated via any suitable devices, e.g., a projector, a photomask, or a direct writing lithography device. In some embodiments, as shown in FIG. 17C, the stimulus irradiation 1744 with the predetermined 1D intensity variation or 2D intensity variations may be generated via a projector 1750, such as a digital micromirror device (“DMD”) projector, or a spatial light modulator (“SLM”) projector, etc. The projector 1750 may be configured to project a computer-generated image onto the birefringent medium layer 1715. That is, the projector 1750 may emit an image light representing the computer-generated image onto the birefringent medium layer 1715. The image light representing the computer-generated image may be configured with any suitable 1D light intensity variation or 2D light intensity variations in one or two dimensions. The light intensity variation of the image light means that local intensities at different portions of the image light may be different. The image light may be configured with at least two different levels of intensities at two different portions of the image light (or image).

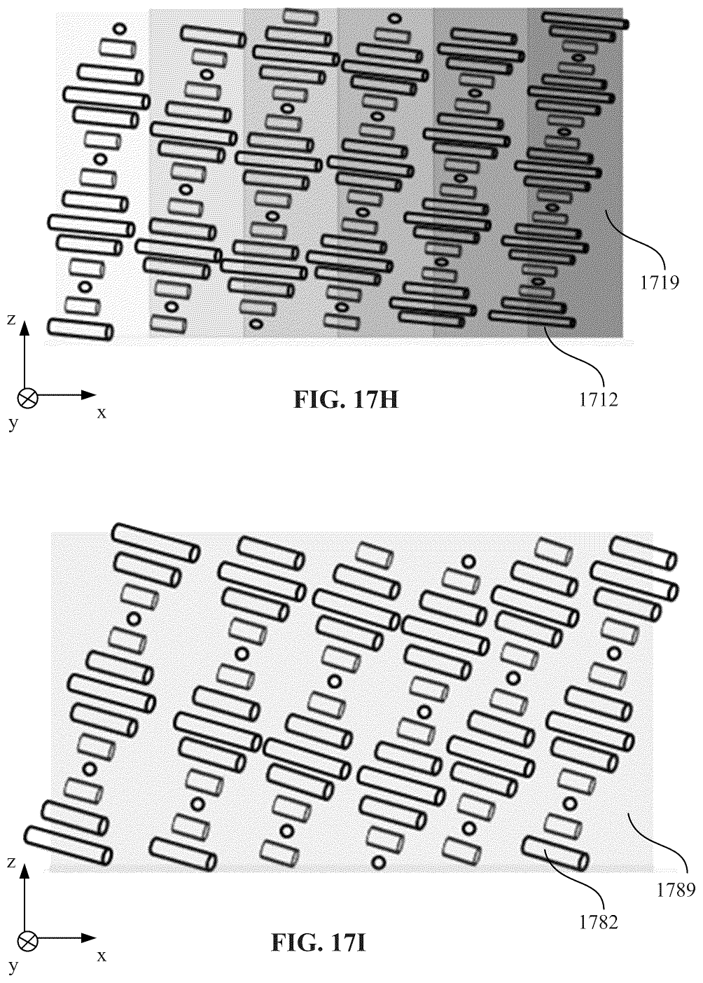

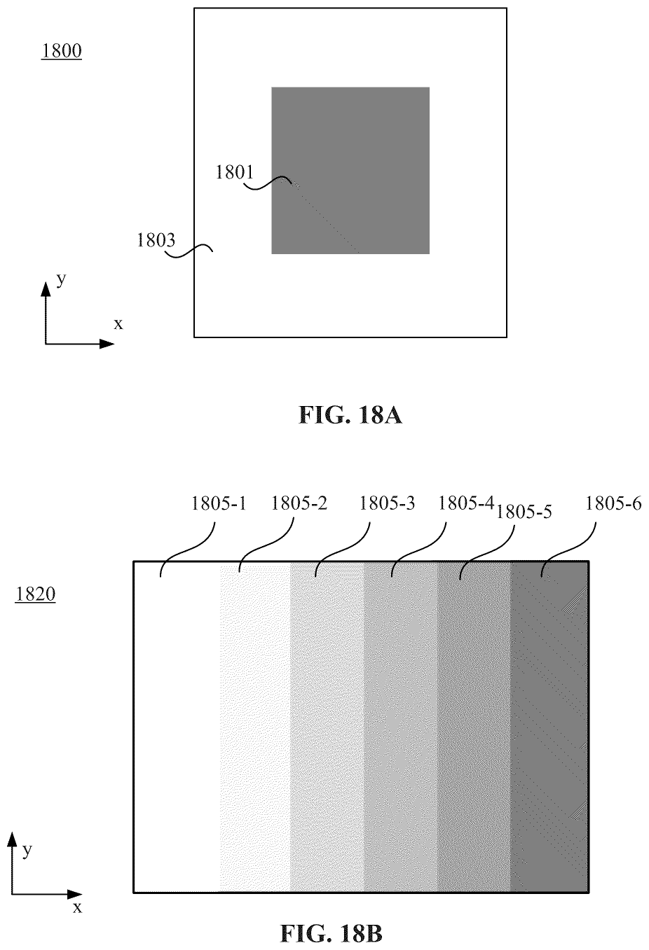

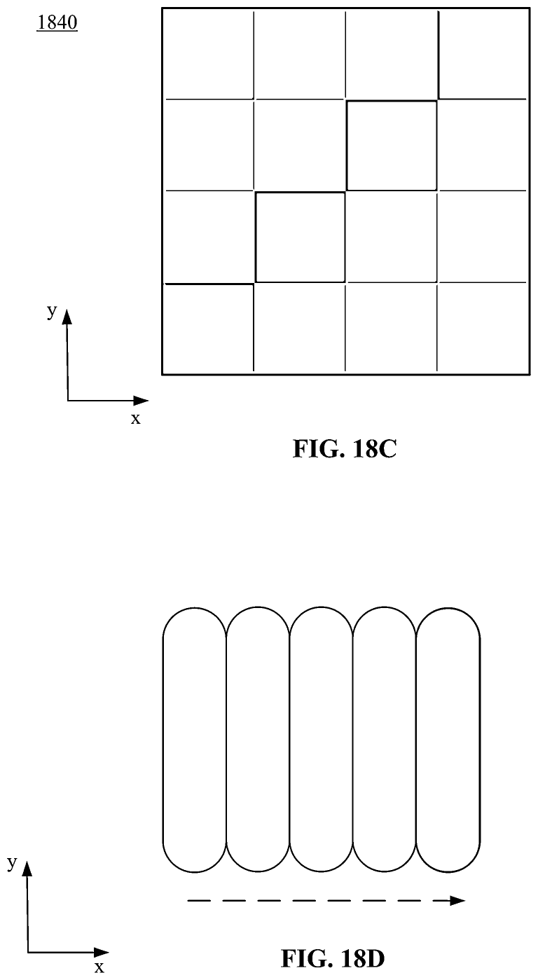

FIGS. 18A-18C illustrate x-y sectional views of computer-generated images projected by the projector 1750 onto the birefringent medium layer 1715, according to various embodiments of the present disclosure. In FIGS. 18A-18C, the intensity of the computer-generated image is represented by grey scales, in which the darker grey indicates a higher intensity, and the lighter grey indicates a lower intensity. In the embodiment shown in FIG. 18A, a computer-generated image 1800 may be configured with two levels of intensities. For example, the computer-generated image 1800 may have a central portion 1801 with a relatively high level of intensity, and a periphery portion 1803 with a relatively low level of intensity surrounding the central portion 1801.

In the embodiment shown in FIG. 18B, a computer-generated image 1820 may be configured with six levels of intensities. For example, the computer-generated image 1820 may include six portions 1805-1 to 1805-6 arranged in the x-axis direction, with the levels of intensities gradually increasing in the +x-axis direction. In the embodiment shown in FIG. 18C, a computer-generated image 1840 may be configured with four levels of intensities. For example, the computer-generated image 1840 may include sixteen portions arranged in a 4×4 array, with the levels of intensities gradually varying in both of the x-axis direction and y-axis direction.

Referring to FIG. 17D, in some embodiments, the stimulus irradiation 1744 with the predetermined 1D intensity variation or 2D intensity variations within the wavefront may be generated via a photomask 1755. The photomask 1755 may be configured with a predetermined transmittance variation for the wavelength spectrum of the stimulus irradiation 1742. The transmittance variation results in a light intensity variation of a stimulus irradiation 1744 output from the photomask 1755, to which the birefringent medium layer 1715 is exposed. For example, the photomask 1755 may have a predetermined 1D transmittance variation or 2D transmittance variations in one or two dimensions (or directions) within a film plane (e.g., the x-y plane shown in FIG. 17D) of the photomask 1755. The transmittance variation of the photomask 1755 means that local transmittances at different portions of the photomask 1755 may be different, which causes the different light intensities of the stimulus irradiation 1744 at different portions of the wavefront. For example, a light source (not shown, e.g., a projector) may generate a uniform stimulus irradiation 1742 onto the photomask 1755, and the photomask 1755 may transform the stimulus irradiation 1742 with a spatially uniform intensity across the wavefront, into the stimulus irradiation 1744 with the predetermined 1D intensity variation or 2D intensity variations across the wavefront.

In some embodiments, the photomask 1755 may be a binary half-tone photomask that uses two levels of grey tones, e.g., including optically opaque regions with a relatively low transmittance and optically transparent regions with a relatively high transmittance. In some embodiments, the photomask 1755 may be a grey-tone photomask that uses at least three levels of grey tones, providing at least three different levels of transmission, such as 0%, 175%, 50%, 75%, and 100%, etc. In FIG. 17D, the transmittance of the photomask 1755 is represented by grey scales, in which the darker grey indicates a lower transmittance, and the lighter grey indicates a higher transmittance. For discussion purposes, FIG. 17D shows that the transmittance of the photomask 1755 gradually increases in the +x-axis direction. Thus, the exposure intensity within the film plane of the birefringent medium layer 1715 may increase in the +x-axis direction.

FIG. 17E shows a direct writing system or device 1780 configured for fabricating an LCPH element with varying slant angle or twist angle (or for slant angle or twist angle patterning). In some embodiments, as shown in FIG. 17E, the stimulus irradiation 1744 with the predetermined 1D intensity variation or 2D intensity variations may be generated via direct writing lithography technology. The direct writing system 1780 may include a light source 1760 configured to output a light 1762, a light conditioning element 1763 configured to collimate the light 1762 received from the light source 1760 as a collimated light 1764, and a focusing lens 1765 configured to focus the collimated light 1764 into a small spot (e.g., a focal spot) or a small line (e.g., a focal line) at a focal plane thereof.

The direct writing system 1780 may also include a scanning stage 1767 on which the substrate 1705, the alignment structure 1710, and the birefringent medium layer 1715 is mounted. The direct writing system may also include a controller (not shown) communicatively coupled with the light source 1760 and the scanning stage 1767 to control the operations thereof. The controller may control the scanning stage 1767 to translate the substrate 1705 (on which the birefringent medium layer 1715 is disposed) in one or more directions (e.g., in the x-axis direction, y-axis direction) within the film plane of the birefringent medium layer 1715, thereby scanning the focal spot or the focal line in one or more two dimensions within the film plane of the birefringent medium layer 1715. The controller may control the light source 1760 to adjust the intensity of the output light 1762 in accordance with the scanning of the focal spot or the focal line within the film plane of the birefringent medium layer 1715. For example, the controller may control the intensity of the output light 1762 to vary over time in a predetermined intensity variation profile while controlling the scanning stage 1767 to translate the birefringent medium layer 1715 in a predetermined scanning profile (e.g., including the information of the scanning speed and the scanning path, etc.). The spatial resolution of the scanning (or the smallest scanning step) provided by the scanning stage 1767 may be equal to, less than, or greater than the width of small spot (e.g., focal spot) or the small line (e.g., focal line).

FIG. 18D illustrates an x-y sectional view of an intensity variation of the output light 1762 in accordance with a scanning of the focal line within the film plane of the birefringent medium layer 1715. In FIG. 18D, the intensity of the output light 1762 is represented by grey scales, in which the darker grey indicates a higher intensity, the lighter grey indicates a lower intensity, and the scanning direction is in the +x-axis direction (represented by a dashed arrow). For discussion purposes, FIG. 18D shows the scanning stage 1767 scans the focal line in the +x-axis direction with a spatial resolution equal to the width of the focal line, and the intensity of the output light 1762 increases by one level per scanning step.

Although not shown, in some embodiments, the scanning stage 1767 shown in FIG. 17E may also be configured to translate the substrate 1705 (on which the birefringent medium layer 1715 is disposed) in the thickness direction of the birefringent medium layer 1715, thereby scanning the focal spot or the focal line in the thickness direction of the birefringent medium layer 1715. Through varying the intensity of the output light 1762 over time according to a predetermined intensity variation profile while the scanning stage 1767 translates the birefringent medium layer 1715 in the thickness direction of the birefringent medium layer 1715, a predetermined exposure intensity variation in the thickness direction of the birefringent medium layer 1715 may be obtained.

Referring back to FIG. 17C, in some embodiments, the exposure intensity variation along the thickness direction of the birefringent medium layer 1715 may be generated through configuring an absorption variation of the stimulus irradiation 1744 along the thickness direction of the birefringent medium layer 1715. The absorption variation refers to the variation in the amount of the stimulus irradiation 1744 that is absorbed by the absorbing additive 1704. More absorption amount of the stimulus irradiation 1744 means a lower exposure intensity for the birefringent medium layer 1715, and less absorption amount of the stimulus irradiation 1744 means a higher exposure intensity for the birefringent medium layer 1715.

In some embodiments, the absorption variation of the stimulus irradiation 1744 along the thickness direction may be achieved through configuring the composition, the concentration, and/or the concentration variation of the absorbing additive 1704 along the thickness of the birefringent medium layer 1715. For example, in some embodiments, the absorbing additive 1704 may be configured with a non-uniform distribution along the thickness direction (e.g., z-axis direction) of the birefringent medium layer 1715. The non-uniform distribution may also be referred to as a non-uniform concentration, or a predetermined concentration variation. For discussion purposes, FIG. 17C and FIG. 17D show that along the thickness direction of the birefringent medium layer 1715 from the first surface 1715-1 to the second surface 1715-2, the concentration of the absorbing additive 1704 in the birefringent medium layer 1715 increases in the −z-axis direction. Thus, the amount of the stimulus irradiation 1744 being absorbed may increase in the −z-axis direction, and the intensity of the stimulus irradiation 1744 in the thickness direction of the birefringent medium layer 1715 for activating the photo-responsive chiral dopant 1702 may decrease in the −x-axis direction.

Thus, when the stimulus irradiation 1744 propagates inside the birefringent medium layer 1715 along the thickness direction thereof, the intensity of the stimulus irradiation 1744 may be configured to vary in a controlled manner according to a desirable intensity variation profile, pattern, or distribution, along the thickness direction from a light incidence surface (e.g., a first surface) 1715-1 to a light exiting surface (e.g., a second surface) 1715-2. For example, the intensity of the stimulus irradiation 1744 may be configured to vary in a predetermined gradient manner, such as a predetermined linearly gradient manner, a predetermined non-linearly gradient manner, a predetermined stepped gradient manner, or a suitable combination thereof. In some embodiments, by configuring the distribution of the absorbing additive 1704 in a suitable profile, the intensity of the stimulus irradiation 1744 may first increase in a predetermined gradient manner, then decrease in another predetermined gradient manner. After the process of photo-isomerization of the photo-responsive chiral dopant 1702 via the stimulus irradiation 1744, the slant angle or twist angle may vary in a predetermined gradient manner along the thickness direction from the first surface 1715-1 to the second surface 1715-2.

In some embodiments, although not shown, the stimulus irradiation 1744 may be configured with a uniform intensity within the wavefront, and the exposure intensity variation within the film plane of the birefringent medium layer 1715 may be generated through configuring an absorption variation of the stimulus irradiation 1744 within the film plane of the birefringent medium layer 1715. The absorbing additive 1704 may be configured with a predetermined non-uniform distribution (or concentration variation) in one or more directions with the film plane of the birefringent medium layer 1715. In some embodiments, although not shown, the absorbing additive 1704 may form a separate layer, rather than being doped into the birefringent medium layer 1715. The separate layer of the absorbing additive 1704 may be disposed at a surface of the birefringent medium layer 1715 facing the stimulus irradiation 1744. The absorbing additive 1704 may be configured with a predetermined non-uniform distribution (or concentration variation) in one or more directions with the film plane of the separate layer. Thus, the stimulus irradiation 1744 transmitted through the separate layer of the absorbing additive 1704 may have a predetermined non-uniform intensity variation.

The intensity variation of the stimulus irradiation 1744 within the birefringent medium layer 1715 is used as an example of the stimulus irradiation variation in illustrating and explaining the principles of introducing a slant angle or twist angle variation within the birefringent medium layer 1715. The principles may be applicable to introducing a slant angle or twist angle variation within the birefringent medium layer 1715 via a light intensity, wavelength, dose, and/or time duration variation of the stimulus irradiation 1744 within the birefringent medium layer 1715.

As shown in FIG. 17F, after the birefringent medium layer 1715 is exposed to the stimulus irradiation 1744, a predetermined slant angle or twist angle variation may be established in the birefringent medium layer 1715. For discussion purposes, FIG. 17E shows that a series of slanted Bragg planes (represented by solid black lines) are formed within the birefringent medium layer 1715, and the tilt angles of the slanted Bragg planes with respect to the surface of the birefringent medium layer 1715 increases along the +x-axis direction. Thus, the slant angle of the helical twist structures formed within the birefringent medium layer 1715 may decrease along the +x-axis direction. For discussion purposes, the birefringent medium layer 1715 having the established slant angle or twist angle variation is referred to as a birefringent medium layer 1717.

Referring to FIG. 17F and FIG. 17G, the birefringent medium layer 1717 may be exposed to a polymerization irradiation 1784 to form a polymerized birefringent medium layer 1719 (shown in FIG. 17G), thereby stabilizing the slant angle or twist angle variation. The polymerized birefringent medium layer 1719 may provide a spatially varying optical response according to the slant angle or twist angle variation. The polymerization irradiation 1784 may have a wavelength range within the absorption band of the photo-initiator, activating the photo-initiator to generate the polymerization initiating species. In some embodiments, the polymerization irradiation 1784 may be a UV irradiation. For example, as shown in FIG. 17F, the birefringent medium layer 1717 may be exposed to a UV light beam (also referred to as 1784 for discussion purposes). Under a sufficient exposure to the UV light beam 1784, the birefringent material (e.g., RM monomers) in the birefringent medium layer 1717 may be polymerized or crosslinked to stabilize the orientations of the optically anisotropic molecules, thereby stabilizing the slant angle or twist angle variation.

In some embodiments, the exposure of the birefringent medium layer 1717 under the polymerization irradiation 1784 may be carried out in air, in an inert atmosphere formed by, e.g., nitrogen, argon, carbon-dioxide, or in vacuum. The polymerization irradiation 1784 may be unpolarized or polarized (e.g., linearly polarized). The polarization of the polymerization irradiation 1784 may be spatially uniform in a predetermined space within which the birefringent medium layer 1717 is disposed. For example, the polymerization irradiation 1784 may be linearly polarized with a fixed polarization direction in the predetermined space.

FIG. 17G illustrates an x-z view of the LCPH element 1700 including the polymerized birefringent medium layer 1719. In some embodiments, the substrate 1705 and/or the alignment structure 1710 may be used to fabricate, store, or transport the fabricated LCPH element 1700. In some embodiments, the substrate 1705 and/or the alignment structure 1710 may be detachable or removable from the fabricated LCPH element 1700 after the LCPH element 1700 is fabricated or transported to another place or device. That is, the substrate 1705 and/or the alignment structure 1710 may be used in fabrication, transportation, and/or storage to support the LCPH element 1700 provided on the substrate 1705 and/or the alignment structure 1710, and may be separated or removed from the LCPH element 1700 when the fabrication of the LCPH element 1700 is completed, or when the LCPH element 1700 is to be implemented in an optical device. In some embodiments, the substrate 1705 and/or the alignment structure 1710 may not be separated from the LCPH element 1700.

FIG. 17H schematically illustrate an x-z view of the polymerized birefringent medium layer 1719, showing out-of-plane orientations of optically anisotropic molecules 1712 shown in FIG. 17G, according to an embodiment of the present disclosure. For discussion purposes, FIG. 17H shows that in the polymerized birefringent medium layer 1719, the helical pitch of the helical twist structures decreases in the +x-axis direction, and the tilt angle of the Bragg planes with respect to the surface of the polymerized birefringent medium layer 1719 decreases in the +x-axis direction. Thus, the slant angle of the helical twist structures may increase in the +x-axis direction.

In comparison, FIG. 17I schematically illustrates an x-z view of a conventional LCPH element with a constant slant angle, showing out-of-plane orientations of optically anisotropic molecules 1782. As shown in FIG. 17I, the helical pitch of the helical twist structures, the tilt angles of the Bragg planes with respect to the surface of the LCPH element 1789, and the slant angles of the helical twist structures are constant in the +x-axis direction.

In conventional technology, a conventional birefringent medium layer may not include the absorbing additive 1704. As the stimulus irradiation 1744 propagates inside the conventional birefringent medium layer that does not include the absorbing additive 1704 along the thickness direction, the intensity of the stimulus irradiation 1744 may naturally decrease due to beam attenuation by the birefringent medium layer through, e.g., absorption, reflection, and/or scattering, etc. When the ingredients of the birefringent medium layer are fixed, the attenuation coefficient of the birefringent medium layer may be constant. In addition, the attenuation coefficient of the birefringent medium layer may not change significantly when the concentrations of the birefringent material, chiral dopants, and the photo-initiator in the conventional birefringent medium layer vary. Thus, in conventional technology, the natural intensity variation of the stimulus irradiation 1744 along the thickness direction of the birefringent medium layer may not be controllable and adjustable. Accordingly, the HTP variation in the thickness direction of the birefringent medium layer of the birefringent medium layer may also be non-controllable and non-adjustable. Once the birefringent material is selected, the natural decay of the intensity of the stimulus irradiation 1744 in the thickness direction as the stimulus irradiation 1744 propagates therethrough cannot be conveniently controlled or adjusted. In some situations, in the thickness direction of the conventional birefringent medium layer, the intensity variation of the stimulus irradiation 1744 caused by the natural attenuation of the birefringent material may not be sufficiently large to cause a noticeable HTP variation in the thickness direction. That is, the HTP in the thickness direction of the birefringent medium layer may be deemed as constant or uniform.

Compared to the conventional processes, the disclosed processes shown in FIGS. 17A-17F according to embodiments of the present disclosure may provide more flexibility to control the slant angle or twist angle variation in one or more directions within the film plane and/or in the thickness direction of the polymerized birefringent medium layer 1719. In some embodiments, the disclosed processes shown in FIGS. 17A-17F may provide controllable 1D, 2D, or 3D birefringence patterning, and the polymerized birefringent medium layer 1719 fabricated based on the disclosed processes may have a predetermined 1D slant angle or twist angle variation, 2D slant angle or twist angle variations, or 3D slant angle or twist angle variations in one or more directions within the film plane and/or in the thickness direction.

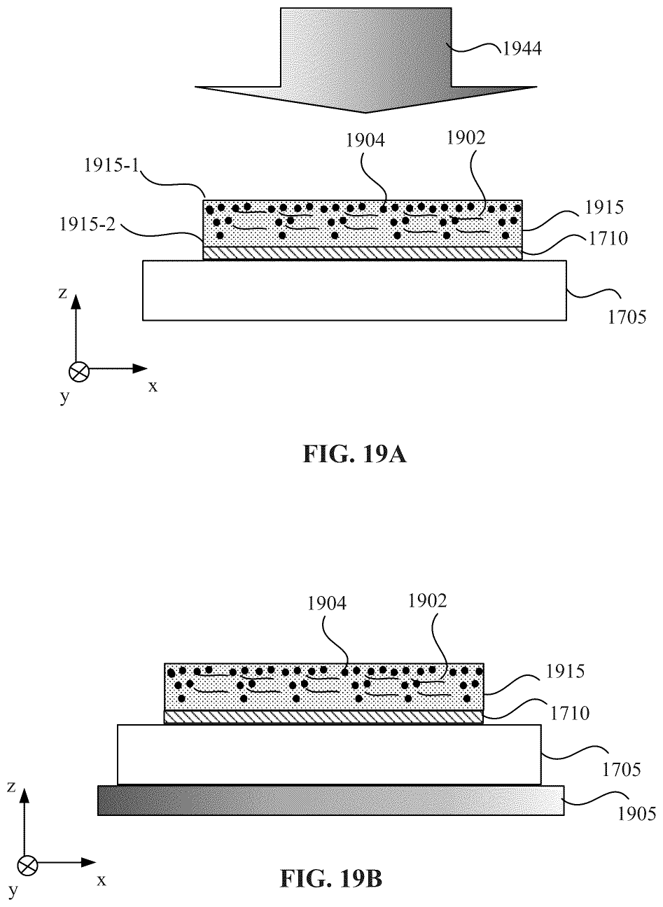

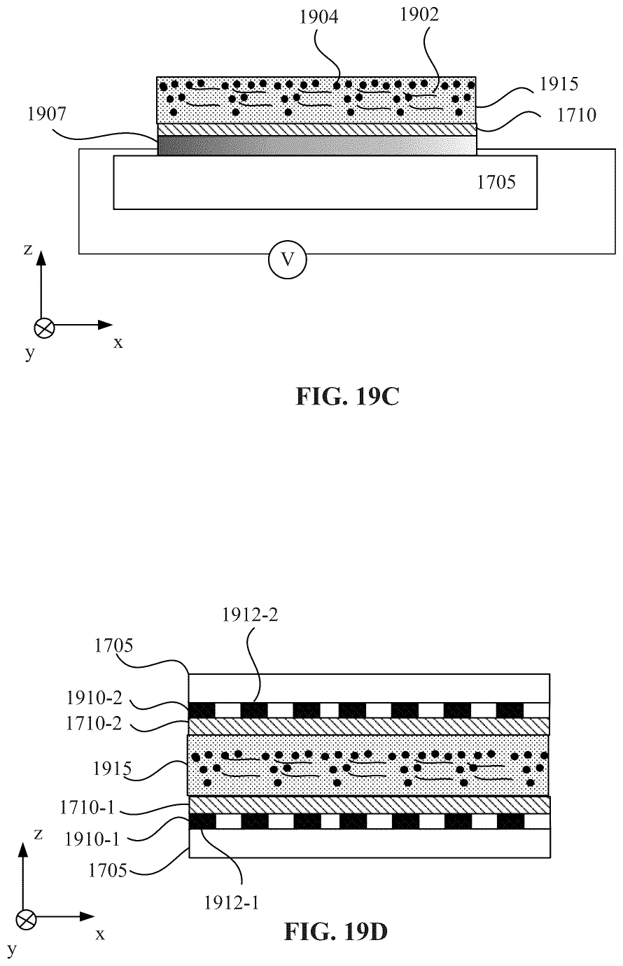

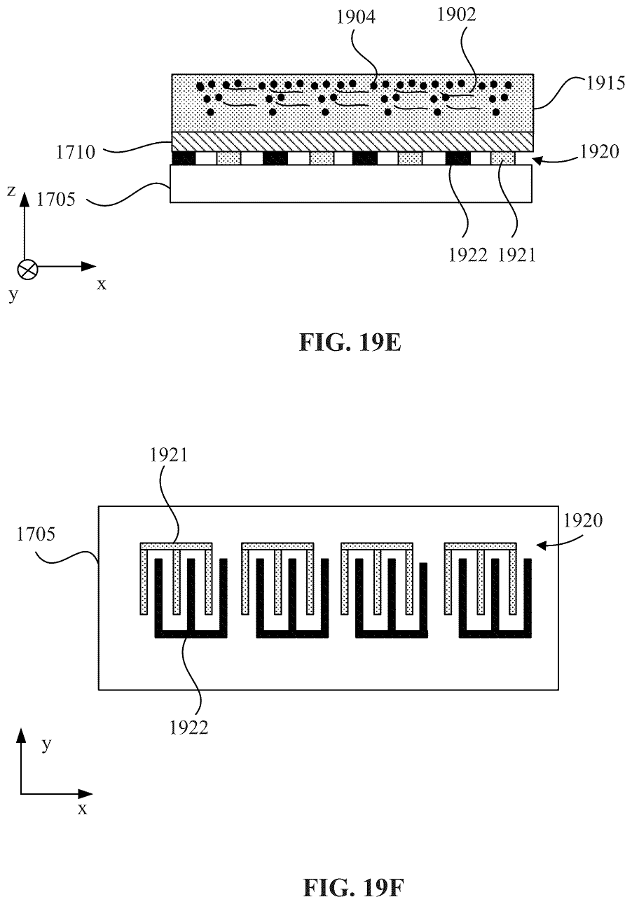

FIGS. 19A-19E schematically illustrate processes for fabricating an LCPH element with varying slant angle or twist angle (or for slant angle or twist angle patterning), according to various embodiments of the present disclosure. The fabrication processes shown in FIGS. 19A-19E may include steps or processes similar to those shown in FIGS. 17A-17F. Descriptions of the similar steps and elements can refer to the descriptions rendered above in connection with FIGS. 17A-17F. Although the substrate and films or layers are shown as having flat surfaces, in some embodiments, the substrate and films or layers formed thereon may include curved surfaces.

As shown in FIG. 19A, the alignment structure 1710 may be first formed on the surface (e.g., the top surface) of the substrate 1705, and a birefringent medium layer 1915 may be formed on the alignment structure 1710. The birefringent medium layer 1915 may be similar to the birefringent medium layer 1715 shown in FIG. 17B. For example, the birefringent medium layer 1915 may include a mixture of a host birefringent material, a stimuli-responsive chiral dopant 1902, and a photo-initiator for polymerization. The host birefringent material and the photo-initiator included in the birefringent medium layer 1915 may be similar to the host birefringent material and the photo-initiator included in the birefringent medium layer 1715 shown in FIG. 17B, respectively. In some embodiments, the birefringent medium layer 1915 may also include other ingredients, such as an absorbing additive (or absorber) 1904, a non-stimuli-responsive chiral dopant, dyes, and/or a surfactant, etc. The non-stimuli-responsive chiral dopant may have a constant HTP that is not tunable by an external stimulus.

In the embodiment shown in FIG. 19A, the stimuli-responsive chiral dopant 1902 may include a thermal-responsive chiral dopant (also referred to as 1902) with a thermal-responsive HTP. In some embodiments, as the temperature of the thermal-responsive chiral dopant 1902 changes, the conformation of the chiral molecules may change, resulting in a change of the intermolecular interaction between the thermal-responsive chiral dopant and the host material, which, in turn, results in a change in the HTP of the thermal-responsive chiral dopant 1902. The HTP of the thermal-responsive chiral dopant 1902 may vary (e.g., increase, decrease, or reverse the handedness) as the temperature of the thermal-responsive chiral dopant 1902 increases. FIG. 21C illustrates various chemical structures of chiral materials that may be included in the thermal-responsive chiral dopant 1902. In FIG. 21C, “R” denotes a right-handed chiral material, and “S” denotes a left-handed chiral material.

Thus, through configuring a predetermined 1D, 2D, or 3D temperature variation(s) of the thermal-responsive chiral dopant 1902 (or the birefringent medium layer 1915), a predetermined 1D, 2D, or 3D HTP variation(s) of the thermal-responsive chiral dopant 1902 may be achieved in the birefringent medium layer 1915, which, in turn, results in a predetermined 1D, 2D, or 3D helical pitch variation(s) in the birefringent medium layer 1915. The predetermined 1D, 2D, or 3D helical pitch variation in the birefringent medium layer 1915 may result in a predetermined 1D, 2D, or 3D slant angle or twist angle variation of the helical twist structures in the birefringent medium layer 1915.

Referring to FIGS. 19A-19E, the predetermined 1D, 2D, or 3D temperature variation(s) of the thermal-responsive chiral dopant 1902 (or the birefringent medium layer 1915) may be configured via any suitable devices and methods, e.g., an IR irradiation, a thermal processing device configured to provide a predetermined thermal pattern, such as a predetermined output thermal energy pattern, an electric field having a predetermined intensity or frequency pattern, or a combination thereof. The thermal processing device may include a heating element (e.g., a heating stage), a resistive heating element providing a predetermined conductive surface pattern, a cooling element (e.g., a cooling stage), or a combination thereof.

In some embodiments, configuring a predetermined 1D, 2D, or 3D temperature variation(s) of the thermal-responsive chiral dopant 1902 (or the birefringent medium layer 1915) may include configuring a predetermined 1D or 2D temperature variation(s) within the film plane of the birefringent medium layer 1915, and/or configuring a predetermined 1D temperature variation along the thickness direction of the birefringent medium layer 1915. In some embodiments, the predetermined 1D or 2D temperature variation(s) within the film plane of the birefringent medium layer 1915 may be configured via configuring the IR irradiation, the thermal processing device, the electric field, or a combination thereof. In some embodiments, the predetermined temperature variation along the thickness direction of the birefringent medium layer 1915 may be configured via controlling the distributed variation (or concentration variation) of the absorbing additive 1904 along the thickness direction of the birefringent medium layer 1915. In some embodiments, the absorbing additive 1904 may be configured to absorb an IR irradiation that may activate the thermal-responsive chiral dopant 1902. In some embodiments, the absorbing additive 1904 may include absorbing dyes that absorb an IR light for generating heat (referred to as IR absorbing dyes).

In the embodiment shown in FIG. 19A, the temperature of the birefringent medium layer 1915 may be changed via a stimulus irradiation (e.g., IR irradiation) 1944, based on the photothermal effect. In some embodiments, the IR irradiation 1944 may be absorbed by the thermal-responsive chiral dopant 1902 to generate heat. In some embodiments, the temperature of the birefringent medium layer 1915 (or heat generated by the thermal-responsive chiral dopant 1902) may depend on the intensity, the wavelength, the time duration, or the dose (amount), etc., of the IR irradiation 1944. For example, as the intensity, the time duration, or the dose (amount) of the IR irradiation 1944 increases, the temperature of the birefringent medium layer 1915 (or heat generated by the thermal-responsive chiral dopant 1902) may increase. Thus, the temperature of the birefringent medium layer 1915 may be configured with a predetermined variation, through controlling a variation of the intensity, the wavelength, the time duration, and/or the dose (amount) of the IR irradiation 1944 within the birefringent medium layer 1915.

Similar to controlling the stimulus irradiation 1744 shown in FIG. 17C, controlling the IR irradiation 1944 may include configuring the intensity, wavelength, dose, and/or time duration of the IR irradiation 1944 in one or more direction within the film plane (e.g., the x-y plane) of the birefringent medium layer 1915, and/or configuring the intensity of the IR irradiation 1944 in the thickness direction (e.g., the z-axis direction) of the birefringent medium layer 1915. For discussion purposes, FIG. 19A illustrates the intensity variation of the IR irradiation 1944 (also referred to an exposure intensity variation or variation of exposure intensity) as an example. In some embodiments, the intensity variation within the film plane of the birefringent medium layer 1915 may be configured through configuring the intensity variation of the IR irradiation 1944 within the wavefront. The intensity variation of the IR irradiation 1944 within the wavefront may be introduced through various methods disclosed herein, such as by configuring one or more of a photomask, a projector that generates the IR irradiation 1944, or a direct writing lithography, etc., which may be similar to those shown in FIGS. 17C-17E and FIGS. 18A-18D.

In some embodiments, the intensity variation of the IR irradiation 1944 along the thickness direction of the birefringent medium layer 1915 may be generated through configuring the absorption variation of the IR irradiation 1944 along the thickness direction of the birefringent medium layer 1915. In some embodiments, the absorption variation of the IR irradiation 1944 along the thickness direction may be configurable through configuring the composition, the concentration, and/or the concentration variation of the absorbing additive 1904 along the thickness of the birefringent medium layer 1915.

In some embodiments, the absorbing additive 1904 may be configured with a non-uniform distribution along the thickness direction (e.g., z-axis direction) of the birefringent medium layer 1915. Thus, when the IR irradiation 1944 propagates inside the birefringent medium layer 1915 along the thickness direction thereof, the intensity of the IR irradiation 1944 may be configured to vary in a controlled manner according to a desirable intensity variation profile, pattern, or distribution, along the thickness direction from a light incidence surface (e.g., a first surface) 1915-1 to a light exiting surface (e.g., a second surface) 1915-2. For discussion purposes, FIG. 19A shows that along the thickness direction of the birefringent medium layer 1915 from the first surface 1915-1 to the second surface 1915-2, the concentration of the absorbing additive 1904 in the birefringent medium layer 1915 decreases in the −z-axis direction. Thus, the amount of the IR irradiation 1944 being absorbed may decrease in the −z-axis direction, the heat generated by the absorbing additive 1904 may decrease in the −z-axis direction, and the temperature within the birefringent medium layer 1915 may decrease in the −x-axis direction.

In some embodiments, although not shown, the IR irradiation 1944 may be configured with a uniform intensity within the wavefront, the exposure intensity variation within the film plane of the birefringent medium layer 1915 may be generated through configuring an absorption variation of the IR irradiation 1944 within the film plane of the birefringent medium layer 1915. The absorbing additive 1904 may be configured with a predetermined non-uniform distribution (or concentration variation) in one or more directions with the film plane of the birefringent medium layer 1915. In some embodiments, although not shown, the absorbing additive 1904 may form a separate layer, rather than being doped into the birefringent medium layer 1915. The separate layer of the absorbing additive 1904 may be disposed at a surface of the birefringent medium layer 1915 facing the IR irradiation 1944. The absorbing additive 1904 may be configured with a predetermined non-uniform distribution (or concentration variation) in one or more directions with the film plane of the separate layer. Thus, the IR irradiation 1944 transmitted through the separate layer of the absorbing additive 1904 may have a predetermined non-uniform intensity variation.

In the embodiment shown in FIGS. 19B and 19C, the temperature variation in one or more directions within a film plane of the birefringent medium layer 1915 may be introduced via the thermal processing device, such as a heating element (or stage) or a cooling element (or stage). In the embodiment shown in FIG. 19B, the substrate 1705 on which the birefringent medium layer 1915 is disposed may be coupled to a thermal processing device 1905. The thermal processing device 1905 may be a heating element or a cooling element. The thermal processing device 1905 may be configured to provide a predetermined 1D or 2D output thermal energy variation. When the birefringent medium layer 1915 is subject to thermal processing by the thermal processing device 1905 with the predetermined 1D or 2D output thermal energy variation, a 1D or 2D temperature variation may be generated within the film plane of the birefringent medium layer 1915. In FIG. 19B, the output thermal energy variation provided by the thermal processing device 1905 is represented by grey scales, in which the darker grey indicates a higher output thermal energy (which results in a higher temperature in the birefringent medium layer 1915), the lighter grey indicates a lower output thermal energy (which results in a lower temperature in the birefringent medium layer 1915). For discussion purposes, FIG. 19B shows that the output thermal energy provided by the thermal processing device 1905 decreases in the +x-axis direction in a gradient manner. The gradient manner may be a linear gradient manner, a non-linearly gradient manner, a stepped gradient manner, or a suitable combination thereof, etc. Accordingly, the temperature within the film plane of the birefringent medium layer 1715 may decrease in the +x-axis direction.

In the embodiment shown in FIG. 19C, before forming the alignment structure 1710 at the substrate 1705, a resistive heating element 1907 may be disposed at the substrate 1705. The resistive heating element 1907 is an example of the thermal processing device 1905, or may be a part of the thermal processing device 1905. The alignment structure 1710 may be formed at a surface of the resistive heating element 1907. That is, the resistive heating element 1907 may be disposed between the substrate 1705 and the alignment structure 1710. In some embodiments, the resistive heating element 1907 may include an electrode layer configured with a predetermined 1D or 2D resistance variation(s) within the film plane of the electrode layer. In some embodiments, the resistive heating element 1907 may be visually or optically transparent. For example, the resistive heating element 1907 may be optically transparent to lights at least in the visible spectrum (e.g., about 380 nm to about 700 nm). When a voltage is applied to the resistive heating element 1907, an electrical current passes through the resistive heating element 1907, and heat is generated based on joule heating. Thus, under the applied voltage, the resistive heating element 1907 may provide a predetermined 1D or 2D temperature variation within the film plane of the resistive heating element 1907. Accordingly, a predetermined 1D or 2D temperature variation may be established within the film plane of the birefringent medium layer 1915.

In some embodiments, the resistive heating element 1907 may include an indium tin oxide (“ITO”) layer configured with a predetermined 1D or 2D resistance variation(s) within the film plane of the ITO layer. In some embodiments, the resistive heating element 1907 may include a plurality of heating units (e.g., resistive wires having a substantially small diameter (e.g., about 25 micrometers)). The heating units may be configured with a predetermined 1D or 2D distribution density within the film plane of the resistive heating element 1907.

In FIG. 19C, the resistance of the resistive heating element 1907 is represented by grey scales, in which the darker grey indicates a higher resistance, the lighter grey indicates a lower resistance. For discussion purposes, FIG. 19C shows that the resistance of the resistive heating element 1907 decreases in the +x-axis direction in a gradient manner. The gradient manner may be a linear gradient manner, a non-linearly gradient manner, a stepped gradient manner, or a suitable combination thereof, etc. When the voltage is applied to the resistive heating element 1907, the temperature within the film plane of the resistive heating element 1907 may decrease in the +x-axis direction. Accordingly, the temperature within the film plane of the birefringent medium layer 1715 may decrease in the +x-axis direction.

In the embodiment shown in FIGS. 19D and 19E, the temperature variation in the birefringent medium layer 1915 may be introduced via a high-frequency alternating current (“AC”) electric field generated within the birefringent medium layer 1915. The heat generated based on the pseudo-dielectric relaxation effect may vary with the intensity and/or frequency of the AC electric field. Thus, through configuring an electric field having a predetermined 1D or 2D amplitude variation and/or a predetermined 1D or 2D frequency variation within the film plane of the birefringent medium layer 1915, a predetermined 1D or 2D temperature variation within a film plane of the birefringent medium layer 1915 may be generated.

In the embodiment shown in FIG. 19D, the high-frequency AC electric field that introduces a temperature variation within the film plane of the birefringent medium layer 1915 may be a vertical electric field. As shown in FIG. 19D, two substrates 1705 may be assembled to form a cell with a predetermined cell gap. Each substrate 1705 may be provided with one or more conductive electrode layers and the alignment structure 1710 (1710-1 and 1710-2) at the inner surfaces thereof. For example, a conductive electrode layer 1910-1 or 1910-2 (collectively referred to as 1910) may be formed at the inner surface of the substrate 1705, and the alignment structure 1710 (1710-1 or 1710-2) may be formed at an inner surface of the conductive electrode layer 1910. A birefringent medium may be filled into the cell to form the birefringent medium layer 1915.

In some embodiments, each alignment structure 1710 may be configured to provide a planar alignment (or an alignment with a small pretilt angle), and the alignment structures 1710-1 and 1710-2 may provide parallel or anti-parallel surface alignments. In some embodiments, the alignment structures 1710-1 and 1710-2 may be configured to provide hybrid surface alignments. For example, one of the alignment structures 1710-1 and 1710-2 may be configured to provide a planar alignment (or an alignment with a small pretilt angle), and the other one of the alignment structures 1710-1 and 1710-2 may be configured to provide a homeotropic alignment. Although not shown, in some embodiments, only one alignment structure may be included.

In the embodiment shown in FIG. 19D, each conductive electrode layer 1910-1 or 1910-2 may be a patterned (or pixelated) electrode layer including a plurality of parallel pixel electrodes 1912-1 or 1912-2 (collectively referred to as 1912). In some embodiments, as shown in FIG. 19D, the pixel electrodes 1912-1 may be substantially aligned with the pixel electrodes 1912-2, e.g., in the z-axis direction. In some embodiments, as shown in FIG. 19D, the pixel electrodes 1912-1 may not be substantially aligned in parallel with the pixel electrodes 1912-2. In some embodiments, although not shown, the pixel electrodes 1912-1 may be arranged to be non-parallel with the respective pixel electrodes 1912-2, i.e., the pixel electrodes 1912-1 may intersect with the respective pixel electrodes 1912-2, forming an angle other than 0° or 180°. The pixel electrode 1912 may have any suitable shape, such as a slit pixel electrode, a square pixel electrode, a zigzag pixel electrode, etc. The amplitude and/or frequency of the voltages applied to the pixel electrodes 1912-1 and 1912-2 may be individually or independently controlled. For example, the cell may be communicatively coupled with a controller (not shown). The controller may control the outputs of one or more power sources to individually or independently control the amplitude and/or frequency of the voltages applied to the respective pixel electrodes 1912-1 and 1912-2.

For example, in some embodiments, the pixel electrodes 1912-1 may be applied with the same voltage (e.g., grounded), and the voltage applied to respective pixel electrodes 1912-2 may be configured to have the same frequency and a predetermined 1D or 2D amplitude variation within a film plane of the electrode layer 1910. Thus, a vertical electric field with a predetermined 1D or 2D amplitude (or field intensity) may be generated within the film plane of the birefringent medium layer 1915, which, in turn, results in a predetermined 1D or 2D temperature variation within the film plane of the birefringent medium layer 1915. Although not shown, in some embodiments, one of the conductive electrode layers 1910-1 and 1910-2 may be a planar, continuous electrode layer that functions as a common electrode.

In some embodiments, the pixel electrodes 1912-1 may be applied with the same voltage (e.g., grounded), and the voltage applied to respective pixel electrodes 1912-2 may be configured to have the same amplitude and a predetermined 1D or 2D frequency variation within a film plane of the electrode layer 1910. Thus, a vertical electric field with a predetermined 1D or 2D frequency variation may be generated within the film plane of the birefringent medium layer 1915, which, in turn, results in a predetermined 1D or 2D temperature variation within the film plane of the birefringent medium layer 1915.

In the embodiment shown in FIG. 19E, the high-frequency AC electric field that introduces a temperature variation within the film plane of the birefringent medium layer 1915 may be a horizontal electric field. As shown in FIG. 19E, before forming the alignment structure 1710 at the substrate 1705, a conductive electrode layer 1920 may be disposed at the substrate 1705. The alignment structure 1710 may be formed at a surface of the conductive electrode layer 1920. That is, the conductive electrode layer 1920 may be disposed between the substrate 1705 and the alignment structure 1710. FIG. 19F illustrates an x-y sectional view of the conductive electrode layer 1920 shown in FIG. 19E, according to an embodiment of the present disclosure.

As shown in FIGS. 19E and 19F, the conductive electrode layer 1920 may include a plurality of comb-like inter-digitated electrode structures, each of which may include two arrays 1921 and 1922 of microelectrode strips with an inter-digitated approach. The arrays 1921 and 1922 of microelectrode strips may be individually addressable. The amplitude and/or frequency of the voltages applied to the respective arrays 1921 of microelectrode strips and respective arrays 1922 of microelectrode strips may be individually or independently controlled. For example, the controller may control the outputs of one or more power sources to individually or independently control the amplitude and/or frequency of the voltages applied to the respective arrays 1921 and 1922 of microelectrode strips.

In some embodiments, the arrays 1921 of microelectrode strips may be applied with the same voltage (e.g., grounded), and the voltage applied to the respective arrays 1922 of microelectrode strips may be configured to have the same frequency and a predetermined 1D or 2D amplitude variation within a film plane of the electrode layer 1920. Thus, a horizontal electric field with a predetermined 1D or 2D amplitude (or field intensity) may be generated within the film plane of the birefringent medium layer 1915, which, in turn, results in a predetermined 1D or 2D temperature variation within the film plane of the birefringent medium layer 1915. Although not shown, in some embodiments, the arrays 1921 of microelectrode strips may adhere to each other, functioning as a common electrode.

In some embodiments, the arrays 1921 of microelectrode strips may be applied with the same voltage (e.g., grounded), and the voltage applied to the respective arrays 1922 of microelectrode strips may be configured to have the same amplitude and a predetermined 1D or 2D frequency variation within a film plane of the electrode layer 1920. Thus, a vertical electric field with a predetermined 1D or 2D frequency variation may be generated within the film plane of the birefringent medium layer 1915, which, in turn, results in a predetermined 1D or 2D temperature variation within the film plane of the birefringent medium layer 1915.

Referring to FIGS. 19A-19E, after the predetermined slant angle or twist angle variation(s) within the film plane and/or in the thickness direction of the birefringent medium layer 1915 is generated, the birefringent medium layer 1915 may be exposed to a polymerization irradiation (e.g., 1784 shown in FIG. 17F) to form a polymerized birefringent medium layer, thereby stabilizing the slant angle or twist angle variation. In some embodiments, the IR irradiation 1944 shown in FIG. 19A may be removed, and the birefringent medium layer 1915 may be exposed to the polymerization irradiation 1784 shown in FIG. 17F. In some embodiments, when the birefringent medium layer 1915 is exposed to the polymerization irradiation 1784, the thermal processing device 1905 shown in FIG. 19B, the heating element 1907 shown in FIG. 19C, the respective pixel electrodes 1912 shown in FIG. 19D, or the respective arrays 1921 and 1922 of microelectrode strips shown in FIG. 19E may be operated to provide the predetermined temperature variation within the birefringent medium layer 1915.

In some embodiment, although not shown, the birefringent medium layer 1715 shown in FIGS. 17B-17E may also include the thermal-responsive chiral dopant 1902 in addition to the photo-responsive chiral dopant 1702, and the processes shown in FIGS. 19A-19E may also be used to introduce a twist angle variation or a slant angle variation into the birefringent medium layer 1715. In some embodiments, the birefringent medium layer 1915 shown in FIGS. 19A-19E also includes the photo-responsive chiral dopant 1702 in addition to the thermal-responsive chiral dopant 1902, and the processes shown in FIGS. 17C-17E may also be used to introduce a twist angle variation or a slant angle variation into the birefringent medium layer 1915.

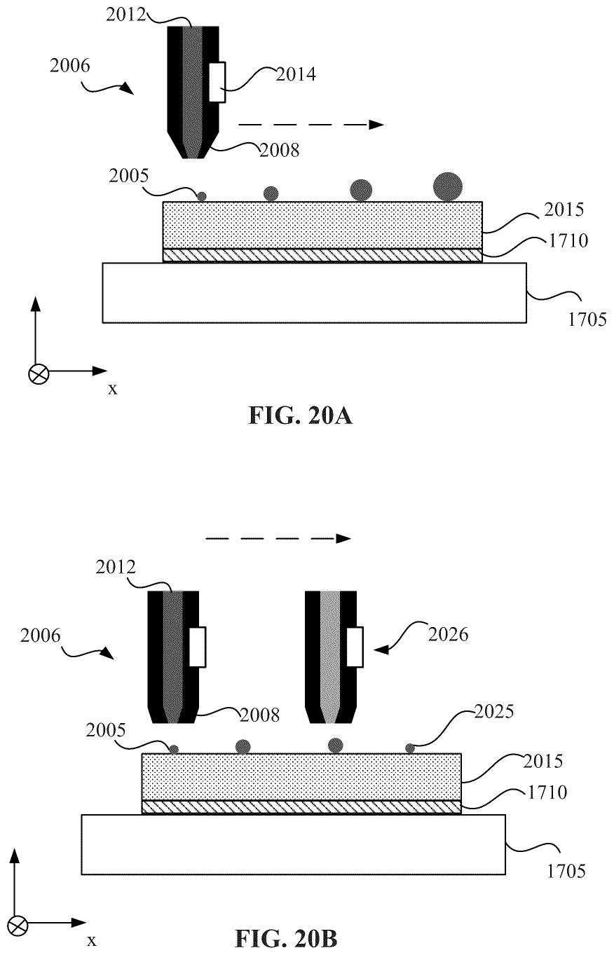

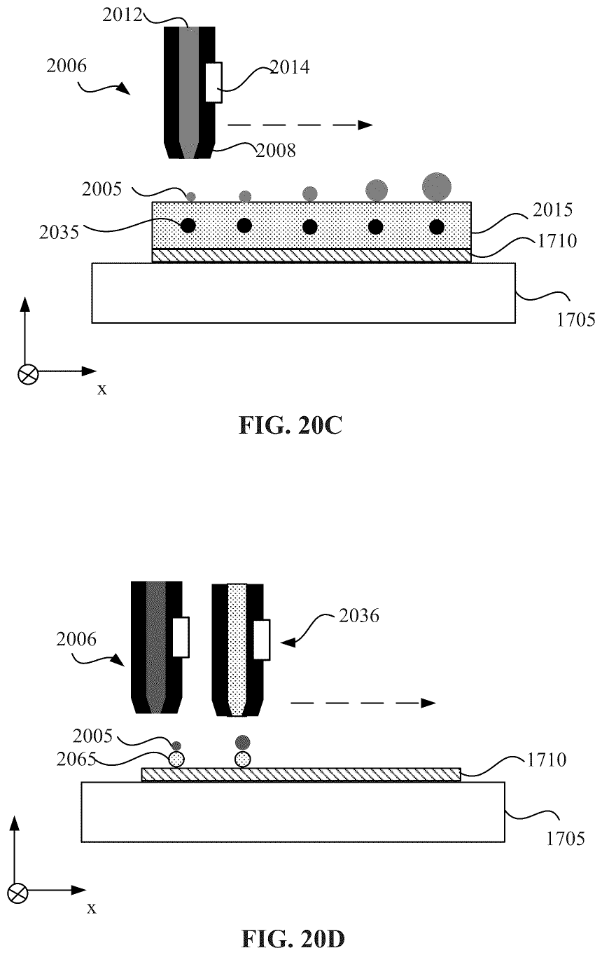

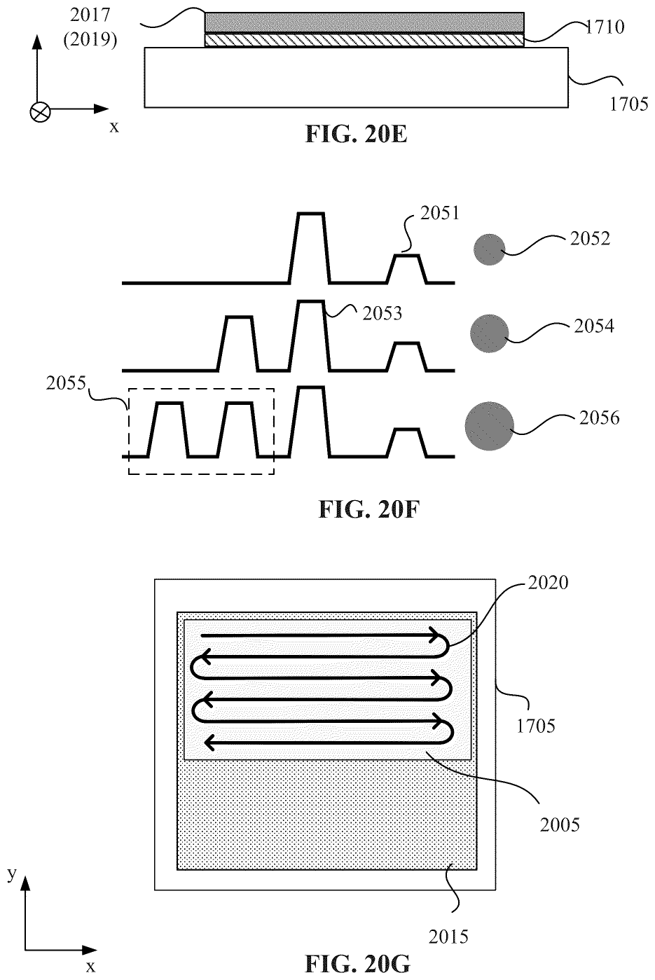

FIGS. 20A-20E schematically illustrate processes for fabricating an LCPH element with varying slant angles or twist angles (or for slant angle or twist angle patterning), according to various embodiments of the present disclosure. The fabrication processes shown in FIGS. 20A-20E may include steps or processes similar to those shown in FIGS. 17A-17F, or FIGS. 19A-19E. Descriptions of the similar steps and similar elements can refer to the descriptions rendered above in connection with FIGS. 17A-17F, or FIGS. 19A-19E. Although the substrate and films or layers are shown as having flat surfaces, in some embodiments, the substrate and films or layers formed thereon may include curved surfaces.

As shown in FIG. 20A, the alignment structure 1710 may be formed on the surface (e.g., the top surface) of the substrate 1705, and a birefringent medium layer 2015 may be formed on the alignment structure 1710. In some embodiments, the birefringent medium layer 2015 may include a mixture of a host birefringent material and a photo-initiator for polymerization. The host birefringent material and the photo-initiator included in the birefringent medium layer 2015 may be respectively similar to the host birefringent material and the photo-initiator included in the birefringent medium layer 1715 shown in FIG. 17B or the birefringent medium layer 1915 shown in FIG. 19A. In some embodiments, the birefringent medium layer 2015 may also include other ingredients, such as an absorbing additive (or absorber) (e.g., 1704 shown in FIG. 17B or 1904 shown in FIG. 19A, etc.), a stimuli-responsive chiral dopant (e.g., 1702 shown in FIG. 17B, or 1902 shown in FIG. 19A, etc.), a non-stimuli-responsive chiral dopant, dyes, and/or a surfactant, etc.

In the embodiment shown in FIG. 20A, after the birefringent medium layer 2015 is formed on the alignment structure 1710, a chiral dopant 2005 may be dispensed at the birefringent medium layer 2015, which may diffuse into the volume of the birefringent medium layer 2015. The chiral dopant 2005 may include any suitable chiral dopants, such as one or more chiral materials having the chemical structures shown in FIG. 6C. Through controlling or configuring the amounts of the chiral dopant 2005 dispensed into different portions of the birefringent medium layer 2015, a predetermined amount variation the chiral dopant 2005 may be generated within the birefringent medium layer 2015, which may result in a predetermined concentration variation of the chiral dopant 2005 within the birefringent medium layer 2015. When the chiral dopant 2005 is presumed to have a constant or fixed HTP, the predetermined concentration variation of the chiral dopant 2005 within the birefringent medium layer 2015 may result in a predetermined helical pitch variation within the birefringent medium layer 2015, which, in turn, results in a predetermined slant angle or twist angle variation within the birefringent medium layer 2015.

The chiral dopant 2005 may be dispensed at the birefringent medium layer 2015 via any suitable methods, e.g., via inkjet printing, aerosol jet printing, spray printing, screen printing, or 3D printing, etc. For discussion purposes, FIG. 20A shows that an inkjet printer is used to dispense the chiral dopant 2005 at the birefringent medium layer 2015. For example, the inkjet printer may include a carriage (not shown) configured to support one or more printheads (for illustrative purposes, a printhead 2006 is shown) over the birefringent medium layer 2015 placed on a supporting stage (not shown) during printing. The relative position of the printhead 2006 with respect to the birefringent medium layer 2015 may be varied by moving at least one of the carriage or the supporting stage. The movement of the carriage and/or the supporting stage may be linear, one dimensional, two dimensional, circular, spiral, or in any other pattern. In some embodiments, the carriage may be movable in one or more linear paths (e.g., the x-axis direction and/or the y-axis direction) and the supporting stage may be stationary. In some embodiments, the carriage may be movable in a curved path (e.g., in a circumferential direction, a spiral direction, etc.). In some embodiments, the carriage may be stationary, and the supporting stage may be movable in one or more linear paths or a curved path. In some embodiments, the supporting stage may be 2D-translational (e.g., movable in the x-axis and y-axis directions) and/or rotational (e.g., rotatable).

In some embodiments, the printhead 2006 may include a nozzle 2008 with an ink outlet, an ink supply channel 2012 through which a body of ink is supplied to the nozzle 2008. The ink (chiral dopant) may be stored in an ink cartridge (not shown). The printhead 2006 may include a flow control device 2014 configured to control the amount (e.g., volume) of the chiral dopant to be dispensed onto birefringent medium layer 2015. In some embodiments, the flow control device 2014 may include a piezoelectric actuator or any other suitable flow control actuators. In some embodiments, the inkjet printer may include a controller (not shown) configured to control the movement of the supporting stage and/or the carriage, thereby controlling the relative position of the printhead 2006 with respect to the birefringent medium layer 2015. In some embodiments, the controller may also control a driving voltage supplied to the flow control device 2014. For example, the controller may control a waveform of the driving voltage (also referred to as a driving voltage waveform) supplied to the flow control device 2014 to control the volume of the droplet (or the size of the droplet).

The inkjet printer may be configured to print lines, dots, and/or any other suitable patterns. In some embodiments, the inkjet printer may be communicatively coupled to a computer. The computer may control the printing operations of the inkjet printer and may receive data from the inkjet printer. In some embodiments, the computer may receive input from a user, and may transmit a programmed moving or printing path to the controller at the inkjet printer for controlling the movement of the supporting stage or the carriage. In some embodiments, the computer may receive input from the user regarding the waveform for controlling the amount of ink dispensed at each location on the birefringent medium layer 2015, and may transmit the waveform to the controller at the inkjet printer for controlling the flow control device 2014. In some embodiments, the controller may be a part of the computer or may be a part of the inkjet printer.

FIG. 20F shows a plurality of example driving voltage waveforms and the corresponding sizes (or volumes) of the droplets. As shown in FIG. 20F, different driving voltage waveforms may correspond to different sizes (or volumes) of the droplets. To dispense different amounts of the chiral dopant 2005 at different locations, droplets of different volumes may be dispensed at different locations of the birefringent medium layer 2015. Different volumes of the chiral dopant 2005 may be realized through controlling or configuring at least one of a time duration or a magnitude of the driving voltage waveform. For example, in some embodiments, both a time duration and a magnitude of the driving voltage waveform may be configured or controlled such that the volumes of the droplets of the chiral dopant 2005 dispensed at two or more locations are different.

For example, as shown in FIG. 20F, when driven by a voltage having a waveform 2051, the printhead 2006 may dispense a chiral dopant droplet 2052 having a first size. When driven by a voltage having a waveform 2053, the printhead 2006 may dispense a chiral dopant droplet 2054 having a second size, which may be larger than the first size. When driven by a voltage having a waveform 2055, the printhead 2006 may dispense a chiral dopant droplet 2056 having a third size, which may be larger than the second size. The driving voltage waveforms 2051, 2053, and 2055 may be different from one another, and the printhead 2006 may dispense droplets 2052, 2054, and 2056 of different volumes or sizes. For example, each of the driving voltage waveforms 2051 and 2053 may include one pulse with the same pulse width. The magnitude of the driving voltage waveform 2053 may be larger than the magnitude of the driving voltage waveform 2051. As a result, the volume (or size) of the chiral dopant droplet 2054 may be larger than the volume (or size) of the chiral dopant droplet 2052. The driving voltage waveform 2055 may include two pulses having a pulse width that is the same as the pulse width of the pulse included in the driving voltage waveform 2053. Although the magnitude of the driving voltage waveform 2055 may be lower than the magnitude of the driving voltage waveform 2053, the volume (or size) of the chiral dopant droplet 2056 may be larger than the volume (or size) of the chiral dopant droplet 2054. The relationship between the time duration and/or the magnitude of the driving voltage waveform and the volume of the chiral dopant droplet shown in FIG. 20F is for illustrative purposes. Other relationships between the time duration and the magnitude of the driving waveform and the volume of the chiral dopant droplet may also be used.

FIG. 20G illustrates a printing path 2020 that may be implemented when printing the chiral dopant 2005 on the birefringent medium layer 2015, according to an embodiment of the present disclosure. The printing path 2020 may be created by the relative movement between the printhead 2006 and the substrate 1705 provided with the birefringent medium layer 2015. In some embodiments, the printing path 2020 may be a moving path of the printhead 2006, or a moving path of the supporting stage on which the substrate 1705 is mounted to. Referring to FIG. 20A and FIG. 20G, through controlling the time duration and/or the magnitude of the driving voltage waveform applied to the flow control device 2014, the printhead 2006 may dispense the chiral dopant droplets with predetermined volumes at predetermined locations of the birefringent medium layer 2015, while printing along the printing path 2020. The chiral dopant 2005 dispensed at the surface of the birefringent medium layer 2015 may diffuse into the volume of the birefringent medium layer 2015. Thus, local amounts of the chiral dopant 2005 within the birefringent medium layer 2015 may be controlled to have a predetermined 1D or 2D variation within the film plane of the birefringent medium layer 2015. After the entire printing path 2020 is completed, a predetermined 1D or 2D concentration (or amount) variation of chiral dopant 2005 may be established within the film plane of the birefringent medium layer 2015.

Referring back to FIG. 20A, in some embodiments, before the chiral dopant 2005 is dispensed at the surface of the birefringent medium layer 2015 and diffuses into the volume of the birefringent medium layer 2015, the birefringent medium layer 2015 itself may not exhibit a chirality (an induced chirality or an intrinsic chirality), and LC molecules in the birefringent medium layer 2015 may not be twisted to form any helical twist structure. For example, before the chiral dopant 2005 is dispensed at the surface of the birefringent medium layer 2015 and diffuses into the volume of the birefringent medium layer 2015, the birefringent medium layer 2015 may not include a chiral dopant, or the host material in the birefringent medium layer 2015 may be an achiral material or a non-chiral material without a chirality. After the chiral dopant 2005 is dispensed at the surface of the birefringent medium layer 2015 and diffuses into the volume of the birefringent medium layer 2015, the chiral dopant 2005 may twist the LC molecules to form helical twist structures in the birefringent medium layer 2015. For discussion purposes, FIG. 20A shows that the printhead 2006 moves in the +x-axis direction, and the amounts of the chiral dopant 2005 dispensed at the birefringent medium layer 2015 increase in the +x-axis direction. As the amounts of the chiral dopant 2005 dispensed at the birefringent medium layer 2015 increase in the +x-axis direction, the helical pitches of the helical twist structures formed in the birefringent medium layer 2015 may decrease in the +x-axis direction. Thus, the slant angle or the twist angle of the birefringent medium layer 2015 may increase in the +x-axis direction.

Although one printhead 2006 is shown in FIG. 20A for illustrative purposes, the inkjet printer may include a plurality of printheads 2006 for dispensing the chiral dopant 2005 at different locations of the birefringent medium layer 2015 simultaneously or sequentially. In some embodiment, the inkjet printer may include a plurality of printheads for dispensing different types of chiral dopants at different portions of the birefringent medium layer 2015. For example, as shown in FIG. 20B, the inkjet printer may include a first printhead 2006 configured to dispense a first chiral dopant 2005 having a chirality of first handedness, and a second printhead 2026 configured to dispense a second chiral dopant 2025 having a chirality of second handedness that is opposite to the first handedness. Thus, in addition to controlling the helical pitch variation of the helical twist structures in the birefringent medium layer 2015, the local handedness of the helical twist structures in the birefringent medium layer 2015 may also be controlled via dispensing chiral dopants of different chiralities at different locations of the birefringent medium layer 2015.

Referring to FIG. 20B and FIG. 20G, in some embodiments, while printing along the printing path 2020, the first printhead 2006 may be configured to dispense droplets of first chiral dopant 2005 with predetermined volumes at a plurality of first predetermined locations of the birefringent medium layer 2015, and the second printhead 2026 may be configured to dispense droplets of second chiral dopant 2025 with predetermined volumes at a plurality of second predetermined locations of the birefringent medium layer 2015. In some embodiments, at least one of the first predetermined locations may be the same as at least one of the second predetermined locations. In some embodiments, at least one of the first predetermined locations may be different from at least one of the second predetermined locations. For example, in some embodiments, the plurality of first predetermined locations may be different from the plurality of second predetermined locations. In other words, in some embodiments, the first chiral dopant 2005 and the second chiral dopant 2025 may be dispensed in at least one same location. In some embodiments, the first chiral dopant 2005 and the second chiral dopant 2025 may be dispensed in at least two different locations. In some embodiments, the first chiral dopant 2005 and the second chiral dopant 2025 may be dispensed in non-overlapping, different locations.

After the entire printing path 2020 is completed, a first predetermined 1D or 2D concentration (or amount) variation of the first chiral dopant 2005 and a second predetermined 1D or 2D concentration (or amount) variation of the second chiral dopant 2025 may be established within the film plane of the birefringent medium layer 2015. For discussion purposes, FIG. 20B shows that the first printhead 2006 and the second printhead 2026 move in the +x-axis direction, the amounts of the first chiral dopant 2005 dispensed at the birefringent medium layer 2015 increases from a left periphery portion to a center portion of the birefringent medium layer 2015 in the +x-axis direction, while the amount of the second chiral dopant 2025 dispensed at the birefringent medium layer 2015 increase from the center portion to a right periphery portion of the birefringent medium layer 2015 in the +x-axis direction. Thus, after the first chiral dopant 2005 and the second chiral dopant 2025 diffuse into the volume of the birefringent medium layer 2015, helical twist structures having the first handedness may be formed in the left portion of the birefringent medium layer 2015, with the helical pitches decreasing in the +x-axis direction, and the slant angle or the twist angle increasing in the +x-axis direction. Helical twist structures having the second handedness may be formed in the right portion of the birefringent medium layer 2015, with the helical pitches increasing in the +x-axis direction, and the slant angle or the twist angle decreasing in the +x-axis direction.

Although one first printhead 2006 and one second printhead 2026 are shown in FIG. 20B for illustrative purposes, the inkjet printer may include a plurality of first printheads 2006 for dispensing the first chiral dopant 2005 at different locations of the birefringent medium layer 2015 simultaneously or sequentially, and/or a plurality of second printheads 2026 for dispensing the second chiral dopant 2025 at different locations of the birefringent medium layer 2015 simultaneously or sequentially.

In the embodiment shown in FIG. 20C, before the chiral dopant 2005 is dispensed at the surface of the birefringent medium layer 2015 and diffuses into the volume of the birefringent medium layer 2015, the birefringent medium layer 2015 itself may exhibit a chirality (an induced chirality or an intrinsic chirality) having a predetermined handedness. For discussion purposes, the chiral dopant 2005 is referred to as a first chiral dopant 2005 having a first handedness, and the birefringent medium layer 2015 itself may exhibit a second chirality having a second handedness. For example, before the first chiral dopant 2005 is dispensed at the surface of the birefringent medium layer 2015, the birefringent medium layer 2015 itself may include a chiral dopant with a chirality of the second handedness, or the host birefringent material in the birefringent medium layer 2015 may be a chiral material with a chirality of the second handedness. Thus, before the first chiral dopant 2005 is dispensed at the surface of the birefringent medium layer 2015, LC molecules in the birefringent medium layer 2015 may have been twisted to form helical twist structure having the second handedness. The second handedness may be the same as or opposite to the first handedness.

For discussion purposes, FIG. 20C shows that the birefringent medium layer 2015 itself includes a second chiral dopant 2035 with a chirality of the second handedness, and the second chiral dopant 2035 is uniformly distributed within the birefringent medium layer 2015. In some embodiments, the second handedness of the second chiral dopant 2035 may be opposite to the first handedness of the first chiral dopant 2005. As the printhead 2006 dispenses the first chiral dopant 2005 at the birefringent medium layer 2015, the helical pitches of the helical twist structures formed in the birefringent medium layer 2015 may vary with the amounts of the first chiral dopant 2005 dispensed at the birefringent medium layer 2015. In some embodiments, when the local amount of the first chiral dopant 2005 is greater than a predetermined amount (e.g., the local amount of the second chiral dopant 2035), the handedness of the helical twist structures formed in the birefringent medium layer 2015 may also be reversed to the first handedness from the second handedness.

For discussion purposes, FIG. 20C shows that the printhead 2006 moves in the +x-axis direction, the amount of the first chiral dopant 2005 dispensed at the birefringent medium layer 2015 increases in the +x-axis direction. FIG. 20C also shows that, at the left portion of the birefringent medium layer 2015, the local amounts of the first chiral dopant 2005 are less than the local amounts of the second chiral dopant 2035 at corresponding locations. At the center portion of the birefringent medium layer 2015, the local amounts of the first chiral dopant 2005 are substantially equal to the local amounts of the second chiral dopant 2035 at corresponding locations. At the right portion of the birefringent medium layer 2015, the local amounts of the first chiral dopant 2005 are greater than the local amounts of the second chiral dopant 2035 at corresponding locations.

Thus, after the first chiral dopant 2005 diffuses into the volume of the birefringent medium layer 2015, helical twist structures having the second handedness may be formed in the left portion of the birefringent medium layer 2015, with the helical pitches increasing in the +x-axis direction, and the slant angle or the twist angle decreasing in the +x-axis direction. Helical twist structures having sufficiently large helical pitches may be formed in the center portion of the birefringent medium layer 2015, or helical twist structures may disappear in the center portion of the birefringent medium layer 2015. Helical twist structures having the first handedness may be formed in the right portion of the birefringent medium layer 2015, with the helical pitches decreasing in the +x-axis direction, and the slant angle or the twist angle increasing in the +x-axis direction.

Referring to FIGS. 20A-20C, after the chiral dopant 2005 and/or the chiral dopant 2025 is dispensed at the birefringent medium layer 2015, the birefringent medium layer 2015 may be thermally processed (e.g., heated) to a temperature at which a mixture of the host birefringent material and the chiral dopant 2005 and/or the chiral dopant 2025 may be in an LC phase, an isotropic phase, or in a transition from the LC phase to the isotropic phase. Then the birefringent medium layer 2015 including the doped chiral dopant 2005 and/or the chiral dopant 2025 may be thermally processed (e.g., cooled) to a predetermined temperature, e.g., a room temperature. A predetermined slant angle or twist angle variation(s) may be formed within the birefringent medium layer 2015. Then the birefringent medium layer 2015 may be exposed to a polymerization irradiation (e.g., 1784 shown in FIG. 17F) to form a polymerized birefringent medium layer, thereby stabilizing the slant angle or twist angle variation.

In some embodiments, as shown in FIGS. 20D-20E, after the alignment structure 1710 is formed on the surface (e.g., the top surface) of the substrate 1705, a birefringent medium 2065 may be dispensed at the alignment structure 1710 via any suitable methods, e.g., via inkjet printing, aerosol jet printing, spray printing, screen printing, or 3D printing, etc. The birefringent medium 2065 may include a mixture of materials that are similar to those forming the birefringent medium layer 2015. For example, the birefringent medium 2065 may include a host birefringent material and a photo-initiator for polymerization. In some embodiments, the birefringent medium 2065 may also include other ingredients, such as an absorbing additive (or absorber) (e.g., 1704 shown in FIG. 17B or 1904 shown in FIG. 19A, etc.), a stimuli-responsive chiral dopant (e.g., 1702 shown in FIG. 17B, or 1902 shown in FIG. 19A, etc.), a non-stimuli-responsive chiral dopant, dyes, and/or a surfactant, etc.

For discussion purposes, FIG. 20D shows that the inkjet printer may include a printhead 2036 configured to dispense the birefringent medium 2065 at a surface of the alignment structure 1710, and the printhead 2006 configured to dispense the chiral dopant 2005 at the surface of the alignment structure 1710. Referring to FIG. 20D and FIG. 20G, in some embodiments, while printing along the printing path 2020, the printhead 2006 may be configured to dispense droplets of the chiral dopant 2005 with predetermined volumes at a plurality of predetermined locations of the alignment structure 1710, and the printhead 2036 may be configured to dispense droplets of the birefringent medium 2065 with predetermined volumes at the corresponding predetermined locations of the alignment structure 1710. The birefringent medium 2065 and the chiral dopant 2005 may be mixed at the same predetermined locations of the alignment structure 1710 to form a birefringent medium layer 2017 shown in FIG. 20E.

The amount of the birefringent medium 2065 and the amount of the chiral dopant 2005 dispensed at a same predetermined location of the alignment structure 1710 may be configured, or a ratio between the volume (or amount) of the birefringent medium 2065 and the volume (or amount) of the chiral dopant 2005 dispensed at a same predetermined location of the alignment structure 1710 may be controlled. Accordingly, the helical pitch at a corresponding location of the birefringent medium layer 2017 may be controlled, which, in turn, controls the twist angle or slant angle at the corresponding location. Thus, by configuring the ratios between the volumes of the birefringent medium 2065 and the volumes of the chiral dopant 2005 dispensed at predetermined locations of the alignment structure 1710, the birefringent medium layer 2017 may be fabricated with a predetermined 1D or 2D slant angle or twist angle variation(s) within the film plane of the birefringent medium layer 2017. In some embodiments, the birefringent medium layer 2017 may be exposed to a polymerization irradiation (e.g., 1784 shown in FIG. 17F) to form a polymerized birefringent medium layer 2019, thereby stabilizing the slant angle or twist angle variation within the birefringent medium layer 2019.

The polymerized birefringent medium layer 2019 may be a first polymerized birefringent medium layer configured with a first predetermined 1D or 2D slant angle or twist angle variation(s) within the film plane thereof. In some embodiments, although not shown, a second polymerized birefringent medium layer configured with a second predetermined 1D or 2D slant angle or twist angle variation(s) within the film plane thereof may be formed at (e.g., on a top surface of) the first polymerized birefringent medium layer 2019, via processes similar to those forming the first polymerized birefringent medium layer 2019. In some embodiments, through the first predetermined 1D or 2D slant angle or twist angle variation(s) and the second predetermined 1D or 2D slant angle or twist angle variation(s), a predetermined slant angle or twist angle variation along the thickness direction of the stack of the first and second polymerized birefringent medium layers may be achieved.

Although one printhead 2006 and one printhead 2036 are shown in FIG. 20D for illustrative purposes, the inkjet printer may include a plurality of printheads 2006 for dispensing the chiral dopant 2005 at different locations of the alignment structure 1710 simultaneously or sequentially, and/or a plurality of printheads 2036 for dispensing the birefringent medium 2065 at different locations of the alignment structure 1710 simultaneously or sequentially.

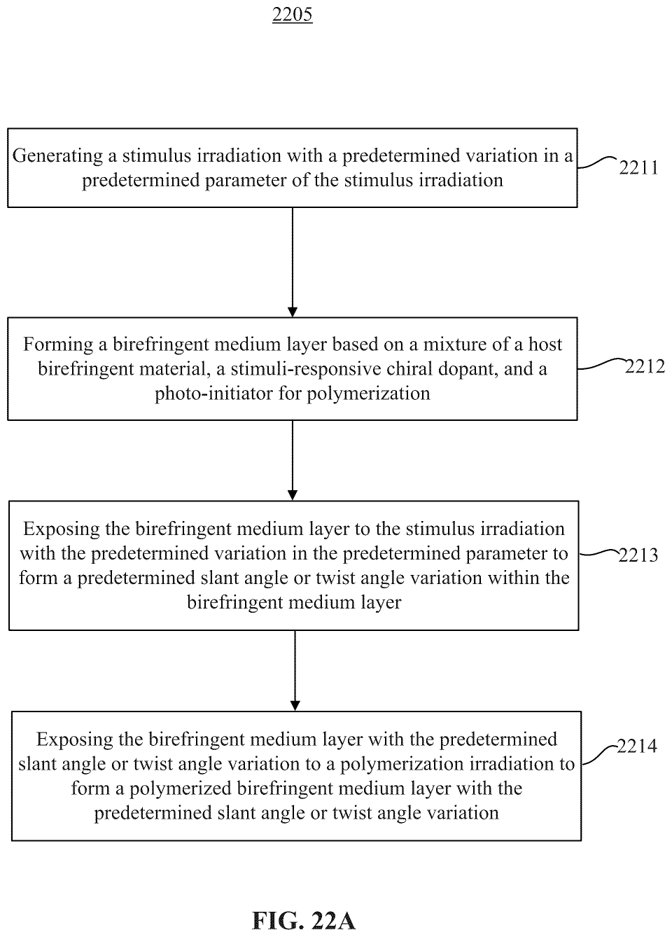

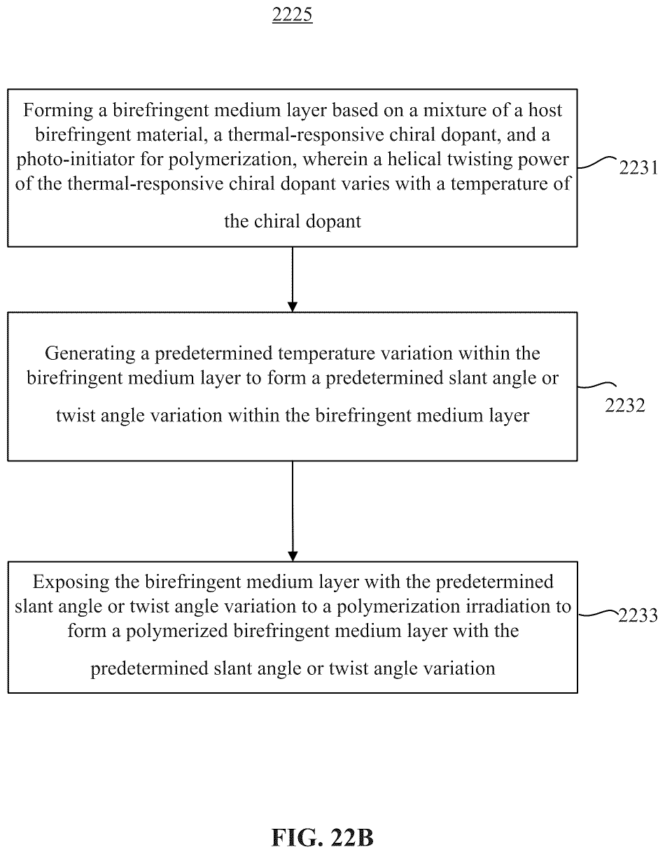

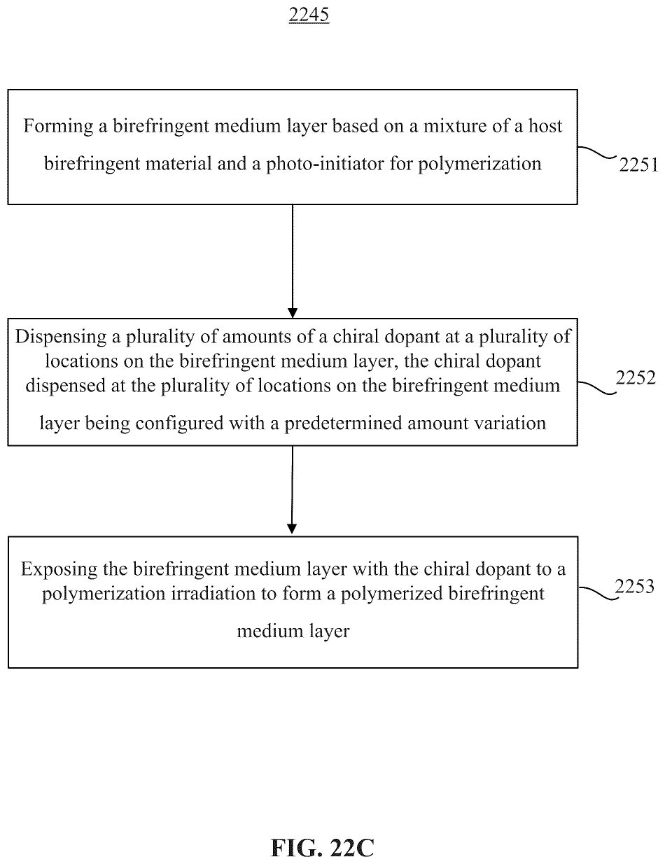

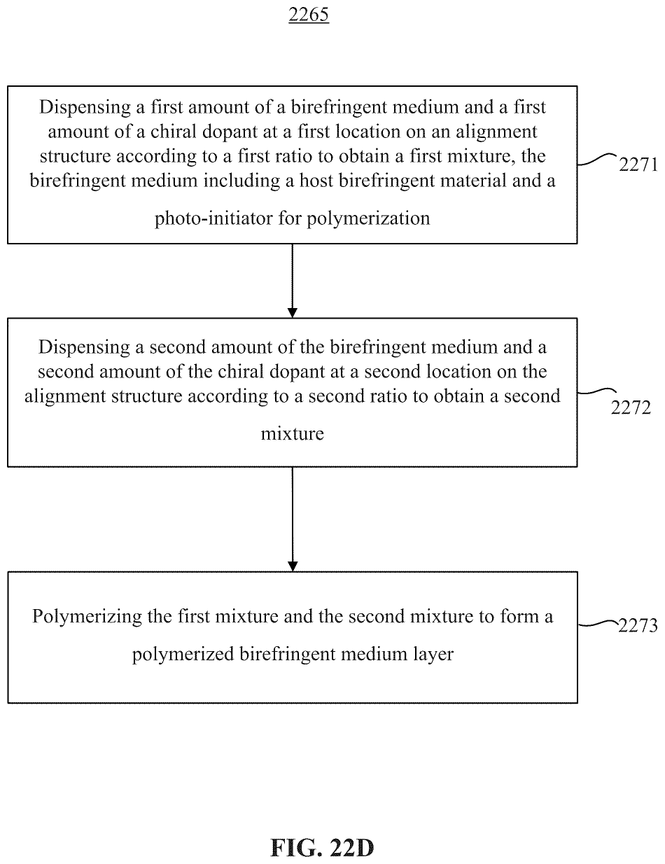

FIGS. 22A-22D are flowcharts illustrating various methods for fabricating an LCPH element with a predetermined slant angle or twist angle variation, according to various embodiments of the present disclosure. FIG. 22A is a flowchart illustrating a method 2205 for fabricating an LCPH element with a predetermined slant angle or twist angle variation, according to an embodiment of the present disclosure. As shown in FIG. 22A, the method 2205 may include generating a stimulus irradiation with a predetermined variation in a predetermined parameter of the stimulus irradiation (step 2211). The method 2205 may also include forming a birefringent medium layer based on a mixture of a host birefringent material, a stimuli-responsive chiral dopant, and a photo-initiator for polymerization (step 2212). The method 2200 may also include exposing the birefringent medium layer to the stimulus irradiation with the predetermined variation in the predetermined parameter to form a predetermined slant angle or twist angle variation within the birefringent medium layer (step 2213). The method 2205 may also include exposing the birefringent medium layer with the predetermined slant angle or twist angle variation to a polymerization irradiation to form a polymerized birefringent medium layer with the predetermined slant angle or twist angle variation (step 2214).

In some embodiments, the stimuli-responsive chiral dopant may include a photo-responsive chiral dopant with a photo-responsive HTP. In some embodiments, the predetermined variation in the predetermined parameter of the stimulus irradiation may include at least one of a predetermined intensity variation, a predetermined wavelength variation, a predetermined time duration variation, or a predetermined dose variation. In some embodiments, the stimulus irradiation may have a wavelength (or wavelength range) within a UV wavelength range, a visible wavelength range, an infrared wavelength range, or a combination thereof. In some embodiments, the stimuli-responsive chiral dopant may include a thermal-responsive chiral dopant with a thermal-responsive HTP, and the stimulus irradiation may have a wavelength (or wavelength range) within an infrared wavelength range.

In some embodiments, the mixture may also include an absorbing additive configured to have an absorption band associated with the wavelength spectrum of the stimulus irradiation. The absorbing additive may have a predetermined non-uniform distribution in a thickness direction of the birefringent medium layer.

In some embodiments, the stimulus irradiation with the predetermined variation in the predetermined parameter of the stimulus irradiation may be generated via a projector, a photomask, or a direct writing device. In some embodiments, the stimulus irradiation with the predetermined variation in the predetermined parameter of the stimulus irradiation may be generated by a projector through projecting an image light with a predetermined intensity, wavelength, and/or time duration variation within a wavefront of the image light, onto the birefringent medium layer.

In some embodiments, the stimulus irradiation with the predetermined variation in the predetermined parameter of the stimulus irradiation may be a first stimulus irradiation with a predetermined intensity variation, and the first stimulus irradiation with the predetermined intensity variation may be generated based on a second stimulus irradiation with a spatially uniform intensity. The second stimulus irradiation may transmit through a photomask, and the photomask may convert the second stimulus irradiation into the first stimulus irradiation with the predetermined intensity variation. The photomask may be configured with a predetermined transmittance variation within a film plane of the photomask for the second stimulus irradiation.

In some embodiments, the stimulus irradiation with the predetermined variation in the predetermined parameter of the stimulus irradiation may be generated through focusing a light output from a light source into a spot or a line at a focal plane; and varying an intensity of the light over time in a predetermined intensity variation profile. In some embodiments, exposing the birefringent medium layer to the stimulus irradiation with the predetermined variation in the predetermined parameter of the stimulus irradiation may include scanning the spot or the line in one or two directions within a film plane and/or a thickness direction of the birefringent medium layer in a predetermined scanning profile. The method may include other steps not listed in the flowchart, including those processes described above in connection with other figures.

FIG. 22B is a flowchart illustrating a method 2225 for fabricating an LCPH element with a predetermined slant angle or twist angle variation, according to an embodiment of the present disclosure. As shown in FIG. 22B, the method 2225 may include forming a birefringent medium layer based on a mixture of a host birefringent material, a thermal-responsive chiral dopant, and a photo-initiator for polymerization, wherein a helical twisting power of the thermal-responsive chiral dopant varies with a temperature of the chiral dopant (step 2231). The stimuli-responsive chiral dopant may include a thermal-responsive chiral dopant with a thermal-responsive HTP. The method 2225 may also include generating a predetermined temperature variation within the birefringent medium layer to form a predetermined slant angle or twist angle variation within the birefringent medium layer (step 2232). The method 2225 may also include exposing the birefringent medium layer with the predetermined slant angle or twist angle variation to a polymerization irradiation to form a polymerized birefringent medium layer with the predetermined slant angle or twist angle variation (step 2233).

FIG. 22C is a flowchart illustrating a method 2245 for fabricating an LCPH element with a predetermined slant angle or twist angle variation, according to an embodiment of the present disclosure. As shown in FIG. 22C, the method 2245 may include forming a birefringent medium layer based on a mixture of a host birefringent material and a photo-initiator for polymerization (step 2251). The method 2245 may include dispensing a plurality of amounts of a chiral dopant at a plurality of locations on the birefringent medium layer, the chiral dopant dispensed at the plurality of locations on the birefringent medium layer being configured with a predetermined amount variation (step 2252). The chiral dopant dispensed at the plurality of locations of the birefringent medium layer may be configured with a predetermined amount variation. For example, a first amount of the chiral dopant dispensed at a first location of the birefringent medium layer may be different from a second amount of the chiral dopant dispensed at a second location of the birefringent medium layer. The method 2245 may also include exposing the birefringent medium layer with the chiral dopant to a polymerization irradiation to form a polymerized birefringent medium layer (step 2253).

In some embodiments, the chiral dopant dispensed at the plurality of locations of the birefringent medium layer may be a first chiral dopant having a chirality of first handedness, and the mixture may include a second dopant chiral dopant having a chirality of second handedness that is opposite to the first handedness. In some embodiments, the chiral dopant dispensed at the plurality of locations of the birefringent medium layer may be a first chiral dopant having a chirality of first handedness. The plurality of locations of the birefringent medium layer at which the first chiral dopant is dispensed are a plurality of first locations. The first chiral dopant dispensed at the plurality of first locations of the birefringent medium layer may be configured with a first predetermined amount variation. In some embodiments, after dispensing the plurality of amounts of the first chiral dopant at the plurality of first locations of the birefringent medium layer and before exposing the birefringent medium layer with the first chiral dopant to a polymerization irradiation to form the polymerized birefringent medium layer, the method may include dispensing a plurality of amounts of a second chiral dopant at a plurality of second locations of the birefringent medium layer. The second dopant chiral dopant may have a chirality of second handedness that is opposite to the first handedness. In some embodiments, the second chiral dopant dispensed at the plurality of second locations of the birefringent medium layer may be configured with a second predetermined amount variation.

FIG. 22D is a flowchart illustrating a method 2265 for fabricating an LCPH element with a predetermined slant angle or twist angle variation, according to an embodiment of the present disclosure. As shown in FIG. 22D, the method 2265 may include dispensing a first amount of a birefringent medium and a first amount of a chiral dopant at a first location on an alignment structure according to a first ratio to obtain a first mixture, the birefringent medium including a host birefringent material and a photo-initiator for polymerization (step 2271). The birefringent medium may include a mixture of a host birefringent material and a photo-initiator for polymerization. The method 2265 may also include dispensing a second amount of the birefringent medium and a second amount of the chiral dopant at a second location on the alignment structure according to a second ratio to obtain a second mixture (step 2272). The method 2265 may also include polymerizing the first mixture and the second mixture to form a polymerized birefringent medium layer (step 2273).

In some embodiments, the chiral dopant may be a first chiral dopant having a chirality of first handedness, and the mixture may include a second dopant chiral dopant having a chirality of second handedness that is opposite to the first handedness. In some embodiments, the polymerized birefringent medium layer may be a first polymerized birefringent medium layer, and the method may include dispensing an amount of the birefringent medium and an amount of the chiral dopant at a first location of the first polymerized birefringent medium layer according to a third ratio to obtain a third mixture; dispensing an amount of the birefringent medium and an amount of the chiral dopant at a second location of the first polymerized birefringent medium layer according to a fourth ratio to obtain a fourth mixture; and polymerizing the third mixture and the fourth mixture to form a second polymerized birefringent medium layer on the first polymerized birefringent medium.

The LCPH elements fabricated based on the disclosed processes and methods may be implemented in systems or devices for imaging, sensing, communication, biomedical applications, etc. For example, the LCPH elements fabricated based on the disclosed processes and methods may be implemented in various systems for augmented reality (“AR”), virtual reality (“VR”), and/or mixed reality (“MR”) applications. An artificial reality system, such as a head-mounted display (“HMD”) or heads-up display (“HUD”) system, generally includes a near-eye display (“NED”) system in the form of a headset or a pair of glasses, and configured to present content to a user via an electronic or optic display within a short distance, for example, about 10-20 mm in front of the eyes of a user. The NED system may display virtual objects or combine images of real objects with virtual objects, as in VR, AR, or MR applications. For example, in an AR system, a user may view both images of virtual objects (e.g., computer-generated images (“CGIs”)) and the surrounding environment by, for example, seeing through transparent display glasses or lenses (also referred to as an optical see-through AR system).

In some embodiments, a method is provided. The method includes generating a stimulus irradiation with a predetermined variation in a predetermined parameter of the stimulus irradiation; forming a birefringent medium layer based on a mixture of a host birefringent material, a stimuli-responsive chiral dopant, and a photo-initiator for polymerization; exposing the birefringent medium layer to the stimulus irradiation with the predetermined variation in the predetermined parameter to form a predetermined slant angle or twist angle variation within the birefringent medium layer; and exposing the birefringent medium layer with the predetermined slant angle or twist angle variation to a polymerization irradiation to form a polymerized birefringent medium layer with the predetermined slant angle or twist angle variation.

In some embodiments, the predetermined variation in the predetermined parameter of the stimulus irradiation includes at least one of a predetermined intensity variation, a predetermined wavelength variation, a predetermined time duration variation, or a predetermined dose variation. In some embodiments, the stimulus irradiation has a wavelength range within at least one of an ultraviolet wavelength range, a visible wavelength range, or an infrared wavelength range. In some embodiments, the stimuli-responsive chiral dopant includes a photo-responsive chiral dopant with a photo-responsive helical twisting power. In some embodiments, the stimuli-responsive chiral dopant includes a thermal-responsive chiral dopant with a thermal-responsive helical twisting power.

In some embodiments, the mixture further includes an absorbing additive configured to have an absorption band associated with a wavelength range of the stimulus irradiation, the method further includes configuring a predetermined non-uniform distribution of the absorbing additive in a thickness direction of the birefringent medium layer. In some embodiments, generating the stimulus irradiation with the predetermined variation in the predetermined parameter of the stimulus irradiation includes: generating the stimulus irradiation with the predetermined variation in the predetermined parameter of the stimulus irradiation through a projector, a photomask, or a direct writing device.

In some embodiments, a method is provided. The method includes forming a birefringent medium layer based on a mixture of a host birefringent material, a thermal-responsive chiral dopant, and a photo-initiator for polymerization, wherein a helical twisting power of the thermal-responsive chiral dopant varies with a temperature of the chiral dopant. The method also includes generating a predetermined temperature variation within the birefringent medium layer to form a predetermined slant angle or twist angle variation within the birefringent medium layer. The method also includes exposing the birefringent medium layer with the predetermined slant angle or twist angle variation to a polymerization irradiation to form a polymerized birefringent medium layer with the predetermined slant angle or twist angle variation.

In some embodiments, generating the predetermined temperature variation within the birefringent medium layer to form a predetermined slant angle or twist angle variation within the birefringent medium layer includes: generating an infrared irradiation with a predetermined intensity variation; and exposing the birefringent medium layer to the infrared irradiation with the predetermined intensity variation to form the predetermined slant angle or twist angle variation within the birefringent medium layer.

In some embodiments, the mixture further includes an absorbing additive configured to have an absorption band associated with a wavelength range of the infrared irradiation, and the method further includes configuring a predetermined non-uniform distribution of the absorbing additive in a thickness direction of the birefringent medium layer.

In some embodiments, generating the predetermined temperature variation within the birefringent medium layer to form a predetermined slant angle or twist angle variation within the birefringent medium layer includes: configuring a thermal processing device to provide an output thermal energy variation; and thermally processing the birefringent medium layer using the thermal processing device to generate the predetermined temperature variation within the birefringent medium layer. In some embodiments, the thermal processing device includes a resistive heating element configured with a predetermined resistance variation.

In some embodiments, generating the predetermined temperature variation within the birefringent medium layer to form a predetermined slant angle or twist angle variation within the birefringent medium layer includes: generating, via at least one conductive electrode layer, an electric field within the birefringent medium layer, the electric field having at least one of a predetermined amplitude variation or a predetermined frequency variation and configured to produce the predetermined temperature variation within the birefringent medium layer.

In some embodiments, a method is provided. The method includes forming a birefringent medium layer based on a mixture of a host birefringent material and a photo-initiator for polymerization. The method also includes dispensing a plurality of amounts of a chiral dopant at a plurality of locations on the birefringent medium layer, the chiral dopant dispensed at the plurality of locations on the birefringent medium layer being configured with a predetermined amount variation. The method includes exposing the birefringent medium layer with the chiral dopant to a polymerization irradiation to form a polymerized birefringent medium layer.

In some embodiments, dispensing the plurality of amounts of the chiral dopant at the plurality of locations on the birefringent medium layer includes: dispensing, via inkjet printing, aerosol jet printing, spray printing, screen printing, or 3D printing, the plurality of amounts of the chiral dopant at the plurality of locations on the birefringent medium layer. In some embodiments, the chiral dopant is a first chiral dopant having a chirality of a first handedness, and the mixture includes a second chiral dopant having a chirality of a second handedness that is opposite to the first handedness. In some embodiments, the chiral dopant is a first chiral dopant having a chirality of a first handedness, the plurality of locations on the birefringent medium layer at which the first chiral dopant is dispensed are a plurality of first locations, and the first chiral dopant dispensed at the plurality of first locations on the birefringent medium layer are configured with a first predetermined amount variation, and the method further comprises: after dispensing the plurality of amounts of the first chiral dopant at the plurality of first locations on the birefringent medium layer and before exposing the birefringent medium layer with the first chiral dopant to a polymerization irradiation to form the polymerized birefringent medium layer, dispensing a plurality of amounts of a second chiral dopant at a plurality of second locations on the birefringent medium layer. The second chiral dopant has a chirality of a second handedness that is opposite to the first handedness, and the second chiral dopant dispensed at the plurality of second locations on the birefringent medium layer are configured with a second predetermined amount variation. In some embodiments, at least one of the first locations is different from at least one of the second locations.

In some embodiments, a method is provided. The method includes dispensing a first amount of a birefringent medium and a first amount of a chiral dopant at a first location on an alignment structure according to a first ratio to obtain a first mixture, the birefringent medium including a host birefringent material and a photo-initiator for polymerization. The method also includes dispensing a second amount of the birefringent medium and a second amount of the chiral dopant at a second location on the alignment structure according to a second ratio to obtain a second mixture. The method also includes polymerizing the first mixture and the second mixture to form a polymerized birefringent medium layer.

In some embodiments, dispensing the first amount of the birefringent medium and the first amount of the chiral dopant at the first location on the alignment structure according to the first ratio to obtain the first mixture includes: dispensing, via inkjet printing, aerosol jet printing, spray printing, screen printing, or 3D printing, the first amount of the birefringent medium and the first amount of the chiral dopant at the first location on the alignment structure according to the first ratio to obtain the first mixture. In some embodiments, the chiral dopant is a first chiral dopant having a chirality of a first handedness, and the birefringent medium includes a second chiral dopant having a chirality of a second handedness that is opposite to the first handedness. In some embodiments, the polymerized birefringent medium layer is a first polymerized birefringent medium layer, and the method further comprises: dispensing a third amount of the birefringent medium and a third amount of the chiral dopant at a first location on the first polymerized birefringent medium layer according to a third ratio to obtain a third mixture; dispensing a fourth amount of the birefringent medium and a fourth amount of the chiral dopant at a second location on the first polymerized birefringent medium layer according to a fourth ratio to obtain a fourth mixture; and polymerizing the third mixture and the fourth mixture to form a second polymerized birefringent medium layer on the first polymerized birefringent medium layer.

The foregoing description of the embodiments of the present disclosure have been presented for the purpose of illustration. It is not intended to be exhaustive or to limit the disclosure to the precise forms disclosed. Persons skilled in the relevant art can appreciate that modifications and variations are possible in beam of the above disclosure.

Any of the steps, operations, or processes described herein may be performed or implemented with one or more hardware and/or software modules, alone or in combination with other devices. In one embodiment, a software module is implemented with a computer program product including a computer-readable medium containing computer program code, which can be executed by a computer processor for performing any or all of the steps, operations, or processes described. In some embodiments, a hardware module may include hardware components such as a device, a system, an optical element, a controller, an electrical circuit, a logic gate, etc.

Embodiments of the present disclosure may also relate to an apparatus for performing the operations herein. This apparatus may be specially constructed for the specific purposes, and/or it may include a general-purpose computing device selectively activated or reconfigured by a computer program stored in the computer. Such a computer program may be stored in a non-transitory, tangible computer readable storage medium, or any type of media suitable for storing electronic instructions, which may be coupled to a computer system bus. The non-transitory computer-readable storage medium can be any medium that can store program codes, for example, a magnetic disk, an optical disk, a read-only memory (“ROM”), or a random access memory (“RAM”), an Electrically Programmable read only memory (“EPROM”), an Electrically Erasable Programmable read only memory (“EEPROM”), a register, a hard disk, a solid-state disk drive, a smart media card (“SMC”), a secure digital card (“SD”), a flash card, etc. Furthermore, any computing systems described in the specification may include a single processor or may be architectures employing multiple processors for increased computing capability. The processor may be a central processing unit (“CPU”), a graphics processing unit (“GPU”), or any processing device configured to process data and/or perform computation based on data. The processor may include both software and hardware components. For example, the processor may include a hardware component, such as an application-specific integrated circuit (“ASIC”), a programmable logic device (“PLD”), or a combination thereof. The PLD may be a complex programmable logic device (“CPLD”), a field-programmable gate array (“FPGA”), etc.

Embodiments of the present disclosure may also relate to a product that is produced by a computing process described herein. Such a product may include information resulting from a computing process, where the information is stored on a non-transitory, tangible computer readable storage medium and may include any embodiment of a computer program product or other data combination described herein.

Further, when an embodiment illustrated in a drawing shows a single element, it is understood that the embodiment or an embodiment not shown in the figures but within the scope of the present disclosure may include a plurality of such elements. Likewise, when an embodiment illustrated in a drawing shows a plurality of such elements, it is understood that the embodiment or an embodiment not shown in the figures but within the scope of the present disclosure may include only one such element. The number of elements illustrated in the drawing is for illustration purposes only, and should not be construed as limiting the scope of the embodiment. Moreover, unless otherwise noted, the embodiments shown in the drawings are not mutually exclusive, and they may be combined in any suitable manner. For example, elements shown in one figure/embodiment but not shown in another figure/embodiment may nevertheless be included in the other figure/embodiment. In any optical device disclosed herein including one or more optical layers, films, plates, or elements, the numbers of the layers, films, plates, or elements shown in the figures are for illustrative purposes only. In other embodiments not shown in the figures, which are still within the scope of the present disclosure, the same or different layers, films, plates, or elements shown in the same or different figures/embodiments may be combined or repeated in various manners to form a stack.

Various embodiments have been described to illustrate the exemplary implementations. Based on the disclosed embodiments, a person having ordinary skills in the art may make various other changes, modifications, rearrangements, and substitutions without departing from the scope of the present disclosure. Thus, while the present disclosure has been described in detail with reference to the above embodiments, the present disclosure is not limited to the above described embodiments. The present disclosure may be embodied in other equivalent forms without departing from the scope of the present disclosure. The scope of the present disclosure is defined in the appended claims.

What is claimed is:

1. A device, comprising:
a substrate;
an alignment structure disposed on the substrate; and
a layer of a birefringent medium disposed on the alignment structure, the birefringent medium having an extraordinary refractive index, an ordinary refractive index different from the extraordinary refractive index, and an intermediate refractive index between the extraordinary refractive index and the ordinary refractive index,
wherein molecules of the birefringent medium are configured to form a plurality of helical structures having a helical axis,
wherein the layer is configured with an out-of-plane principal refractive index along the helical axis, and two equal in-plane principal refractive indices within a plane perpendicular to the helical axis, and
wherein the out-of-plane principal refractive index is equal to the intermediate refractive index, and is substantially the same as the two equal in-plane principal refractive indices.

2. The device of claim 1, wherein the molecules of the birefringent medium include biaxial molecules having a biaxial molecular structure.

3. The device of claim 1, wherein the birefringent medium includes at least one of liquid crystal molecules having parallelepiped platelets shapes, liquid crystal molecules having bent shapes, multipodes, or a liquid-crystalline side-chain polymer.

4. The device of claim 1, wherein the birefringent medium includes a mixture of liquid crystal molecules having a rod shape and nanocrystal particles.

5. The device of claim 1, wherein the molecules of the birefringent medium include a mixture of first uniaxial molecules having a first shape and second uniaxial molecules having a second shape different from the first shape.

6. The device of claim 5, wherein the first uniaxial molecules having the first shape include first uniaxial liquid crystal molecules having a rod shape, and the second uniaxial molecules having the second shape include second uniaxial liquid crystal molecules having a disc shape.

7. The device of claim 5, wherein the first uniaxial molecules having the first shape include first uniaxial liquid crystal molecules having a first rod shape, and the second uniaxial molecules having the second shape include second uniaxial liquid crystal molecules having a second rod shape different from the first rod shape.

8. The device of claim 5, wherein the layer of the birefringent medium is a porous liquid crystal polymer layer including a plurality of pores, the first uniaxial molecules are configured to form the helical structures, and the second uniaxial molecules are located within the pores.

9. The device of claim 1, wherein the layer of the birefringent medium includes a plurality of sub-layers stacked along the helical axis, the molecules in each sub-layer being configured with a same orientation, and the molecules in two adjacent sub-layers being configured with different orientations.

10. The device of claim 9, wherein the plurality of sub-layers include a plurality of biaxial liquid crystal polymer layers or a plurality of biaxial organic solid crystals.

11. The device of claim 1, wherein the helical axis is perpendicular to a surface of the layer of the birefringent medium, or tilted with respect to the surface of the layer of the birefringent medium.

12. A method, comprising:
obtaining a substrate with an alignment structure formed thereon; and
forming a layer of a birefringent medium on the alignment structure, wherein molecules of the birefringent medium are aligned by the alignment structure to form a plurality of helical structures having a helical axis, and wherein the birefringent medium is configured with an extraordinary refractive index, an ordinary refractive index different from the extraordinary refractive index, and an intermediate refractive index between the extraordinary refractive index and the ordinary refractive index,
wherein the layer has an out-of-plane principal refractive index along the helical axis, and two equal in-plane principal refractive indices within a plane perpendicular to the helical axis, and
wherein the out-of-plane principal refractive index is equal to the intermediate refractive index, and is substantially the same as the two equal in-plane principal refractive indices.

13. The method of claim 12, wherein the molecules of the birefringent medium include biaxial molecules having a biaxial molecular structure.

14. The method of claim 12, wherein the molecules of the birefringent medium include a mixture of liquid crystal molecules having a rod shape and nanocrystal particles.

15. The method of claim 12, wherein the molecules of the birefringent medium include a mixture of first uniaxial molecules having a first shape and second uniaxial molecules having a second shape different from the first shape.

16. The method of claim 15, wherein forming the layer of the birefringent medium on the alignment structure includes:
forming a first sub-layer including the first uniaxial molecules on the alignment structure, the first uniaxial molecules being configured to form the helical structures within the first sub-layer;
polymerizing the first sub-layer to form a polymerized first sub-layer that is a porous film including a plurality of pores; and
forming a second sub-layer including the second uniaxial molecules on the polymerized first sub-layer, wherein the second uniaxial molecules at least partially fill the pores of the polymerized first sub-layer.

17. The method of claim 12, wherein forming the layer of the birefringent medium on the alignment structure includes:
forming a plurality of sub-layers stacked along the helical axis on the substrate, wherein molecules in each sub-layer are configured with a same orientation, and molecules in two adjacent sub-layers are configured with different orientations.

18. The method of claim 17, wherein the plurality of sub-layers include a plurality of biaxial liquid crystal polymer layers or a plurality of biaxial organic solid crystals.

19. A method, comprising:
forming a first layer including uniaxial molecules arranged in plurality of helical structures having a helical axis, the first layer being defined by a first dimension, a second dimension, and a third dimension that are orthogonal to one another, the first dimension and the second dimension being within a surface of the first layer, and the third dimension being along a thickness direction of the first layer; and
applying an asymmetric field to the first layer along the third dimension and at least one of the first dimension or the second dimension to obtain a second layer having an induced local biaxial optical anisotropy,
wherein an out-of-plane principal refractive index of the first layer along the helical axis is different from an in-plane principal refractive index of the first layer within a plane perpendicular to the helical axis, and
wherein an out-of-plane principal refractive index of the second layer along the helical axis is substantially the same as an in-plane principal refractive index of the second layer within the plane perpendicular to the helical axis.

20. The method of claim 19, wherein the asymmetric field includes at least one of an asymmetric electric field, an asymmetric magnetic field, or an asymmetric mechanical force.
